(19) United States
(12) Patent Application Publication
(10) Pub. No.: US 2011/0213625 A1
(43) Pub. Date: Sep. 1, 2011

(54) Apparatus and method for processing and/or for providing healthcare information and/or helathcare-related information

(76) Inventor: RAYMOND ANTHONY JOAO, YONKERS, NY (US)

(21) Appl. No.: 13/066,868

(22) Filed: Apr. 27, 2011

Related U.S. Application Data
(63) Continuation-in-part of application No. 12/589,294, filed on Oct. 21, 2009.
Application No. 12/589,294 is a continuation-in-part of application No. 11/978,366, filed on Oct. 29, 2007.
Application No. 11/978,366 is a continuation of application No. 09/737,348, filed on Dec. 15, 2000, now Pat. No. 7,464,040.
Application No. 12/589,294 is a continuation-in-part of application No. 11/978,461, filed on Oct. 29, 2007.
Application No. 11/978,461 is a continuation of application No. 09/987,226, filed on Nov. 14, 2001, now Pat. No. 7,490,048.
(60) Provisional application No. 60/172,555, filed on Dec. 18, 1999.
(60) Provisional application No. 60/286,422, filed on Apr. 25, 2001.

(51) Int. Cl. G06Q 50/00; G06Q 10/00

(52) U.S. Cl. 705/3; 705/2

(57) ABSTRACT

A computer-implemented method, including storing a healthcare record or a healthcare history of an individual in a database or a memory device, processing, with or using a processing device, information for allowing an individual to access a healthcare record or a healthcare history of the individual with a first computer or a first communication device; processing information for allowing the individual to access or obtain information, a link, or a hyperlink, to information regarding an employee benefit in which the individual is enrolled; processing information regarding an information request regarding the employee benefit or processing information for generating a claim or a request for, or pursuant to, the employee benefit; generating a message containing information responsive to the information request or responsive to the claim or the request; and transmitting the message to the first computer or to the first communication device.

### RELATED APPLICATIONS

This is a continuation-in-part application of U.S. patent application Ser. No. 12/589,294, filed Oct. 21, 2009, and entitled “APPARATUS AND METHOD FOR PROCESSING AND/OR FOR PROVIDING HEALTHCARE INFORMATION AND/OR HEALTHCARE-RELATED INFORMATION”, which application is a continuation-in-part application of U.S. patent application Ser. No. 11/978,366, filed Oct. 29, 2007, and entitled “APPARATUS AND METHOD FOR PROCESSING AND/OR FOR PROVIDING HEALTHCARE INFORMATION AND/OR HEALTHCARE-RELATED INFORMATION”, which application is a continuation application of U.S. patent application Ser. No. 09/737,348, filed Dec. 15, 2000, and entitled “APPARATUS AND METHOD FOR PROCESSING AND/OR FOR PROVIDING HEALTHCARE INFORMATION AND/OR HEALTHCARE-RELATED INFORMATION”, now U.S. Pat. No. 7,464,040, the subject matter and teachings of which are hereby incorporated by reference herein. U.S. patent application Ser. No. 09/737,348, filed Dec. 15, 2000, now U.S. Pat. No. 7,464,040, claims the benefit of priority of U.S. Provisional Patent Application Ser. No. 60/172,555, filed Dec. 18, 1999, and entitled “APPARATUS AND METHOD FOR PROCESSING AND/OR FOR PROVIDING HEALTHCARE INFORMATION AND/OR HEALTHCARE-RELATED INFORMATION”, the subject matter and teachings of which are hereby incorporated by reference herein. U.S. patent application Ser. No. 12/589,294, filed Oct. 21, 2009, and entitled “APPARATUS AND METHOD FOR PROCESSING AND/OR FOR PROVIDING HEALTHCARE INFORMATION AND/OR HEALTHCARE-RELATED INFORMATION”, is also a continuation-in-part application of U.S. patent application Ser. No. 11/978,461, filed Oct. 29, 2007, and entitled “APPARATUS AND METHOD FOR PROCESSING AND/OR FOR PROVIDING HEALTHCARE INFORMATION AND/OR HEALTHCARE-RELATED INFORMATION”, which application is a continuation application of U.S. patent application Ser. No. 09/987,226, filed Nov. 14, 2001, and entitled “APPARATUS AND METHOD FOR PROCESSING AND/OR FOR PROVIDING HEALTHCARE INFORMATION AND/OR HEALTHCARE-RELATED INFORMATION”, now U.S. Pat. No. 7,490,048, the subject matter and teachings of which are hereby incorporated by reference herein. U.S. patent application Ser. No. 09/987,226, filed Nov. 14, 2001, now U.S. Pat. No. 7,490,048, claims the benefit of priority of U.S. Provisional Patent Application Ser. No. 60/286,422, filed Apr. 25, 2001, and entitled “APPARATUS AND METHOD FOR PROCESSING AND/OR FOR PROVIDING HEALTHCARE INFORMATION AND/OR HEALTHCARE-RELATED INFORMATION”, the subject matter and teachings of which are hereby incorporated by reference herein.

### FIELD OF THE INVENTION

The present invention pertains to an apparatus and a method for processing and/or for providing healthcare information and/or healthcare-related information and, in particular, to an apparatus and a method for processing and/or for providing healthcare information and/or healthcare-related information for a variety of healthcare and healthcare related applications.

### BACKGROUND OF THE INVENTION

Each year, tens of millions of individuals seek or need the assistance of healthcare professionals. In order to perform proper diagnoses and to prescribe appropriate treatments, healthcare professional or providers typically rely on information which is obtained from patients, relatives of patients, previous providers, and/or healthcare facility and/or hospital staff members. The need to have accurate and/or up-to-date data and/or information, in providing healthcare services and/or healthcare-related services, cannot be emphasized enough.

Stories constantly emerge about patients receiving the wrong treatments, having the wrong surgical procedures performed on themselves, receiving a drug or drugs which fatally and/or otherwise adversely interact with another drug or drugs, etc., with stories going on and on. Recently, it has been estimated that between 44,000 and 98,000 individuals die, in the United States alone, as the result of errors or mistakes made by doctors, healthcare providers, and/or healthcare facility workers. There is no doubt that many of these deaths result from inaccurate and/or erroneous information and/or the lack of the availability of correct and/or up-to-date information.

Another problem lies with the fact that the main source of patient information, medical histories, family histories, etc., upon which doctors or providers may base their diagnoses and/or treatments, are patients who usually supply this information on questionnaires or forms just prior to seeing the healthcare provider and/or during a preliminary interview with the provider. In this regard, information obtained from these questionnaires or forms, as well as from these preliminary interviews with the providers, may not necessarily result in sufficient, comprehensive, and/or accurate, information being obtained regarding the patient. Further, there is no guarantee that the same information will be provided, in a uniform manner, to a next or different provider. As a result, patient information may not be uniformly distributed and/or be available to providers at the point of treatment and/or otherwise.

Another problem which exists in the current healthcare system is that doctors or other providers do not always have the latest information and/or research material available to them prior to, and/or during, the diagnosis and/or treatment process.

It is also no secret that healthcare costs are rising at ever-increasing rates and that insurance companies and other healthcare payers expend great resources in processing and reconciling treatment claims and/or claims for healthcare services and/or benefits. Typically, these insurance and/or benefits claims take place in a paper-based environment and, as a result are slow and inefficient. Fraudulent claims and/or claims which cannot be verified pose another major problem for healthcare payers and insurance companies. These problems only serve to add to the growing costs of healthcare, delayed treatments, and a general dissatisfaction with the current healthcare system.

Another problem lies in making up-to-date training materials conveniently available to providers in order to allow providers to remain current with state-of-the-art information and training techniques.

Other problems lie in maintaining patient healthcare records or files private, in safeguarding patient healthcare records or files, in providing notification to patients and other individuals when others have accessed, obtained, and/or made changes to their respective healthcare records or files, and in enabling patients and individuals to restrict and/or limit access to their healthcare records or files.

The list of problems with the current healthcare system goes on and on. In view of the above, there is a great need for an apparatus and a method for providing healthcare information and/or healthcare-related information to the various providers, payers, patients, third party individuals, and/or insurance brokers, agents and/or other intermediaries, which overcomes the shortcomings of prior art.

### SUMMARY OF THE INVENTION

The present invention provides an apparatus and methods for providing healthcare information and/or healthcare-related information which overcomes the shortcomings of the prior art.

The present invention is directed to an apparatus and a method for processing and/or for providing healthcare information and/or healthcare-related information and, in particular, to an apparatus and a method for processing and/or for providing healthcare information and/or healthcare-related information for a variety of healthcare and healthcare related applications.

The apparatus and method of the present invention facilitates the creation and management of a comprehensive healthcare processing system which can manage patient and client records, doctor and other provider records, healthcare insurance and/or payer records, and thereby provide an apparatus, system and methods for providing a variety and a multitude of healthcare information processing applications, processes and services.

The present invention facilitates improved healthcare quality, efficient information collection, processing and dissemination, efficient diagnosis and treatment, cost efficiency, cost containment, as well as many other benefits and advantages as will be described herein. The apparatus and method of the present invention also facilitates the distribution and management of healthcare insurance, life insurance, disability insurance, as well as claims processing related thereto.

The present invention also provides an apparatus and a method for providing a comprehensive processing system which incorporates data and/or information from any combination and/or all of the participants in the healthcare field, including patients, providers, payers or insurance companies, and/or brokers, agents and/or other intermediaries who act on behalf of any of the above-identified persons or entities.

The apparatus of the present invention includes a central processing computer or central processing computer system which can be a network or server computer. The apparatus also includes a healthcare provider communication device or computer which is associated with a healthcare provider such as a healthcare professional, a hospital, a clinic, and/or any other provider of services described herein. The healthcare provider computer(s) can communicate with, and operate in conjunction with, the central processing computer and/or any of the other computers and/or computer systems or communication devices described herein.

The apparatus can also include a healthcare payer communication device or computer which is associated with a healthcare payer such as a healthcare insurer, insurance company, health maintenance organization, a clinic, and/or any other payer of healthcare services and products described herein. The healthcare payer computer(s) can communicate with, and operate in conjunction with, central processing computer and/or any of the other computers and/or computer systems or communication devices described herein.

The apparatus can also include a patient or individual user communication device or computer which is associated with a healthcare patient such as a patient, user, or client who seeks or who is provided with healthcare and/or related services, products and/or related information. The patient computer(s) can communicate with, and operate in conjunction with, central processing computer and/or any of the other computers and/or computer systems described herein.

The apparatus can also include an intermediary communication device or computer which is associated with an intermediary, a broker, an agent, and/or any other individual and/or entity, that can utilize the present invention in order to act for and/or on behalf of any other individual, party, or entity, described herein. The intermediary computer(s) can communicate with, and operate in conjunction with, central processing computer and any of the other computers and/or computer systems described herein.

Each of the central processing computer(s), the provider computer(s), the payer computer(s), the patient computer(s), and/or the intermediary computer(s), can transmit information to, as well as receive information from, any of the computers described herein. In this regard, each of the computers can communicate with, process information from, and/or share data and/or information with, each other and/or any other computer or computers described herein and/or utilized in conjunction with the present invention. In this manner, data and/or information transfer between any of the computers can take place in a bi-directional manner.

The central processing computer(s), the provider computer(s), the payer computers(s), the patient computer(s), and the intermediary computer(s), can communicate with one another, and/or be linked to one another, over a communication network, a telecommunication network, a telephone network, a line-connected network, and/or a wireless communication network.

The present invention can be utilized on, or over, the Internet and/or the World Wide Web and/or on, or over, any other communication network or system, including, but not limited to, a communication network or system, a telecommunication network or system, a telephone communication network or system, a cellular communication network or system, a wireless communication network or system, a wireless Internet network or system, a wireless World Wide Web network or system, a line or wired communication network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, and/or any other communication network or system, and/or any combination of the above communication networks or systems.

The apparatus and method of the present invention can utilize electronic commerce technologies and security methods, techniques and technologies, in any and/or all of the instances of data and/or information processing, and/or data and/or information transmission described herein.

Each of the central processing computer(s), as well as each of the computers or communication devices associated with each of the herein-described users, patients, providers, payers, and/or intermediaries, can include a central processing unit or CPU, a random access memory device(s) (RAM), a read only memory device(s), and a user input device. Each of the central processing computer(s), as well as each of the computers or communication devices associated with each of the herein-described users, patients, providers, payers, and/or intermediaries, can also include a display device, a transmitter(s), a receiver, a database(s), and an output device. The database(s) can contain any and/or all of the data and or information which is needed to perform the various processing methods, services, functions and/or operations, described herein.

The apparatus and method of the present invention can be utilized in numerous preferred embodiments in order to provide a vast array of healthcare and healthcare-related services for any one or more of the various parties described herein. Any patient, user, provider, payer, and/or intermediary, may utilize the present invention in the same, similar and/or analogous manner.

The present invention can be utilized for a number of applications, including, but not limited to, determining and/or ascertaining a medical or healthcare diagnosis, verifying and/or checking a diagnosis or treatment, or performing a self-diagnosis. The present invention can be utilized by any of the parties described herein.

The present invention can perform a diagnosis from data and/or information which can be entered by a user or provider, from data and/or information which can be obtained from medical or healthcare devices, machines, and/or equipment, and/or from data and/or information which can be entered by a user or provider in conjunction with, or along with, data and/or information which can be obtained from medical or healthcare devices, machines, and/or equipment.

The present invention can be utilized to create and maintain comprehensive patient databases which can be accessed via a network environment and/or otherwise, to perform healthcare and/or healthcare-related diagnoses, to provide healthcare and/or healthcare-related expected prognoses, to provide healthcare and/or healthcare-related treatment plans or programs, and/or to provide healthcare and/or healthcare-related treatment progress reports and/or evaluations.

The present invention can also be utilized in order to provide training and continuing education services for healthcare and/or healthcare-related professionals, to provide healthcare, healthcare-related, and/or wellness information, to provide information about healthcare and/or healthcare-related patient, providers, payers, and/or intermediaries, to provide scheduling management services for providers, to provide notification services for patients, providers, payers and/or intermediaries, and/or any other parties described herein, and/or to locate providers, payers and/or intermediaries.

The present invention can also be utilized in order to provide healthcare and/or healthcare-related claim processing services, claims submissions, claim processing, claim status checking, and claim reconciliation, claim fraud prevention, treatment evaluation, healthcare and/or healthcare insurance policy generation, management and administration, provider, payer and/or intermediary evaluation, drug and/or treatment interactivity, treatment, medication and/or organ availability and/or notification services, patient, provider, payer, intermediary and/or third party, notification services. The present invention can also be utilized as a clearinghouse for facilitating the offering, selling, buying, trading, and/or other commerce and/or transactions, involving healthcare and/or healthcare-related services, products and/or goods.

The various computers and/or communication devices can be utilized to transmit and/or to receive transmissions, information, messages, and/or notification messages and/or signals, or reports, to and/or between, the respective parties associated with the respective computers and/or communication devices. The transmission of information, messages, and/or notification messages and/or signals, or reports, can be effected via any one or more of e-mail messages, telephone messages, beeper or pager messages, physical mail delivery, electronic data transmission, and/or can be made via any other suitable and/or appropriate communication method and/or technique.

The present invention can be utilized in order to perform a diagnosis of a sickness, illness and/or other condition. The present invention can also be utilized to ensure that a proper treatment and/or procedure is performed on the patient, and/or to ensure that a subsequent treatment and/or treatments are performed as prescribed. The present invention can also be utilized in order to prevent medical and/or surgical mistakes, mishaps and/or other instances when improper treatment could occur.

The present invention can also be utilized to allow a subsequent care provider to re-evaluate a patient's condition and/or records and to seek additional assistance for the patient, and/or to perform a separate and independent assessment and/or diagnosis of the patient.

The present invention can also be utilized in order to access a patient's or a client's record(s) and input information concerning the treatment and/or procedure to be performed. Thereafter, the present invention can provide notification to a healthcare professional that the treatment and/or procedure may be a prescribed treatment or procedure or a non-prescribed treatment and/or procedure.

Any and/or all processing described herein can be performed in conjunction with a patient's medical history, family history, allergic conditions information, and/or with any other information deemed important and/or essential in an individual's healthcare diagnoses and/or treatments.

The present invention can also be utilized to perform treatment evaluations and/or treatment monitoring so as to allow for an evaluation and/or a monitoring of treatment and/or for providing training for healthcare providers and/or professionals. The present invention can also be utilized in order to allow payer and/or insurance companies to evaluate treatments, treatment plans, treatment progress, and/or any other evaluations and/or verifications for healthcare claims processing.

The present invention can provide treatment evaluation and/or monitoring for healthcare payers which can be utilized for performing claims processing, provider evaluations, patient evaluations, and/or any other useful and/or desired purpose.

The present invention can also be utilized to create and maintain a comprehensive patient healthcare database which can be accessed by any provider, payer, intermediary, and/or other party or user, in order to access the patient's healthcare files and/or records. The comprehensive database can provide data and/or information source which can be accessed by any provider, from anywhere in the world, and at any time, in order to obtain information about a patient in his, her, or its care. Payers can also utilize the comprehensive database in order to ascertain payment eligibility, the existence of pre-existing conditions and/or to obtain any other useful information.

The present invention can also be utilized in order to find and/or to locate providers and/or payers of, and for, respectively, various healthcare treatments, healthcare services and/or healthcare goods or products and/or healthcare-related goods or products. The present invention can also be utilized to find a payer or insurance company for providing desired coverage and/or for paying for certain treatments and/or procedures.

The present invention can also be utilized to find and/or locate supplies, body organs, blood, medications, and/or any other goods, products, and/or supplies, etc. The present invention can also be utilized by intermediaries, such as insurance brokers, who need to find certain insurance companies and/or payers who meet the needs of certain patients and/or clients, and/or other individuals and/or third parties.

The present invention can also be programmed to provide notification of the availability of a provider, the emergence of a patient in need of a certain care, the availability of a payer or an insurance company to offer a policy or a certain policy, the availability of a healthcare facility to provide certain care, the availability of certain supplies, a body organ, a blood type, an expiration of an insurance policy (i.e. healthcare insurance, life insurance, disability insurance, etc.,) and/or the occurrence of any event which may be of interest to any of the patients, users, providers, payers, and/or intermediaries, described herein.

The present invention can also be utilized to schedule appointments with any of the patients, providers, payers, and/or intermediaries, described herein.

The present invention can be utilized by intermediaries, such as, but not limited to brokers, insurance brokers, agents, and others, in order to service their respective clients. The present invention can be utilized to prepare policy quotes, to compare available policies, to generate and/or underwrite policies, and to service policy claims. In this, manner, the present invention can provide a platform for allowing a broker to provide improved services to his or her clients while also providing for a more paperless working relationship.

The present invention can also be utilized to process healthcare claims. The present invention can allow any of the patients, providers, payers, users, and/or intermediaries, to file claims with the respective party electronically and/or otherwise. The present invention can provide for the processing, tracking and reconciliation, of any and/or all healthcare claims and/or healthcare-related claims.

The present invention can also be utilized to notify any party described herein, as well as any third parties, regarding any event, happening, occurrence, and/or any aspect of any claim submission and/or processing activities.

The present invention can also provide for automatic claim submission via the central processing computer once a final diagnosis and treatment has been prescribed by a provider and/or upon the occurrence of an examination and/or the administration of a treatment.

The present invention can also be utilized, in the manner described above in connection with claiming healthcare insurance benefits, disability insurance benefits, and/or life insurance benefits.

The present invention can also be utilized to administer and/or maintain financial accounts for, and/or on behalf of, any of the patients, users, providers, payers, and/or intermediaries, described herein. The present invention can maintain detailed records of any and/or all of such transfers and/or transactions and provide periodic account statements to the respective parties maintaining accounts with the present invention.

The apparatus and method of the present invention can also utilize electronic signatures and/or process electronic signatures and/or electronic signature information which can correspond to any of the herein-described parties in performing any of the herein-described processing routines and/or functions.

The apparatus and method of the present can also be utilized as a healthcare training simulator for any of the providers, healthcare providers, healthcare professionals, and/or other providers described herein. The present invention can also be utilized by any user and/or individual wishing to learn about a certain healthcare field or topic. Data and/or information collected and/or stored by the apparatus, which relates to symptoms and/or conditions, as well as responses to treatments, can be utilized in order to present realistic and confidential training scenarios.

The apparatus and method of the present invention can also be utilized in order to maintain patient healthcare records or files private, to safeguard patient healthcare records or files, to provide notification to patients and other individuals when others have accessed, obtained, and/or made changes to their respective healthcare records or files, and/or to enable patients and individuals to restrict and/or limit access to their healthcare records or files.

The present invention can also be utilized in order to allow patients and individuals to restrict and/or limit access to their healthcare records or files. In this manner, the patient or individual can restrict access to or of information contained in his or her healthcare record(s) or file(s) to only certain healthcare providers, healthcare payers, healthcare insurance providers, individuals, and/or entities. In this manner, the patient or individual can restrict access to his or her healthcare record information or healthcare file information to his or her healthcare provider(s), to his or her healthcare payer(s), to his or her insurance provider(s), to his or her relatives, family members, spouse, next-of-kin, and/or any other designated individual, individuals, entity, or entities.

The present invention can also be used to issue prescriptions or scripts for medicines, medications, or drugs to pharmacies on a patient's or individual's behalf, or issue prescriptions or scripts for procedures, tests, analyses, analysis work-ups, blood work, treatments, therapy, therapy sessions, physical therapy, physical therapy sessions, or any other prescribed goods, services, or activities, or issue referrals to other healthcare providers or providers of other goods or services. In this regard, the present invention can be used by a provider to issue a prescription or an electronic prescription or e-prescriptions, or a referral, via a computer or communication device or via a healthcare record of a patient or individual. A provider can also generate the respective prescription or referral using the present invention or using information contained in a patient's or individual's healthcare record or healthcare file, and can transmit the respective prescription or referral to a respective pharmacy, provider, therapist, or other provider of healthcare services or wellness services, or providers of other goods or services. A copy of the respective prescription or referral can also be stored in or by the present invention or in the healthcare record or the healthcare file of the patient or individual.

The present invention can also perform drug-drug and drug-allergy interaction checks. The present invention can also be used to place orders for medications, medicines, drugs, supplies, or other goods or services, with a respective supplier or provider of same.

The present invention can also be used to provide for the remote control and/or monitoring of healthcare devices, healthcare equipment, blood pressure measurement devices, blood pressure monitoring devices, heart rate or pulse rate measurement devices or monitoring devices, blood-sugar measurement devices or monitoring devices, EKG measurement or monitoring devices, medicine or drug dispensing devices or equipment, medicine or drug feeding devices or equipment, or any other device or equipment used to monitor or care for an individual or patient. In this regard, the present invention can be utilized to provide telehealth or telemedicine services or functions.

The present invention can also be used to control or monitor, or receive and/or store any data or information provided by, any of the healthcare devices or healthcare equipment described herein.

The healthcare device(s) or healthcare equipment can, for example, include, but not be limited to, the herein-described healthcare devices, healthcare equipment, blood pressure measurement devices, blood pressure monitoring devices, heart rate or pulse rate measurement devices or monitoring devices, blood-sugar measurement devices or monitoring devices, EKG measurement or monitoring devices, medicine or drug dispensing devices or equipment, medicine or drug feeding devices or equipment, or any other device or equipment used to monitor or care for an individual or patient, or can be any one or more of, and/or any combination of, a thermometer, a digital thermometer, a stethoscope, a heart rate monitor or measurement device, a pulse rate monitor or measurement device, a blood pressure monitor or measurement device, a blood pressure measurement device, a blood analysis device or machine, a respirator, a respiration monitoring or measurement device, a dialysis machine, a dialysis device, an electrocardiograph (EKG) machine or device, an electrocephalograph (EEG) machine or device, an electromyograph (EMG) machine or device, a magnetic resonance imaging (MRI) machine or device, an X-ray machine or device, a medical imaging machine or device, a thermal imaging machine or device, a heart sound monitor or measurement device, a lung sound monitoring or measurement device, a respiration rate monitoring or measurement device, a laparoscopic device, an arthroscopic device, a vascular testing device, a catheter device, a cardiac performance testing, monitoring, or measurement device, a pulmonary performance testing, monitoring, or measurement device, a vascular system performance monitoring or measurement device, a vascular system testing, monitoring, or measurement device, a metabolism monitoring or measurement device, a sonogram imaging device, a sonogram measurement device, a sonograph device, an optical response device, an optical response measurement device, an intravenous device, an arterial blood pressure measurement or monitoring device, a respiration rate measurement or monitoring device, an ultrasound imaging device, an ultrasound measurement device, a CAT SCAN device, a PET scan device, an optical metabolism measurement or monitoring device, a radiotelemetric device, a doppler medical device, a mammogram device, a carbon dioxide detection or measurement device, a carbon monoxide detection or measurement device, a transvascular impedance measurement or monitoring device, an ultrasonic imaging device, a bone conduction device, a brain function scan analyzer device, an external pulse cardiac monitoring or measurement device, a fetal heart rate measurement, monitoring, or probing, device, an endotrachial cardiac monitoring device, a finger tip blood pressure monitoring device, a psychological monitoring device, a surgical instrument, a vital signs measurement device, an ear pressure regulating device, a phonocardiograph device, an acoustic aneurysm detector device, a blood oxygen detection device, an esophageal probing device, an ultrasonic probing device, an ausculoscope, a vital signs monitoring system, a heart activity monitoring device, a pulmonary activity monitoring device, a sphygmomanometer, an esophageal stethoscope, a venous pressure measuring device, a differential doppler device, a physiological data measuring device, a body tissue movement device, a breathalyzer device, a camera probing device, a microscopic camera probing device, and/or any other bio-metric or physiological data measuring device(s) and/or data acquisition device(s).

The healthcare device can also be, or can include, a camera, a video camera, a microphone, an audio recording device, a telephone, a video conferencing device, a device for storing pictures, photographs, images, video, audio, and/or related data or information, which can be located in a room or other location where an individual or patient can be located or situated in order to allow the individual or patient to be observed and/or in order to allow for communication with the individual or patient.

The healthcare device or healthcare equipment being used can also be implantable in the patient or individual or can be wearable by the individual in any appropriate manner. The respective healthcare device or healthcare equipment being used can be any mobile or wireless device or can include a mobile or wireless communication device. The respective healthcare device or healthcare equipment being used can also be used, worn, or be integrated with, any type or kind of clothing.

The present invention can be used by any of the here-described healthcare providers, providers, insurers, payers, intermediary, intermediaries, third party, third parties, or any other individual or person, in order to remotely access, control, monitor, obtain information from, or otherwise use, any of the herein-described, or any other electrically or electronically controlled or operated healthcare device or healthcare equipment. An individual or patient, or a person assisting the individual or patient, can use a healthcare device or healthcare equipment in order to obtain information or results regarding the individual or patient and store or record the obtained information or results in the healthcare device or healthcare equipment or in a patient computer or communication device. Thereafter, the individual or patient, or the person assisting the individual or patient, can access the apparatus of the present invention, access the individual's or patient's healthcare record or healthcare file, and transmit the information or results to the apparatus or to the central processing computer and the information or results can then be stored in the individual's or patient's healthcare record or healthcare file. Thereafter, a respective healthcare provider, provider, insurer, payer, or any intermediary or third party, or other individual, can access the individual's or patient's healthcare record or healthcare file and obtain or review the information or results.

The present invention can also be utilized by a respective healthcare provider, provider, insurer, payer, or any intermediary or third party, or other individual, to monitor an individual or patient at home, at work, in a hospital, at a healthcare facility, during an operation or a procedure, during a test, during an office visit with another provider, during an MRI, Cat Scan, PET scan, or other procedure, during an exercise session, while asleep, while on vacation, while in surgery, during a stress test, or at any other time or place.

The present invention can also be utilized by a respective healthcare provider, provider, insurer, payer, or any intermediary or third party, or other individual, to monitor an individual or patient while they are located at any type or kind of premises, including, but not limited to, a residential premises, a commercial premises, a healthcare facility or premises, or while they are located in, or traveling in, any type of land, sea, air, or space vehicle. The present invention can also be utilized by a respective healthcare provider, provider, insurer, payer, or any intermediary or third party, or other individual, to monitor an individual or patient while they are located at, or while they are located in, or traveling in, a motor vehicle, an automobile, a mass transportation vehicle, a truck, a tractor trailer, a bus, a school bus, a commercial vehicle, commercial equipment, industrial equipment, a military vehicle, a snowmobile, a jetski, a scooter, a recreational vehicle, a motorcycle, a minibike, a go-cart, a moped, an unmanned vehicle, a train, a subway train, an aircraft, an airplane, a jet, a helicopter, a glider, a spacecraft, a space shuttle, a satellite, an unmanned aircraft, a commercial aircraft, a military aircraft, a boat, a marine vessel, a marine vehicle, a motor boat, a sailboat, a ship, a cruise ship, a commercial boat, a military boat, an unmanned boat, or a submarine. Any necessary or appropriate information, or a link(s) or hyperlink(s), for facilitating access to the respective premises, vehicle, healthcare device, or healthcare equipment, or for facilitating an accessing, controlling, or monitoring, of any healthcare device, healthcare equipment, video device, audio device, videoconferencing device, or communication device, can be provided or stored, or otherwise made available, in the individual's or patient's healthcare record or healthcare file or in the central processing computer or in the database of same.

The present invention can also be utilized by a respective healthcare provider, provider, insurer, payer, or any intermediary or third party, or other individual, to be virtually or remotely present while an individual or patient is being examined, cared for, or treated, by another provider. For example, if an individual or patient is injured while traveling abroad and is treated at a hospital, the individual's or patient's primary care physician can be contacted and can, when provided with the information, link, or hyperlink, can remotely access and monitor, and/or participate in, the examination session or a procedure, and/or can communicate with and/or confer with the treating provider, the individual or patient, and/or any other individual or person. Any necessary or appropriate information, or a link(s) or hyperlink(s), for facilitating access to the respective premises, vehicle, healthcare device, or healthcare equipment, or for facilitating an accessing, controlling, or monitoring, of any healthcare device, healthcare equipment, video device, audio device, videoconferencing device, or communication device, can be provided or stored, or otherwise made available, in the individual's or patient's healthcare record or healthcare file, or in the central processing computer or in the database of same.

The present invention can also be utilized by a respective healthcare provider, provider, insurer, payer, or any intermediary or third party, or other individual, to control a dispensing of a medication or drug, to dispense a medication for an individual or patient so as to administer same to the individual or patient, or can issue an emergency call for help or a 911 call, or to issue a prescription for a medication or a drug, or to issue a referral for a good or a service.

Any and/or all information, links, or hyperlinks, needed to perform any of the functions or operations described herein can be store in, and obtained from, the healthcare record or healthcare file of the individual or patient, thereby providing a healthcare record or healthcare file having a remote monitoring, remote care, remote care management, or telehealth or telemedicine, capability.

The present invention can also be utilized by an individual, a patient, a provider of an individual or patient, a payer or insurer of an individual or patient, or any authorized third party or intermediary, if so authorized, to access the individual's or the patient's healthcare record or healthcare file and to obtain any of the data, information, photographs, pictures, video clips, transcripts, audio clips, x-rays, MRI, CAT, or PET, or other, scan films, test results, lab test results, healthcare histories, records, files, insurance claims, payment histories, or any other of the information described herein as being provided, processed, or stored, by, from, or in, the present invention. The individual, patient, provider of an individual or patient, a payer or insurer of an individual or patient, or any authorized third party or intermediary, can access the central processing computer via a respective computer or communication device, access the individual's or patient's healthcare record or healthcare file, and request or select, and be provided with, the desired data, information, photograph(s), picture(s), video clip(s), transcript(s), audio clip(s), x-ray(s), MRI, CAT, or PET, or other, scan film(s), test results, lab test results, healthcare history or histories, record(s), file(s), insurance claim(s), payment history or histories, or any other of the information described herein as being provided, processed, or stored, by, from, or in, the present invention.

The present invention can also be utilized to provide information regarding ICD, ICD-10, ICD-9, or other codes, diagnostic codes, symptom codes, treatment codes, billings codes, or any other codes or information useful in entering patient or individual information into a healthcare record or healthcare file of the patient or individual. In this manner, the present invention can provide any user, provider, payer, insurer, or intermediary, or any other individual or person using the present invention, with accurate and current data or information so as to ensure that information described herein as being stored in the healthcare records or healthcare files of individuals or patients, records, files of providers, payers, insurers, third parties, or intermediaries, or any insurance claims, prescriptions, referrals, or any other information, described herein as being processed, generated, or stored, by the present invention, is accurate, correct, and up-to-date with current standards in the healthcare field and/or in related fields

Rules algorithms can also be utilized by the present invention so that all processing routines, data or information storing routines, insurance claim generation routines, or prescription or referral generation routines, are performed, created, or generated, correctly and accurately, and/or pursuant to current standards in the healthcare field or related fields.

The present invention can also provide for the security and/or the confidentiality of any and/or all of the data and/or information stored by, and/or processed by, same. Identification cards can also be utilized so as to store pertinent information for any of the respective parties so as to provide the respective party with access to various data and/or information and/or any processing functionality which can be provided by the present invention. The present invention can also be used in connection with an identification card or device, or with information contained therein or thereon. The identification card or device can also take the form of a device which can be implantable within the human body.

The present invention can also utilize, or be utilized in connection with, any or all of the International Classification of Diseases (ICD) codes, ICD-10 codes, ICD-9, or any other ICD codes, or other codes, billing codes, diagnostic codes, treatment codes, or symptom codes, as well as any other codes or coding information which pertains to healthcare, the administration of healthcare services, healthcare record keeping, healthcare billing, healthcare treatments, or any other healthcare or healthcare-related function or service.

Any data or information, or any function, described-herein as capable of being provided by or performed by the present invention, can, if needed, be translated or converted, by the present invention, or by any computer, communication device, or any other device, used in connection with the present invention, into a foreign language or a foreign language counterpart or can be translated or converted into a corresponding foreign language code or information. Any translation or conversion can be performed automatically in response to a respective individual, patient, healthcare provider, provide, payer, insurer, intermediary, or third party, registering or requesting a language preference or translation or conversion request or order with the present invention at any time, or in response to a request or a selection to provide, display, of store, the data or information, or code, or to convert the data or information, or code, into a foreign language at any time. The translation or conversion can be performed using a pre-stored look-up table containing or having foreign language translations or foreign language counterparts of data, information, or codes, which can be used, stored, processed, or generated, in connection with the use of any of the embodiments or functionality of the present invention described herein. The translation or conversion can also be performed using a language translation or code translation software of processing routines. The present invention can translate or convert any of the data or information, or codes, into any number of foreign languages.

The present invention can also be used to provide information regarding audits or other information regarding, for each payer or insurer, the payer's or insurer's responsiveness to process or pay claims, the payer's or insurer's time to pay claims, information regarding why the payer or insurer rejects a claim, claim rejection information regarding the payer or insurer, claims allowed information regarding the payer or insurer, payment rates or schedules for goods or services paid for by the payer or insurer, reimbursement rates paid by the payer or insurer, or any other information which can be used to provide information regarding the payer or insurer. The present invention can also be utilized to record or store information regarding each and every claim submitted to a payer or an insurer as well as information regarding the payer's or insurer's responsiveness to process or pay claims, the payer's or insurer's time to pay claims, information regarding why the payer or insurer rejects a claim or has rejected a claim, claim rejection information regarding the payer or insurer, claims allowed information regarding the payer or insurer, payment rates or schedules for a good or a service paid for by the payer or insurer, reimbursement rates paid by the payer or insurer, and/or any other information which can be used to provide information regarding the payer or insurer.

The present invention can also be used to audit or monitor a healthcare provider, healthcare providers, or any other provider or providers described herein. In this regard, the present invention can be used to provide information regarding, for each healthcare provider or other provider, the respective healthcare provider's or other provider's insurances accepted, fees, fee schedules, claim success rates, diagnosis success rates, treatment success rates, time to update patient healthcare record or healthcare file from service time or date, time to submit insurance claim from service time or date, number of visits per illness, patient or client satisfaction, malpractice claims made against the healthcare provider, complaints made against the healthcare provider, satisfaction ratings, competence ratings, number of patients or clients under care, and/or any other information regarding the healthcare provider or other provider. Any time a respective individual, patient, healthcare provider, provider, insurer, payer, or any intermediary or third party, or other individual, desires to obtain any of the herein-described or other information regarding a healthcare provider or other provider, he, she, or it, can request and obtain a provider report from the apparatus of the present invention.

The present invention can also be utilized in order to identify or select individuals or patients for clinical trials, experimental procedures, experimental treatments, healthcare focus groups, healthcare surveys, or any other activities or events which involve one or more individuals or patients.

The present invention can also be used to test new medications, medicines, drugs, pharmaceutical products, pharmaceutical services healthcare devices, goods, or services, new or experimental treatments or procedures, treatment plans, or care management plans, as well as can be used to obtain survey information or focus group information from identified or selected individuals and/or patients. The present invention can also be used to identify or select, and generate a list of individuals or patients with or having a specific condition(s) which list of individuals or patients can be used for research, quality improvement, outreach, reduction of disparities, care management, treatment planning, infection disease control, or any other healthcare-related activity or use.

The present invention can also be used to determine or measure the effectiveness of, or side effects experienced or associated with, any medications, medicines, drugs, dietary supplements, supplements, or over-the-counter products or substances, or the effectiveness of procedures, treatments, treatment plans, care management plans, or any other good or service which can be offered in the marketplace.

The present invention can also be used to provide updated reports regarding the effectiveness of, or side effects experienced or associated with, any medications, medicines, drugs, dietary supplements, supplements, or over-the-counter products or substances, or the effectiveness of procedures, treatments, treatment plans, care management plans, or any other good or service, automatically or on an on-going basis.

The present invention can also be used to provide information regarding health conditions, healthcare conditions, illnesses, diagnoses, symptoms, treatments, treatment plans, care management practices, insurance information, information regarding type of insurance, wellness information, healthcare practices, healthcare history patterns, healthcare history patterns, healthcare trends, treatment trends, statistics, statistical analyses, studies, study trends, or any other pertinent healthcare or healthcare-related information, regarding any number or type of groups of individuals or patients. The present invention can also provide any of the above-described information for any number of groups of individuals or patients based on gender, age, occupation, education, ethnicity, country of origin, religion, or any demographic or demographics, or any other criteria. The present invention can also be utilized in order to provide statistical information or probability information regarding any of the above-described information.

The present invention can also provide updated reports regarding health conditions, healthcare conditions, illnesses, diagnoses, symptoms, treatments, treatment plans, care management practices, insurance information, information regarding type of insurance, wellness information, healthcare practices, healthcare history patterns, healthcare history patterns, healthcare trends, treatment trends, statistics, statistical analyses, studies, study trends, or any other pertinent healthcare or healthcare-related information, regarding any number or type of groups of individuals or patients, or any of the herein-described information for any number of groups of individuals or patients based on gender, age, occupation, education, ethnicity, country of origin, religion, or any demographic or demographics, or any other criteria, automatically, or otherwise, or on an on-going basis. Any reports can be stored for retrieval by any of the herein-described users, individuals, patients, healthcare providers, other providers, payers, insurers, intermediaries, or third parties, or any other person or entities, who or which utilize the present invention.

Any and/or all of the signals, messages, reports, notification messages, or any other communications, described herein as being transmitted from one device, computer, or communication device, to another, can be, or can be included in, or be attached to, an e-mail message, an instant messaging message, an electronic transmission, or electronic data transmission or any other data or information transmission, and can be transmitted via any appropriate or necessary computer(s) or device(s).

Any of the herein-described individuals, patients, healthcare providers, providers, payers, insurers, third parties, or intermediaries, or any other person or entity, who or which utilizes the present invention, if so authorized, can program same so as to have any of the herein-described data, information, reports, signals, messages, notification messages, news reports, study reports, news of developments pertinent to the healthcare field or healthcare related fields, or any other information described herein as being provided by the present invention, transmitted to he, she, or it, or to a computer or communication device used by or associated with he, she, or it, as this data, information, reports, signals, messages, notification messages, news reports, study reports, news of developments pertinent to the healthcare field or healthcare related fields, or any other information, is generated by, or made available to, the present invention.

At any time a medication, medicine, or drug, is prescribed, is being considered as part of a treatment, or is about to be administered, to an individual or a patient, the present invention can be used to determine whether or not the respective medication, medicine, or drug, could result in any adverse drug interaction(s) or adverse reaction(s) with any other medication, medicine, or drug, the individual or patient may currently be taking, or the present invention can be used to determine whether or not the individual or patient is, or may be, allergic to the respective medication, medicine, or drug.

The present invention, when processing information for generating any of the treatment plans described herein, can also determine whether or not any respective medication, medicine, or drug, or treatment, being considered could result in any adverse drug interaction(s), adverse reaction(s), or have any other adverse effect, with any other medication, medicine, or drug, or treatment, the individual or patient may currently be taking or have undergone, or the present invention can determine whether or not the individual or patient is, or may be, allergic to the respective medication, medicine, drug, or treatment.

The present invention can also be used to perform drug formulary checks for or regarding any medication, medicine, or drug.

The present invention can also be used to perform processing routines to effectuate medication, medicine, or drug, reconciliation at any time in or during the treatment, care, or care management, of or for an individual or patient. These medication, medicine, or drug, reconciliation processing routines can be performed continuously during a treatment or care setting for an individual or patient, as well as in between treatment or care settings for the individual or patient.

The present invention can also be used to store immunization records and information for each individual, as well as other immunization data and/or information and, at any appropriate time, upon any updating of immunization information, upon an updating of a certain number of immunization records, upon an updating of immunization information for a specified number of individuals or patients, at any pre-specified or pre-selected time, at pre-specified time intervals, upon request by a public health agency or department, upon request by an immunization center or an immunization registry, upon request by a healthcare provider, a healthcare facility, a hospital, a research center or facility, a payer or insurer, an intermediary, or any person, individual, or entity, can generate an immunization information report and can transmit same to a respective computer or communication device associated with or used by a requesting public health agency or department, immunization center or immunization registry, healthcare provider, healthcare facility, hospital, research center or facility, payer or insurer, intermediary, or person, individual, or entity.

The present invention can also receive and process a request, by any healthcare provider, any other provider, a patient or individual, a payer or insurer, a secondary payer or insurer, a tertiary payer or other payer or insurer, or any authorized third party or intermediary, to provide co-payment information and/or deductible information regarding an insurance policy, a healthcare insurance policy, a disability insurance policy, or a life insurance policy, of or for any individual or patient described herein, or co-payment information and/or deductible information regarding any healthcare payer or healthcare payment policy or plan. The present invention can also be used to process a request and generate a co-payment or deductible information message and transmit same the respective computer or communication device associated with, or used by, a respective healthcare provider, any other provider, a patient or individual, a payer or insurer, a secondary payer or insurer, a tertiary payer or other payer or insurer, or any authorized third party or intermediary.

The present invention can also be utilized to provide employee benefits information, to allow individuals, patients, or any other person or third party to enroll in employee benefits or in an employee benefit, to submit a claim or claims or make a request for, or pursuant to, an employee benefit or an insurance policy or payment policy or plan, to take or transfer an employee benefit from one job to another or to maintain an employee benefit after leaving a position or retiring from a job or position, thereby providing benefits portability, or to post information regarding a need or desire for an employee benefit or policy. The present invention can also be utilized to allow a benefit provider to provide information to individuals, patients, or any other person or third party, of an availability of, or an offering of, a benefit, a policy, an insurance policy, or other policy, plan, or program, which is being offered by the provider.

The present invention can also be used to provide a user, patient, individual, or any other authorized person, with information regarding any employee benefits or employee benefits insurance policies or plans which the user, patient, individual, or other authorized person may have, or be covered under, as a beneficiary. Information, links, or hyperlinks, regarding, or providing a link to, any employee benefits, healthcare insurance policies, disability insurance policies, life insurance policies, healthcare payment plans, individual retirement accounts (IRAs), self-employed pension (SEP) accounts, bank accounts, savings accounts, financial accounts, or a vacation time benefit, a personal time benefit, a sick time benefit, a healthcare insurance benefit, a disability insurance benefit, a life insurance benefit, an employee discount benefit, a buying service benefit, a tuition reimbursement benefit, an educational assistance benefit, an in-house training benefit, a child care benefit, a day care program benefit, a stock option benefit, a pension benefit, a retirement benefit, a credit union benefit, an employee stock ownership benefit, a profit sharing benefit, an educational assistance program benefit, a child care program benefit, or any other employee benefit which can be offered to an employee by a respective employer, or any of the other employee benefit(s) described herein, can also be included in any of the databases of any of the herein-described computers or communication devices. Information, links, or hyperlinks, regarding, or providing a link to, any employee benefits, healthcare insurance policies, disability insurance policies, life insurance policies, healthcare payment plans, individual retirement accounts (IRAs), self-employed pension (SEP) accounts, bank accounts, savings accounts, financial accounts, or any of the other employee benefits described herein, or any employers or benefits providers, can also be included in the healthcare record or healthcare file of each patient or individual, or in any of the databases of any of the herein-described computers or communication devices.

The present invention can also provide any of the herein-described functionality to employees, independent contractors, temporary workers, freelancers, or any other individuals who are provided with, or who maintain for themselves, any employee benefits or any benefits that can or may be offered as an employee benefit.

The present invention can also be utilized by an individual or a patient, having a healthcare record or a healthcare file, to access or obtain information regarding an employee benefit via the present invention or by using information, a link, or a hyperlink, contained in or stored in the individual's or patient's healthcare record or healthcare file. The present invention can also record and store, in the individual's or the patient's healthcare record or healthcare file, any information regarding the individual's or the patient's request for information and/or the information provided in response thereto.

In another preferred embodiment, the present invention can be utilized by an individual or patient, having a healthcare record or a healthcare file, to submit or file a request or a claim for, or pursuant to, an employee benefit via, or using information, a link, or a hyperlink, contained in or stored in the individual's or patient's healthcare record or healthcare file.

Any messages generated by the present invention can contain information regarding a confirmation that the request or claim for, or pursuant to, the employee benefit has been received by the benefit provider of the employee benefit, that the request or the claim is allowed or will be allowed, that a benefit or a payment in response to the request or the claim will be provided, that a payment has been made, or will be made, to a financial account, a savings account, a checking account, or any other employee benefit financial account, of or associated with the individual or patient, that the request or the claim is denied or disallowed or will be denied or disallowed, that a benefit or a payment in response to the request or the claim will not be provided, that more information is needed from the individual or patient, or that a response to the request or the claim will be forthcoming.

The present invention can also record and store, in the individual's or the patient's healthcare record or healthcare file, or in any database of any of the herein-described computers or communication devices, any information regarding the individual's or the patient's request or claim for, or pursuant to, the employee benefit, and/or any completed form(s), claims form(s), request form(s), or other needed or required information, which was submitted pertaining to the request or the claim, the message, or any information contained in the message.

The present invention can also be utilized as, and/or as a platform for, an insurance exchange in order to provide a venue by which to allow insurers or payers to sell healthcare insurance, disability insurance, life insurance, automobile insurance, homeowner's insurance, property or casualty insurance, or any other insurance policy, payer policy, payer program, or payer plan.

The present invention can also be utilized to allow an individual or a patient to post a request for an insurance policy, or his or her requirement for an insurance policy or his or her need for an insurance policy. The insurance policy can be a policy for healthcare insurance, disability insurance, life insurance, automobile insurance, homeowner's insurance, property or casualty insurance, or any other insurance policy, payer policy, payer program, or payer plan. The present invention can provide information regarding the individual's or the patient's posting of the request for an insurance policy, or the requirement for an insurance policy or the need for an insurance policy, to any number of insurers or payers or any brokers of insurance. Thereafter, any insurer or payer, or a broker, can offer the individual or patient an insurance policy fitting or matching the individual's or patient's request, requirements, or needs. If the individual or the patient decides to purchase the offered insurance policy, he or she can do so and can be enrolled in the insurance policy via the present invention.

The present invention can also be utilized to allow an insurer, a payer, a healthcare provider, or a provider of any goods, products, or services, to offer, and/or to transmit messages offering their respective insurance policies, payment policies, payment plans, payment programs, benefits, benefits packages, or any other goods, products, or services, to any number of the herein-described individuals or patients who utilize the present invention. Any of the insurance policies offered via the present invention can be a policy for healthcare insurance, disability insurance, life insurance, automobile insurance, homeowner's insurance, property or casualty insurance, or any other insurance policy, payer policy, payer program, or payer plan.

The present invention can be utilized in a same, a similar, or an analogous manner, in order to allow an insurer, payer, or any provider, to sell or to offer to sell disability insurance, life insurance, automobile insurance, homeowner's insurance, property or casualty insurance, or any other insurance policy, payer policy, payer program, or payer plan, or in connection with selling any good, product, or service, which can be the subject of commerce.

The present invention can be utilized in order to provide for the selling or the purchasing of any type or kind of healthcare insurance policy, disability insurance policy, life insurance policy, or any other insurance policy, payer policy, payer program, or payer plan, and can provide for allowing any individual, patient, employer, third party, or intermediary, to pay for same, with any and/or all information regarding the respective healthcare insurance policy, disability insurance policy, life insurance policy, or any other insurance policy, payer policy, payer program, or payer plan, being recorded and/or stored in the healthcare record or the healthcare file of the insured individual or patient.

The present invention can also provide for the portability of benefits, such as the portability of healthcare insurance, disability insurance, life insurance, or their respective policies, or any other related or unrelated insurance policy, payer policy, payer program, or payer plan, from one job to another job, from one employment relationship to another employment relationship, from a period of employment to a period of unemployment, from a period of unemployment to a period of employment, from a period of employment to a period of self-employment, or from a period of employment to and/or through a period of retirement, or from or between any employment or unemployment status, or from or as the result of any change in employment, unemployment, or retirement, status, of an individual or patient.

The present invention can also be utilized in a same, a similar, or an analogous, manner in order to provide healthcare information, healthcare-related information, and/or any of the herein-described functionality, for or regarding animals of any type or kind, pets, dogs, cats, domestic animals, zoo animals, theme park animals, circus animals, animals used in entertainment shows or water shows, or any other animals for which an owner, keeper, or caretaker, desires to store or maintain a healthcare record, a healthcare file, or a healthcare history, or for which an owner, keeper, or caretaker, desires to utilize any of the functionality described herein as being provided by the present invention.

The present invention can also be used to generate a message containing laboratory testing results and transmit same to a computer or communication device associated with or used by an individual or patient and/or to a provider computer or communication device associated with or used by the healthcare provider of the individual or patient who ordered the test, or to any other healthcare provider of the individual or patient. The message can also be sent to and/or stored in the healthcare record or healthcare file of the individual or patient.

The present invention can also utilize intelligent agents, software agents, and/or mobile agents, which agents can be programmed to act for, and/or on behalf of, any of the parties described herein. The intelligent agent(s) can act on behalf of the respective party in various related interactions and/or other activities which are described as being performed herein and/or which may be incidental and/or related thereto. Therefore, the present invention also provides an agent-based apparatus and method for providing healthcare information and/or healthcare-related information.

The apparatus of the present invention can also be programmed to be self-activating and/or activated automatically. The apparatus of the present invention can also be programmed in order to automatically generate and/or transmit any of the e-mails, electronic message transmissions, electronic notification transmissions, reports, and/or any of the communications, described herein, between any of the parties which utilize the present invention.

The data and/or information, described as being stored in the various databases utilized by the respective computers and/or communication devices can be continuously updated so as to store the latest values for the data and/or information and can be stored and be made available for future processing routines.

Any and/or all of the data and/or information described herein as being stored in any of the various databases, can be linked via relational database techniques and/or via any appropriate database management techniques. The data and/or information can be updated via inputs from any of the computers and/or communication devices described herein, and/or external computers or communication devices, in real-time, and/or via dynamically linked database management techniques. The data and/or information which is stored in the various databases can be linked via any suitable data linking techniques such as, for example, dynamically linked lists (DLLs), linked lists, and object links embedded (OLE's).

### BRIEF DESCRIPTION OF THE DRAWINGS

In the Drawings:

FIG. 1 illustrates a preferred embodiment of the present invention, in block diagram form;

FIG. 2 illustrates the central processing computer of FIG. 1, in block diagram form;

FIG. 3 illustrates the provider communication device of FIG. 1, in block diagram form;

FIG. 4 illustrates the payer communication of FIG. 1, in block diagram form;

FIG. 5 illustrates the patient communication device of FIG. 1, in block diagram form;

FIG. 6 illustrates the intermediary communication device of FIG. 1, in block diagram form;

FIGS. 7A and 7B illustrate a preferred embodiment method of using the present invention, in flow diagram form;

FIGS. 8A and 8B illustrate another preferred embodiment method of using the present invention, in flow diagram form;

FIGS. 9A and 9B illustrate still another preferred embodiment method of using the present invention, in flow diagram form;

FIG. 10 illustrates yet another preferred embodiment method of using the present invention, in flow diagram form;

FIGS. 11A and 11B illustrate another preferred embodiment method of using the present invention, in flow diagram form;

FIGS. 12A and 12B illustrate still another preferred embodiment method of using the present invention, in flow diagram form;

FIGS. 13A, 13B and 13C illustrate yet another preferred embodiment method of using the present invention, in flow diagram form;

FIGS. 14A and 14B illustrate another preferred embodiment method of using the present invention, in flow diagram form;

FIGS. 15A and 15B illustrate another preferred embodiment method of using the present invention, in flow diagram form;

FIGS. 16A and 16B illustrate another preferred embodiment method of using the present invention, in flow diagram form;

FIGS. 17A and 17B illustrate another preferred embodiment method of using the present invention, in flow diagram form;

FIG. 18 illustrates still another preferred embodiment method of using the present invention, in flow diagram form;

FIG. 19 illustrates yet another preferred embodiment method of using the present invention, in flow diagram form;

FIG. 20 illustrates another preferred embodiment method of using the present invention, in flow diagram form;

FIG. 21 illustrates still another preferred embodiment method of using the present invention, in flow diagram form;

FIG. 22 illustrates yet another preferred embodiment method of using the present invention, in flow diagram form;

FIG. 23 illustrates another preferred embodiment method of using the present invention, in flow diagram form;

FIG. 24 illustrates still another preferred embodiment method of using the present invention, in flow diagram form;

FIG. 25 illustrates yet another preferred embodiment method of using the present invention, in flow diagram form;

FIG. 26 illustrates another preferred embodiment method of using the present invention, in flow diagram form;

FIG. 27 illustrates still another preferred embodiment method of using the present invention, in flow diagram form;

FIG. 28 illustrates yet another preferred embodiment method of using the present invention, in flow diagram form; and

FIG. 29 illustrates another preferred embodiment method of using the present invention, in flow diagram form.

### DESCRIPTION OF THE PREFERRED EMBODIMENT

The present invention is directed to an apparatus and a method for processing and/or for providing healthcare information and/or healthcare-related information and, in particular, to an apparatus and a method for processing and/or for providing healthcare information and/or healthcare-related information for a variety of healthcare and healthcare related applications.

The apparatus and method of the present invention facilitates the creation and management of a comprehensive healthcare processing system which can manage patient and client records, doctor and other provider records, healthcare insurance and/or payer records, and thereby provide an apparatus, system, and methods for providing a variety and a multitude of healthcare information processing applications, processes and services.

The present invention facilitates improved healthcare quality, efficient information collection, processing and dissemination, efficient diagnosis and treatment, cost efficiency, cost containment, as well as many other benefits and advantages as will be described herein.

The apparatus and method of the present invention also facilitates the distribution and management of healthcare insurance, life insurance, disability insurance, as well as claims processing related thereto.

The present invention also provides an apparatus and a method for providing a comprehensive processing system which incorporates data and/or information from any combination and/or all of the participants in the healthcare field including, but not limited to, patients and those seeking healthcare, healthcare providers, doctors, including medical doctors, surgeons, physicians, dentists, orthodontists, periodontists, endodontists, oral surgeons, osteopaths, psychologists, optometrists, podiatrists, osteopaths, chiropractors, pharmacists, therapists, physical therapists, respiratory therapists, nurses, healthcare aids, nutritionists, and/or any other person, individual, and/or professional who can provide healthcare, healthcare-related, wellness and/or wellness-related services and/or products, insurance companies, healthcare insurance companies, disability insurance companies, property or casualty insurance companies, health maintenance organizations, healthcare providers, and any other payer and/or provider of healthcare services and/or products, healthcare claims processing centers, healthcare insurance brokers and/or agents, and/or any other third party and/or intermediary who or which acts on behalf of another and/or assists in to providing of healthcare and/or related services.

The apparatus and method of the present invention can also be utilized in order to maintain patient healthcare records or files private, to safeguard patient healthcare records or files, to provide notification to patients and other individuals when others have accessed, obtained, and/or made changes to their respective healthcare records or files, and/or to enable patients and individuals to restrict and/or limit access to their healthcare records or files.

Applicant hereby incorporates by reference herein the subject matter and teachings of U.S. patent application Ser. No. 09/737,348 which teaches and discloses an apparatus and method for processing and/or for providing healthcare information and/or healthcare-related information. Applicant also hereby incorporates by reference herein the subject matter and teachings of U.S. Provisional Patent Application Ser. No. 60/286,422 which teaches and discloses an apparatus and method for processing and/or for providing healthcare information and/or healthcare-related information. Applicant also hereby incorporates by reference herein the subject matter and teachings of U.S. Provisional Patent Application Ser. No. 60/172,555 which teaches and discloses an apparatus and method for processing and/or for providing healthcare information and/or healthcare-related information.

Applicant also hereby incorporates by reference herein the subject matter of U.S. patent application Ser. No. 09/162,889 which teaches an apparatus and method for processing healthcare data. Applicant also hereby incorporates by reference herein the subject matter of U.S. Pat. No. 5,961,332 which teaches an apparatus for processing psychological data and method of use thereof.

As used herein, the terms “individual”, “patient”, “client”, “user” or the like, or their plural forms, refers to any person, individual, patient, and/or client who uses the present invention, and/or who seeks and/or who receives healthcare services, healthcare-related services, healthcare-related information, and/or any of the other services and/or products provided by the present invention.

As used herein, the terms “doctor”, “healthcare provider”, “provider”, “therapist”, “healthcare information specialist”, etc., or their plural forms, refers to any medical doctor, including any and all of the various medical specialists and/or specialties, including, but not limited to internists, orthopedists, opthamalogists, cardiologists, hematologists, endocrinologists, oncologists, ears, nose and throat specialists, neurologists, urologists, gastrointerologists, dermatologists, pediatricians), medical specialist, surgeon, surgical specialists, including any and/or forms and/or types of surgeons), physician, dentist, psychiatrist, psychologist, optometrist, podiatrist, osteopath, chiropractor, pharmacist, therapist, physical therapist, respiratory therapist, nurse, healthcare aid, nutritionist, and/or any other person, individual and/or professional who can provide healthcare, healthcare-relate, wellness and/or wellness-related services and/or products.

As used herein, the terms “insurer”, “payer”, “insurance provider”, “heath insurance provider”, “life insurance provider”, “disability insurance provider”, etc., or their plural forms, refers to any insurance companies, healthcare insurance companies, disability insurance companies, property or casualty insurance companies, health maintenance organizations, healthcare providers, and any other payer and/or provider of healthcare services and/or products, who which provide and/or pay for healthcare and/or healthcare-related benefits, services, and/or products, and/or who or which provide respective health insurance, life insurance and/or disability insurance benefits, services and/or products.

As used herein, the terms “broker”, “agent”, “billing service”, “collection agent”, “manager”, intermediary”, “assistant”, etc., or their plural forms, refer to any broker, insurance broker, agent, insurance agent, intermediary, third party, billing service provider, collection agent, claim processing agent, and/or any other person, individual, and/or entity, which acts on behalf of, or for, any of the individuals, patients, doctors, healthcare providers, insurers, payers, etc., described herein.

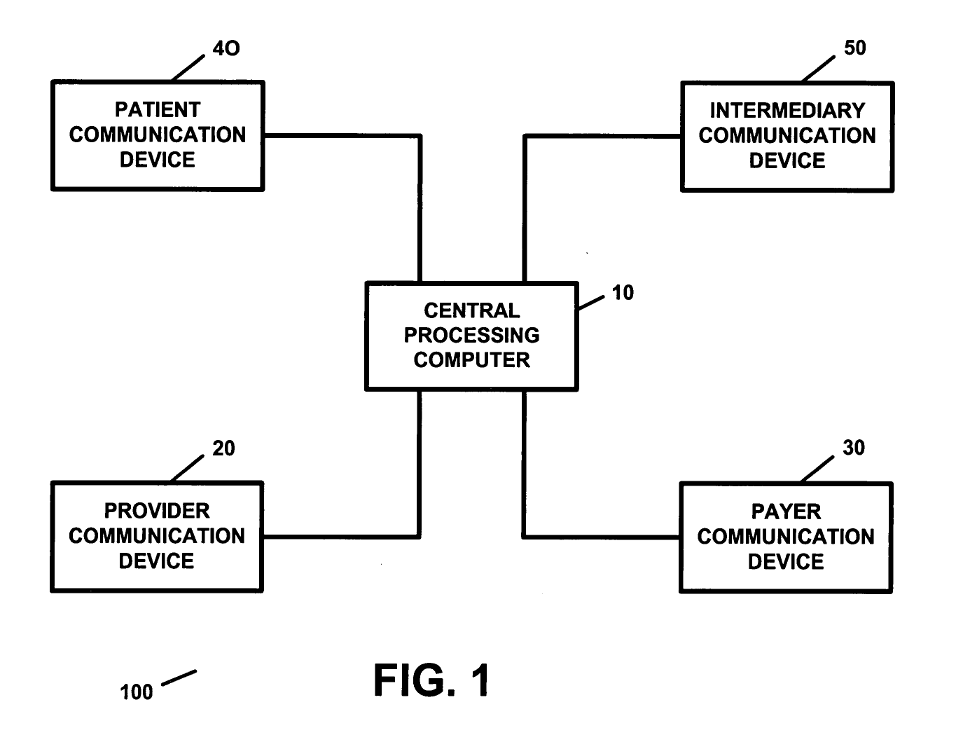

FIG. 1 illustrates the apparatus of the present invention, in block diagram form. The apparatus of the present invention is denoted generally by the reference numeral 100. In the preferred embodiment, the apparatus 100 of the present invention includes a central processing computer or central processing computer system 10 (hereinafter referred to as the “central processing computer 10”). In the preferred embodiment the central processing computer 10 can be a network or server computer.

In the preferred embodiment, the central processing computer 10 can provide control over the apparatus 100 and can perform any of the various processing services and/or functions described herein. The central processing computer 10 may be a single computer or system of computers and/or may be include a plurality of computers or computer systems which are utilized in conjunction with one another. The central processing computer 10, in the preferred embodiment can provides services for any of the other computers and/or computer systems described herein as being associated with any of the individuals, patients, healthcare providers, insurers, payers, brokers, agents, and/or intermediaries, described herein.

The apparatus 100 also includes a healthcare provider communication device or computer 20 (hereinafter referred to as “provider communication device 20” or “provider computer 20”) which is associated with a healthcare provider such as a healthcare professional, a hospital, a clinic, and/or any other provider of services described herein. A provider computer 20 can also be associated with, or can be used by, any research institution, research facility, teaching institution, teaching hospital, college, university, school, or other institution or entity which may perform research, or provide research information or any related information regarding studies, findings, or developments, in the healthcare field or in healthcare-related fields. A provider computer 20 can also be associated with, or can be used by, any public health department, public health agency, public health facility, or other public health entity, on any one or more of a national level, a country level, a state level, a provincial level, a county level, a city level, a municipal level, or any other level, which is entrusted to provide for the public health and/or to perform services or oversight regarding public health. A provider computer 20 can also be associated with, or can be used by, any immunization registry or immunization registries. A provider computer 20 can also be associated with, or can be used by, any source or provider of educational or instructional information, or information regarding instructions or procedures, or links or hyperlinks to same.

Any number or amount of healthcare provider computers 20 can be utilized in conjunction with a healthcare provider and/or group of providers. The healthcare provider computer(s) 20 can communicate with, and operate in conjunction with, the central processing computer 10 and/or any of the other computers and/or computer systems associated with any of the other individuals and/or entities which utilize and/or operate in conjunction with the present invention.

The apparatus 100 can also include a healthcare payer communication device or computer 30 (hereinafter referred to as “payer communication device 30” or “payer computer 30”) which is associated with a healthcare payer such as a healthcare insurer, insurance company, health maintenance organization, a clinic, and/or any other payer of healthcare services and products described herein. Any number or amount of healthcare payer computers 30 can be utilized in conjunction with a healthcare payer and/or group of payers. The healthcare payer computer(s) 30 can communicate with, and operate in conjunction with, central processing computer 10 and/or any of the other computers and/or computer systems associated with any of the other individuals and/or entities which utilize and/or operate in conjunction with the present invention.

The apparatus 100 can also include a patient or individual user communication device or computer 40 (hereinafter “patient communication device 40” or “patient computer 40”) which is associated with a healthcare patient such as a patient, user, or client who seeks or who is provided with healthcare and/or related services, products and/or related information. The patient communication device 40 can also be utilized by any individual, party, or entity, who or which may merely utilize the present invention in order to obtain information of interest.

A patient communication device 40 may also be located at public places or locations, such as at kiosks or other publicly available computer or communication devices. Any number or amount of patient computers 40 can be utilized in conjunction with a patient and/or group of patients. The patient computer(s) 40 can communicate with, and operate in conjunction with, the central processing computer 10 and/or any of the other computers and/or computer systems associated with any of the other individuals and/or entities which utilize and/or operate in conjunction with the present invention. The patient computer(s) 40 can also be utilized by any other individual or entity desiring to utilize and/or to obtain information from the apparatus 100 and/or from any other the

The apparatus 100 can also include an intermediary communication device or computer 50 (hereinafter referred to as “intermediary communication device 50” or “intermediary computer 50”) which is associated with an intermediary, a broker, an agent, and/or any other individual and/or entity, that can utilize the present invention in order to act for and/or on behalf of any other individual, party, or entity, described herein. Any number or amount of intermediary computers 50 can be utilized in conjunction with an intermediary and/or group of intermediaries. The intermediary computer(s) 50 can communicate with, and operate in conjunction with, the central processing computer 10 and any of the other computers and/or computer systems associated with any of the other individuals and/or entities which utilize and/or operate in conjunction with the present invention.

In the preferred embodiment, any of the provider computer(s) 20, the payer computer(s) 30, the patient computer(s) 40, and/or the intermediary computer(s) 50, can be any computer or communication device, including, but not limited to, a personal computer, a home computer, a server computer, a network computer, a hand-held computer, a palmtop computer, a laptop computer, a personal communication device, a cellular telephone, a wireless telephone, a mobile telephone, a digital television, an interactive television, a digital television, a personal digital assistant, a telephone, a digital telephone, a television, an interactive television, a beeper, a pager, and/or a watch.

Each of the central processing computer(s) 10, the provider computer(s) 20, the payer computer(s) 30, the patient computer(s) 40, and/or the intermediary computer(s) 50, can transmit information to, as well as receive information from, any of the computers 10, 20, 30, 40, and 50, described herein. In this regard, each of the computers 10, 20, 30, 40, and 50, can communicate with, process information from, and/or share data and/or information with, each other and/or any other computer or computers 10, 20, 30, 40, and 50, described herein and/or utilized in conjunction with the present invention. In this manner, data and/or information transfer between any of the computers 10, 20, 30, 40, and 50, can communicate with any other computer or computers 10, 20, 30, 40, and 50, in a bi-directional manner.

The central processing computer(s) 10, the provider computer(s) 20, the payer computers(s) 30, the patient computer(s) 40, and the intermediary computer(s) 50, can communicate with one another, and/or be linked to one another, over a communication network, a telecommunication network, a telephone network, a line-connected network, and/or a wireless communication network. Each of the computers 10, 20, 30, 40, and 50, can be linked with any other computer or computers directly or indirectly directly or indirectly with one another so as to facilitate a direct or indirect bi-directional communication said respective computers. Communications between each of the computers 10, 20, 30, 40, or 50 can also involve an e-mail server or e-mail servers in those instances when e-mails are described as being used to transmit or send any of the information, signals, messages, reports, notification messages, or any other communications, described herein, by or between any of the computers 10, 20, 30, 40, or 50, or when any of the information, signals, messages, reports, notification messages, or any other communications, described herein, are transmitted by and/or between any of the parties described herein and/or by or between any of the computers 10, 20, 30, 40, or 50, or any other computers or communication devices, computer systems, communication network equipment, server computers, etc., or any other devices used or needed in order to facilitate communications or the transmission of any of the herein-described information, signals, messages, reports, notification messages, or any other communications.

In a preferred embodiment, any and/or all of the signals, messages, reports, notification messages, or any other communications, described herein as being transmitted from one device, computer, or communication device, to another, can be, or can be included in, or be attached to, an e-mail message, an instant messaging message, an electronic transmission, or an electronic data transmission or electronic data interchange, or can be transmitted via any other data or information transmission, and can be transmitted via or using any appropriate or necessary computer(s) or device(s).

In the preferred embodiment, the present invention is utilized on, and/or over, the Internet and/or the World Wide Web. The present invention, in the preferred embodiment, can also utilize wireless Internet and/or World Wide Web services, equipment and/or devices. The central processing computer(s) 10, in the preferred embodiment, has a web site or web sites associated therewith.

Although the Internet and/or the World Wide Web is a preferred communication system and/or medium utilized, the present invention, in all of the embodiments described herein, can also be utilized with any appropriate communication network or system including, but not limited to, a communication network or system, a telecommunication network or system, a telephone communication network or system, a cellular communication network or system, a wireless communication network or system, a line or wired communication network or system, a wireless Internet network or system, a wireless World Wide Web network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, a cable television network or system, and/or any other communication network or system, and/or any combination of the above communication networks or systems.

In the preferred embodiment, each of the central processing computer(s) 10, the provider computer(s) 20, the payer computer(s) 30, the patient computer(s) 40, and intermediary computer(s), can transmit data and/or information using TCP/IP, as well as any other Internet and/or World Wide Web, and/or communication, protocols.

The apparatus 100 of the present invention can utilize electronic commerce technologies and security methods, techniques and technologies, in any and/or all of the instances of data and/or information processing, and/or data and/or information transmission described herein.

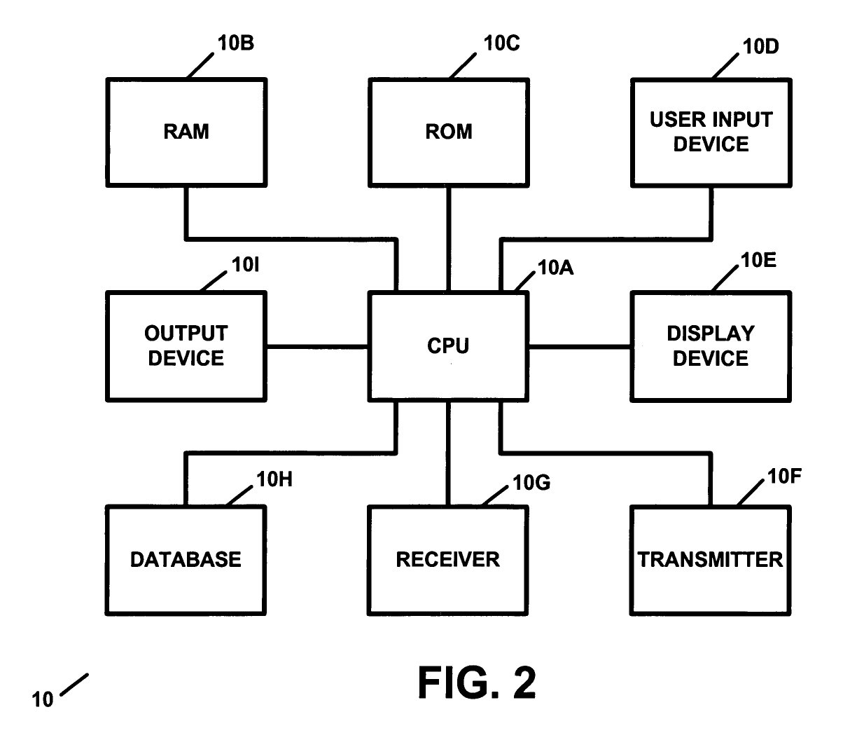

FIG. 2 illustrates the central processing computer 10, in block diagram form. The central processing computer 10, in the preferred embodiment, is a network computer or computer system, or any other communication device which can provide the functionality of, and which can be utilized as a central processing computer such as an Internet server computer and/or a web site server computer. In the preferred embodiment, the central processing computer 10 includes a central processing unit or CPU 10A, which in the preferred embodiment, is a microprocessor. The CPU 10A may also be a microcomputer, a minicomputer, a macro-computer, and/or a mainframe computer, depending upon the application.

The central processing computer 10 also includes a random access memory device(s) 10B (RAM) and a read only memory device(s) 10C (ROM), each of which is connected to the CPU 10A, a user input device 10D, for entering data and/or commands into the central processing computer 10, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering healthcare data and/or information, for example pulse rate monitors, blood pressure monitors, electrocardiograms, blood-sugars monitors, etc., if desired, which input device(s) are also connected to the CPU 10A. The central processing computer 10 also includes a display device 10E for displaying data and/or information to a user or operator.

The central processing computer 10 also includes a transmitter(s) 10F, for transmitting signals and/or data and/or information to any one or more of the central processing computer(s) 10, the provider computer(s) 20, the payer computers(s) 30, the patient computer(s) 40, and the intermediary computer(s) 50 individual computer(s), which may be utilized in conjunction with the present invention. The central processing computer 10 also includes a receiver 10G, for receiving signals and/or data and/or information from any one or more of the central processing computer(s) 10, the provider computer(s) 20, the payer computers(s) 30, the patient computer(s) 40, and the intermediary computer(s) 50, which may be utilized in conjunction with the present invention.

The central processing computer 10 also includes a database(s) 10H which contains data and/or information pertaining to the patients, providers, payers, and intermediaries who or which are serviced by the present invention and/or who or which utilize the present invention.

The database 10H can contain any and/or all of the information needed and/or required in order to perform any and/or all of the functions, services and/or operations described herein as being performed by the central processing computer 10 or the apparatus 100 of the present invention. In this regard the database 10H can contain data and/or information regarding patient name, patient identification information, patient social security number or other identification information, date of birth, sex, gender, race, nationality, ethnicity, spoken language, preferred language, other languages, religion or religious affiliation, next-of-kin, relatives, emergency contact person, doctors or providers, therapists, nutritionists, insurance or payer information, group insurance information, group health insurance information, life insurance information, disability insurance information, patient address, phone number, e-mail and/or other contact information, medical history, psychological history, dental history, family history, family medical, psychological, and/or dental history, past and/or current or active symptoms, past and/or current or active diagnoses, past and/or current or active treatments or treatment plans, care management plan or plans, allergies, active or current medications or prescription drugs, active or current medication allergies, past, active, or current allergies, smoking status, insurance coverage, insurance co-payment and/or deductible information, co-payment information regarding any payer or insurer insurance policy or payment plan, deductible information regarding any payer or insurer insurance policy or payment plan, benefit eligibility information, insurance information, insurance claim procedures, insurance claim forms, doctor or provider appointment schedules, past treatments, past diagnosis, symptoms, insurance claim forms, employer information, lifestyle information, treatment plans, treatment progress, broker/agent/intermediary information, education information, age, sex, marital status, employee benefits information, types or services and/or treatments needed, and any other data and/or information regarding the patient which would be needed and/or desired in order to perform any and/or all of the functions, services and/or operations described herein.

The database 10H can also contain provider office visit summaries, hospital discharge summaries, hospital discharge instructions, and/or any examination, treatment, testing, or procedure, summary, and any instructions, treatment plan or instructions, care management plan or instructions, or any other information which can be provided to any individual, patient, provider, payer, insurer, third party or intermediary, or caregiver, described herein as using the apparatus 100 and method of the present invention, or described herein as being able to receive services, provide services, or otherwise use or be serviced by, the apparatus 100 and method of the present invention.

In the case of deceased patients or individuals, the database 10H can contain information regarding date of death, place of death, preliminary cause of death, and/or final determination of cause of death. The database 10H can also contain information regarding any other information regarding a deceased patient or individual and can also contain information regarding final resting place.

The database 10H can also contain, for each patient or individual, information regarding dates of appointments or services with or from healthcare providers or other providers, dates of laboratory tests, dates of treatments, operations, or procedures, dates of doctor visits, therapy sessions, vital signs, healthcare chart changes, or information regarding height, weight, blood pressure, heart rate, pulse rate, body-mass index, growth charts, and/or any other related or pertinent data or information.

The database(s) 10H can also contain healthcare and/or medical video, image, and/or audio, and/or text, data and/or information, and/or surgical video, image, and/or audio, and/or text, data and/or information, and/or dental video, image, and/or audio, and/or text, data and/or information, such as, for example, x-rays, Magnetic Resonant Images (MRI), CAT scans, digital x-ray files, digital Magnetic Resonant Imaging (MRI) files, digital CAT scan files, and/or any other video, imaging, and/or audio, healthcare data and/or information which can be utilized by healthcare providers, payers, intermediaries, patients, and/or other users of the present invention. In this manner, the present invention can facilitate the availability of any of the above-described video, image, and/or audio, data and/or information in a network environment. For example, a medical specialist can have access to, and/or review, an MRI or a CAT scan for a patient, from any location and at any time.

The database 10H can also contain data and/or information regarding providers including provider name, provider social security number or identification number, type of professional or service provider, address, phone number, fax number, e-mail and/or other contact information, experience, specialties, insurances accepted, schedule of charges, financial account identification information, resume information, education, work experience, claim forms, appointment schedules, procedures performed, and/or any other data and/or information concerning the providers for providing any and/or all of the functions, services, and/or operations described herein as being performed by the present invention.

The database 10H can also contain data and/or information regarding all possible fields of medicine, surgery, psychiatry, psychology, dentistry, oral surgery, optometry, podiatry, physical therapy, respiratory therapy, hypnosis, osteopathy, nutrition, wellness, and/or any other possible healthcare fields and/or subject matter which can possibly by utilized in the processing and/or operation of the present invention.

The database 10H can also contain information on illnesses, symptoms, diseases and/or sicknesses, theories, scientific theories, research data and/or information, diagnosis information, treatment information, treatment plans, treatment processes, treatment progresses, treatment interactions, side effects, expected treatment results, treatment providers, treatment durations, treatment costs, pre-treatment information, post-treatment information, treatment monitoring information, statistical information regarding diagnoses, treatments, treatment success rates, treatment failure rates, treatment centers, therapy plans, therapy success rates, therapy failure rates, treatment procedures, medications treatments, non-medication treatments, healthcare institutions, treatment evaluating criteria, treatment mistakes and/or mishaps, indicators of mistakes and/or mishaps, corrective actions, links to providers, links to treatment centers or institutions, reimbursement rates, nutrition information, diet information, exercise information, exercise routines, treatment options, healthcare advise, wellness advice, preventive care, preventive procedure, health maintenance, drug and medication information, drug interaction information, video information, including video files or clips and other information, regarding illnesses, diseases, treatments and follow-up care, audio information, including audio files or clips and other information, regarding illnesses, diseases, treatments and follow-up care, treatment and/or procedure information and/or narratives, treatment analysis, diagnosis analysis, diagnosis monitoring, diagnosis confirmation and/or checking, and/or other information for providing the herein-described functions, services, and/or operations.

The database 10H can also contain information regarding the insurance companies and payers described herein, including, but not limited to, payer name, address, phone number, fax number, e-mail address, identification number(s), coverage types, policies and/or coverages provided, reimbursement rates, patients and/or providers serviced and/or covered by the payer, policy information, claim forms, claim procedures, claim status, claim processing information, claim submission procedures and policies, reasonable and customary charges, co-payment information, pre-approval information and/or procedures, claim form information, electronic form claim forms, insurance and/or coverage requirements, guidelines, and/or triggering events, covered procedures and/or treatments, uncovered procedures and/or treatments, claim approval information, claim approval history, claim approval statistics, claim rejection or denial information, claim rejection or denial history, claim rejection or denial statistics, financial account information, network provider information, network patient information, claim statistics, preventative care and/or benefits information, benefits information, benefits request information and/or claim forms, claim submission information, claim processing information, claim status information, payment information and statistics, and/or any other data and/or information regarding and/or related to payers which are needed and/or desired for providing any and/or all of the functions, services, and/or operations described herein.

The database 10H can also contain data and/or information regarding the brokers, agents and/or intermediaries described herein, including, but not limited to, intermediary name, address, phone number, fax number, e-mail address, clients, patients services, insurance policies, policy information, policy quote information, policy proposal information, any and/or all of the above information described herein regarding patients, providers, payers, etc. which may be of interest to the intermediaries described herein which may be useful and/or beneficial to the intermediaries in providing any of the functions, services, and/or operation described herein.

The database 10H can also contain contact information such as phone numbers, fax numbers, pager numbers, beeper numbers, e-mail addresses, hyperlinks to, and/or any other information which can facilitate contact between any of the parties described herein. The database 10H also includes electronic signature data and/or information for any of the parties, patients, providers, payers, and/or intermediaries, described herein for facilitating transactions, claim submissions, financial transactions, etc., by and/or between any of the above patients, providers, payers, and/or intermediaries.

The data and/or information in the database 10H can also include links to any other information, information sources, news sources, and/or other information and/or data which can or may be utilized by the present invention and/or by any of the patients, providers, payers, intermediaries and/or any other users of the present invention.

The database 10H can also contain data and/or information regarding healthcare news, healthcare developments, healthcare discoveries, etc., for and including the medical field, surgical field, psychological field, dental field, nutrition field, fitness field, etc., and/or any other healthcare field or fields.

The database 10H, in the preferred embodiment, can also contain video and/or audio files which can be utilized for training of healthcare professionals as well as for providing general information to any user of the present invention. In this manner, and as will be described hereinbelow, the apparatus 100 can be utilized as a simulator for providing training in medical diagnosing, medical training, surgical training, psychiatric training, psychological training, dental training, oral surgery training, therapist training, and/or for training any of the healthcare providers described herein and/or envisioned.

For example, the present invention can be utilized to provide a medical doctor with a set of symptoms, evaluate the diagnosis and treatment prescribed and provide follow-up patient conditions which may or may not call for the medical doctor to re-evaluate his or her diagnosis and/or treatment. In a similar fashion, the present invention can be used for training and continuing education and training for any of the healthcare providers described herein and/or otherwise envisioned utilizing the present invention.

The database 10H can also contain data and/or information restricting access by any of the providers, payers, patients, intermediaries, and/or other users, to any of the data and/or information stored in the database 10H.

The database 10H can also contain information correlating symptoms and/or conditions with diagnoses, prognoses, and/or treatments, treatment methods, procedures, etc. The database 10H also contains any and/or all information needed and/or desired for facilitating the processing of symptoms, conditions, medical histories, family histories, and other information, in order to arrive at diagnoses and/or prognoses, treatments, prescriptions, procedures and/or any other healthcare and/or healthcare-related information.

The database 10H can also contain information regarding medical records, medical charts, x-rays, MRIs, and/or any other information, described herein and/or otherwise, which can be associated with an individual's or patient's medical history, medical record, or medical file, for any individual or patient who utilizes the apparatus 100 and method of the present invention.

The database 10H can also contain information regarding surgical records, surgical charts, x-rays, MRIs, and/or any other information, described herein and/or otherwise, which can be associated with an individual's or patient's surgical history, surgical record, or surgical file, for any individual or patient who utilizes the apparatus 100 and method of the present invention.

The database 10H can also contain information regarding dental records, dental charts, x-rays, and/or any other information, described herein and/or otherwise, which can be associated with an individual's or patient's dental history, dental record, or dental file, for any individual or patient who utilizes the apparatus 100 and method of the present invention.

The database 10H can also contain information regarding a prescription drug record, file, or account, for an individual or patient for any individual or patient who utilizes the apparatus 100 and method of the present invention.

The database 10H can also contain information regarding a healthcare spending account or healthcare spending accounts for any individual or patient, or for any of the individuals or patients, described herein or otherwise, who utilize the apparatus 100 and method of the present invention. For example, the healthcare spending account is or can be an account which can be a deposit account, a credit account, a debit account, an electronic money or an electronic cash account, or any combination of same, which can be held by any individual, patient, employer, bank, credit union, financial institution, investment institution, healthcare insurer, healthcare payer, or any other third party, and which can be used as a source of funds for payment for any type of healthcare service or healthcare product which is provided to, or administered to, or sought by, any individual or patient who utilizes the apparatus 100 and method of the present invention. In a preferred embodiment, the healthcare spending account can be used by the individual or patient to pay for any healthcare service, treatment, procedure, or product, at any time a payment is desired to be made for same.

The database 10H can also contain, for each individual or patient who utilizes the apparatus 100 and method of the present invention, information regarding, or a record of, each and every instance of a provider office visit involving the individual or patient, a communication(s) with a provider or providers involving or regarding the individual or patient, a payment(s) made by or on behalf of the individual or patient, an insurance claim(s) made by a provider or providers on a healthcare insurance policy or account for or regarding the individual or patient, including information regarding date of claim, time of claim, or the provider making the claim, a co-payment(s) made by or on behalf of the individual or patient, a payment(s) made on an insurance claim, a denial(s) of an insurance claim or insurance claims, or a resolution(s) of an insurance claim or insurance claims. The database 10H can also contain information regarding a history or record of insurance claims made by a provider or providers, or made by an individual or patient, for each individual or patient who utilizes the apparatus 100 and method of the present invention.

The database 10H can also contain credit report data or information, a credit report, credit reports, or a credit history, for any individual or patient, or for any of the individuals or patients, described herein or otherwise, who utilize the apparatus 100 and method of the present invention. The credit report or credit reports, or credit history, can contain any of the information which is typically provided by, or which may be provided by, any commercial or other credit reporting company or agency, such as, for example, but not limited to, credit reporting companies such as TransUnion LLC, Experian Information Solutions, Inc., Equifax, Inc., or any other credit reporting company, agency, or bureau, or any credit card company or financial institution. The database 10H can also contain any data or information which is typically found in a credit report database or credit history database, and/or any data and/or information which is, or which can be, utilized in generating, and/or analyzing, a credit report or credit reports, or a credit history, for, or on behalf of, any individual or patient, or for any of the individuals or patients, described herein or otherwise, who utilize the apparatus 100 and method of the present invention. The database 10H can also contain e-mail contact information, telephone contact information, cellular telephone contact information, and/or any other suitable contact information, for an individual or patient which can be utilized to notify the individual or patient when information regarding his or her credit report or credit reports, or credit history, is accessed, obtained, changed, or when a new entry of information is made in same.

The database 10H can also include advertisements, advertisement materials and information, marketing materials or information, commercials, video clips, infomercials, and any other information, which can include text information, video information, audio information, or any combination of same, which can be used to provide an advertisement, or advertisement material or information, to or for any individual, patient, provider, healthcare provider, payer, healthcare payer, insurer, healthcare insurer, product provider, service provider, third party provider, or any other person or entity, who or which utilizes the apparatus 100 and method of the present invention. A respective advertisement, advertisement material and information, marketing material or information, commercial, video clips, infomercials, and/or any other information, can be used to advertise or market any product(s) or service(s) which can be used by, provided to, provided by, advertised to, advertised by, marketed to, or marketed by, any individual, patient, provider, healthcare provider, payer, healthcare payer, insurer, healthcare insurer, product provider, service provider, third party provider, or any other person or entity, who or which utilizes the apparatus 100 and method of the present invention.

The database 10H can also contain news information, news reports, published reports, theses, study reports, or any other data or information regarding health issues, healthcare issues, health conditions, diseases, treatments, drugs, medications, healthcare procedures, medical procedures, surgical procedures, dental procedures, prescription products or services, non-prescription products or services, over-the-counter products or services, health or wellness issues or recommendations, exercise issues or recommendations, alternate therapy or treatment types or recommendations, herbal therapies or recommendations, or any other data or information which can be used by or provided to any individual, patient, provider, healthcare provider, payer, healthcare payer, insurer, healthcare insurer, product provider, service provider, third party provider, or any other person or entity, who or which utilizes the apparatus 100 and method of the present invention. The news information, news reports, published reports, theses, study reports, or any other data or information can include text information, video information, audio information, or any combination of same.

The news information, news reports, published reports, theses, study reports, or any other data or information, stored in the database 10H, can be transmitted to, or fed to, the central processing computer 10, for storage in the database 10H, by or from any appropriate computer or communication device, which is associated with or used by any news source, news organization, research institution, research professional, healthcare facility, an author, researcher, academician, or any other individual, person, or entity. An intermediary communication device 50 can also be utilized to transmit the news information, news reports, published reports, theses, study reports, or any other data or information to the central processing computer 10.

The database 10H can also contain prescription drugs information, prescription medication information, over-the-counter drug or medication information, wellness information, exercise and fitness information, and/or any other information pertinent to an individual's or a patient's heath, well-being, or treatment.

The database 10H can also include language translation information or software so that any of the data or information described herein as being stored in the database 10H, or as being provided in any of the messages, reports, or other communications, described herein can be translated into any language.

The database 10H can also contain statistical and/or other probabilistic and/or mathematical information for assigning and/or correlating certain levels and/or estimates for any and/or all of the information, diagnoses, prognoses, treatments, procedures, and/or any other information processed and/or generated by the central processing computer 10 and/or the apparatus 100. Applicant hereby incorporates by reference herein the teachings of Basic Business Statistics Concepts and Applications, Mark L. Berenson and David M. Levine, 6^{th} Edition, Prentice Hall 1996.

The database 10H, in the preferred embodiment, can be a database which may include individual databases or collections of databases, with each database being designated to store any and all of the data and/or information described herein. The database 10H, or collection of databases, may be updated by each of the respective patients, providers, payers, users, and/or intermediaries, and/or by any other third party, in real-time, and/or via dynamically linked database management techniques.

The data and/or information stored in the database 10H can also be updated by and/or dynamically linked to, various external sources, including but not limited to news services, research publications, research facilities, healthcare laboratories, providers of healthcare goods and/or services, pharmaceutical companies, research institutions, schools. The databse 10H will contain any and all information deemed necessary and/or desirable for providing all of the processing and/or services and/or functions described herein. Applicant hereby incorporates by reference herein the subject matter of Fundamentals of Database Systems, by Ramez Elmasri and Shamkant B. Navathe, 2^{nd} Ed., Addison-Wesley Publishing Company, 1994.

The database 10H can also contain data and/or information regarding any and/or all International Classification of Diseases (ICD) codes, ICD-10 codes, ICD-9, or any other ICD codes, or other codes, billing codes, diagnostic codes, treatment codes, or symptom codes, as well as any other codes or coding information which pertains to healthcare, the administration of healthcare services, healthcare record keeping, healthcare billing, healthcare diagnostics, healthcare treatments, or any other healthcare or healthcare-related functions or services, or any information or function, described-herein as capable of being provided by the apparatus 100 and method of the present invention. The database 10H can also contain data and/or information regarding the foreign language translations or conversions of or for, or for the foreign language translation or converting, of any of the herein-described International Classification of Diseases (ICD) codes, ICD-10 codes, ICD-9, any other ICD codes, or other codes, billing codes, diagnostic codes, treatment codes, symptom codes, as well as any other codes or coding information which pertains to healthcare, the administration of healthcare services, healthcare record keeping, healthcare billing, healthcare diagnostics, healthcare treatments, or any of the healthcare or healthcare-related functions or services, or any information or function described-herein as capable of being provided by the apparatus 100 and method of the present invention, into any one or any number of foreign languages.

The database 10H can contain any look-up tables, or information for use in a look table, for translating or converting any of the data, information, or codes, described herein, into any one or any number of foreign languages. The database 10H can also contain any language translation software or language conversion software which can be used to perform any of the foreign language translation or foreign language conversion processing or functionality described as being performed by the apparatus 100 and method of the present invention.

The database 10H can also contain any information or software, or rules algorithms, which can be used in generating insurance claim forms which can be submitted error-free to any of the insurers or payers described herein.

The database 10H can also contain digital pictures, photographs, images, video, or video clips, of individuals or patients, as well as digital pictures, photographs, images, video, or video clips, of physical conditions of or regarding an individual or patient, which can be accessed or retrieved by any of the individuals, patients, providers, payers, or intermediaries, described herein as utilizing the apparatus 100 and method of the present invention. For example, in instances where photographs or images can be useful to see a state of a physical condition of a patient or individual, or to compare a state of a physical condition from one point in time to another, or to track the state of a physical condition, a photograph(s), picture(s), or image(s), or video clip, can be digitally recorded, with a camera or video recording device, and stored in the database 10H and/or in the patient's or individual's healthcare record or healthcare file for later retrieval, use, and/or review.

For example, a dermatologist seeking to determine if a skin condition has or is changing in size, shape, or color, can take and store, in the database 10H and/or in the patient's or individual's healthcare record or healthcare file, one or more photographs, pictures, or images, or a video clips, of the skin condition. In an analogous manner, a plastic surgeon can obtain and store, in the database 10H and/or in the patient's or individual's healthcare record or healthcare file, photographs, pictures, or images, or video clips, showing physical conditions of an individual or patient before, after, or during a procedure or procedures. A dentist or an oral health professional can obtain and store, in the database 10H and/or in the patient's or individual's healthcare record or healthcare file, in addition to x-rays, a photograph(s), picture(s), or image(s), or a video clip(s), showing physical conditions of an individual's or patient's mouth, teeth, gums, or other physical oral state, for later retrieval, use, or review. In an analogous manner, any healthcare provider can obtain and store, in the database 10H and/or in a patient's or individual's healthcare record or healthcare file, a photograph(s), picture(s), or image(s), or a video clip(s), obtained in or during an office visit, an examination, a procedure, an operation, a treatment, or during any other occasion, event, occurrence, or happening, for later retrieval and use as needed or desired by any provider, payer, patient, individual, or intermediary, described herein as being able to utilize the apparatus 100 and method of the present invention.

The database 10H can also contain video and/or audio clips or recordings of office visits, examinations, procedures, operations, or any other healthcare, healthcare-related, or any other event(s), occurrence(s), or happening(s), which may or which can be of interest to any provider, insurer, payer, patient, individual, or intermediary, described herein as being able to utilize the apparatus 100 and method of the present invention.

The database 10H can also contain transcripts of office visits, examinations, procedures, operations, or any other healthcare, healthcare-related, or any other event(s), occurrence(s), or happening(s), which may or which can be of interest to any provider, insurer, payer, patient, individual, or intermediary, described herein as being able to utilize the apparatus 100 and method of the present invention.

The database 10H can also contain data, information, links, or hyperlinks, which can allow a healthcare provider to create or generate and/or transmit prescriptions or electronic prescriptions, or prescription forms, to pharmacies or other providers, for a patient or individual, or prescriptions or electronic prescriptions for tests, analyses, analysis work-ups, procedures, therapy, physical therapy, or other healthcare or healthcare-related services, for a patient or individual, or which can allow a healthcare provider to transmit a referral or an electronic referral or referral form to other healthcare providers or other providers of goods or services for a patient or individual.

The database 10H can also contain data, information, links, or hyperlinks, which can allow a healthcare provider to perform remote control or monitoring of healthcare devices or equipment used in the treatment of, a care of, or a monitoring of, a patient or individual, while the patient or individual is at home, in a hospital, in a nursing home, in a care facility, or traveling in or on, respectively, a car, automobile, train, subway train, boat, helicopter, airplane, aircraft, or any other vehicle.

The database 10H can also contain data, information, or software, for performing healthcare audits, for performing meaningful use information processing routines, for identifying or selecting individuals for clinical trials, experimental procedures, experimental treatments, healthcare focus groups, healthcare surveys, or other activities or events, or for performing any other processing routines which can advantageously use any of the information stored in the database 10H, any information stored in any of the herein-described healthcare records, files, or histories, described herein, or any other information, stored by the apparatus 100 of the present invention or any of its computers, communication devices, component parts, or devices, or any other information stored in, provided by, generated by, or used by, the apparatus 100 of the present invention. For example, with regards to clinical trials, experimental procedures, experimental treatments, healthcare focus groups, healthcare surveys, or other activities or events, the database 10H can contain information regarding whether or not an individual or patient can or may be a candidate for, be eligible to participate in, has agreed to be candidate for, or has agreed to participate in, clinical trials, experimental procedures, experimental treatments, healthcare focus groups, healthcare surveys, or other activities or events, or has agreed to be candidate for, or has agreed to participate in, a particular clinical trial(s), experimental procedure(s), experimental treatment(s), healthcare focus group(s), healthcare survey(s), or other activities or events.

The database 10H can also contain any data and/or information needed or used to determine or measure the effectiveness of, or side effects experienced or associated with, any medication(s), medicine(s), drug(s), dietary supplement(s), supplement(s), vitamin(s), nutrient(s), over-the-counter product(s) or substance(s), or the effectiveness of a procedure(s), treatment(s), treatment plan(s), care management plan(s), or any other good(s) or service(s) which can be offered in the marketplace.

The database 10H can also contain data and/or information relating to information regarding health conditions, healthcare conditions, illnesses, diagnoses, symptoms, treatments, treatment plans, care management plans, care management practices, insurance information, information regarding type of insurance, wellness information, healthcare practices, healthcare history patterns, healthcare trends, treatment trends, care management trends, statistics, statistical analyses, studies, study trends, or any other healthcare or healthcare-related information, for or regarding any number or type of groups of individuals or patients, and any data or information for determining same. The database 10H can also contain data or information regarding, or for determining, any of the above-described information for any number of groups of individuals or patients based on sex, gender, age, occupation, education, ethnicity, nationality, country of origin, religion, or any demographic or demographics, or any other criteria. The database 10H can also contain data or information regarding, or for determining statistical information or probability information regarding, any of the herein-described information.

The database 10H can also contain data or information for implementing and for performing drug formulary checks or analyses, as well as data or information for performing medication, medicine, or drug, reconciliation.

The database 10H can also contain immunization data or information.

The database 10H can also contain educational or instructional information, links or hyperlinks to same, information regarding instructions or procedures, or links or hyperlinks to same, in order to allow for the providing of patient-specific educational or instructional information or resources to patients or individuals, as well as to any of the herein-described healthcare providers, other providers, payers or insurers, or intermediaries or caregivers.

The database 10H can also contain data or information necessary or desired for administering employee benefits for any of the individuals or patients who utilize the apparatus 100 and method of the present invention.

The database 10H can also contain data or information necessary or desired for purchasing or enrolling in employee benefits for any of the individuals or patients who utilize the apparatus 100 and method of the present invention.

The database 10H can also contain data or information necessary or desired for allowing any individual or patient to make a request or a claim for, or pursuant to, or to file a request or a claim for, an employee benefit or employee benefits, for any of the individuals or patients who utilize the apparatus 100 and method of the present invention.

The database 10H can also contain data or information for facilitating, or for providing for, the portability of healthcare insurance or health insurance benefits, life insurance or life insurance benefits, or disability insurance or disability insurance benefits, or for providing for the portability of any other employee benefit or employee benefits.

The database 10H can also contain any of the messages or reports described herein as being generated by or provided by the apparatus 100 and method of the present invention, for later use by any provider, insurer, payer, patient, individual, or intermediary, or any other person or entity, described herein as being able to utilize the apparatus 100 and method of the present invention.

The database 10H can also contain any data, information, or software, for performing any of the processing routines or functionality described herein as being capable of being performed by, or provided by, the apparatus 100 of the present invention.

The data and/or information which is contained and/or stored in the database 10H as well as any of the other databases 20H, 30H, 40, and 50H, described herein can be obtained from the various patients, individuals, providers, payers, and/or intermediaries, who or which utilize and/or who or which are serviced by the present invention. For example, the respective patients, providers, payers, intermediaries, and/or other users, could fill out questionnaires, forms, narratives, claim forms, and/or any other information medium, in written form, electronically, and/or otherwise.

Data and/or information stored in the database 10H as well as any of the other databases described herein can be updated by multiple parties. For example, a patient may provide a medical history for his or her individual file, his or her medical doctor can update the medical history information for the patient upon examining and/or treating him or her. The payer may also update the file with any associated payment or payment-related information. Should the patient go to another doctor or different type of doctor, all previous information would be available for, and can be updateable by, the next doctor.

The database 10H can also contain information regarding alternate medicine techniques, herbal techniques, meditation techniques, exercise techniques, self healing, faith healing, and/or other non-medicine treatments and/or techniques.

The database 10H can also include statistical data and/or information regarding diagnoses, and/or alternate diagnoses, treatment success, treatment failure, as well as statistical data and/or information regarding misdiagnoses. The database 10H also contains data and/or information regarding experimental treatments as well as statistical information regarding same, successes of same and failures of same.

In any and/or all of the embodiments described herein, any of the data and/or information which is or which may be stored in the database 10H, and/or any of the other databases described herein, can be utilized and/or can appear in any of the reports, diagnostic reports, treatment reports, evaluation reports, provider reports, payer reports, patient reports, training reports, and/or any other reports, described herein.

The central processing computer 10 also includes an output device 10I for output any data, information, report, etc., described herein. In the preferred embodiment, the output device 10I can be a printer, a display, a transmitter, a modem, and/or any other device which can be used to output data.

Any of the data and/or information for any of the patients, individuals, providers, payers, and/or intermediaries, can be updated by different parities and which such updated data and/or information being made available to other respective parties so as to provide and ensure comprehensive and up-to-date healthcare and healthcare-related information.

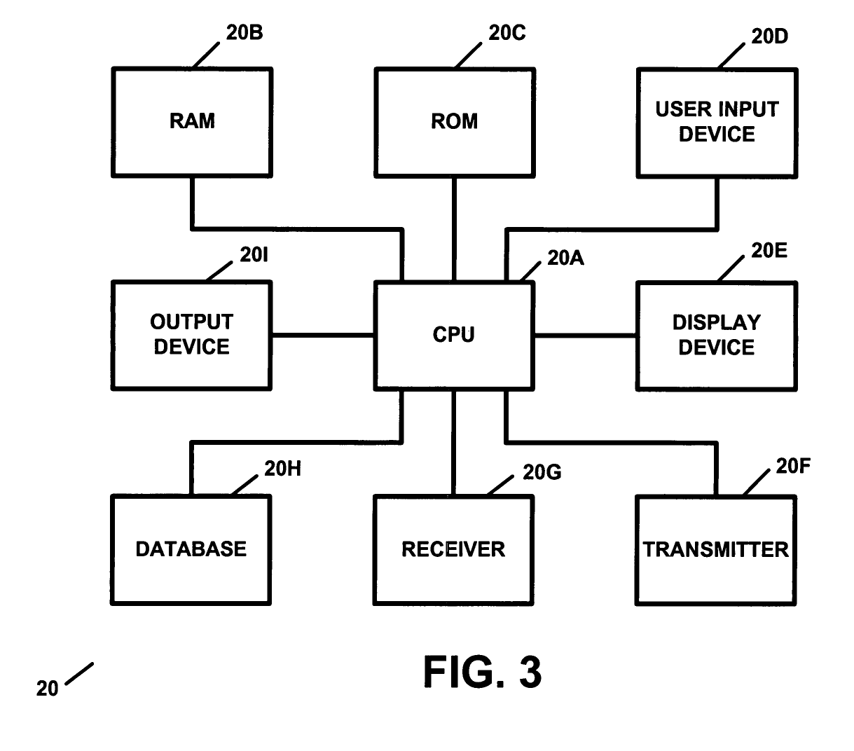

FIG. 3 illustrates the provider communication device 20, in block diagram form. The provider communication device 20, in the preferred embodiment, can be personal computer, a network computer or computer system, or any other computer or communication device, which is utilized as a provider computer 20. In the preferred embodiment, the provider communication device 20 includes a central processing unit or CPU 20A, which in the preferred embodiment, is a microprocessor. The CPU 20A may also be a microcomputer, a minicomputer, a macro-computer, and/or a mainframe computer, depending upon the application.

The provider communication device 20 also includes a random access memory device(s) 20B (RAM) and a read only memory device(s) 20C (ROM), each of which is connected to the CPU 20A, a user input device 20D, for entering data and/or commands into the provider communication device 20, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering healthcare data and/or information, for example pulse rate monitors, blood pressure monitors, electrocardiograms, blood-sugars monitors, etc., if desired, which input device(s) are also connected to the CPU 20A.

The user input device 20D can also acquire, receive, generate and/or provide, data which can be entered by a user or individual and/or can be a device which can acquire, receive, generate and/or provide, digital data such as medical, healthcare, bio-metric, physiological, and/or any other kind of healthcare data and/or healthcare-related data. For example, a user input device 20D can be a keyboard for allowing a user to input information into the provider communication device and/or a user input device can, for example, by a heart rate monitor or EKG machine which can receive information from a patient or individual and generate a digital signal, digital data, analog data, and/or any other signal, data, and/or information, which is representative of the patient's or individual's heart rate, pulse rate, and/or cardiac activity.

The user input device 20D can also be, or can include, any one or more of, and/or any combination of, a thermometer, a digital thermometer, a stethoscope, a heart rate monitor or measurement device, a pulse rate monitor or measurement device, a blood pressure monitor or measurement device, a blood pressure measurement device, blood analysis device or machine, a respirator, a respiration monitoring or measurement device, a dialysis machine, a dialysis device, electrocardiograph (EKG) machine or device, electrocephalograph (EEG) machine or device, electromyograph (EMG) machine or device, a magnetic resonance imaging (MRI) machine or device, X-ray machine or device, medical imaging machine or device, thermal imaging machine or device, a heart sound monitor or measurement device, a lung sound monitoring or measurement device, respiration rate monitoring or measurement device, a laprascopic device, an arthroscopic device, a vascular testing device, a catheter device, a cardiac performance testing, monitoring, or measurement device, a pulmonary performance testing, monitoring, or measurement device, a vascular system performance monitoring or measurement device, a vascular system testing, monitoring, or measurement device, a metabolism monitoring or measurement device, a sonogram imaging device, a sonogram measurement device, a sonograph device, an optical response device, an optical response measurement device, an intravenous device, an arterial blood pressure measurement or monitoring device, a respiration rate measurement or monitoring device, an ultrasound imaging device, an ultrasound measurement device, a CAT SCAN device, a PET scan device, an optical metabolism measurement or monitoring device, a radiotelemetric device, a doppler medical device, a mammogram device, a carbon dioxide detection or measurement device, a carbon monoxide detection or measurement device, a transvascular impedence measurement or monitoring device, an ultrasonic imaging device, a bone conduction device, a brain function scan analyzer device, external pulse cardiac monitoring or measurement device, a fetal heart rate measurement, monitoring, or probing, device, an endotrachial cardiac monitoring device, a finger tip blood pressure monitoring device, a psychological monitoring device, a surgical instrument, a vital signs measurement device, ear pressure regulating device, phonocardiograph device, acoustic aneurysm detector device, blood oxygen detection device, esophageal probing device, ultrasonic probing device, ausculoscope, vital signs monitoring system, heart activity monitoring device, pulmonary activity monitoring device, sphygmomanometer, esophageal stethoscope, venous pressure measuring device, differential doppler device, physiological data measuring device, body tissue movement device, breathalyzer device, camera probing device, microscopic camera probing device, any scope having a camera and/or a light, a laparoscopic device, a laparoscopic camera device, a camera used in or associated with equipment for performing visual probing of the body or any portions, parts, or organs, thereof, such as, but not limited to, a colonoscopy, an endoscopy, an esophagoscopy, a gastroscopy, or any devices used in laparoscopic surgery or other surgeries, an ingestible or implantable pill, capsule, or device, containing a camera and/or a light and equipment or circuitry for transmitting information as well as images to equipment inside or outside the body, and/or any other bio-metric or physiological data measuring device(s) and/or data acquisition device (hereinafter referred to generally or collectively as “healthcare equipment input device”, “healthcare measurement input device”, or “healthcare monitoring input device”).

The user input device 20D can also be, or can include, a pacemaker, a device for monitoring blood pressure or blood flow, or an ingestible or implantable pill, capsule, or device, containing a camera and/or a light and equipment or circuitry for transmitting information as well as images to equipment inside or outside the body.

The provider communication device 20 also includes a display device 20E for displaying data and/or information to a user or operator.

The provider communication device 20 also includes a transmitter(s) 20F, for transmitting signals and/or data and/or information to any one or more of the central processing computer(s) 10, the provider computer(s) 20, the payer computers(s) 30, the patient computer(s) 40, and the intermediary computer(s) 50 individual computer(s), which may be utilized in conjunction with the present invention. The provider communication device 20 also includes a receiver 20G, for receiving signals and/or data and/or information from any one or more of the central processing computer(s) 10, the provider computer(s) 20, the payer computers(s) 30, the patient computer(s) 40, and the intermediary computer(s) 50, which may be utilized in conjunction with the present invention.

The provider communication device 20 also includes a database(s) 20H. The database 20H can contain and/or be linked to any of the data and/or information described herein as being stored in the database 10H.

The provider communication device 20 also includes an output device 20I for output any data, information, report, etc., described herein. In the preferred embodiment, the output device 20I can be a printer, a display, a transmitter, a modem, and/or any other device which can be used to output data.

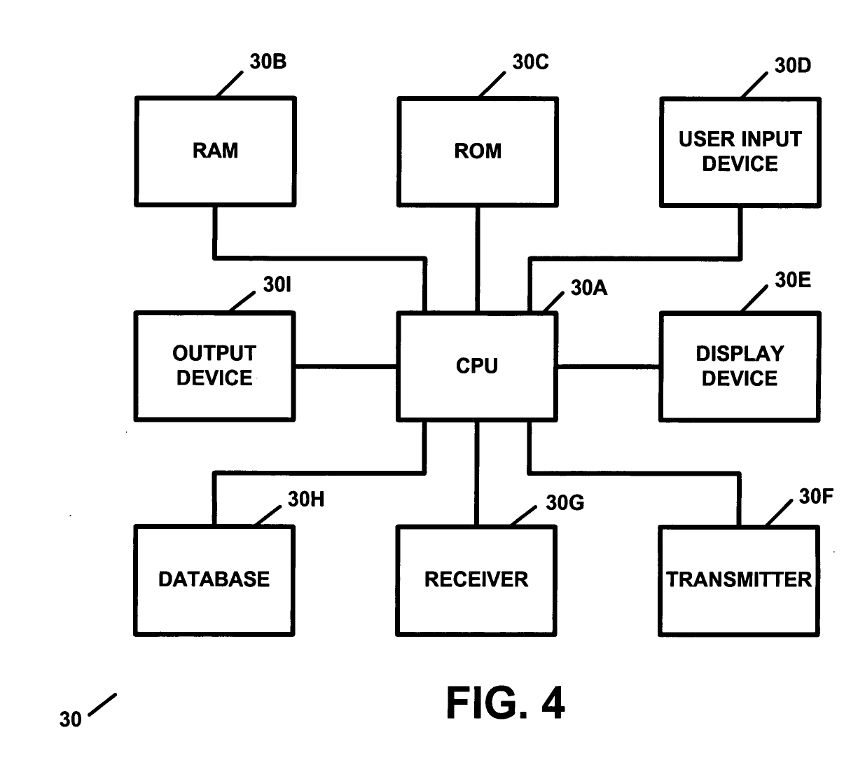

FIG. 4 illustrates the payer communication device 30, in block diagram form. The payer communication device 30, in the preferred embodiment, can be personal computer, a network computer or computer system, or any other computer or communication device, which is utilized as a payer computer 30. In the preferred embodiment, the payer communication device 30 includes a central processing unit or CPU 30A, which in the preferred embodiment, is a microprocessor. The CPU 30A may also be a microcomputer, a minicomputer, a macro-computer, and/or a mainframe computer, depending upon the application.

The payer communication device 30 also includes a random access memory device(s) 30B (RAM) and a read only memory device(s) 30C (ROM), each of which is connected to the CPU 30A, a user input device 30D, for entering data and/or commands into the payer communication device 30, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering healthcare data and/or information, for example pulse rate monitors, blood pressure monitors, electro-cardiograms, blood-sugars monitors, etc., if desired, which input device(s) are also connected to the CPU 30A. The payer communication device 30 also includes a display device 30E for displaying data and/or information to a user or operator.

The payer communication device 30 also includes a transmitter(s) 30F, for transmitting signals and/or data and/or information to any one or more of the central processing computer(s) 10, the provider computer(s) 20, the payer computers(s) 30, the patient computer(s) 40, and the intermediary computer(s) 50 individual computer(s), which may be utilized in conjunction with the present invention. The payer communication device 30 also includes a receiver 30G, for receiving signals and/or data and/or information from any one or more of the central processing computer(s) 10, the provider computer(s) 20, the payer computers(s) 30, the patient computer(s) 40, and the intermediary computer(s) 50, which may be utilized in conjunction with the present invention.

The payer communication device 30 also includes a database(s) 30H. The database 30H can contain and/or be linked to any of the data and/or information described herein as being stored in the database 10H.

The payer communication device 30 also includes an output device 301 for output any data, information, report, etc., described herein. In the preferred embodiment, the output device 301 can be a printer, a display, a transmitter, a modem, and/or any other device which can be used to output data.

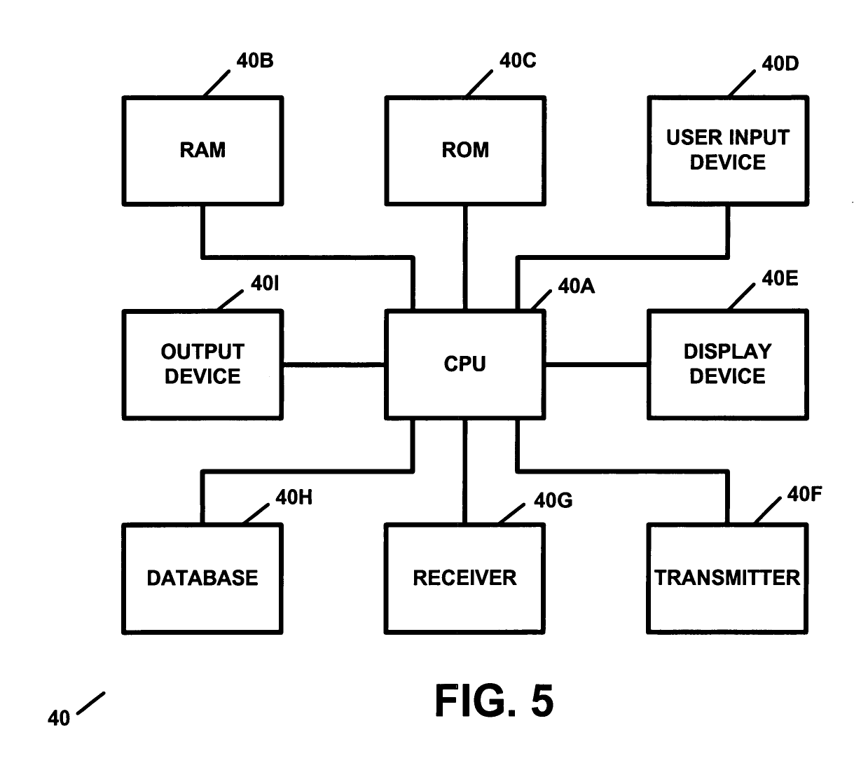

FIG. 5 illustrates the patient communication device 40, in block diagram form. The patient communication device 40, in the preferred embodiment, can be personal computer, a network computer or computer system, or any other computer or communication device, which is utilized as a patient computer. In the preferred embodiment, the patient communication device 40 includes a central processing unit or CPU 40A, which in the preferred embodiment, is a microprocessor. The CPU 40A may also be a microcomputer, a minicomputer, a macro-computer, and/or a mainframe computer, depending upon the application.

The patient communication device 40 also includes a random access memory device(s) 40B (RAM) and a read only memory device(s) 40C (ROM), each of which is connected to the CPU 40A, a user input device 40D, for entering data and/or commands into the patient communication device 40, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering healthcare data and/or information, for example pulse rate monitors, blood pressure monitors, electro-cardiograms, blood-sugars monitors, etc., if desired, which input device(s) are also connected to the CPU 40A.

The user input device 40D can also acquire, receive, generate and/or provide, data which can be entered by a user or individual and/or can be a device which can acquire, receive, generate and/or provide, digital data such as medical, healthcare, bio-metric, physiological, and/or any other kind of healthcare data and/or healthcare-related data. For example, a user input device 40D can be a keyboard for allowing a user to input information into the patient communication device and/or a user input device can, for example, by a heart rate monitor or EKG machine which can receive information from a patient or individual and generate a digital signal, digital data, analog data, and/or any other signal, data, and/or information, which is representative of the patient's or individual's heart rate, pulse rate, and/or cardiac activity.

The user input device 40D can also be, or can include, any one or more of, and/or any combination of, a thermometer, a digital thermometer, a stethoscope, a heart rate monitor or measurement device, a pulse rate monitor or measurement device, a blood pressure monitor or measurement device, a blood pressure measurement device, a blood analysis device or machine, a respirator, a respiration monitoring or measurement device, a dialysis machine, a dialysis device, electrocardiograph (EKG) machine or device, electrocephalograph (EEG) machine or device, electromyograph (EMG) machine or device, a magnetic resonance imaging (MRI) machine or device, X-ray machine or device, medical imaging machine or device, thermal imaging machine or device, a heart sound monitor or measurement device, a lung sound monitoring or measurement device, respiration rate monitoring or measurement device, a laprascopic device, an arthroscopic device, a vascular testing device, a catheter device, a cardiac performance testing, monitoring, or measurement device, a pulmonary performance testing, monitoring, or measurement device, a vascular system performance monitoring or measurement device, a vascular system testing, monitoring, or measurement device, a metabolism monitoring or measurement device, a sonogram imaging device, a sonogram measurement device, a sonograph device, an optical response device, an optical response measurement device, an intravenous device, an arterial blood pressure measurement or monitoring device, a respiration rate measurement or monitoring device, an ultrasound imaging device, an ultrasound measurement device, a CAT SCAN device, an optical metabolism measurement or monitoring device, a radiotelemetric device, a doppler medical device, a mammogram device, a carbon dioxide detection or measurement device, a carbon monoxide detection or measurement device, a transvascular impedence measurement or monitoring device, an ultrasonic imaging device, a bone conduction device, a brain function scan analyzer device, external pulse cardiac monitoring or measurement device, a fetal heart rate measurement, monitoring, or probing, device, an endotrachial cardiac monitoring device, a finger tip blood pressure monitoring device, a psychological monitoring device, a surgical instrument, a vital signs measurement device, ear pressure regulating device, phonocardiograph device, acoustic aneurysm detector device, blood oxygen detection device, esophageal probing device, ultrasonic probing device, ausculoscope, vital signs monitoring system, heart activity monitoring device, pulmonary activity monitoring device, sphygmomanometer, esophageal stethoscope, venous pressure measuring device, differential doppler device, physiological data measuring device, body tissue movement device, breathalyzer device, camera probing device, microscopic camera probing device, and/or any other bio-metric or physiological data measuring device(s) and/or data acquisition device data acquisition device (hereinafter referred to generally or collectively as “healthcare equipment input device”, “healthcare measurement input device”, or “healthcare monitoring input device”).

The patient communication device 40 also includes a display device 40E for displaying data and/or information to a user or operator.

The patient communication device 40 also includes a transmitter(s) 40F, for transmitting signals and/or data and/or information to any one or more of the central processing computer(s) 10, the provider computer(s) 20, the payer computers(s) 30, the patient computer(s) 40, and the intermediary computer(s) 50 individual computer(s), which may be utilized in conjunction with the present invention. The patient communication device 40 also includes a receiver 40G, for receiving signals and/or data and/or information from any one or more of the central processing computer(s) 10, the provider computer(s) 20, the payer computers(s) 30, the patient computer(s) 40, and the intermediary computer(s) 50, which may be utilized in conjunction with the present invention.

The patient communication device 40 also includes a database(s) 40H. The database 40H can contain and/or be linked to any of the data and/or information described herein as being stored in the database 10H.

The patient communication device 40 also includes an output device 401 for output any data, information, report, etc., described herein. In the preferred embodiment, the output device 40I can be a printer, a display, a transmitter, a modem, and/or any other device which can be used to output data.

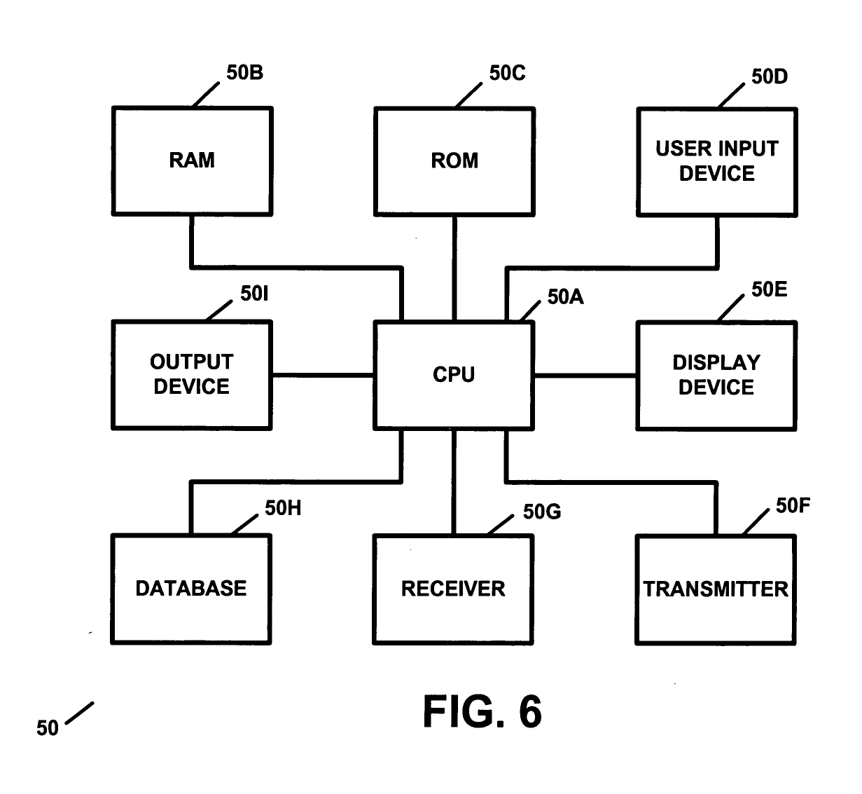

FIG. 6 illustrates the intermediary computer 50, in block diagram form. The intermediary computer 50, in the preferred embodiment, can be personal computer, a network computer or computer system, or any other computer or communication device, which is utilized as an intermediary computer 50. In the preferred embodiment, the intermediary computer 50 includes a central processing unit or CPU 50A, which in the preferred embodiment, is a microprocessor. The CPU 50A may also be a microcomputer, a minicomputer, a macro-computer, and/or a mainframe computer, depending upon the application.

The intermediary computer 50 also includes a random access memory device(s) 50B (RAM) and a read only memory device(s) 50C (ROM), each of which is connected to the CPU 50A, a user input device 50D, for entering data and/or commands into the intermediary computer 50, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering healthcare data and/or information, for example pulse rate monitors, blood pressure monitors, electrocardiograms, blood-sugars monitors, etc., if desired, which input device(s) are also connected to the CPU 50A. The intermediary computer 50 also includes a display device 50E for displaying data and/or information to a user or operator.

The intermediary computer 50 also includes a transmitter(s) 50F, for transmitting signals and/or data and/or information to any one or more of the central processing computer(s) 10, the provider computer(s) 20, the payer computers(s) 30, the patient computer(s) 40, and the intermediary computer(s) 50 individual computer(s), which may be utilized in conjunction with the present invention. The intermediary computer 50 also includes a receiver 50G, for receiving signals and/or data and/or information from any one or more of the central processing computer(s) 10, the provider computer(s) 20, the payer computers(s) 30, the patient computer(s) 40, and the intermediary computer(s) 50, which may be utilized in conjunction with the present invention.

The intermediary computer 50 also includes a database(s) 50H. The database 50H can contain and/or be linked to any of the data and/or information described herein as being stored in the database 10H.

The intermediary communication device 50 also includes an output device 501 for output any data, information, report, etc., described herein. In the preferred embodiment, the output device 501 can be a printer, a display, a transmitter, a modem, and/or any other device which can be used to output data.

In any and/or all of the embodiments described herein, any one of the central processing computers 10, the provider communication devices 20, the payer communication devices 30, the patient communication devices 40, and/or the intermediary communication devices 50, can include input devices (not shown) for facilitating the data entry of a patients vital signs and or other medical data such as, but not limited to, pulse rate, blood pressure, blood-sugar level, etc., and any other data and or information which can be input into the respective computer and/or communication device and be transmitted to the central processing computer consistent with the utilization of the present invention as described herein.

The apparatus and method of the present invention can be utilized in numerous preferred embodiments in order to provide a vast array of healthcare and healthcare-related services for any one or more of the various parties described herein. While certain of the preferred embodiments may be described with regards to utilization by a particular party, it is important to note that any patient, user, provider, payer, and/or intermediary may utilize the present invention in the same, similar and/or analogous manner. For example, a preferred embodiment for determining and/or ascertaining a medical diagnosis can be described as being utilized by a treating physician as well as be utilized by a provider to verify and/or check a diagnosis as well as by a patient or other user or individual in order to perform a self-diagnosis or double check a doctors diagnosis. In the same manner, any other preferred embodiment and/or other uses of the present invention can be utilized by any of the parties described herein.

The present invention, in its various preferred embodiments can be utilized to create and maintain comprehensive patient databases which can be accessed via a network environment and/or otherwise, to perform healthcare and/or healthcare-related diagnoses, to provide healthcare and/or healthcare-related expected prognoses, to provide healthcare and/or healthcare-related treatment plans or programs, and/or to provide healthcare and/or healthcare-related treatment progress reports and/or evaluations.

The present invention can also be utilized in order to provide training and continuing education services for healthcare and/or healthcare-related professionals, to provide healthcare, healthcare-related, and/or wellness information, to provide information about healthcare and/or healthcare-related patient, providers, payers, and/or intermediaries, to provide scheduling management services for providers, to provide notification services for patients, providers, payers and/or intermediaries and/or any other parties described herein, and/or to locate providers, payers and/or intermediaries.

The present invention can also be utilized, in preferred embodiments, in order to healthcare and/or healthcare-related claim processing services, claims submissions, claim processing, claim status checking, and claim reconciliation, claim fraud prevention, treatment evaluation, healthcare and/or healthcare insurance policy generation, management and administration, provider, payer and/or intermediary evaluation, drug and/or treatment interactivity, treatment, medication and/or organ availability and/or notification services, patient, provider, payer, intermediary, and/or third party, notification services.

The present invention can also be utilized as a clearinghouse for facilitating the offering, selling, buying, trading, and/or other commerce and/or transactions, involving healthcare and/or healthcare-related services, products and/or goods.

In any and/or all of the embodiments described herein, the various computers and/or communication devices 10, 20, 30, 40 and/or 50, can be utilized to transmit and/or to receive transmissions, information, messages, and/or notification messages and/or signals to, and/or between, the respective parties associated with the respective computers and/or communication devices. The transmission of information, messages, and/or notification messages and/or signals, or reports, in any and/or all of the embodiments described herein can be effected via any one or more of e-mail messages, telephone messages, beeper or pager messages, physical mail delivery, electronic data transmission, and/or can be made via any other suitable and/or appropriate communication method and/or technique.

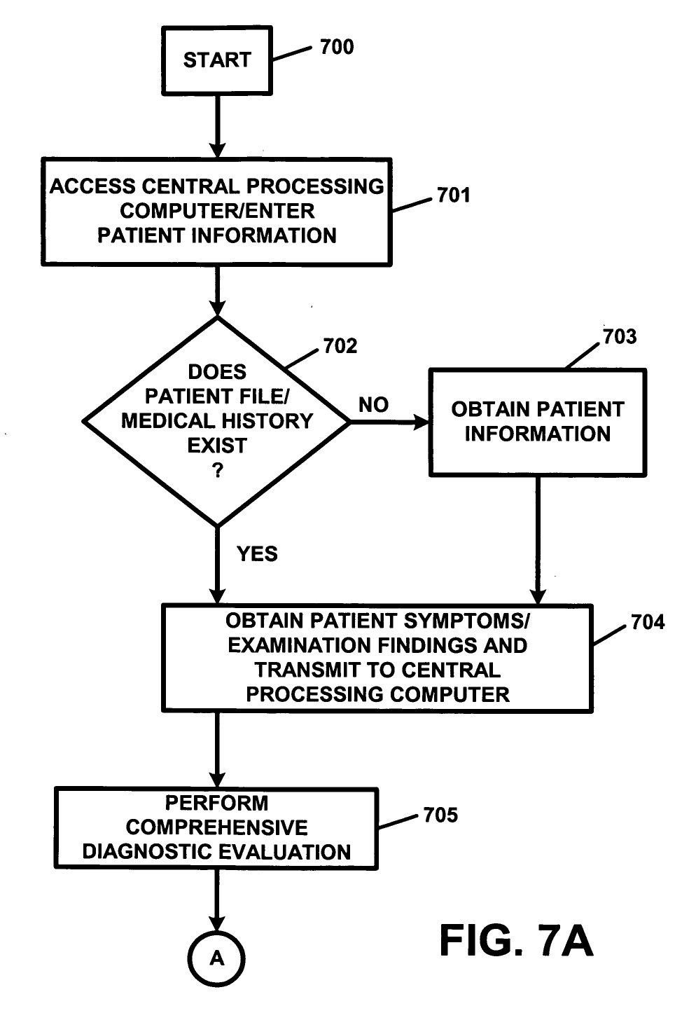

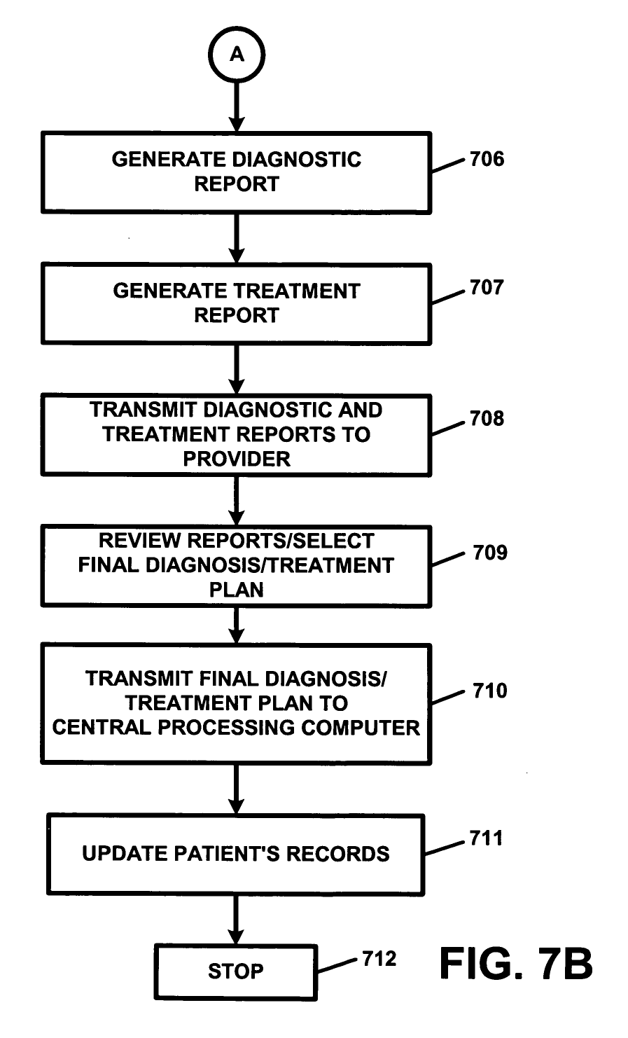

In a preferred embodiment, the present invention can be utilized in order to perform a diagnosis of a sickness, illness and/or other condition. FIGS. 7A and 7B illustrate a preferred embodiment method of using the present invention, in block diagram form. While the method of FIGS. 7A and 7B is described in the context of a medical doctor performing a diagnosis of a medical condition, the method of FIGS. 7A and 7B can be similarly utilized by surgeons, psychologists, psychiatrists, dentists, and/or any other healthcare provider or healthcare professional described herein. The method of FIGS. 7A and 7B may also be utilized by any user, patient, provider, payer, and/or intermediary in order to ascertain a diagnosis and/or in order to check on, verify, and/or ascertain the correctness of a diagnosis of another.

The operation of the apparatus 100 commences at step 700. At step 701, the provider can access the central processing computer 10 and enter data and/or information regarding the patient. At step 702, the central processing computer 10 will determine if a file and/or medical history exists for the patient. If, at step 702, it is determined that a medical history does not exist, the central processing computer 10 will, at step 703, request that a medical history, family history and/or other information related thereto be provided by the patient or accompanying individual. At step 703, the information provided by the patient or accompanying individual will then be entered via the provider communication device 20 and transmitted to, and be stored at, the central processing computer 10. Thereafter, processing will proceed to step 704.

If, at step 702, it is determined that a patient's medical history does in fact exist, the processing will proceed to step 704. At step 704, the patient's symptoms, if any, and/or examination findings, are obtained from the patient and are transmitted from the provider communication device 20 to the central processing computer 10.

At step 704, data and/or information which can be obtained via any of the herein-described healthcare equipment input devices 20D, healthcare measurement input devices 20D, or healthcare monitoring input devices 20D, can also be transmitted to the central processing computer 10. The data and/or information obtained via any of the described healthcare equipment input devices 20D, healthcare measurement input devices 20D, or healthcare monitoring input devices 20D, can be transmitted from the from the provider communication device 20 to the central processing computer 10.

In this manner, the data and/or information which is transmitted to the central processing computer 10, at step 704, can include provider or user entered data and/or information, which can be entered via the user input device 20D such as a keyboard, a mouse, a cardreader, or other input device which can be utilized in conjunction with a computer or a communication device, and/or can include data and/or information which can be obtained and/or acquired by any of the herein-described healthcare equipment input devices 20D, healthcare measurement input devices 20D, or healthcare monitoring input devices 20D.

In a preferred embodiment, both provider or user entered data and/or information obtained and/or acquired by any of the herein-described healthcare equipment input devices 20D, healthcare measurement input devices 20D, or healthcare monitoring input devices 20D, can be utilized in performing a patient diagnosis. In another preferred embodiment, only data and/or information obtained and/or acquired by any of the herein-described healthcare equipment input devices 20D, healthcare measurement input devices 20D, or healthcare monitoring input devices 20D, can be utilized in performing a patient diagnosis. In another preferred embodiment, only provider or user entered data and/or information can be utilized in performing a patient diagnosis.

The central processing computer 10 will, at step 705 receive and process the patient symptoms, if any, examination findings, and/or any other data and/or information, in conjunction with the patient's medical history and/or other information, medical theories, principles, criteria and/or other medical information needed to make a diagnosis. At step 705, the central processing computer 10 will perform a comprehensive diagnostic evaluation of the patient's symptoms, if any, and/or the examination findings.

As described above, the diagnostic evaluation or diagnosis can be based upon both provider or user entered data and/or information and data and/or information obtained or acquired by any of the herein-described healthcare equipment input devices 20D, healthcare measurement input devices 20D, or healthcare monitoring input devices 20D, can be based upon only data and/or information obtained and/or acquired by any of the herein-described healthcare equipment input devices 20D, healthcare measurement input devices 20D, or healthcare monitoring input devices 20D, or can be based upon only provider or user entered data and/or information.

For example, a provider can enter patient symptom information along with patient data obtained from any of the herein-described healthcare equipment input devices 20D, healthcare measurement input devices 20D, or healthcare monitoring input devices 20D. A diagnosis can, thereafter, be processed utilizing data obtained from both the provider and any of the herein-described healthcare equipment input devices 20D, healthcare measurement input devices 20D, or healthcare monitoring input devices 20D.

Patient data can also be obtained solely from any of the herein-described healthcare equipment input devices 20D, healthcare measurement input devices 20D, or healthcare monitoring input devices 20D, with such patient data being utilized in order to arrive at a diagnosis. Patient data, in another preferred embodiment, can also be obtained solely from a provider or the patient himself or herself. A patient can also utilized the apparatus in conjunction with home healthcare equipment input devices, healthcare measurement input devices, or healthcare monitoring input devices.

In another preferred embodiment, the patient, or any other person assisting the patient, can access the central processing computer 10 via the patient communication device 40 and, at step 704, the patient or other person can enter or input information regarding a condition, symptom, a blood pressure reading, a heart rate or pulse rate, a blood sugar level or blood glucose level, or any other data or information pertaining to the patient. The data or information entered by the patient or other person can be also be obtained via any of the herein-described healthcare equipment input devices, healthcare measurement input devices, or healthcare monitoring input devices, which can be located at the patient's home, at a hospital, at a patient's bedside, or at any other appropriate or suitable location, and can also be transmitted to the central processing computer 10, via the respective device itself, or in a case where the respective device is or can be connected with or linked with the patient communication device 40, via the patient communication device 40. In this preferred embodiment, the patient or other person can enter or input information, such as, but not limited to, his or her condition, notes, symptoms, blood pressure readings, heart rate or pulse rate readings, blood sugar level or blood glucose level, or any other data or information which can be entered by, or obtained by, the patient or other person. The patient or other person entered data or information can be received and stored in patient's file or medical history at the central processing computer 10, and/or at the provider communication device 20, and can be accessed by and reviewed by the provider, or any other authorized provider, at any time.

As and for and illustrative example, a patient being treated for high blood pressure can be instructed by the provider to take his or her own blood pressure reading, or have it take by a person assisting the patient, each day for an instructed or pre-determined time period, and to transmit the readings to the central processing computer 10 for storage in his or her file or medical history, and/or to the provider communication device 20. The readings can be transmitted to the central processing computer 10, and/or to the provider communication device 20, via the respective device or via the patient's communication device 40. The provider, or any other authorized provider, can, at any time, access the patient's file or medical history and review the blood pressure readings taken by or entered by the patient or the person assisting the patient.

The provider can also utilize the patient or other person entered data or information in making an examination finding, noting a symptom, making a diagnosis, or prescribing a course of treatment.

In another preferred embodiment, the central processing computer 10, and/or the provider communication device 20, can be programmed to process and/or analyze the patient-entered data, based on pre-defined criteria or otherwise, and can automatically generate a message and transmit or provide the message to the provider via the provider communication device 20 or to or via a second provider communication device 20 in order to provide the provider with notification of a patient condition. For example, if the provider wants to be notified if the patient's blood pressure is a certain reading, above or below a certain reading, has changed, or has not changed, the provider can program the apparatus 100 or the central processing computer 10, or the provider communication device 20, to analyze the patient-entered blood pressure data or information, and if the blood pressure is determined to be a certain reading, above or below a certain reading, has changed, or has not changed, the central processing computer 10 can generate a message containing information regarding the patient's blood pressure condition and can transmit the message to the provider communication device 20, or the provider communication device 20 can either provide the information to the provider or transmit the information to a second provider communication device 20. Thereafter, the provider can receive, review, or act in response to, the information contained in the message.

Although a blood pressure condition has been described as a monitored condition in the above example, it is important to note that the apparatus 100 and method of the present invention can be utilized to monitor any condition capable of being monitored by any of the healthcare devices or equipment or healthcare measurement devices or equipment described herein so that any data or information capable of being obtained by any of those devices or equipment can be automatically monitored, analyzed, or reported to the provider. In this regard, heart rate or pulse rate reading, a blood sugar or blood glucose level or reading, or any other data, information, or condition, can be automatically monitored or reported.

In another preferred embodiment, the provider can, via his or her provider communication device 20 using the Internet and/or the World Wide Web, a telephone line, a cellular or wireless communication network, or any other communication network or system, access, control, monitor, or obtain readings, measurements, data, or information, from or via any healthcare device(s) or healthcare monitoring device(s) or healthcare measurement device(s) or equipment, which can be or which can include, but which is not limited to, any of the devices or equipment described herein which can be used to obtain healthcare data or information or healthcare-related data or information from or for a patient. Applicant hereby incorporates by reference herein the subject matter and teachings of the U.S. Pat. Nos. 5,917,405, 6,542,076, 6,542,077, 6,549,130, 6,587,046, which disclose and teach a control, monitoring, and/or security, apparatus and method which can be used to control and/or monitor electrically or electronically activated, controlled, and/or operated, devices or equipment which can be located at a premises or at a vehicle. For example, Applicant hereby incorporates by reference the teachings of U.S. Pat. No. 6,542,076 at FIGS. 1-16 and Col. 20, line 41 through Col. 105, line 58 which discloses and teaches a control, monitoring, and/or security, apparatus which can be used to remotely control various electrical or electronically or electronically activated, controlled, and/or operated, devices or equipment, which can be located at any premises, a home, a commercial premises, or at a vehicle, including, but not limited to, an automobile, an ambulance, an emergency rescue vehicle, a fire truck, a bus, a train, a subway train, a land vehicle, a marine vehicle, an aircraft, helicopter, or other vehicle used for air travel, a recreational vehicle, or any other type of premises or vehicle described in U.S. Pat. No. 6,542,076. The teachings of U.S. Pat. No. 6,542,076, at FIGS. 1-16 and Col. 20, line 41 through Col. 105, line 58, also teach the remote control and/or monitoring of devices and equipment via the Internet and/or the World Wide Web, or via any suitable communication network or system described therein, and these teachings are also incorporated by reference herein.

In this regard, in another preferred embodiment, the provider, or any authorized provider, can, from a remote location, monitor the patient, and/or control and/or monitor a healthcare device(s) or equipment being used to monitor the patient. The provider can also utilize the apparatus 100 and method of the present invention to remotely monitor the patient in a hospital, a healthcare facility, or in the patient's own home. The provider can also be automatically notified, by means of a message being transmitted from the respective device or equipment to the provider communication device 20, and/or from the central processing computer 10 to the provider communication device 20, of a message or an alert or alerts obtained from the respective device or equipment, such as an emergency call or a detection of an emergency occurrence detected by or associated with the respective device or equipment. Any data or information obtained by the provider can also be transmitted to the central processing computer 10 for inclusion in the patient's file or medical history, and can be processed in the manner described herein with regard to steps 704 and 705 described herein, and/or in any other appropriate manner consistent with the teachings and use of the apparatus 100 and method of the present invention.

In the above described manner, the apparatus 100 and method of the present invention can be utilized in order to allow a provider to monitor a patient or any number of patients from a remote location and via any of the provider communication devices 20 described herein.

At step 706, the central processing computer 10 will generate a diagnostic report which can include a diagnosis of the patient's condition, if needed. The diagnostic report which is generated at step 706 can, if needed, include a single diagnosis and/or a list of possible diagnoses, along with their respective probabilities of occurrence and/or statistical information corresponding thereto, which may pertain to the patient's condition. At step 707, the central processing computer 10 will then generate a treatment report which will outline and/or prescribe treatment for the single diagnosis and/or for the list of possible diagnoses, if any. The central processing computer 10, when generating the treatment report, can process same in conjunction with, and consider, possible drug interactions and/or treatment interactions.

At step 708, the central processing computer 10 will transmit the diagnostic report and/or treatment report to the provider's communication device 20 at which point the medical doctor can obtain the diagnosis or possible diagnoses, if any, and corresponding treatment plans. The medical doctor can then, at step 709, review the diagnostic report and/or treatment report and choose the final diagnosis and/or treatment plan, if needed, to administer to the patient.

At step 710, the medical doctor will transmit the final diagnosis and treatment plan, including the prescribed treatment and/or treatment plan, if any, to the central processing computer 10. The prescribed treatment and/or treatment plan can also include a prescribed treatment, treatment regimen, information or instructions regarding further or additional examination and/or tests or testing, information regarding one or more prescriptions for further examination or testing, one or more doctor referrals, one or more prescriptions for further testing, blood work, x-rays, MRIs, CAT scans, PET scans, or other information gathering or testing, one or more prescriptions for prescribed drugs, medication, therapy, physical therapy, and/or other therapy. At step 710, any prescription for any drug, medication, or therapy, can also be transmitted to a communication device or computer of or associated with other providers such as a respective pharmacy, or therapist. Similarly, at step 710, any prescription for further examination or for follow-up testing of any kind, or a doctor referral, can also be transmitted to a communication device or computer of or associated with a respective provider.

In another preferred embodiment, at step 710, the medical doctor or any other provider using the apparatus 100 can also generate and/or transmit a prescription or an electronic prescription for a medication, a medicine, or a drug, or for a procedure, a test, an analysis, an analysis work-up, blood work, a treatment, or a therapy, or can generate and/or transmit a referral to another provider, for submission or transmission to the respective pharmacy or other provider, and for storage in the patient's healthcare record or healthcare file.

In another preferred embodiment, the final diagnosis and treatment plan, including the prescribed treatment and/or treatment plan, can also be transmitted by the central processing computer 10, at step 710, back to the provider for his or her records, to another provider of the individual or patient, to a payer or insurer of the individual or patient, to the individual or patient, or to a third party or intermediary, by transmitting the final diagnosis and/or treatment plan, to a respective provider computer or communication device 20, to a respective payer computer or communication device 30, to a respective patient computer or communication device 40, or to a respective intermediary computer or communication device 50 either directly, such as via any suitable electronic or other transmission, or indirectly, such as via an e-mail server in the case when the final diagnosis and treatment plan is included in, or is attached to, an e-mail message. The copy of the final diagnosis and treatment plan can also be stored by or in the respective provider computer or communication device 20, the respective payer computer or communication device 30, the respective patient computer or communication device 40, or the respective intermediary computer or communication device 50. In another preferred embodiment, the final diagnosis and treatment plan can contain individual-specific or patient-specific educational information or individual-specific or patient-specific instructional information, or a link(s) or hyperlink(s) to same, regarding the diagnosis, treatment, or treatment plan, or information relating thereto, so as to provide this educational information or instructional information to the individual or patient. The individual or patient can thereafter access or obtain the educational information or instructional information via the apparatus 100 and method of the present invention. In this manner, the apparatus 100 and method of the present invention can provide individual-specific or patient-specific educational information or individual-specific or patient-specific instructional information regarding the diagnosis, treatment, or treatment plan.

In another preferred embodiment, the apparatus 100 or the central processing computer 10 can be programmed to identify the individual-specific or patient-specific educational information or individual-specific or patient-specific instructional information regarding the diagnosis, treatment, or treatment plan, and/or any information, link(s), or hyperlink(s), relating thereto or pertaining thereto.

At step 711, the central processing computer 10 will then update the patient's records in the database 10H so as to include all of the data and information described as being processed and/or generated by the central processing computer 10, including, but not limited to the patient's symptoms, if any, the examination findings, the information contained in the diagnostic report and the treatment report, the final diagnosis and the prescribed treatment. At step 711, the central processing computer 10 can also generate a message containing information regarding the patient's symptoms, if any, the examination findings, the information contained in the diagnostic report and/or the treatment report, the final diagnosis and/or the prescribed treatment. At step 711, the central processing computer 10 can also transmit the message as an e-mail message, as a text message, as an instant messaging message, or as any other type of message, in electronic form or otherwise, to the individual or patient such as by transmitting same to the patient communication device 40 of or associated with the individual or patient, and/or to any one or more of a provider communication device 20 of or associated with the provider or another provider, a payer communication device 30 of or associated with the individual's or patient's payer or insurer, or, if authorized or allowed, to an intermediary communication device 50 of or associated with an intermediary authorized or allowed to receive same.

The message or messages, or any other communication(s) or transmission(s) described herein, provided to the individual or patient, to the provider or another provider, to the payer or insurer, or to the intermediary, can also contain information such as advertisement(s) or marketing materials for a healthcare product(s) or service(s), an advertisement(s) or marketing materials for a health, wellness, or exercise, product(s) or service(s), or a news report or other information, pertinent to the individual or patient, or pertinent to or relating to the individual's or patient's condition or symptoms, if any, any examination finding(s), any information contained in the diagnostic report and/or the treatment report, or any final diagnosis and/or prescribed treatment. At step 711, the central processing computer 10, in response to a request by the provider, can also process information in order to request or create a subscription for the individual or patient so that the individual or patient can receive future information, by mail, by e-mail, text message, or otherwise, regarding a news report or other data or information which would be of interest to the individual or patient or pertinent to the individual's or patient's condition.

In the manner described above, the individual or patient can be provided with information regarding his or her provider's actions taken on his or her behalf, or the provider's diagnosis or treatment planning, pursuant to a diagnosis or a condition. In the manner described above, news or other information regarding an individual's or patient's health condition, symptoms, diagnosis, or treatment, can also be disseminated to the individual or patient on a regular and/or on an on-going basis. In this regard, news or information, which may be pertinent, relevant, or otherwise helpful, for allowing an individual or patient to understand a diagnosis, a treatment plan or regimen, a condition, or an illness, or which can help the individual or patient to take corrective or preventive action or measures regarding a condition or an illness, can be provided to the individual or patient, or can be transmitted to the patient's communication device 40, at the provider's direction or discretion, on a one-time basis, on a regular on on-going basis, or when the news or information becomes available, or otherwise.

In another preferred embodiment, information regarding a providing of news or information to the individual or patient, as with the individual's or patient's other healthcare information, can be ordered, prescribed, or otherwise disseminated or provided to the individual or patient pursuant to, and/or in accordance with, any and/or all healthcare privacy laws, rules, or regulations, in effect at the time.

The news or information described herein can be disseminated or provided to an individual or patient based on, or in response to, a diagnosis, a prescribed treatment, a treatment plan, a drug or medication which can be recommended or prescribed for the individual or patient, a recommended or prescribed procedure or operation, a recommended or prescribed physical therapy, drug or medication therapy, alternate therapy, herbal therapy, acupuncture therapy, or any other therapy which may be recommended or prescribed by any of the providers or types of providers described herein, or in response to any other action taken by any provider in response to a condition, symptom, family healthcare history, diagnosis, or any other information obtained, regarding the individual or patient.

Thereafter, operation of the apparatus 100 will cease at step 712. The patient's records will then be updated and be available for the patient's next treatment and/or diagnosis.

In another preferred embodiment, any and/or all of the data or information which is input, transmitted to, or provided by, the apparatus 100, when used as described in the embodiment of FIGS. 7A and 7B, can be dated stamped and/or time stamped.

In another preferred embodiment, the diagnostic report and/or treatment reports can be accompanied by medical information, textbook materials, laboratory materials, reference materials, video clips of any pertinent information, audio clips of any pertinent information, hyperlinks to informational sources, information regarding providers and/or facilities for obtaining treatment and/or therapy, provider and/or facility contact information, and/or any other pertinent and/or relevant information.

In another preferred embodiment, the diagnostic report and/or treatment reports can be accompanied by health and/or wellness information which can include suggestions for health and/or wellness foods, goods, products, and/or services. The diagnostic report and/or treatment reports can also be accompanied by health and/or fitness information, diets, nutritional information, and/or any other information which may be of assistance to the patient and/or provider. The diagnostic and/or treatment reports can also contain warnings regarding misdiagnoses, warnings about treatments, information about experimental treatments, etc. The diagnostic and/or treatment reports can also contain information, statistical and/or otherwise, regarding diagnoses, misdiagnoses, treatment successes, and/or treatment failures. The diagnostic and/or treatment reports can also contain information regarding alternate medicine such as treatments regarding herbal remedies and/or treatments, meditation, self-healing, faith healing, yoga, tai chi, exercise therapy, and/or other therapies and/or therapy types.

As noted above, the method of utilizing the present invention, as described in FIGS. 7A and 7B, is equally applicable to, and can be utilized in the same manner, by any and/or all of the respective healthcare providers, professionals, and/or related providers. The apparatus of FIGS. 7A and 7B can also be utilized in a same or similar manner by any of the herein-described users, patients, healthcare providers, or healthcare payers.

The apparatus of FIGS. 7A and 7B can also utilize electronic signatures and/or process electronic signatures and/or electronic signature information which can correspond to any of the herein-described parties in performing any of the herein-described processing routines and/or functions.

In another preferred embodiment, the apparatus and method of the present invention can be utilized to ensure that a proper treatment and/or procedure is performed on the patient. Referring once again to FIGS. 7A and 7B and the above description of same, the present invention can be utilized to ensure that a subsequent treatment and/or treatments are performed as prescribed. As noted above with reference to FIG. 6 and, in particular, a final diagnosis and prescribed treatment is stored in the patient's file or records in the database 10H of the central processing computer.

When the patient seeks treatment from a subsequent medical doctor, surgeon, or other healthcare professional, the medical doctor, surgeon, or other healthcare professional, can access the central processing computer 10 at the time of treatment, access the patient's medical history and prescribed treatment plan and assess same in order to make sure that the treatment to be provided is called for in the prescribed treatment. In this manner, the present invention can be utilized in order to prevent medical and/or surgical mistakes, mishaps and/or other instances when improper treatment could occur.

It is also envisioned that the subsequent care medical doctor, surgeon, or other healthcare professional, could also re-evaluate the patient's condition and/or records and seek additional assistance and/or perform a separate and independent assessment and/or diagnosis of the patient. In any event, the present invention can provide the subsequent care medical doctor, surgeon, or other healthcare professional, with the patient's complete medical history, information, past diagnoses and/or past treatments and/or prescriptions. In this manner, a subsequent care provider can be provided with as complete and as up to date information as possible in order to administer treatment.

For example, the present invention can be utilized in the following manner. A patient scheduled for surgery on a certain body part (i.e. left ankle) may enter the hospital. Due to a hospital clerical error, the right ankle is noted to be operated on.

Prior to the surgery, the surgeon may access the central processing computer 10, via a provider communication device 20 located in the operating room, and/or another location in the hospital, in order to verify the procedure to be performed. In response thereto, the central processing computer 10 will transmit a message that it is the left ankle which is to be operated on. Thereafter, the surgeon can investigate the situation and ensure that the correct and prescribed surgery and/or procedure is performed. Once the surgery is completed, the patient's record will be updated accordingly. While a surgical procedure is described, it is important to note that any treatment, procedure, etc., which can be performed by any healthcare professional described herein, and/or in any healthcare field described herein, can be verified in the above-described manner. In this manner, the present invention can be utilized to pre-screen subsequent and/or follow-up treatments and/or procedures so as to prevent healthcare mistakes and/or mishaps.

The embodiment of FIGS. 7A and 7B can perform diagnoses by utilizing entered data and/or information and/or data and/or information which can be obtained by, acquired by, and/or measured by, any of the herein-described user input devices 20D.

In another preferred embodiment, the healthcare professional can access the central processing computer 10 via the provider communication device 20, access the patient's or client's record and input information concerning the treatment and/or procedure to be performed. Thereafter, the central processing computer 10 can process the information and transmit a message to the healthcare professional notifying the healthcare professional that the treatment and/or procedure is either the prescribed treatment or procedure or that it is not the prescribed treatment and/or procedure. The message provided by the central processing computer, to the treating healthcare professional, can also include information regarding the treatment and/or the procedure, such as instructions, steps, and/or any other accompanying information.

In any and/or all of the embodiments described herein, the central processing computer 10, in performing any processing of patient information, diagnosis information, and/or treatment information, described herein, can perform such processing in conjunction with drug and/or other treatment interaction information so as to provide an added safeguard in the diagnosis and treatment planning processes. Any and/or all processing described herein is also performed in conjunction with each patient's medical history, family history, allergic conditions information, and/or with any other information deemed important and/or essential in the individual's healthcare diagnoses and/or treatments.

In another preferred embodiment, the present invention can be utilized to perform treatment evaluations and/or treatment monitoring. In this manner, the present invention can be utilized by any of the providers, payers, patients, users, and/or intermediaries, described herein to evaluate and/or monitor treatments, provide training and/or oversight for healthcare providers and/or professionals, and/or allow payer and/or insurance companies to evaluate treatments, treatment plans, treatment progress, and/or any other evaluations and/or verifications for healthcare claims processing. In this embodiment, the present invention can be utilized so as to safeguard against the use of incorrect and/or unconventional and/or fraudulent treatment and/or care.

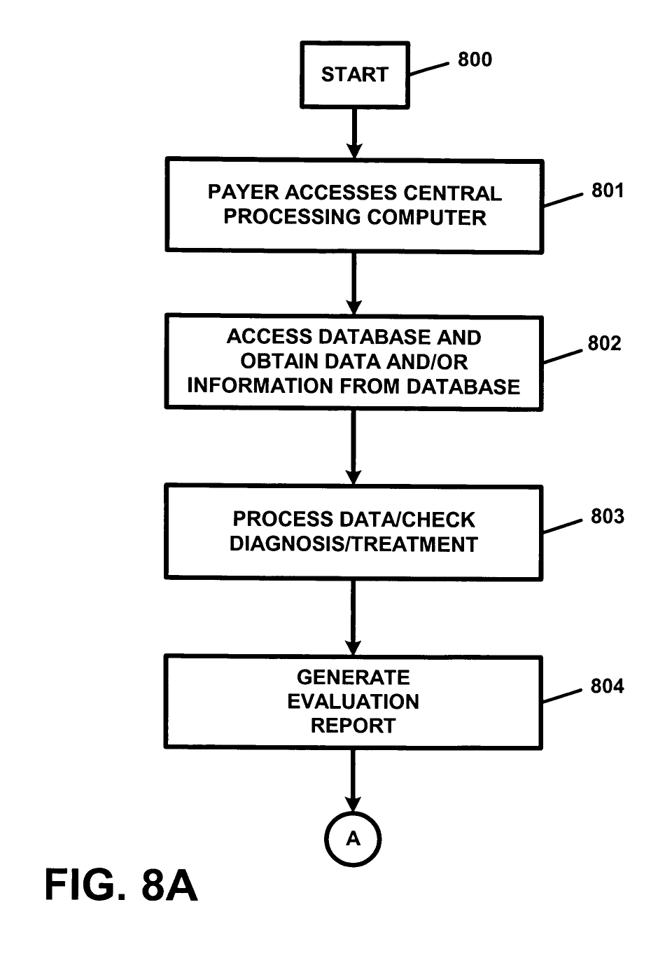

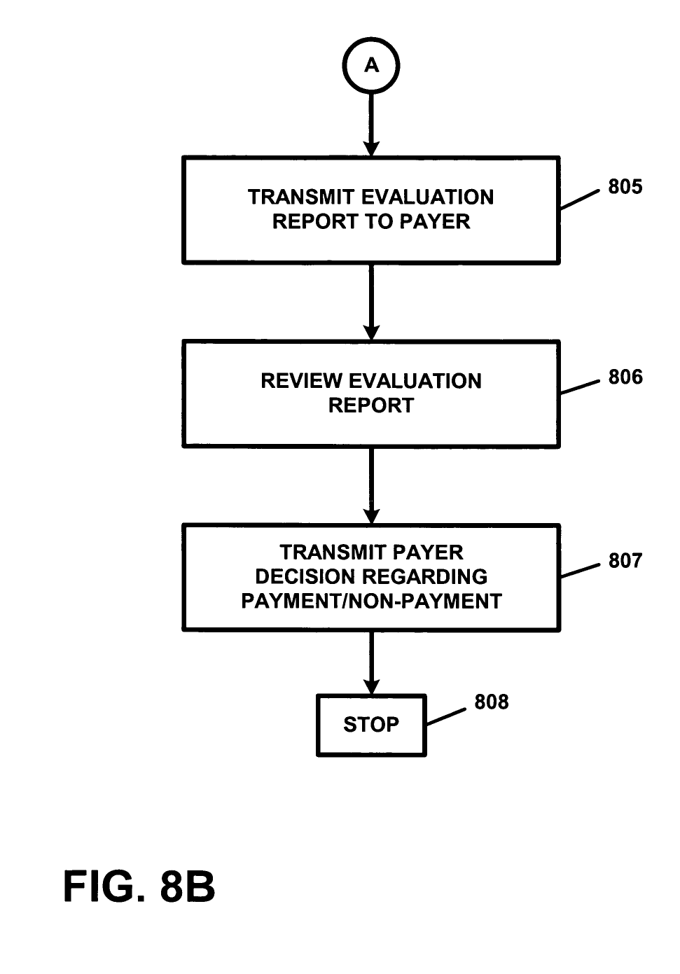

FIGS. 8A and 8B illustrate another preferred embodiment of a method of use of the present invention, in flow diagram form. FIGS. 8A and 8B illustrate a preferred embodiment method of use of the present invention in order to evaluate and/or monitor treatments, treatment plans and/or the administration of healthcare. While described as being utilized by payers and/or an insurance company in evaluating and/or monitoring treatment, it is important to note that the embodiment of FIGS. 8A and 8B can be utilized by any provider, patient, user, including healthcare students and/or healthcare professionals-in-training, or other providers, and/or intermediary, for obtaining the information provided by the embodiment of FIGS. 8A and 8B and utilizing it any manner they see fit.

With reference to FIGS. 8A and 8B, the operation of the apparatus 100 commences at step 800. At step 801, the payer or payer's employee or agent (hereinafter, for simplicity, referred to at payer's employee) can access the central processing computer 10. At step the payer's employee can enter information concerning the patient, the treatment, and/or care, which is desired to be evaluated and/or monitored.

At step 802, the central processing computer 10 will access the database 10H and obtain patient information, patient medical history, family history, if pertinent, symptom information, provider information, diagnostic report information, treatment report information, final diagnoses information, prescribed treatment information, and/or any other information which can be relevant and/or pertinent. Any and/or all of the information described above can be stored in the database 10H from prior processing and/or use of the present invention. Other data and/or information can also be obtained from the payer's employee and/or from other third party and/or outside sources.

At step 803, the central processing computer 10 will perform a processing routine in conjunction with the above-described information in order to determine if the diagnoses and associated and/or related treatment or treatments are appropriate and/or in-line with current standards for the given healthcare field. The central processing computer 10 can also calculate and/or provide statistical information regarding any of diagnoses and/or treatments under study. At step 804, the central processing computer 10 will generate an evaluation report which will provide data and information regarding the information obtained from step 803.

The central processing computer 10 can then, at step 805, transmit the evaluation report and/or any other appropriate information, to the payer communication device 30. The central processing computer, in another preferred embodiment, can, at step 803 and/or at step 804, determine and/or provide, as part of the evaluation report, information concerning whether the diagnoses and/or treatments are considered appropriate and/or valid, and/or in-line with standards, as well as recommend that claims for the treatment(s) are valid and should be paid by the payer, and/or that the claims for the treatment(s) are invalid and should be denied.

Thereafter, at step 806, the payer or the payer's employee can review the evaluation report and take any action deemed appropriate. In another preferred embodiment, the evaluation report can also contain an advertisement(s) or marketing material for a product(s) or service(s) deemed to be of interest for the payer or the payer's employee. At step 807, the payer or payer's employee can transmit data and/or information regarding the payer's or payer employee's action and/or decision. Step 807 is an optional step and can be dispensed with if the payer or payer's employee chooses not to respond to and/or to transmit information to, the central processing computer 10. Thereafter, the operation of the apparatus will cease at step 808.

The apparatus of FIGS. 8A and 8B can also utilize electronic signatures and/or process electronic signatures and/or electronic signature information which can correspond to any of the herein-described parties in performing any of the herein-described processing routines and/or functions.

The present invention when utilized as described in FIGS. 8A and 8B, can provide treatment evaluation and/or monitoring for healthcare payers which can be utilized for performing claims processing, provider evaluations, patient evaluations, and/or any other useful and/or desired purpose. The present invention, when utilized as described in FIGS. 8A and 8B, can also be utilized by any provider, patient, payer, user, and/or intermediary, to evaluate and/or monitor treatments, evaluate providers, evaluate patients, evaluate payers, ascertain payers claims paying and/or processing traits, and/or for educational purposes and/or for any other useful and/or desired purpose.

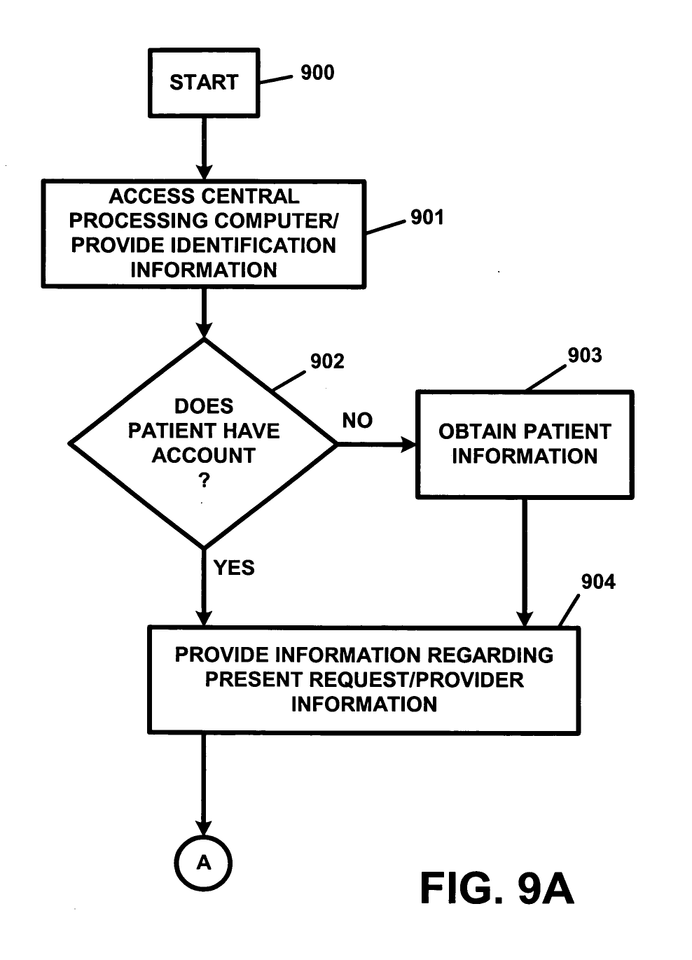

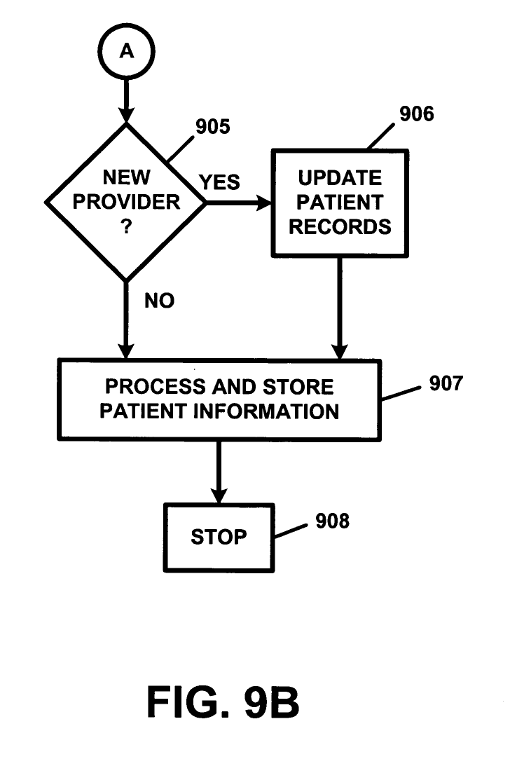

In another preferred embodiment of the present invention, the apparatus and method of the present invention can be utilized to create and maintain a comprehensive patient healthcare database. FIGS. 9A and 9B illustrate another preferred embodiment use of the present invention, in flow diagram form. With reference to FIGS. 9A and 9B, the operation of the apparatus 100 commences at step 900.

At step 901, the patient will access the central processing computer 10 and provide identification information. At step 902, the central processing computer 10 will determine whether the patient has an account and/or a file with the central processing computer and/or the service utilizing same. If, at step 902, it is determined that the patient does not have an account with the central processing computer 10, the processing will proceed to step 903 and patient will be prompted and/or asked to fill out any necessary forms and/or answer questions so as to provide a comprehensive medical history and family history, if possible.

All provided data and/or information will be stored in the database 10H and a patient account, file and/or record will be created at step 903. Thereafter, processing will proceed to step 904. If, at step 902, the patient is determined to have an account with the central processing computer, processing will proceed directly to step 904.

At step 904, the patient will provide information concerning the present healthcare request and present provider information. At step 905, the central processing computer 10, will then determine if the present provider is a new provider. If, at step 905, it is determined that the present provider is a new provider, the central processing computer 10 will proceed to step 906 and update the patient's files or records so as to include the present provider as a new provider for the patient. Thereafter, the central processing computer 10 will proceed to step 907 and will process and store, in the database 10H and/or in the patient's files or records, any pertinent patient information, symptoms, diagnoses and/or treatments, final diagnosis and/or prescribed treatment, for the provider visit or for the event or occurrence.

If, however, at step 905, it is determined that the present provider is an existing provider for the patient, the central processing computer 10 will proceed directly to step 907 and process and store, in the database 10H and/or in the patient's files or records, any pertinent patient information, symptoms, diagnoses and/or treatments, final diagnosis and/or prescribed treatment, for the provider visit or for the event or occurrence. Thereafter, operation of the present invention will cease at step 908.

The apparatus of FIGS. 9A and 9B can also utilize electronic signatures and/or process electronic signatures and/or electronic signature information which can correspond to any of the herein-described parties in performing any of the herein-described processing routines and/or functions.

In this manner, the present invention can be utilized so as to create and maintain a comprehensive healthcare patient database which can be accessed by any provider, payer, intermediary, and/or other party or user, in order to access the patient's healthcare files and/or records. The comprehensive database, which in the preferred embodiment of the present invention, is stored and/or maintained in the database 10H of the central processing computer 10, can contain and/or store any of the data and/or information obtained from, and/or provided by, any and/or all of the herein-described embodiments of the present invention.

The comprehensive database provides a data and/or information source which can be accessed by any provider, from anywhere in the world, and at any time, in order to obtain information about a patient in his, her, or its care. For example, a patient traveling far from home and out of reach by his or her current healthcare provider can be treated by another provider who can access the central processing computer 10, from any location, and at any time, and obtain up-to-date and/or comprehensive patient healthcare and/or medical and family history information, current healthcare and/or medical condition, current treatment and/or care and/or any other information which can facilitate optimal healthcare and/or medical treatment.

In the same manner, new providers can obtain existing information concerning healthcare and/or medical history, family history, current healthcare conditions and/or treatments as well as any other information from the central processing computer 10 thereby allowing the new provider to obtain accurate information and dispensing with the need to obtain same form the patient. The information provided from the present invention can also assist the provider in diagnosing the patient. Providers can also utilize the comprehensive database in order to ascertain past and/or current providers who may be contacted for assistance and/or for insight in the treatment process.

In a similar manner, payers can utilize the comprehensive database in order to ascertain payer eligibility, the existence of pre-existing conditions and/or to obtain any other useful information.

In another preferred embodiment, the present invention can be utilized in order to find and/or to locate providers and/or payers of, and for, respectively, various healthcare treatments, healthcare services and/or healthcare goods or products and/or healthcare-related goods or products. Information regarding the various providers and/or payers, along with information regarding the services and/or goods or products they provide and/or pay for, respectively, is stored in the database 10H.

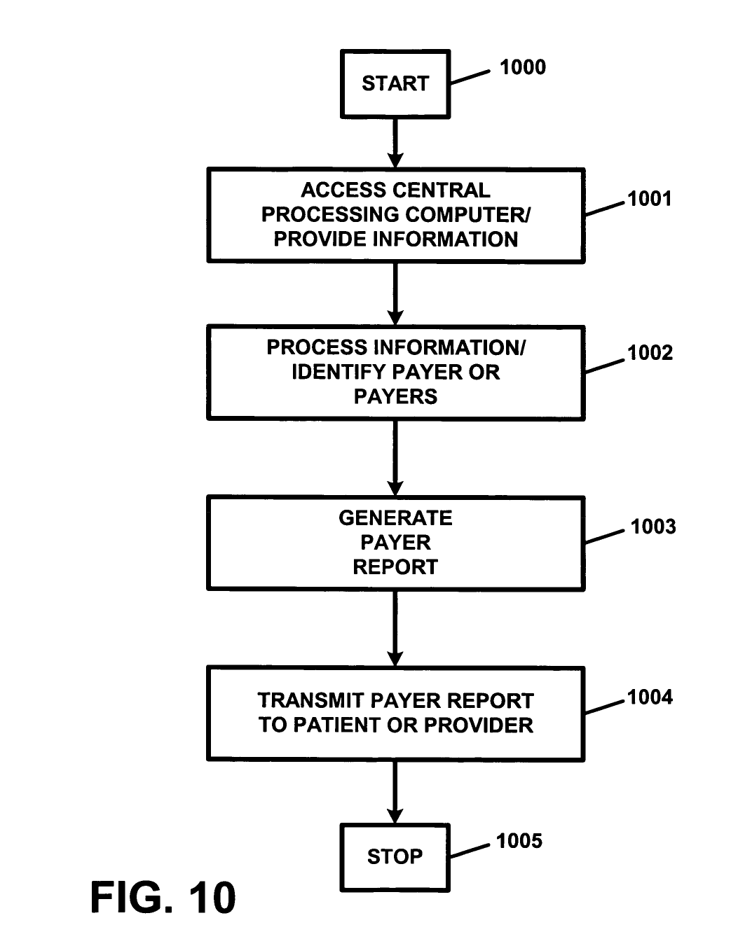

FIG. 10 illustrates another preferred embodiment method of utilizing the present invention. In the embodiment of FIG. 10, the present invention can be utilized by any patient, user, provider, payer, and/or intermediary, in order to locate a provider and/or a payer of healthcare and/or healthcare-related services, goods, or products. For example, assume that a patient has been recently diagnosed as needing an operation to repair his vision. The patient or his provider would need to find a doctor who specializes in performing the needed surgical procedure. The present invention can thereafter be utilized to locate a specialist for performing that function.

With reference to FIG. 10, operation of the apparatus 100 commences at step 1000. At step 1001, the patient or provider accesses that central processing computer 10 and provides information regarding the service needed. At step 1002, the central processing computer 10 will process the request and identify one or more specialists along with their backgrounds, insurance coverage accepted, fees, and/or any educational, professional experience and/or any other information about the provider. At step 1003, the central processing computer 10 can generate a provider report and transmit same to the patient or provider at step 1004. Thereafter, operation of the apparatus ceases at step 1005.

In a similar manner, the embodiment of FIG. 10 can be utilized to find a facility for receiving a certain and/or desired form of care and/or for obtaining a certain procedure. In this embodiment, the facility is defined to be the provider and the present invention can be utilized as described above.

In another similar manner, the embodiment of FIG. 10 can be utilized to find a payer or insurance company for providing desired coverage and/or for paying for certain treatments and/or procedures. In the case of locating payers, the method of FIG. 10 can be repeated for locating payers for certain healthcare services, goods or products.

At step 1001, the patient or provider accesses that central processing computer 10 and provides information regarding the coverage needed. At step 1002, the central processing computer 10 will process the request and identify one or more payers along with information about the payer or payers. At step 1003, the central processing computer 10 can generate a payer report and transmit same to the patient or provider at step 1004. Thereafter, operation of the apparatus ceases at step 1005.

In another similar manner, the embodiment of FIG. 10 can be utilized to find and/or locate supplies, body organs, blood, medications, and/or any other goods, products, and/or supplies, etc. In this embodiment, the identification, location, cost, etc., of any of the above goods, products, supplies, organs etc., can be stored in the database 10H.

With reference to FIG. 10, operation of the apparatus 100 commences at step 1000. At step 1001, the patient or provider accesses that central processing computer 10 and provides information regarding the supply, body organ, blood, medication, and/or any other good, product, or supply or supplies needed.

At step 1002, the central processing computer 10 will process the request and identify the existence and/or location of the respective supply, body organ, blood, medication, and/or any other good, product, or supply or supplies, along with its location, cost and any other pertinent information. At step 1003, the central processing computer 10 can generate a report and transmit same to the patient or provider at step 1004. Thereafter, operation of the apparatus ceases at step 1005.

In another similar manner, the embodiment of FIG. 10 can be utilized to find a payer or insurance company for providing desired coverage and/or for paying for certain treatments and/or procedures. In the case of locating payers, the method of FIG. 10 can be repeated for locating payers for certain healthcare services, goods or products. At step 1001, the patient or provider accesses that central processing computer 10 and provides information regarding the coverage needed. At step 1002, the central processing computer 10 will process the request and identify one or more payers along with information about the payer or payers. At step 1003, the central processing computer 10 can generate a payer report and transmit same to the patient or provider at step 1004. In another preferred embodiment, the payer report can also contain an advertisement(s) or marketing material for a product(s) or service(s) deemed to be of interest for the patient or for the provider. Thereafter, operation of the apparatus ceases at step 1005.

The embodiment of FIG. 10 can also be utilized by intermediaries, such as insurance brokers who need to find certain insurance companies and/or payers who meet the needs of certain patients and/or clients, and/or other individuals and/or third parties.

In another preferred embodiment of FIG. 10, any patient, user, provider, payer, and/or intermediary can request to be notified of the availability of a provider, the emergence of a patient in need of a certain care, the availability of a payer or an insurance company to offer a policy or a certain policy, the availability of a healthcare facility to provide certain care, the availability of certain supplies, a body organ, a blood type, an expiration of an insurance policy (i.e. healthcare insurance, life insurance, disability insurance, etc.,) and/or the occurrence of any event which may be of interest to any of the patients, users, providers, payers, and/or intermediaries, described herein.

In this embodiment, the party requesting to be notified of the event or occurrence, whichever it may be, (hereinafter the “requesting party”), can access the central processing computer 10 via their respective communication device. Thereafter, the requesting party can enter his request, provide any conditions attached to the request, and provide contact information. The central processing computer 10 can process the information received from the requesting party and store all pertinent information in the database 10H.

Thereafter, another party (hereinafter the “supplying party”) contacts the central processing computer 10, either to enter information about the occurrence of an event and/or the availability of a service, a good or products, and/or any other herein-described and/or envisioned occurrence and/or good, product and/or service availability, or to review requests which have been previously submitted, which the supplying party may be interested in responding to.

If the entry of the supplying party can satisfy a request of a requesting party, and/or if the supplying party desires to satisfy a request of a requesting party, the central processing computer 10 will generate and/or transmit an e-mail message, a beeper or pager message, and/or a telephone call, and/or other communication to the communication device of the requesting party.

The communication or message can include information for bring the requesting party and the supplying party together to act towards effecting and/or consummating the transaction. Thereafter, upon notification to the central processing computer 10 by either the requesting party and/or the supplying party, or both, the central processing computer 10 can remove the request from the database 10H. In this manner, the central processing computer 10 and/or the apparatus 100 can be utilized as a clearinghouse for effecting transactions for any of the services, goods, products, and/or any other entities described herein.

In another preferred embodiment, the present invention can be utilized to schedule appointments with any of the patients, providers, payers, and/or intermediaries, described herein. In this manner, for example, can make an appointment with the provider over the communication network which services the present invention.

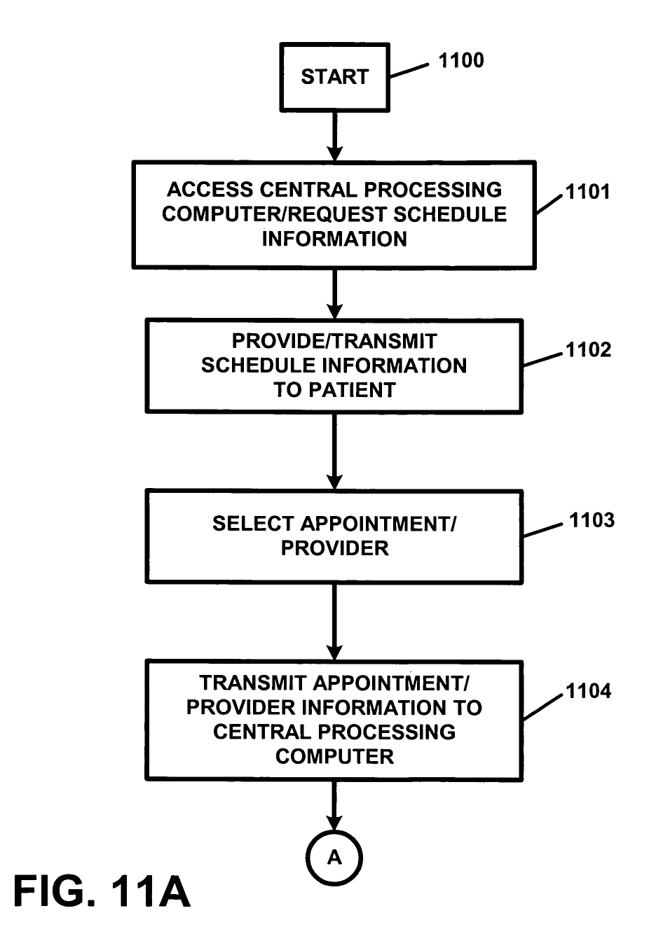

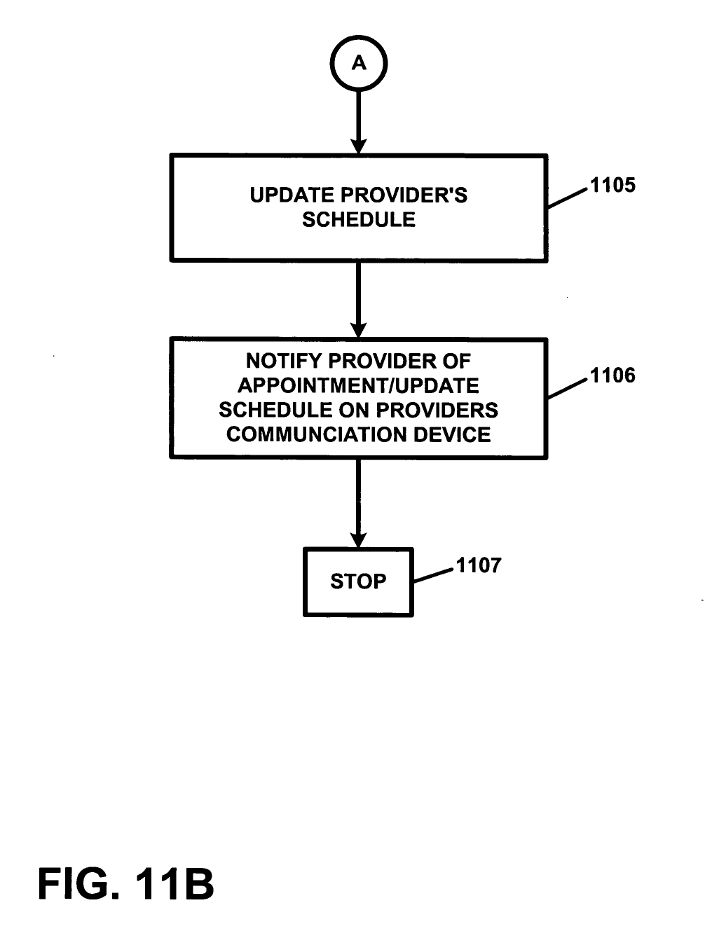

FIGS. 11A and 11B illustrate another preferred embodiment method of using the present invention, in flow diagram form. In the embodiment of FIGS. 11A and 11B, provider scheduling information can be stored in the database 10H. Operation of the apparatus 100 commences at step 1100. At step 1101, the patient accesses the central processing computer 10 and requests the schedule or schedules of a provider or a number of providers. At step 1102, the central processing computer 10 provides the schedule information to the patient. At step 1103, the patient can select the appointment he or she wishes to make.

At step 1104, the appointment information is transmitted to and received at the central processing computer 10. At step 1105, the central processing computer 10 will update the provider's schedule to reflect the new appointment. At step 1106, the central processing computer 10 will transmit a signal, such as an e-mail and/or other transmission and/or communication to provider communication device 20 to notify the provider and to update the providers schedule on the provider computer 20. In the preferred embodiment, the scheduling files stored on the database 10H of the central processing computer 10 and the database 20H on the provider communication device 20, and/or any portions and/or fields, or records, of same, can be dynamically linked to one another so that changes made to the schedule or schedules by either the central processing computer and/or on the provider communication device will be reflected in real-time so as to ensure that the most up-to-date schedules are available at all times. In another preferred embodiment, the signal can also contain an advertisement(s) or marketing material for a product(s) or service(s) deemed to be of interest for the provider.

In another preferred embodiment, the central processing computer 10 can generate an appointment reminder message anytime prior to the appointment, or at any pre-determined or pre-programmed time, before the appointment. The appointment reminder message can contain information for reminding the individual or patient of the scheduled appointment. Thereafter, the central processing computer 10 can transmit the appointment reminder message as an e-mail message, as an instant message, as a text message, as a pre-recorded or electronically generated telephone message, or as any other appropriate message, to the patient communication device 40 of or associated with the individual or patient. The central processing computer 10 can also transmit multiple appointment reminder messages to multiple communication devices 40 such as a computer, a cellular telephone, a wireless telephone, a mobile telephone, a personal digital assistant, a digital television, an interactive television, a beeper, a pager, and/or a telephone.

Operation of the apparatus 100 will thereafter cease at step 1107. In another preferred embodiment, the central processing computer and/or the provider communication device can generate and/or transmit an e-mail to the patient communication device 40 in order to confirm the appointment and/or to serve as a reminder to the patient.

In the same manner, any patient, user, provider, payer, and/or intermediary can utilize the preferred embodiment of FIGS. 11A and 11B in order to schedule an appointment with any other patient, user, provider, payer, and/or intermediary, described herein.

In another preferred embodiment, the present invention can be utilized by intermediaries, such as, but not limited to brokers, insurance brokers, agents, and others, in order to service their respective clients. For example, the database 10H can contain insurance policy information, conditions, premiums, insurers providing same, as well as any other useful information in servicing insured's needs. The database 10H can also contain client information, policy requirements for any of the health insurance, life insurance, and/or disability insurance, policies in force for the insured along with premiums paid and/or expiration dates.

In another preferred embodiment, a broker, for example can prepare policy quotes, compare available policies, generate policies, and service policy claims via the information provided by the central processing computer 10 and/or the apparatus 100 of the present invention. The broker may also request to be notified, electronically and/or otherwise via a message generated and/or transmitted via the central processing computer 10, of times and/or instances when an insured's policy is up for renewal.

The broker may then utilize any of the information provided by, and/or contained in, the database 10H of the present invention in order to respond to an insured client's needs and/or requests, such as, but not limited to preparing policy quotes for comparison, finding a policy and/or policies for addressing the insured's particular needs, assisting in resolving claims issues and/or claims processing issues, and/or assisting and/or providing any other information which could allow the broker or other intermediary to provide assistance to, and/or to provide added value to its client or clients.

In this, manner, the present invention can provide a platform for allowing a broker to provide improved services to his or her insured while also providing for a more paperless working relationship.

In another preferred embodiment of the present invention, the present invention can be utilized in order to provide notification to any of the patients, providers, payers, users, and/or intermediaries. For example, a medical specialist can be electronically and/or otherwise notified if a patient is diagnosed with an illness and/or a condition which he or she specializes in, treating.

As another example, a payer can be electronically and/or otherwise notified when a patient may be admitted to a hospital and/or other facility for care. The present invention can also be utilized to electronically and/or otherwise notify a provider when his or her patient has been diagnosed with an illness even when the patient may not be under the provider's care, and/or to notify a patient if a provider has become available to perform a treatment and/or a procedure on, and/or for, the patient.

The present invention can also be utilized in order to provide notification, electronically and/or otherwise, to any respective party, regarding any event, happening, and/or occurrence, which is described herein and/or which may be reasonably foreseen from the comprehensive nature of the present invention in providing comprehensive healthcare processing.

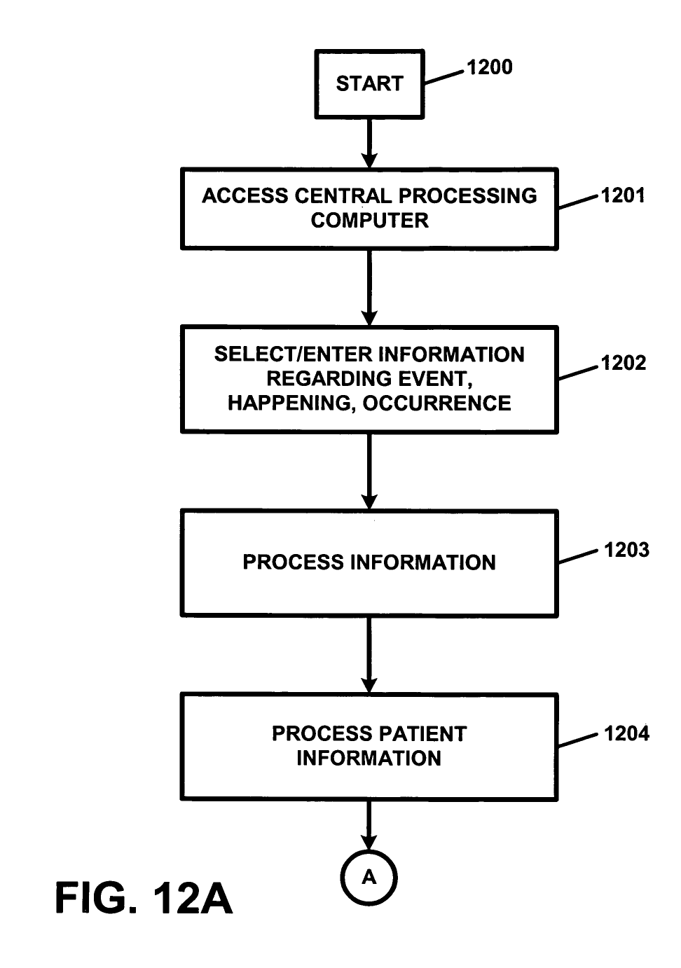

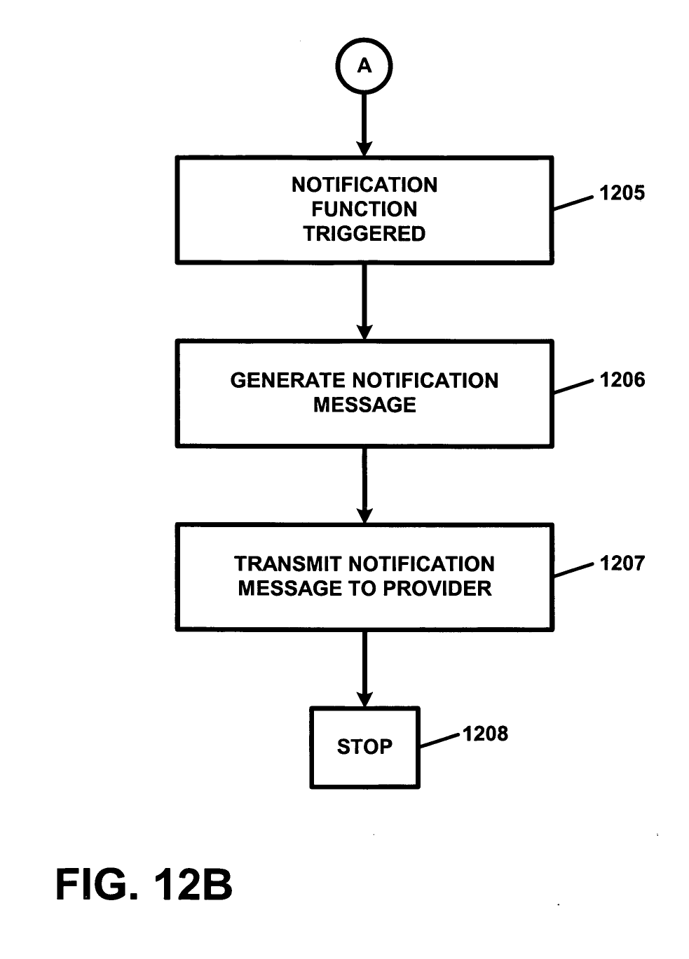

FIGS. 12A and 12B illustrate another preferred embodiment method of utilizing the present invention, in flow diagram form. In the preferred embodiment of FIGS. 12A and 12B, the present invention can provide notification to any respective party, electronically and/or otherwise, in response to the occurrence of an event, happening, and/or occurrence.

While the description of the embodiment of FIGS. 12A and 12B will be directed to notifying a doctor or other healthcare provider when a patient requires the provider's treatment and/or care, it is important to note that the embodiment of the FIGS. 12A and 12B can be utilized so as to provide notification services and/or functionality for any defined event, happening, and/or occurrence, and to any of the respective patients, users, providers, payers, and/or intermediaries, described herein.

The operation of the apparatus 100 commences at step 1200. At step 1201, the provider can access the central processing computer 10. At step 1202, the provider can select and/or enter the information concerning the notifying event, happening, and/or occurrence, and/or the conditions for notifying the provider. For example, an obstetrician can request to be notified when a pregnant patient enters a hospital in labor. At step 1203, the central processing computer 10 processes the above information. At step 1204, the central processing computer 10, upon receiving information concerning the pregnant patient's admission to the hospital, will process the pregnant patient's information.

At step 1205, the central processing computer 10 will identify and/or ascertain that the provider's-condition for notification has been met or has been triggered. Thereafter, at step 1206, the central processing computer will generate an appropriate message to notify the provider. At step 1207, the central processing computer 10 can transmit the notification message to the provider's communication device as any one or more of an e-mail, a beeper or pager message, a telephone call, and/or in any other manner. The central processing computer 10 can also transmit multiple notification messages to multiple communication devices such as a computer, a personal digital assistant, a beeper or pager and/or a telephone. Thereafter, operation of the apparatus will cease at step 1208.

In a similar manner, a payer may also request to be notified upon the admission of a patient to a hospital and/or other care facility. A patient may also request that certain providers and/or payers be notified by the present invention of an event, happening, and/or occurrence involving the patient. There is no limit to the scenarios and/or alternate embodiments in which the present invention can be utilized in order to provide notification to any of the patients, users, providers, payers, and/or intermediaries, described herein. For example, a provider or a payer can be notified upon an admission of the individual or patient to a healthcare facility, an administration of a treatment, an administration of a procedure, a making of a diagnosis, or any other pre-defined event, happening, or occurrence. In the case of a making of a diagnosis, the notification message can be in the form of an e-mail message or an instant message and/or can contain or can include, or can contain a link(s) to, a digital or electronic copy of an x-ray or copies of x-rays, an MRI image or MRI images, a CAT scan image or CAT scan images, a PET scan image or images, a copy of any other type of image obtained from any type of healthcare equipment or device, a test result or test results, a blood pressure reading or blood pressure readings, a heart pulse rate or reading, a note or notes regarding the individual or patient, a photograph or photographs of the individual or patient, a photograph or photographs of an accident scene, information regarding a vital sign or vital signs, or any other data or information which may be useful for, or of interest to, the provider or payer to have access to regarding the individual or patient or regarding the event, happening, or occurrence.

In still another preferred embodiment, the present invention can be utilized to facilitate healthcare claims processing. Any of the patients, providers, payers, users, and/or intermediaries, can file claims with the respective party electronically via the present invention. The claim forms for each payer and/or other party can be accessed from the respective party's communication device, filled out and submitted electronically by the claiming party or claimant. Any and/or all submissions can be electronically dated and/or otherwise marked, the status of the claim can be provided to the claimant at any time and any interested third parties may be notified of any action taken on a claim.

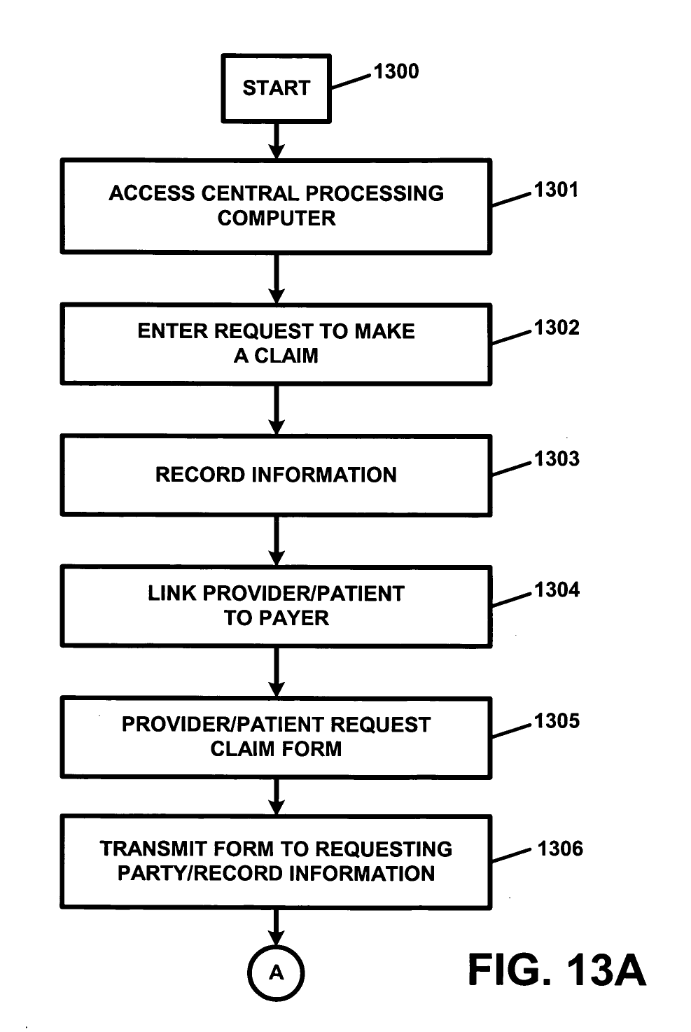

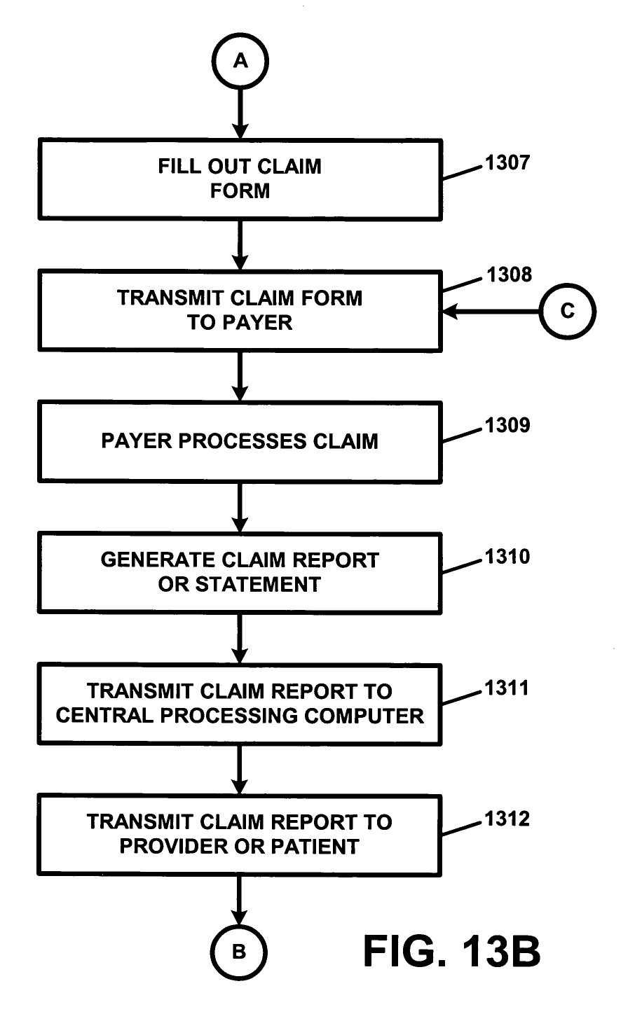

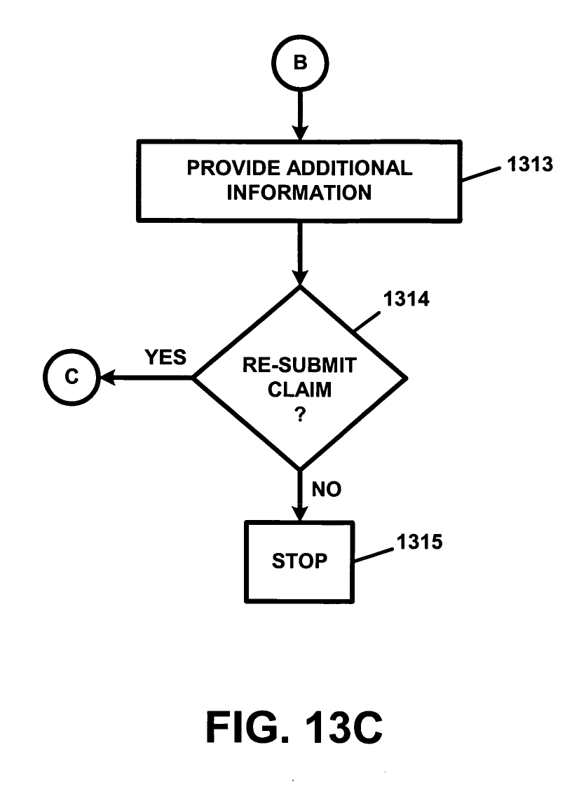

FIGS. 13A, 13B and 13C illustrate a method of utilizing the present invention to perform claims processing services. While it is understood that any appropriate party can file claims with any party described herein, for simplicity, a preferred embodiment where providers and/or patients file claims is described herein. The method, however, can be adapted for use by any party described herein.

With reference to FIGS. 13A, 13B and 13C, operation of the apparatus 100 commences at step 1300. At step 1301, the provider or patient, whichever the case may be, accesses the central processing computer 10 via the respective communication device 20 or 40. At step 1302, the provider or patient enters a request to make a claim.

At step 1303, the central processing computer 10 will record any information regarding the claim request and, thereafter, at step 1304, link the provider or patient directly to the respective payer communication device 30. At step 1305, the provider or patient can request a claim form. At 1306, the claim form will be transmitted from the payer communication device 30, via the central processing computer 10, which will record the occurrence of same, to the communication device 20 or 40 of the respective provider or patient. The provider or patient can fill out the form on the respective communication device 20 or 40 at step 1307.

At step 1308, the provider or patient transmits the completed form to the payer communication device 30 via the central processing computer 10 which will record the occurrence of same. At step 1309, the payer will process the claim and, at step 1310, generate a claim report or statement. At step 1311, the claim report or statement is transmitted to the central processing computer 10, which can record the occurrence as well as the action taken by the payer (i.e. claim approved or denied).

Thereafter, the central processing computer 10 will, at step 1312, transmit the claim report or statement to the communication device 20 or 40, respectively, of the provider or patient. Thereafter, at step 1313, the provider or patient can provide the additional information and/or re-submit the claim form to the central processing computer. At step 1314, the central processing computer 10 will determine if the provider or patient has provided additional information and/or has decided to resubmit the claim.

If, at step 1314, it is determined that additional information has been provided and/or that the claim is to be re-submitted, the processing will proceed to step 1308 and the processing of steps 1308 through 1314 will be repeated until a resolution is reached between the parties involved. Thereafter, the operation of the apparatus 100 will cease at step 1315. If at step 1314, it is determined that no new additional information has been submitted and/or that the claim is not to be re-submitted then the operation of the apparatus 100 will cease at step 1315

In this manner, the present invention can facilitate an expedited and/or a paperless claim process. Further, records of the transactions, such as, but not limited to claim request, claim form request and/or delivery, claim submission, claim processing, claim report or statement, claim re-submission, provision of additional information, and/or any and/or all other transactions, which occur during the claim processing procedure or process, can be recorded and maintained at the central processing computer 10 so as to provide for a third party record and/or monitoring of same.

The central processing computer 10, can notify any party described herein, as well as any third parties, regarding any event, happening, occurrence, and/or any aspect of any claim submission and/or processing activities. For example, a provider can be notified at regular interval on a payer's or payers decisions to pay for certain treatments and/or procedures. Similarly, a patient's employer can be notified regarding claim payments made by its group health insurer so as to ensure that its employees are being properly serviced and/or provided for. Other information may similarly be provided to any appropriate requesting party described herein and/or any qualified and/or appropriate third party. Notification can be provided to any appropriate party, via any of the communication methods and/or techniques described herein, and can be for, and/or include, any pertinent information.

The apparatus of FIGS. 13A and 13B can also utilize electronic signatures and/or process electronic signatures and/or electronic signature information which can correspond to any of the herein-described parties in performing any of the herein-described processing routines and/or functions.

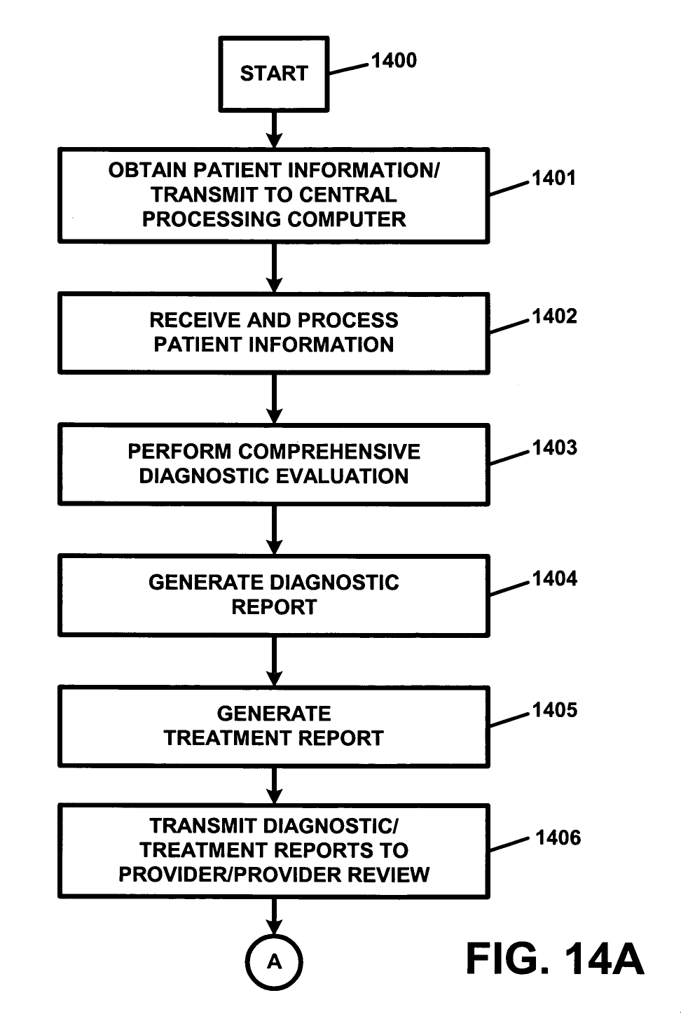

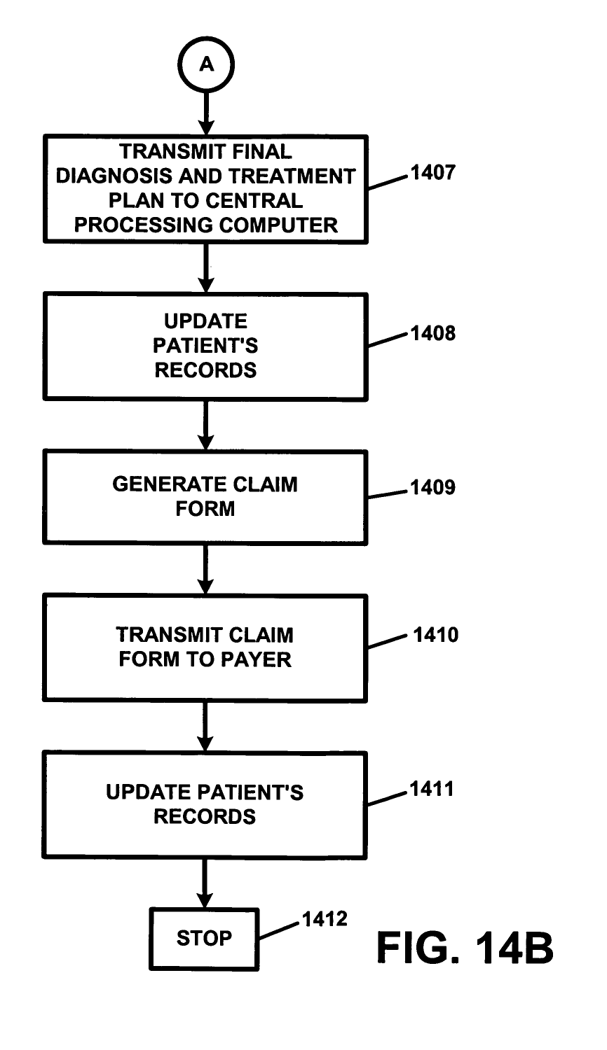

In another preferred embodiment, the present invention can provide for automatic claim submission via the central processing computer 10 once a final diagnosis and treatment has been prescribed by a provider and/or upon the occurrence of an examination and/or the administration of a treatment. FIGS. 14A and 14B illustrate another preferred embodiment method of utilizing the present invention.

With reference to FIGS. 14A and 14B, operation of the apparatus 100 commences at step 1400. At step 1401, the patient's symptoms, if any, and/or examination findings are obtained from the patient and transmitted from the provider communication device 20 to the central processing computer 10. The central processing computer 10 will, at step 1402 receive and process the patient symptoms, if any, and/or the examination findings, in conjunction with the patient's medical history and/or other information, medical theories, principles, criteria and/or other medical information needed to make a diagnosis. At step 1403, the central processing computer 10 will perform a comprehensive diagnostic evaluation of the patient's symptoms, if any, and/or the examination findings.

At step 1404, the central processing computer 10 will generate a diagnostic report which can include a diagnosis of the patient's condition. The diagnostic report which is generated at step 1404 can, if needed, include a single diagnosis and/or a list of possible diagnoses along with their respective probabilities, which may pertain to the patient's condition. At step 1405, the central processing computer 10 can then generate, if needed, a treatment report which will outline and/or prescribe treatment for the single diagnosis and/or for the list of possible diagnoses. The central processing computer 10, when generating the treatment report, can, if needed, process same in conjunction with, and consider, possible drug interactions and/or treatment interactions.

At step 1406, the central processing computer 10 will transmit the diagnostic report and/or treatment report to the provider's communication device 20 at which point the medical doctor can obtain the diagnosis or possible diagnoses and corresponding treatment plans, if any. The medical doctor can then review the diagnostic report and/or treatment report and choose a final diagnosis and/or treatment plan to administer to the patient. At step 1407, the medical doctor will transmit the final diagnosis and treatment plan, including the prescribed treatment and/or treatment plan, to the central processing computer 10. In another preferred embodiment, at step 1407, the medical doctor or any other provider using the apparatus 100 can also generate and/or transmit a prescription or an electronic prescription for a medication, a medicine, or a drug, or for a procedure, a test, an analysis, an analysis work-up, blood work, a treatment, or a therapy, or can generate and/or transmit a referral to another provider, for submission or transmission to the respective pharmacy or other provider, and for storage in the patient's healthcare record or healthcare file.

In another preferred embodiment, the final diagnosis and/or treatment plan, including the prescribed treatment and/or treatment plan, can also be transmitted by the central processing computer 10, at step 1407, back to the provider for his or her records, to another provider of the individual or patient, to a payer or insurer of the individual or patient, to the individual or patient, or to a third party or intermediary, by transmitting the final diagnosis and/or treatment plan to a respective provider computer or communication device 20, to a respective payer computer or communication device 30, to a respective patient computer or communication device 40, or to a respective intermediary computer or communication device 50 either directly, such as via any suitable electronic or other transmission, or indirectly, such as via an e-mail server in the case when the final diagnosis and/or treatment plan is included in, or is attached to, an e-mail message. The copy of the final diagnosis and/or treatment plan can also be stored by or in the respective provider computer or communication device 20, the respective patient computer or communication device 40, or the respective intermediary computer or communication device 50. In another preferred embodiment, the final diagnosis and/or treatment plan can contain individual-specific or patient-specific educational information or individual-specific or patient-specific instructional information, or a link(s) or hyperlink(s) to same, regarding the diagnosis, treatment, or treatment plan, or information relating thereto, so as to provide this educational information or instructional information to the individual or patient. The individual or patient can thereafter access or obtain the educational information or instructional information via the apparatus 100 and method of the present invention. In this manner, the apparatus 100 and method of the present invention can provide individual-specific or patient-specific educational information or individual-specific or patient-specific instructional information regarding the diagnosis, treatment, or treatment plan.

In another preferred embodiment, the apparatus 100 or the central processing computer 10 can be programmed to identify the individual-specific or patient-specific educational information or individual-specific or patient-specific instructional information regarding the diagnosis, treatment, or treatment plan, and/or any information, link(s), or hyperlink(s) relating thereto or pertaining thereto.

At step 1408, the central processing computer 10 will then update the patient's records in the database 10H so as to include all of the data and information described as being processed and/or generated by the central processing computer 10, including, but not limited to the patient's symptoms, the information contained in the diagnostic report and the treatment report, the final diagnosis and the prescribed treatment. At step 1408, the central processing computer 10 can also generate a co-payment message or a deductible message containing information regarding a co-payment due by the patient under the patient's insurance policy or a deductible which has to be met by the patient under the patient's policy. At step 1408, the co-payment message or the deductible message can be transmitted to the provider's computer or communication device 20. At step 1408, the co-payment message or the deductible message can also be transmitted to the payer's computer or communication device 30, to the patient's computer or communication device 40, or to an intermediary's computer or communication device 50.

At step 1408, the central processing computer 10 can also generate a benefit eligibility message containing information regarding the patient's eligibility to receive benefits under an insurance policy, a payment policy, or a payment plan. At step 1408, the benefit eligibility message can be transmitted to the provider's computer or communication device 20. At step 1408, the benefit eligibility message can be also be transmitted to the payer's computer or communication device 30, to the patient's computer or communication device 40, or to an intermediary's computer or communication device 50.

Thereafter, at step 1409, the central processing computer 10 will generate a claim form which can meet the formal claim submission requirements of the patient's payer or insurance company. At step 1410, the claim form will be submitted by the central processing computer 10 to the respective payer computer 30. In another preferred embodiment, a copy of the claim form can also be transmitted by the central processing computer 10, at step 1410, to the provider, to the individual or patient, or to a third party or intermediary, by transmitting the copy of the claim form to a respective provider computer or communication device 20, to a respective patient computer or communication device 40, or to a respective intermediary computer or communication device 50, either directly, such as via any suitable electronic or other transmission, or indirectly, such as via an e-mail server in the case when the copy of the claim form is included in, or is attached to, an e-mail message. The copy of the claim form can also be stored by or in the respective provider computer or communication device 20, the respective patient computer or communication device 40, or the respective intermediary computer or communication device 50. At step 1411, any and/or all pertinent information regarding the claim submission, the patient, the provider visit, and/or any diagnoses and/or treatments considered, the final diagnosis and/or the prescribed treatment, can be stored and the patient's records will then be updated and be available for the patient's next treatment and/or diagnosis.

In another preferred embodiment, at step 1411, the central processing computer 10 can generate a respective office visit summary report, a procedure summary report, a treatment summary report, a provider or healthcare facility or hospital discharge report, or any other report containing information regarding a summary or clinical summary of or relating to an office visit, a procedure, a treatment, a hospital stay, or any other interaction with a provider or healthcare facility, as well as instructions for the patient or individual. A copy of the respective office visit summary report, procedure summary report, treatment summary report, provider or healthcare facility or hospital discharge report, or other report, can also be transmitted, at step 1411, by the central processing computer 10, to the patient or individual computer or communication device 40, to the provider computer or communication device 20 of the provider as well as the respective provider computer or communication device 20 of any other healthcare provider or healthcare providers of the patient or individual authorized or selected by the patient or individual to receive same, to the payer or insurer computer or communication device 30, and/or to an intermediary computer or communication device 50.

In another preferred embodiment, the respective office visit summary report, procedure summary report, treatment summary report, or provider or healthcare facility or hospital discharge report, or any other report, can contain individual-specific or patient-specific educational information or individual-specific or patient-specific instructional information, or a link(s) or hyperlink(s) to same, regarding a diagnosis, a treatment, a treatment plan, an office visit summary, a procedure summary, a treatment summary, a provider or healthcare facility or hospital discharge report, or any other report, or any other information relating thereto, so as to provide this educational information or instructional information to the individual or patient. The individual or patient can thereafter access or obtain the educational information or instructional information via the apparatus 100 and method of the present invention. In this manner, the apparatus 100 and method of the present invention can provide individual-specific or patient-specific educational information or individual-specific or patient-specific instructional information regarding the diagnosis, treatment, treatment plan, office visit summary, procedure summary, treatment summary, or provider or healthcare facility or hospital discharge report, or other report.

In another preferred embodiment, the apparatus 100 or the central processing computer 10 can be programmed to identify the individual-specific or patient-specific educational information or individual-specific or patient-specific instructional information regarding the diagnosis, the treatment, the treatment plan, the office visit summary, the procedure summary, the treatment summary, or the provider or healthcare facility or hospital discharge report, or the other report, and/or any information, link(s), or hyperlink(s) relating thereto or pertaining thereto.

In another preferred embodiment, the claim submission, which is either submitted at step 1410 and/or stored at step 1411, can be date stamped and/or time stamped. In this manner, claim processing can be tracked or monitored so as to facilitate audits of the payer or insurance company in order to ascertain if the payer or insurance company is properly and/or efficiently handling a claim or claims for the patient, and/or if the payer or insurance company is in compliance with any laws, rules, or regulations, governing claims processing and/or handling. Information regarding the data stamped and/or time stamped claims, including the payer's or the insurance company's processing or handling of same, and the response or reply to same, can also be stored in the database 10H of the central processing computer 10 and can be accessed and/or obtained by any authorized user or entity. In this manner, the apparatus 100 of the present invention can be used in order to ascertain information regarding the processing and/or handling of claims by a respective payer or insurance company for any individual or patient or for any group or groups of individuals or patients.

The operation of the apparatus 100 will then cease at step 1412. In this manner, the present invention can provide for the automatic and/or for the programmed submission of healthcare claims, claim forms, claim requests, benefit requests, etc., upon the conclusion of a provider's service, consultation, treatment, procedure, and/or any other event which triggers coverage under a healthcare insurance policy and/or a payer's liability to pay for services and/or treatments.

In another preferred embodiment, in instances where a diagnosis, a reported laboratory finding, or other determination warrants providing notice or reporting to a public health agency, the apparatus 100 or the central processing computer 10 can, at step 1411, store information regarding the diagnosis, the reported laboratory finding, or the other determination, in the database 10H, generate a determination finding report, and transmit the determination finding report to one or more provider computers or communication devices 20 associated with a public health agency or department, and/or when authorized or allowed, to a provider computer or communication device 20 associated with a healthcare provider, to a payer computer or communication device 30, or to a patient computer or communication device 40. In another preferred embodiment, in a same, a similar, or an analogous, manner as described above for a diagnosis, reported laboratory finding, or other determination which warrants providing notice of same or reporting same, advance directives for patients or individuals 65 years of age or older, or any other prescribed or selected age, can also be stored in the database 10H and be reported to a public agency by generating and transmitting an advance directive report message to one or more provider computers or communication devices 20 associated with a public health agency or department, and/or, where authorized or allowed, to a provider computer or communication device 20 associated with a healthcare provider, to a payer computer or communication device 30, or to a patient computer or communication device 40.

In another preferred embodiment, in a same, a similar, or an analogous manner, as described above for a diagnosis, reported laboratory finding, or other determination which warrants providing notice of same or reporting same, syndromic surveillance data or information can also be submitted to a public health agency or public health agencies or departments. In instances where a syndromic surveillance data or information is obtained, the apparatus 100 or the central processing computer 10 can, at step 1411, store information regarding the syndromic surveillance data or information in the database 10H, generate a syndromic surveillance data or information report, and transmit that syndromic surveillance data or information report to one or more provider computers or communication devices 20 associated with a public health agency or department, and/or when authorized or allowed, to a provider computer or communication device 20 associated with a healthcare provider, to a payer computer or communication device 30, or to a patient computer or communication device 40.

In another preferred embodiment, the claim form transmitted to the payer computer 30 can have attached thereto, or can include, an x-ray, x-rays, a lab result or lab results, an MRI image, MRI images, a CAT scan image, a PET scan image, provider notes, patient records or information, patient provided information, etc, and/or any other information which can be obtained by or with any healthcare, medical, or dental, equipment or device, or any other information which may be requested of, or obtained from, a provider or which may be used by a payer or insurance company in processing, investigating, or evaluating, a claim submission. In this regard, the claim form can also, for example, contain or include, or can have attached thereto, or can contain a link or links to, a digital or electronic copy of an x-ray or copies of x-rays, a MRI image or MRI images, a CAT scan image or CAT scan images, a PET scan image or images, a copy of any other type of image obtained from any type of healthcare equipment or device, a test result or test results, a blood pressure reading or blood pressure readings, a heart pulse rate or reading, a note or notes regarding the individual or patient, a photograph or photographs of the individual or patient, a photograph or photographs of an accident scene, information regarding a vital sign or vital signs, or any other information which may be requested of, or obtained from, a provider, or information which may be requested of, or obtained from, the patient, or which may be used by a payer or insurance company in processing, investigating, or evaluating, a claim submission.

In another preferred embodiment of the embodiment of FIGS. 14A and 14B, or any and/or all the herein-described embodiments, the apparatus 100 or the central processing computer 10 can provide information regarding ICD, ICD-10, ICD-9, or other, codes, diagnostic codes, symptom codes, treatment codes, billings codes, or any other codes or information useful in entering or recording patient or individual information into a healthcare record or a healthcare file of the patient or individual. In this manner, the apparatus 100 of the present invention can provide any user, provider, payer, insurer, or intermediary, or any other individual or person, using the apparatus 100 of the present invention, with accurate and current data or information so as to ensure that the information described herein as being stored in the healthcare records or the healthcare files of individuals or patients, records or files of providers, payers, insurers, third parties, or intermediaries, or any insurance claims, prescriptions, referrals, or any other information, described herein as being processed, generated, or stored, by the apparatus 100 of the present invention, is accurate, correct, and up-to-date with current standards in the healthcare field or any related fields.

In the embodiment of FIGS. 14A and 14B, as well as any and/or all of the other embodiments described herein, the apparatus 100 of the present invention can also process and/or store information regarding a payment made, or a co-payment made, by or on behalf of the patient to the provider. In another preferred embodiment, as well as any and/or all of the other embodiments described herein, any one or more of the apparatus 100, the central processing computer 10, the provider communication device 20, the payer communication device 30, the patient communication device 40, or the intermediary communication device 50, can process a payment, or information regarding a payment, made by, for, or on behalf of, any individual or patient which involves a payment being from a healthcare spending account associated with the individual or patient. In another preferred embodiment, as well as any and/or all of the other embodiments described herein, any one or more of the apparatus 100, the central processing computer 10, the provider communication device 20, the payer communication device 30, the patient communication device 40, or the intermediary communication device 50, can process a payment, a deposit, or a withdrawal, or information regarding a payment, a deposit, or a withdrawal, made to or from a healthcare spending account associated with any individual or patient.

In the embodiment of FIGS. 14A and 14B, as well as any and/or all of the other embodiments described herein, the apparatus 100 of the present invention can also process and/or store information regarding an insurance claim made by or on behalf of the patient. In this regard, in another preferred embodiment, the patient, or any individual acting on behalf of the patient to submit a healthcare insurance claim for the patient, can access the central processing computer 10 via a patient communication device 40 or via any other communication device, access and fill out an insurance claim form for the patient's respective payer or insurance company, and submit the claim form to the payer communication device 30 of or associated with the patient's payer or insurance company. In this regard, both providers and patients, or individuals acting on behalf of a patient or patients, can submit insurance claims to the central processing computer 10.

In another preferred embodiment, any healthcare provider of the patient or the individual, any payer or insurer of the patient or the individual, or the patient or the individual himself or herself, can program the central processing computer 10 to generate a reminder message or reminder messages, at any desired or selected times or time intervals, for follow-up care, preventative care, and/or to remind the patient or the individual to follow certain procedures and instructions for his or her care and/or well being. The central processing computer 10 can transmit the reminder message or reminder messages to the patient computer or communication device 40. The reminder messages can be sent on an on-going basis, as desired, to provide the patient or the individual with these reminders.

In another preferred embodiment, any of the patients or individuals described herein can, at any time, access the central processing computer 10 via his or her patient computer or communication device 40 and can request to be provided with an electronic copy of his or her healthcare record or healthcare file, or any portion of same, or an electronic copy of office visit summaries and/or instructions, discharge summaries, procedures, or instructions, symptom summaries, diagnosis summaries, treatment summaries, treatment plan summaries, diagnostic test results, lab or laboratory test results, problem lists, allergy lists, medication lists, medicine or drug lists, medication allergy information, medicine allergy information, drug allergy information, information regarding side effects of medications, medicines, or drugs, and/or any other healthcare information or healthcare-related information. The central processing computer 10 can process the request, generate the respective report, summary, message, or information, containing the electronic copy of the healthcare record or the healthcare file, or any portion of same, or the electronic copy of one or more of the office visit summaries and/or instructions, discharge summaries, procedures, or instructions, symptom summaries, diagnosis summaries, treatment summaries, treatment plan summaries, diagnostic test results, lab or laboratory test results, problem lists, allergy lists, medication lists, medicine lists or drug lists, medication allergy information, medicine allergy information, drug allergy information, information regarding side effects of medication, medicines, or drugs, and/or any other healthcare information or healthcare-related information, and transmit the respective report, summary, message, or information, to the patient computer or communication device 40. In another preferred embodiment, the respective report, summary, message, or information, can also be transmitted to the provider computer or communication device 20 of an authorized provider or providers and/or to a payer computer or communication device 30 of an authorized payer or insurer, or to an intermediary computer or communication device 50 of an authorized third party or intermediary. In this regard, any authorized provider and/or payer or insurer of the patient or individual, or any authorized third party or intermediary, can be provided with an electronic copy of the healthcare record or healthcare file, or any portion of same, or an electronic copy of one or more of the office visit summaries and/or instructions, discharge summaries, procedures, or instructions, symptom summaries, diagnosis summaries, treatment summaries, treatment plan summaries, diagnostic test results, lab or laboratory test results, problem lists, allergy lists, medication lists, medicine lists or drug lists, medication allergy information, medicine allergy information, drug allergy information, information regarding side effects of medication, medicines, or drugs, and/or any other healthcare information or healthcare-related information.

In another preferred embodiment, any authorized provider or payer or insurer of the patient or the individual can exchange information regarding the patient or individual with any other authorized provider or payer or insurer of the patient or the individual.

In another preferred embodiment, a patient or an individual acting on behalf of a patient, can also submit employee benefits-related healthcare insurance claims utilizing the apparatus 100 and method of the present invention. Applicant hereby incorporates by reference herein the subject matter and teachings of U.S. Pat. No. 7,305,347 which discloses and teaches an apparatus and method for providing employee benefits and/or employee benefits information. For example, Applicant hereby incorporates by reference herein the subject matter and teachings of U.S. Pat. No. 7,305,347 in FIGS. 1-4 and Col. 11, line 37, to Col 36, line 34, which discloses and teaches an apparatus and method for providing employee benefits and/or employee benefits information which can be utilized by an individual to claim or request a benefit pursuant to a healthcare insurance employee benefit. In this regard, the apparatus 100 and method of the present invention can, in another preferred embodiment, process information regarding a healthcare insurance claim or a healthcare benefit claim made by the patient, or by an individual on behalf of a patient, to a payer or insurance company of or associated with the patient pursuant to a healthcare-related employee benefit.

In the embodiment of FIGS. 14A and 14B, as well as any and/or all of the other embodiments described herein, the apparatus 100 of the present invention can also store information, regarding a claim submission, a claim made, or a claim submitted, by a provider or by a patient, or on behalf of the patient, or the apparatus 100 can also store information regarding a payment made or a co-payment made, or a charge incurred, or outstanding charges which remain unpaid, by a patient, in the patient's credit report information or credit history information which is described herein as being stored in the database 10H. In another preferred embodiment, the apparatus 100 of the present invention can also generate and transmit a message, including any changes made to, or any new information added to, or stored in, the patient's credit report information or credit history information, to any appropriate credit reporting company, bureau, or agency, or any of the other entities described herein, such as credit card companies or financial institutions, for inclusion into a credit report or credit history of the patient.

In another preferred embodiment of FIGS. 14A and 14B, as well as any of the other embodiments described herein, the central processing computer 10 can generate a message anytime an individual's or patient's credit report or credit reports, or credit history, is or has been accessed, obtained, changed, altered, or modified, or upon a new entry of information being stored in same, or being attempted to be stored in same. Thereafter, the message can be transmitted by the central processing computer 10 to the patient communication device 40, or to a communication device, computer, e-mail server, or any other appropriate or suitable device which can be used to relay the message to the patient communication device 40, as a telephone message, an e-mail message, an instant messaging message, a message sent to a cellular telephone or personal digital assistant, or any other suitable message, in order to provide the individual or patient with notification of the event or occurrence involving the individual's or patient's credit report or credit reports, or credit history. In another preferred embodiment, the message can be transmitted before the accessing, obtaining, changing, alteration, or modification, to the credit report or credit reports, or credit history, is completed, so that the individual or patient can intervene, via the patient communication device 40 or any other appropriate communication device, so as to dispute or prevent the accessing, obtaining, changing, alteration, or modification, to his or her credit report or credit reports, or credit history.

In the embodiment of FIGS. 14A and 14B, as well as any and/or all of the other embodiments described herein, the present invention can utilize and/or process electronic signatures in order to effectuate and/or process any of the respective transactions which are described as taking place between, and/or which can transpire involving, any of the respective parties described herein. Applicant hereby incorporates by reference herein the subject matter and teachings of Applied Cryptography, Second Edition, Bruce Schneier, Wiley, 1996.

The present invention can also be utilized, in the manner described above, in connection with claiming healthcare insurance benefits, to claim disability insurance benefits and/or life insurance benefits.

In another preferred embodiment, the apparatus 100 can administer and/or maintain financial accounts for, and/or on behalf of, any of the patients, users, providers, payers, and/or intermediaries, described herein. In this manner, any of the parties described herein as utilizing the services of the apparatus 100, and/or the central processing computer 10, can have all financial transaction managed and/or monitored by the central processing computer 10. In the preferred embodiment, the financial accounts can be conventional savings accounts, checking account, credit accounts, debit accounts, electronic money accounts, digital money accounts, etc., and/or any other appropriate account(s).

In the preferred embodiment, any of the respective parties may select to have the central processing computer 10 administer any financial transactions on their behalf. For example, a payer may deposit a sum of money which can be ear-marked for payment of healthcare provider services. A provider may open an account and deposit a sum of money to pay any vendor bills. The provider may also open an account to receive payment from payers and/or patients for services rendered. Each time a financial transaction is to occur, such as, for example, the payment from a payer to a provider resulting from a patient's claim, the central processing computer 10 will transfer funds (and/or deduct funds) from the payer's account and deposit the funds (and/or add the funds) to the providers account. Notwithstanding the examples provided above, the central processing computer 10 can effectuate any type of financial transaction(s) for, between, and/or on behalf of, any of the parties described herein. Further, the apparatus 100 and/or the central processing computer 10 can process electronic signatures which can be associated with and/or which can correspond to any of the respective parties to a transaction.

The central processing computer 10, in the preferred embodiment, can maintain detailed records of any and/or all of such transfer and/or transactions and provide periodic account statements to the respective parties maintaining accounts with the central processing computer 10. In this manner, the present invention can provide an apparatus and a method for maintaining financial accounts, effecting financial transactions, and providing accounting and/or other notification services, for, and/or on behalf, any of the parties described herein.

In another preferred embodiment, the apparatus and method of the present can be utilized as healthcare training simulator for any of the providers, healthcare providers, healthcare professionals, and/or other providers described herein. The present invention can also be utilized by any user and/or individual wishing to learn about a certain healthcare field or topic. The present invention can be utilized to provide formal training, supplemental training, informal training, continuing education training, and/or any other training.

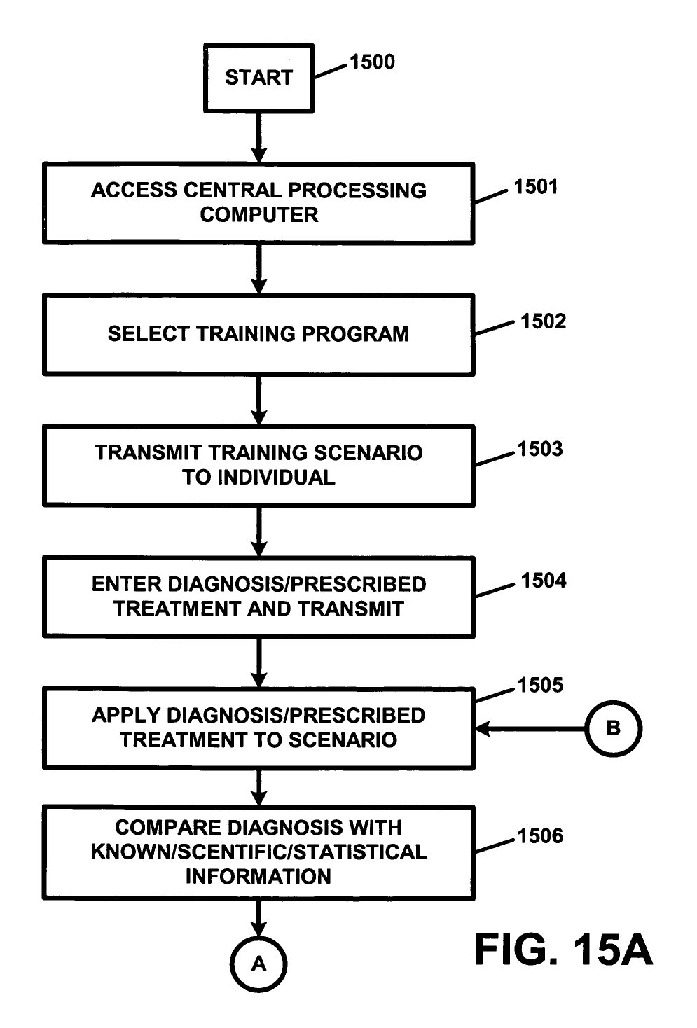

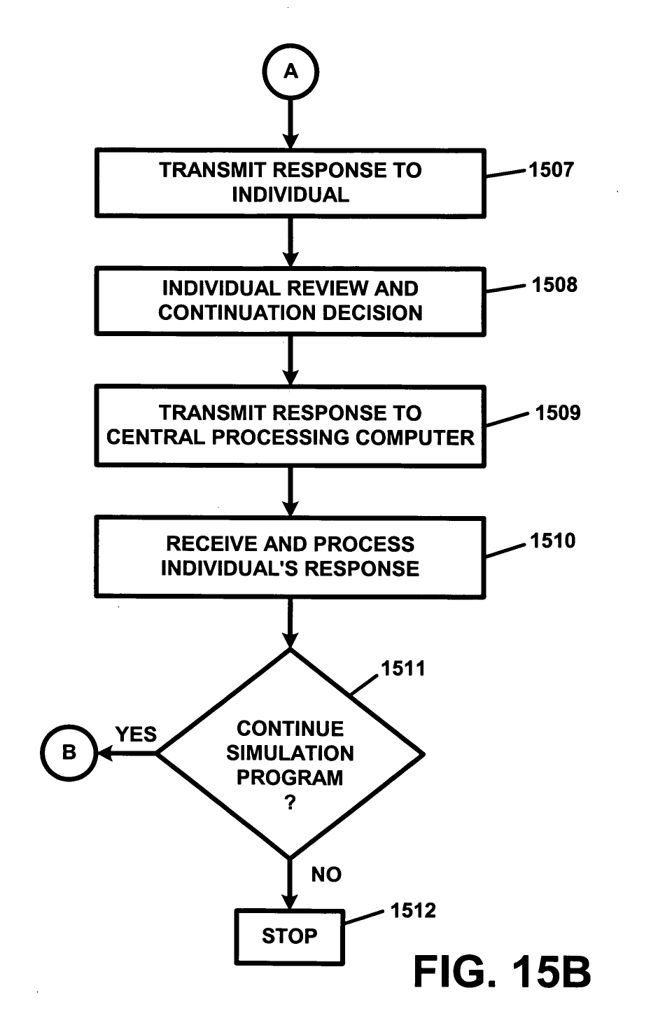

FIGS. 15A and 15B illustrates another preferred embodiment method for utilizing the present invention, in flow diagram form. The operation of the apparatus commences at step 1500. At step 1501, the individual utilizing the training simulator (referred to hereinafter as “the user”) who could be any provider, student provider, and/or any other individual and/or party described herein, can access the central processing computer 10 via an appropriate computer or communication device. At step 1502, the user can select the training program which he or she wishes to train from. At step 1503, the central processing computer 10 will transmit the training scenario and/or information, including the symptoms and/or conditions of a hypothetical patient. The training scenario can include any one or more of text information, a video tapped file or video clip, audio information, and/or any other multimedia information.

At step 1504, the user can enter his or her diagnosis and prescribed treatment and/or treatments for the presented scenario and transmit same to the central processing computer 10. At step 1505, the user's diagnosis and prescribed treatment can be applied to the scenario. At step 1506, the central processing computer 10 will compare the diagnosis against any diagnosis or diagnoses which are known to be correct and/or against any scientific and/or statistical norms. At step 1506, the central processing computer 10 will apply the prescribed treatment or treatments to the hypothetical patient and compute a revised set of symptoms and/or conditions which can result from the applied treatment and/or treatments. Once again, statistical information can be utilized to arrive at a realistic response to the treatment and/or treatments. The user's diagnosis and prescribed treatment, as well as information regarding the correctness and/or viability of same can be recorded by the central processing computer 10 at step 1506.

At step 1507, the central processing computer 10 will transmit a response to the user's diagnosis and prescribed treatment. The response can include the patient's response to the prescribed treatment, and/or an evaluation of the diagnosis and prescribed treatment or treatments. The response can also include training materials, which can include any one or more of text information, video information, and/or audio information.

At step 1508, the user can review the material and/or information contained in the response and can decide whether he or she wishes to continue the training simulation. At step 1509, the user will transmit a response to the central processing computer 10 which contains an instruction to either continue the simulation, in which case the user's response will also include a revised diagnosis and prescribed treatment or treatments, or to terminate the training simulation.

At step 1510, the central processing computer 10 will receive and process the user's response provided at step 1509. At step 1511, the central processing computer 10 will determine whether the user desires to continue the simulation or whether the user desires to terminate the simulation. If, at step 1511, it is determined that the user desires to continue the training simulation, the operation of the central processing computer 10 returns to step 1505 and the above-described process will be repeated from step 1505. If, however, it is determined that the user desires to terminate the training simulation the operation of the apparatus 100 will cease at step 1512. User responses, including diagnostic and treatment decisions, and/or performance, can be recorded and/or can be stored and, thereafter the information can be utilized to evaluate the user and/or for comparing the user's progress and/or improvements, as well as aptitude and skills, in the pertinent field of training, and/or the information can be utilized for any other useful purpose.

In this manner the apparatus and method of the present invention can be utilized to provide an interactive healthcare training simulator which can be utilized for training in any and/or all of the fields of medicine, surgery, psychiatry, psychology, psychotherapy, dentistry, oral surgery, nutrition, health and fitness, and/or in any other healthcare and/or healthcare-related field.

Data and/or information collected and/or stored by the apparatus 100, which relates to symptoms and/or conditions, as well as responses to treatments, can be utilized in order to present realistic and confidential training scenarios. In this manner, the present invention can be utilized to compile a vast amount of information relating to the various fields of healthcare. The information can then be utilized to provide realistic training for providers and/or student providers. In this manner, the present invention can utilize information obtained from other preferred embodiments in order to provide simulated training scenarios.

In another preferred embodiment, the apparatus 100 and method of the present invention can be utilized in order to maintain patient healthcare records or files private and/or to safeguard patient healthcare records or files, by restricting and/or limiting access to the respective records or files.

The apparatus 100 and/or the central processing computer 10 can process information regarding the identity of, and/or the information which is authorized and/or allowed to be provided to, a requesting individual or entity who or which can be any individual, entity, patient, provider, payer, and/or intermediary, and/or any other individual or entity, who or which may request information regarding a patient's or an individual's healthcare records or file. Thereafter, the apparatus 100 and/or the central processing computer 10 can determine whether the respective information requesting individual or entity is authorized or allowed to access, obtain, and/or to change or alter any information contained in a respective patient's or individual's healthcare records or file.

The apparatus 100 and/or the central processing computer 10 can utilize and/or process passwords, electronic signatures, and/or any other information and/or encoded and/or encrypted information in determining an individual's or an entity's authorization to access, obtain, and/or change or alter, any information in a respective healthcare record(s) or file(s).

If the apparatus 100 and/or the central processing computer 10 determines that an individual or entity is authorized or allowed to access, obtain, and/or to change or alter, any information contained in a respective patient's or individual's healthcare record(s) or file(s), the apparatus 100 and/or the central processing computer 10 will respectively allow access to the information, provide the information, and/or process and store changes, alterations, and/or updates, to the respective healthcare record(s) or file(s). If, however, the apparatus 100 and/or the central processing computer 10 determines that an individual or entity is not authorized or not allowed to access, obtain, and/or to change or alter, any information contained in a respective patient's or individual's healthcare record(s) or file(s), the apparatus 100 and/or the central processing computer 10 will prohibit or disallow access to the information.

In another preferred embodiment of the apparatus 100 and method of the present invention, the apparatus 100 can provide notification to patients or other individuals when others have accessed, obtained, and/or made changes to, their respective healthcare records or files. The apparatus 100 can also provide notification to healthcare provider's, including but not limited to, the patient's or individual's provider or providers, and/or healthcare payers or insurance providers, including but not limited to, the patient's or individual's healthcare payer(s) or insurance provider(s), when others have accessed, obtained, and/or made changes to, their respective healthcare records or files.

It is envisioned that healthcare records or files can be accessed, obtained, changed, or altered, by any one or more of a patient, an individual, a relative of a patient, a relative of a an individual, an interested third party, a healthcare provider, a healthcare provider to the patient, a healthcare provider to the patient or individual, a healthcare payer, an insurance provider, and/or a healthcare payer or insurance provider of the patient or individual. In this manner, the apparatus 100 and method of the present invention can maintain and/or safeguard healthcare records or files for any of the patients and/or individuals described herein. In the same manner, the apparatus 100 and method of the present invention can also maintain and safeguard records and/or files of, or regarding any of the herein-described healthcare providers and/or healthcare payers.

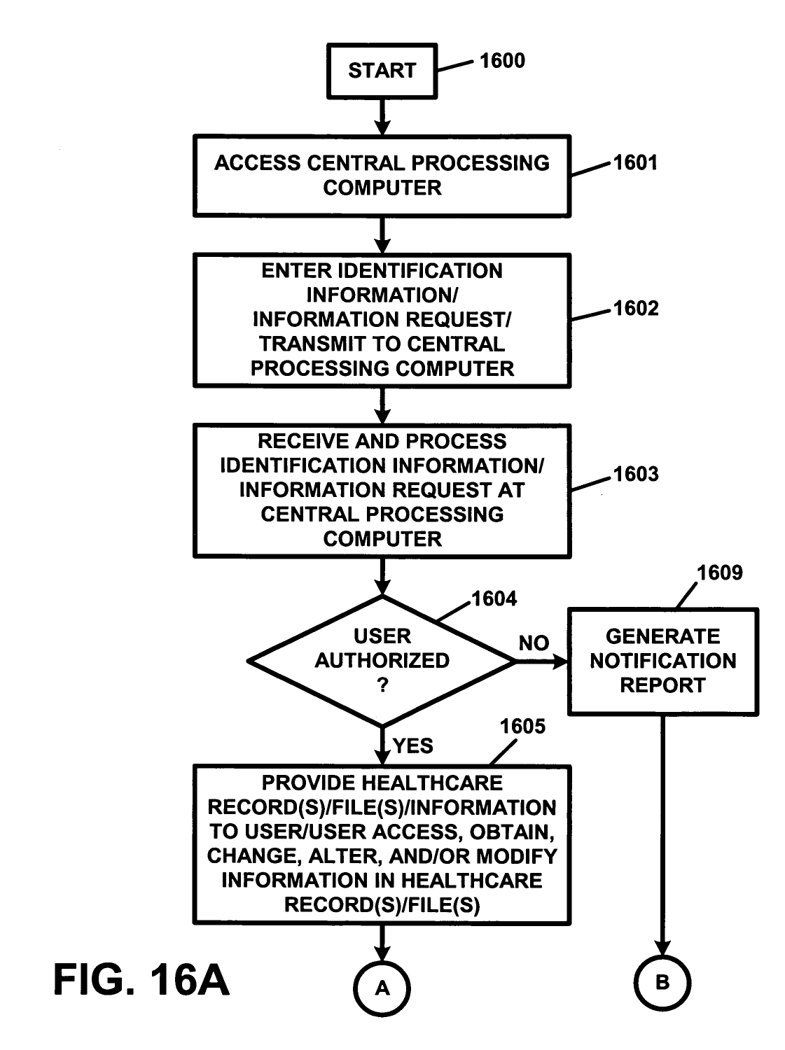

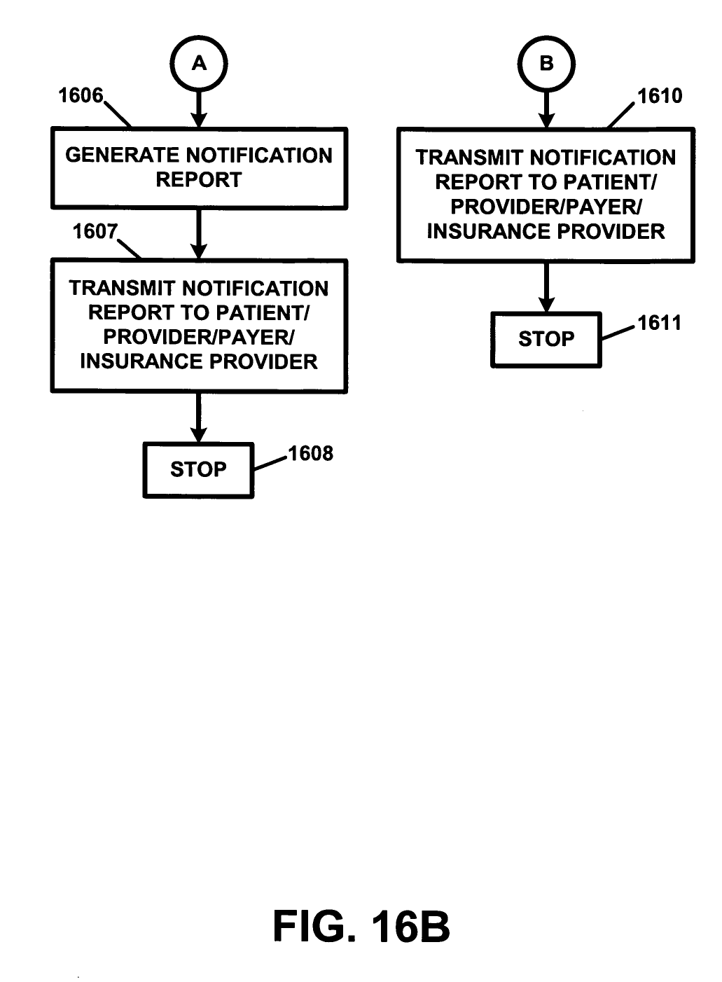

In another preferred embodiment, the apparatus 100 and method of the present invention can provide notification to a patient or individual when his or her healthcare record(s) or file(s), or any portion thereof, has been accessed, obtained, changed, altered, updated, and/or other modified, and/or when a request has been made to access, obtain, change, alter, update, and/or otherwise modify, his or her healthcare record(s) or file(s), or any portion thereof. FIGS. 16A and 16B illustrate another preferred embodiment method for utilizing the apparatus 100 of the present invention, in flow diagram form.

With reference to FIGS. 16A and 16B, the operation of the apparatus commences at step 1600. At step 1601, any one or more of a healthcare provider, a healthcare payer, an insurance provider, a patient, an individual, a relative of a patient or individual, and/or any other third party individual or entity (hereinafter referred to as “user”) can access the central processing computer 10 via a respective computer or communication device and/or via their or its respective computer or communication device.

For example, a healthcare provider can access the central processing computer in order to access, obtain, change, alter, or modify, information contained in a patient's healthcare record(s) or file(s) for any appropriate reason, such as, but not limited to, updating a record or file, making a diagnosis, prescribing a treatment, providing a treatment plan or program, providing information to other providers, submitting insurance claim information, etc., and/or for any other reason.

A healthcare payer or insurance provider can provider can access the central processing computer in order to access, obtain, change, alter, or modify, information contained in a patient's healthcare record(s) or file(s) for any appropriate reason, such as but not limited to, processing an insurance claim, obtaining additional information regarding the patient or individual, etc., and/or for any other reason.

A patient or individual can access, obtain, change, alter, or modify, information contained in a patient's healthcare record(s) or file(s) for any appropriate reason, such as, but not limited to, updating a healthcare record or file, providing information to a healthcare provider, providing information to a healthcare payer or insurance provider, obtaining treatment information, obtaining healthcare provider information, obtaining healthcare payer information, obtaining provider information, obtaining insurance provider information, etc., and/or for any other reason.

A third party individual or entity can also access, obtain, change, alter, or modify, information contained in a patient's healthcare record(s) or file(s) for any appropriate reason, such as, but not limited to, updating a healthcare record or file, providing information regarding a patient or patients, providing information regarding an individual or individuals, providing information to a healthcare provider, providing information to a healthcare payer or insurance provider, obtaining treatment information, obtaining healthcare provider information, obtaining healthcare payer information, obtaining provider information, obtaining insurance provider information, etc., and/or for any other reason.

At step 1602, the user can enter identification information, a password, an electronic signature, a code, and/or any other information which may be needed for accessing the data and/or information stored in the central processing computer 10. The identification information can be entered by the user and/or be provided by the user's computer or communication device. At step 1602, the user can also enter an information request and/or a request to access, obtain, change, alter, or modify, information contained in a patient's healthcare record(s) or file(s). At step 1602, the user's identification information and information regarding the user's request can also be transmitted to the central processing computer 10.

At step 1603, the central processing computer 10 will receive and process the user's identification information and information regarding the user's request. At step 1604, the central processing computer 10 will determine whether the user is an authorized user. At step 1604, the central processing computer 10 can also determine whether the user is authorized to access, obtain, change, alter, or modify, the requested patient healthcare record(s) or file(s) and/or whether the user is authorized to access, obtain, change, alter, or modify, the requested information contained in a patient's healthcare record(s) or file(s). If, at step 1604, the central processing computer 10 determines that the user is an authorized user and/or that the user is authorized to access, obtain, change, alter, or modify, the requested healthcare record(s) or file(s), the operation of the apparatus 100 will proceed to step 1605.

At step 1605, central processing computer 10 will provide the requested information and/or the information in requested healthcare record(s) or file(s) to the user. At step 1605, the user can any one or more of access any information contained in the respective healthcare record(s) or file(s), obtain any information contained in the respective healthcare record(s) or file(s), change any information contained in the respective healthcare record(s) or file(s), alter any information contained in the respective healthcare record(s) or file(s), update any information contained in the respective healthcare record(s) or file(s), and/or modify any information contained in the respective healthcare record(s) or file(s).

For example, a healthcare provider can obtain patient information, update a patients record(s) or file(s), submit an insurance claim, prescribe a treatment for the patient, and/or perform any other task on, or involving the information contained in the patient's healthcare record(s) or file(s). A patient or individual can update his or her own healthcare record(s) or file(s) information, such as by providing medical, dental, or healthcare history, symptoms, etc. A healthcare payer or insurance provider can update claim information, obtain information for processing and/or analyzing insurance claims, and/or perform any other task.

At step 1605, the respective user can obtain, access, change, alter, or modify, any of the information contained in the patient's healthcare record(s) or file(s), for which the user is authorized. At step 1605, the respective user can perform any task on, or regarding, the information contained in the patient's healthcare record(s) or file(s).

At step 1606, the central processing computer 10 will generate a notification report containing information regarding the user who or which obtained, accessed, changed, altered, or modified, the healthcare record(s) or file(s), user identification information, the time and date the user obtained, accessed, changed, altered, or modified, the healthcare record(s) or file(s), the reason for the user obtaining, accessing, changing, altering, or modifying, the healthcare record(s) or file(s), the nature of any changes, alterations, or modifications, made to the information contained in the healthcare record(s) or file(s), the subject of, and/or the actual, changes, alterations, or modifications, made to the healthcare record(s) or file(s), and/or any other information regarding the user's obtaining, accessing, changing, altering, or modifying, the information contained in the healthcare record(s) or file(s).

At step 1607, the central processing computer 10 will transmit the notification report to the patient or individual whose healthcare record(s) or file(s) were accessed by the user. The notification report can be transmitted as an e-mail message, as a beeper message, as a pager message, as a telephone call, as a pre-recorder telephone call message, as an electronic transmission, and/or as any other information transmission or message. The notification report can be transmitted to the patient, to the patient computer 40, and/or to a patient communication device.

At step 1607, the notification report can also be transmitted to the patient's healthcare provider or healthcare providers, to the patient's healthcare payer or healthcare payers, to the patient's insurance provider or insurance providers, and/or to any third party individuals or entities authorized to receive the notification report. The notification report can be transmitted to any of the respective computers or communication devices associated with the respective healthcare provider(s), healthcare payer(s), insurance provider(s), and/or third party individual(s), entity, or entities.

Thereafter, the operation of the apparatus 100 will cease at step 1608.

If, however, at step 1604, it is determined that the user is not an authorized user and/or that the user is not authorized to access, obtain, change, alter, or modify, the requested healthcare record(s) or file(s), or any information contained therein, then the operation of the apparatus 100 will proceed to step 1609.

At step 1609, the central processing computer 10 will generate a notification report containing information regarding the user who or which attempted to obtain, access, change, alter, or modify, the healthcare record(s) or file(s), user identification information, the time and date of the user's attempted access of the healthcare record(s) or file(s), the reason for the user's attempted access of the healthcare record(s) or file(s), and/or any other information regarding the user's attempted access of the healthcare record(s) or file(s).

At step 1610, the central processing computer 10 will transmit the notification report to the patient or individual whose healthcare record(s) or file(s) were attempted to be accessed by the user. The notification report can be transmitted as an e-mail message, as a beeper message, as a pager message, a physical letter/mail delivery, as a telephone call, as a pre-recorder telephone call message, as an electronic transmission, and/or as any other information transmission or message. The notification report can be transmitted to the patient, to the patient computer 40, and/or to a patient communication device.

At step 1610, the notification report can also be transmitted to the patient's healthcare provider or healthcare providers, to the patient's healthcare payer or healthcare payers, to the patient's insurance provider or insurance providers, and/or to any third party individuals or entities authorized to receive the notification report. The notification report can be transmitted to any of the respective computers or communication devices associated with the respective healthcare provider(s), healthcare payer(s), insurance provider(s), and/or third party individual(s), entity, or entities.

Any of the notification reports described herein as being provided by the apparatus 100 of FIGS. 16A and 16B can be transmitted to the respective patient, individual, healthcare provider, healthcare payer, insurance provider, and/or third party, in real-time, in a time-delayed manner, and/or in any other appropriate manner.

Thereafter, the operation of the apparatus 100 will cease at step 1611.

In another preferred embodiment of FIGS. 16A and 16B, a respective patient, individual, healthcare provider, healthcare payer, insurance provider, and/or third party, upon receiving notification that an individual or entity is any one or more of accessing, obtaining, changing, altering, and/or modifying, information contained in a healthcare record or file, can terminate the accessing, obtaining, changing, altering, and/or modifying, information contained in a healthcare record or file, in real-time, such as by transmitting a “terminate” or “deny access” message or signal to the central processing computer 10 via a respective computer or communication device.

In another preferred embodiment, the apparatus 100 of FIGS. 16A and 16B, and in particular, the central processing computer 10, can store information regarding any accessing, obtaining, changing, altering, and/or modifying, of any of the information contained in any of the healthcare records and/or healthcare files by any of the herein-described healthcare providers, healthcare payers, insurance providers, patients, individuals and/or third parties.

The stored information can include any one or more of the data, time, reason, purpose, and/or the nature, of the accessing, obtaining, changing, altering, and/or modifying, of any of the information contained in any of the healthcare records and/or healthcare files by any of the herein-described healthcare providers, healthcare payers, insurance providers, patients, individuals and/or third parties. The stored information can also include the subject matter of any changes, alterations, and/or modifications, to the healthcare record(s) or file(s).

The central processing computer 10 can generate and/or provide activity reports regarding any accessing, obtaining, changing, altering, and/or modifying, of any of the information contained in any of the healthcare records and/or healthcare files by any of the herein-described healthcare providers, healthcare payers, insurance providers, patients, individuals and/or third parties. The central processing computer 10 can generate activity reports upon demand and/or upon request. The central processing computer 10 can also be programmed to generate activity reports periodically, such as daily, weekly, monthly, bi-monthly, quarterly, annually, and/or for any other time period.

The activity reports can include information regarding any number of healthcare records or files for any number of patients or individuals.

The central processing computer 10 can transmit the activity reports to the respective healthcare providers, healthcare payers, insurance providers, patients, individuals and/or third parties, by transmitting same to a respective computer or communication device associated with the respective

healthcare provider(s), healthcare payer(s), insurance provider(s), patient(s), individual(s), third party, and/or third parties. The activity report can be transmitted as an e-mail message, as a beeper message, as a pager message, a physical letter/mail delivery, as a telephone call, as a pre-recorded telephone call message, as an electronic transmission, and/or as any other information transmission or message.

Any of the activity reports described herein as being provided by the apparatus 100 of FIGS. 16A and 16B can be transmitted to the respective patient, individual, healthcare provider, healthcare payer, insurance provider, and/or third party, in real-time, in a time-delayed manner, and/or in any other appropriate manner.

In another preferred embodiment, the apparatus 100 can be utilized in order to allow patients and individuals to restrict and/or limit access to their healthcare records or files. In this manner, the patient or individual can restrict access of information contained in his or her healthcare record(s) or file(s) to only certain healthcare providers, healthcare payers, healthcare insurance providers, individuals, and/or entities. In this manner, the patient or individual can restrict access to his or her healthcare record information or healthcare file information to his or her healthcare provider(s), to his or her healthcare payer(s), to his or her insurance provider(s), to his or her relatives, family members, spouse, next-of-kin, and/or any other designated individual, individuals, entity, or entities.

The patient or individual can also restrict access to, the ability to obtain, the ability to change, alter, or modify, any information contained in his or her healthcare record(s) or file(s) to only certain information, certain portions of information, certain subject matter. For example, a patient or individual can restrict a medical doctor's access to his or her dental records, dental files, psychological files, etc. A patient can restrict a healthcare payer's access to unrelated or irrelevant information. A patient or individual can also restrict a third party individual's access to certain information.

The patient or individual can restrict access to any of his or her healthcare record(s) or file(s), and/or to any portions or sections of same, by any of the herein-described healthcare providers, healthcare payers, insurance providers, and/or any third party individual or entities, to that extant that said restricted access can be is lawful and/or legal. The patient or individual can also restrict access to any of his or her healthcare record(s) or file(s), and/or to any portions or sections of same, by any of the herein-described healthcare providers, healthcare payers, insurance providers, and/or any third party individual or entities, to the extent sufficient or necessary in order to maintain confidentiality, to keep certain information secret or accessible to a select few, and/or to address patient privacy concerns.

The patient or individual can also limit access to information, by any of the herein-described healthcare providers, healthcare payers, insurance providers, and/or any third party individual or entities, to only certain information or sections of information contained in his or her healthcare record(s) or file(s), and/or to limit access to certain information or sections of information contained in his or her healthcare record(s) or file(s), for use for only specifically designated purposes.

For example, a patient or individual can limit a healthcare provider's access to certain medical history information only to the extent that said information can be utilized to perform a diagnosis for a certain ailment(s), illness, or symptom(s), and/or to allow for the submission of an insurance claim, and/or for any other reason. A patient or individual can also, for example, limit an healthcare payer's or an insurance provider's access to certain information to the extent of verifying or disproving certain conditions, pre-existing conditions, to process an insurance claim submission, and/or for any other reason.

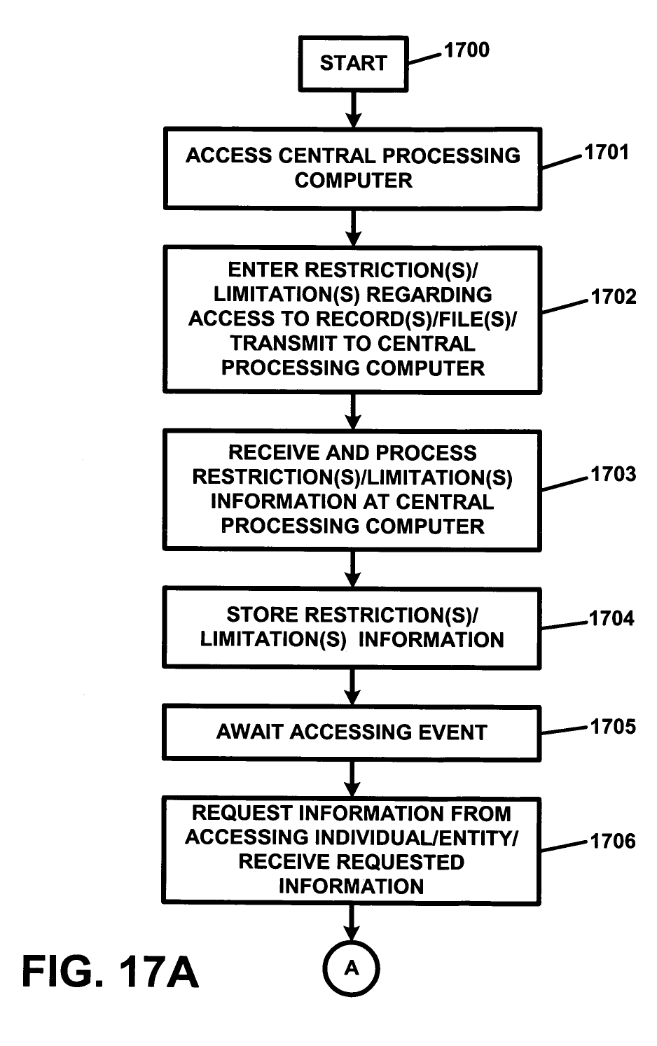

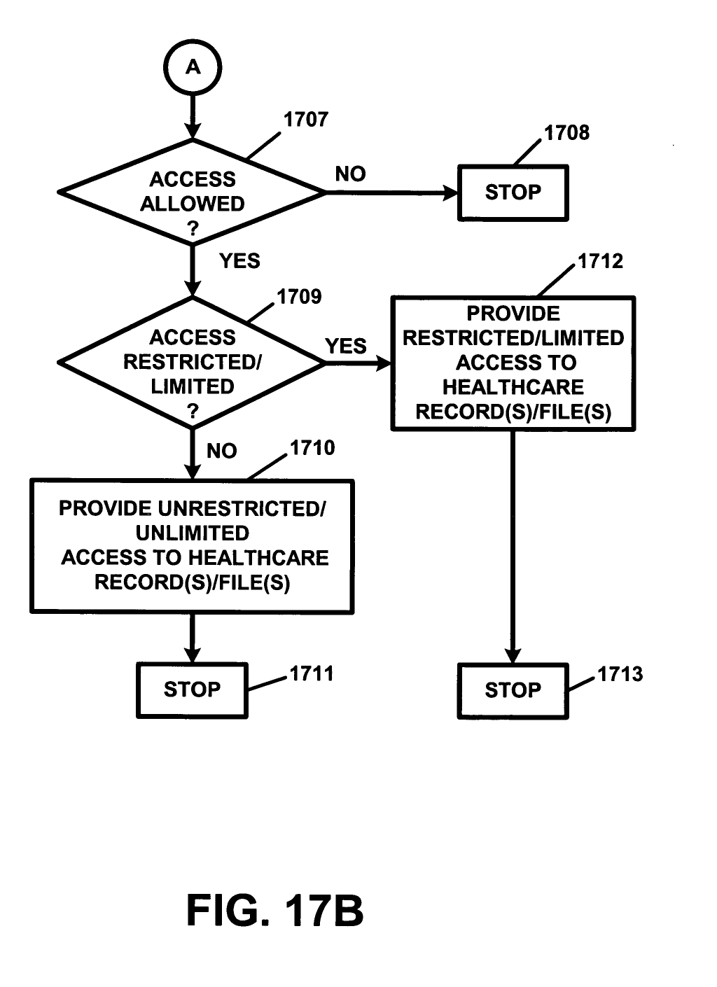

FIGS. 17A and 17B illustrate another preferred embodiment method of utilizing the apparatus 100 of the present invention in flow diagram form. With reference to FIGS. 17A and 17B, the operation of the apparatus 100 commences at step 1700. At step 1701, the patient or individual (hereinafter referred to as the “patient”) can access the central processing computer 10 via his or her patient computer 40. At step 1702, the patient can enter information regarding the restrictions and/or limitations on the access to his or her healthcare record(s) or file(s).

At step 1702, the patient can enter information regarding any restrictions and/or limitations to the access to his or her healthcare record(s) or file(s) to only a certain healthcare provider(s), a certain type of healthcare provider(s), to a certain healthcare payer(s), a certain type of healthcare payer(s), a certain insurance provider(s), a certain type of insurance provider(s), a certain individual(s), third party, or third parties.

At step 1702, the patient can also restrict and/or limit access to his or her healthcare record(s) or file(s), or any information and/or portions of information contained in his or her healthcare record(s) or file(s), for only certain designated purposes (i.e. diagnosis, second opinions, insurance claims submission, insurance claims processing, etc.).

The patient can also restrict and/or limit access to his or her healthcare record(s) or file(s), or any information and/or portions of information contained in his or her healthcare record(s) or file(s), to certain times, days, dates, or other designated times. The patient can also restrict and/or limit access to his or her healthcare record(s) or file(s), or any information and/or portions of information contained in his or her healthcare record(s) or file(s), until such time as certain pre-conditions are met.

For example, the pre-condition can be the establishment of a doctor-patient relationship, the establishment of an insured-insurer relationship, the establishment of a family or next-of-kin relationship, and/or the satisfaction of any condition or pre-condition which can be defined by, or dictated by, any of the herein-described patients, healthcare providers, healthcare payers, insurance providers, and/or third parties). The patient can also restrict or limit the ability of a healthcare provider, a healthcare payer, an insurance provider, a patient, an individual, and/or a third party, to obtain, access, change, alter, or modify, any information contained in the patient's healthcare record(s) or file(s).

The patient can enter any other restriction or limitations to access to his or her healthcare record(s) or file(s), and/or to any information and/or portions of information contained therein, at step 1702.

At step 1702, the restriction or limitation information can be transmitted to the central processing computer 10. At step 1703, the central processing computer 10 will receive and process the restriction and/or limitation information in conjunction with the patient's healthcare record(s) or file(s). At step 1704, the central processing computer 10 will store the restriction or limitation information in the database 10H.

At step 1705, the apparatus 100 will await the accessing of the central processing computer 10 by any individual, healthcare provider, healthcare payer, insurance provider, and/or any third party, who or which desires to access the patient's healthcare record(s) or file(s). Upon the attempted accessing of the patient's healthcare record(s) or file(s) by any of the herein-described individuals, healthcare providers, healthcare payers, insurance providers, and/or any third parties, the operation of the apparatus 100 will proceed to step 1706. At step 1706, the apparatus 100 and/or the central processing computer 10 can request information from the individual, healthcare provider, healthcare payer, insurance provider, and/or any third party, who or which desires to access the patient's healthcare record(s) or file(s).

The requested information can include the name or identity of the individual, healthcare provider, healthcare payer, insurance provider, and/or any third party, the type, nature, or credentials, of the individual, healthcare provider, healthcare payer, insurance provider, and/or third party, the nature or purpose of the requested access of the patient's healthcare record(s) or file(s), information regarding the satisfaction and/or the existence of any conditions or pre-conditions to access of the patient's healthcare record(s) or file(s) and/or to any information and/or sections of information contained in the healthcare record(s) or file(s).

At step 1706, the central processing computer 10 can receive the individual's, the healthcare provider's, the healthcare payer's, the insurance provider's, and/or the third party's, response(s) to the requested information. At step 1707, the central processing computer 10 will determine if the individual's, the healthcare provider's, the healthcare payer's, the insurance provider's, and/or the third party's, access is allowed.

If, at step 1707, it is determined that the individual's, the healthcare provider's, the healthcare payer's, the insurance provider's, and/or the third party's, access is not allowed the operation of the apparatus 100 will cease at step 1708. If, at step 1707, it is determined that the individual's, the healthcare provider's, the healthcare payer's, the insurance provider's, and/or the third party's, access is allowed, the operation of the apparatus 100 will proceed to step 1709.

At step 1709, the central processing computer 10 will determine whether the individual's, the healthcare provider's, the healthcare payer's, the insurance provider's, and/or the third party's, access is restricted or limited. If, at step 1709, it is determined that the individual's, the healthcare provider's, the healthcare payer's, the insurance provider's, and/or the third party's, access is not restricted or not limited, then the operation of the apparatus 100 will proceed to step 1710. At step 1710 the apparatus 100 and/or the central processing computer 10 will provide the respective individual, healthcare provider, healthcare payer, insurance provider, and/or the third party, with unrestricted and/or with unlimited access to the patient's healthcare record(s) or file(s). Thereafter, the operation of the apparatus will cease at step 1711.

If, at step 1709, it is determined that the individual's, the healthcare provider's, the healthcare payer's, the insurance provider's, and/or the third party's, access is restricted or is limited, then the operation of the apparatus 100 will proceed to step 1712. At step 1712, the apparatus 100 and/or the central processing computer 10 will provide the respective individual, healthcare provider, healthcare payer, insurance provider, and/or the third party, with the restricted and/or with the limited access to the patient's healthcare record(s) or file(s). Thereafter, the operation of the apparatus will cease at step 1713.

In another preferred embodiment, a provider can utilize the apparatus 100 and method of the present invention to issue prescriptions or scripts for medicines, medications, or drugs, to pharmacies on a patient's or an individual's behalf, or to issue prescriptions or scripts for procedures, tests, analyses, analysis work-ups, blood work, treatments, therapy, therapy sessions, physical therapy, physical therapy sessions, or any other prescribed goods, services, or activities, or to issue referrals to other healthcare providers or providers of any other goods or services. In this regard, the apparatus 100 and method of the present invention can be used by a provider to issue a prescription, or an electronic prescription or e-prescription, or to issue a referral, via the central processing computer 10 and/or via a healthcare record or healthcare file of a patient or an individual.

In this embodiment, the provider can generate the respective prescription or referral via his or her provider computer or communication device 20 using the central processing computer 10 or information contained in a patient's or an individual's healthcare record or healthcare file, and can then transmit the respective prescription or referral to a respective pharmacy, provider, therapist, or other provider of healthcare services or wellness services, or providers of any other goods or services. A copy of the respective prescription or referral can be stored in the database 10H, the healthcare record or the healthcare file of the patient or the individual, the provider's computer or communication device 20, and/or can be transmitted to the provider's computer or communication device 20, to the payer computer or communication device 30 of the insurer or payer of the patient or the individual, to the patent's or the individual's patient computer or communication device 40, or to an intermediary's intermediary computer or communication device 50.

In another preferred embodiment, the central processing computer 10, in processing information for generating the respective prescription or referral can perform any drug-drug and drug-allergy interaction checks.

In another preferred embodiment, the healthcare provider or a healthcare facility can place orders for medications, medicines, drugs, supplies, or other goods or services, with a respective supplier or provider of same by placing the order via the central processing computer 10. The central processing computer 10 can then forward the order to a respective provider computer or communication device 20 associated with the respective supplier or provider.

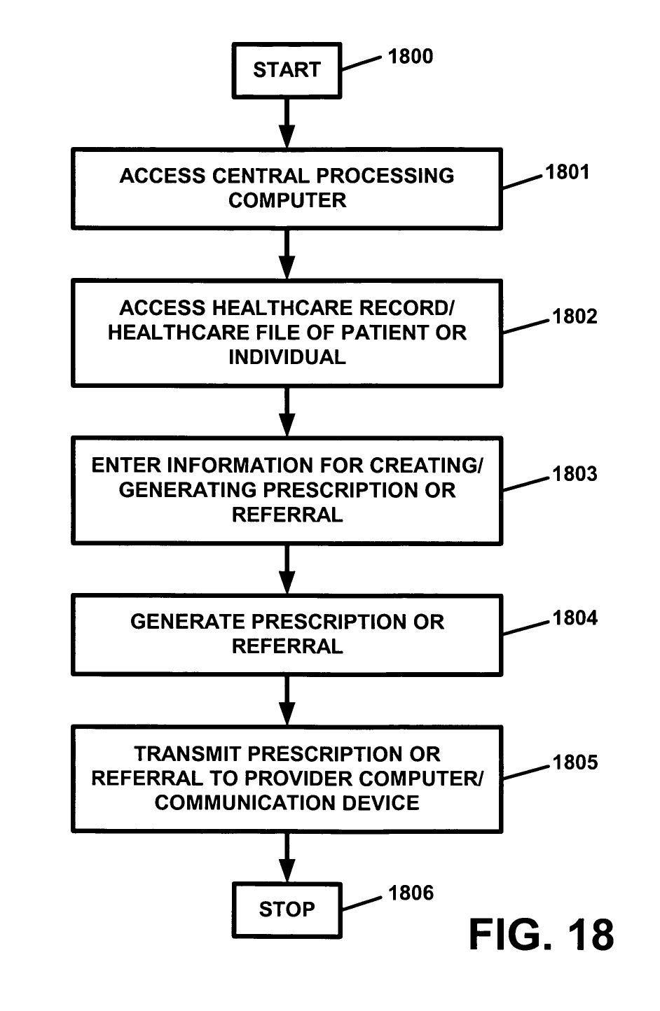

FIG. 18 illustrates, in flow diagram form, another preferred embodiment method for utilizing the apparatus 100 and method of the present invention in order to allow a provider to issue a respective prescription for a medicine, a medication, or a drug, to a pharmacy on a patient's or an individual's behalf, or to issue a respective prescription or script for a procedure, a treatment, a therapy, a therapy session, a physical therapy, a physical therapy session, or any other prescribed good, service, or activity, for or on behalf of a patient or an individual, or to issue a respective referral to a healthcare provider or a provider of any goods or services for or on behalf of a patient or individual. With reference to FIG. 18, the operation of the apparatus 100 commences at step 1800.

At step 1801, the provider can access the central processing computer 10 via his or her provider computer or communication device 20. At step 1802, the provider can access the healthcare record or the healthcare file of the patient or the individual. At step 1803, the provider can enter information for creating or generating a prescription or a referral for the patient or the individual via the provider computer or communication device 20. In the case of creating or generating a prescription, the provider can enter information for generating a prescription script or a prescription form containing information regarding a prescription for a medication, a medicine, a drug, a procedure, a test, an analysis, an analysis work-up, blood work, a treatment, a therapy, a therapy session, physical therapy, a physical therapy session, a course of physical therapy, or any other prescribed good, service, or activity, for the patient or the individual. In the case of creating or generating a referral or a referral form, the provider can enter information for generating a referral or a referral form containing information regarding a referral to a healthcare provider or any other provider of a good or service.

At step 1804, the central processing computer 10 can generate the respective prescription or script, or the prescription form, or can generate the respective referral or the referral form, using the information entered by the provider and/or by using any pertinent information stored in the patient's or the individual's healthcare record or healthcare file.

At step 1805, the central processing computer 10 can transmit the respective prescription or script, or prescription form, or the respective referral or referral form, to a provider computer or communication device 20, which, in the case of a prescription, is associated with or used by the provider who or which is to fulfill the prescription, such as a pharmacy in the case of a prescription for a medicine, a medication, or a drug, or to a provider, lab, healthcare care facility, or other entity, who or which is to perform the prescribed service or services or who or which is the provide the prescribed goods, or, in the case of a referral, the referral can be transmitted to a provider computer or communication device 20 associated with or used by the provider to which the patient or the individual is referred for a respective service or good. In instances where a respective provider utilizes a facsimile machine or fax machine to receive prescriptions or referrals, the prescription or referral can be transmitted to the provider's facsimile machine or fax machine. At step 1805, a copy of the respective prescription or script or prescription form, or a copy of the respective referral or referral form, can be stored in the patient's or the individual's healthcare record or healthcare file, and/or can be transmitted to and/or stored at the prescribing or referring provider's provider computer or communication device 20, can be transmitted to the payer computer or communication device 30 of the insurer or payer of the patient or the individual, can be transmitted to the patent's or the individual's patient computer or communication device 40, or can be transmitted to an intermediary's intermediary computer or communication device 50.

Thereafter, the operation of the apparatus 100 will cease at step 1806.

In another preferred embodiment, the apparatus 100 and method of the present invention can be used to provide for the remote control and/or monitoring of healthcare devices, healthcare equipment, blood pressure measurement devices, blood pressure monitoring devices, heart rate or pulse rate measurement devices or monitoring devices, blood-sugar measurement devices or monitoring devices, EKG measurement or monitoring devices, medicine or drug dispensing devices or equipment, medicine or drug feeding devices or equipment, feeding devices or equipment, or any other device or equipment described herein which can be used to monitor or to care for an individual or patient. In this regard, the apparatus 100 and method of the present invention can be utilized to provide telehealth or telemedicine services or functions.

In another preferred embodiment, the present invention can be used to control or monitor, or to receive and/or store any data or information provided by, any of the healthcare devices or healthcare equipment described herein.

The healthcare device(s) or healthcare equipment can, for example, include, but not be limited to, any of the aforementioned healthcare devices, healthcare equipment, blood pressure measurement devices, blood pressure monitoring devices, heart rate or pulse rate measurement devices or monitoring devices, blood-sugar measurement devices or monitoring devices, EKG measurement or monitoring devices, medicine or drug dispensing devices or equipment, medicine or drug feeding devices or equipment, feeding devices or equipment, or any other herein-described device or equipment which can be used to monitor or to care for an individual or patient. The healthcare device(s) or healthcare equipment can also be any one or more of, and/or any combination of, a thermometer, a digital thermometer, a stethoscope, a heart rate monitor or measurement device, a pulse rate monitor or measurement device, a blood pressure monitor or measurement device, a blood pressure measurement device, a blood analysis device or machine, a respirator, a respiration monitoring or measurement device, a dialysis machine, a dialysis device, an electrocardiograph (EKG) machine or device, an electrocephalograph (EEG) machine or device, an electromyograph (EMG) machine or device, a magnetic resonance imaging (MRI) machine or device, an X-ray machine or device, a medical imaging machine or device, a thermal imaging machine or device, a heart sound monitor or measurement device, a lung sound monitoring or measurement device, a respiration rate monitoring or measurement device, a laprascopic device, an arthroscopic device, a vascular testing device, a catheter device, a cardiac performance testing, monitoring, or measurement, device, a pulmonary performance testing, monitoring, or measurement, device, a vascular system performance monitoring or measurement device, a vascular system testing, monitoring, or measurement, device, a metabolism monitoring or measurement device, a sonogram imaging device, a sonogram measurement device, a sonograph device, an optical response device, an optical response measurement device, an intravenous device, an arterial blood pressure measurement or monitoring device, a respiration rate measurement or monitoring device, an ultrasound imaging device, an ultrasound measurement device, a CAT SCAN device, a PET scan device, an optical metabolism measurement or monitoring device, a radiotelemetric device, a doppler medical device, a mammogram device, a carbon dioxide detection or measurement device, a carbon monoxide detection or measurement device, a transvascular impedence measurement or monitoring device, an ultrasonic imaging device, a bone conduction device, a brain function scan analyzer device, an external pulse cardiac monitoring or measurement device, a fetal heart rate measurement, monitoring, or probing, device, an endotrachial cardiac monitoring device, a finger tip blood pressure monitoring device, a psychological monitoring device, a surgical instrument, a vital signs measurement device, an ear pressure regulating device, a phonocardiograph device, an acoustic aneurysm detector device, a blood oxygen detection device, an esophageal probing device, an ultrasonic probing device, an ausculoscope, a vital signs monitoring system, a heart activity monitoring device, a pulmonary activity monitoring device, a sphygmomanometer, an esophageal stethoscope, a venous pressure measuring device, a differential doppler device, a physiological data measuring device, a body tissue movement device, a breathalyzer device, a camera probing device, a microscopic camera probing device, and/or any other bio-metric or physiological data measuring device(s) and/or data acquisition device(s).

The healthcare device or healthcare equipment can also be, or can include, a camera, a video camera, a video recording device, a microphone, an audio recording device, a telephone, a video conferencing device, a device for storing pictures, photographs, images, video, audio, and/or related data or information, which device can be located in a room or other location where an individual or patient can be located or situated in order to allow the individual or patient to be observed and/or in order to allow for communication with the individual or patient.

In another preferred embodiment, the respective healthcare device or healthcare equipment being used can be implantable in the patient or individual or can be worn, or can be wearable, by the patient or individual in any appropriate manner. In another preferred embodiment, the respective healthcare device or healthcare equipment being used can be any mobile or wireless device or can include a mobile or wireless communication device. In another preferred embodiment, the respective healthcare device or healthcare equipment being used can be worn or integrated with any type or kind of clothing or accessory. The respective healthcare device or healthcare equipment being used can also be worn or integrated with any type or kind of item of jewelry, a watch, a bracelet, a necklace, or any other wearable item.

In another preferred embodiment, the respective healthcare device or healthcare equipment, which can be any one or any combination of any of the herein-described devices or equipment, or any implantable or wearable device, can also be, or can also include, all of the components of a patient computer or communication device 40 associated with or used by a patient or individual, or can be, or can be utilized as, an input device 40D of the patient computer or communication device 40.

In a preferred embodiment, in an situation where a healthcare device or healthcare equipment, or a plurality of healthcare devices(s) or a plurality of pieces of healthcare equipment, is or are to be utilized in connection with the apparatus 100 of the present invention, in order allow a healthcare provider, provider, insurer, payer, or any intermediary or third party, or another individual, to remotely monitor a patient or an individual, or to remotely control or monitor a healthcare device or healthcare equipment for a patient or an individual, information, a link, or a hyperlink, corresponding to, or associated with, each healthcare device or each piece of healthcare equipment, assigned to or used for a patient or an individual, can be stored in the database 10H, or in the healthcare record or healthcare file of the patient or the individual.

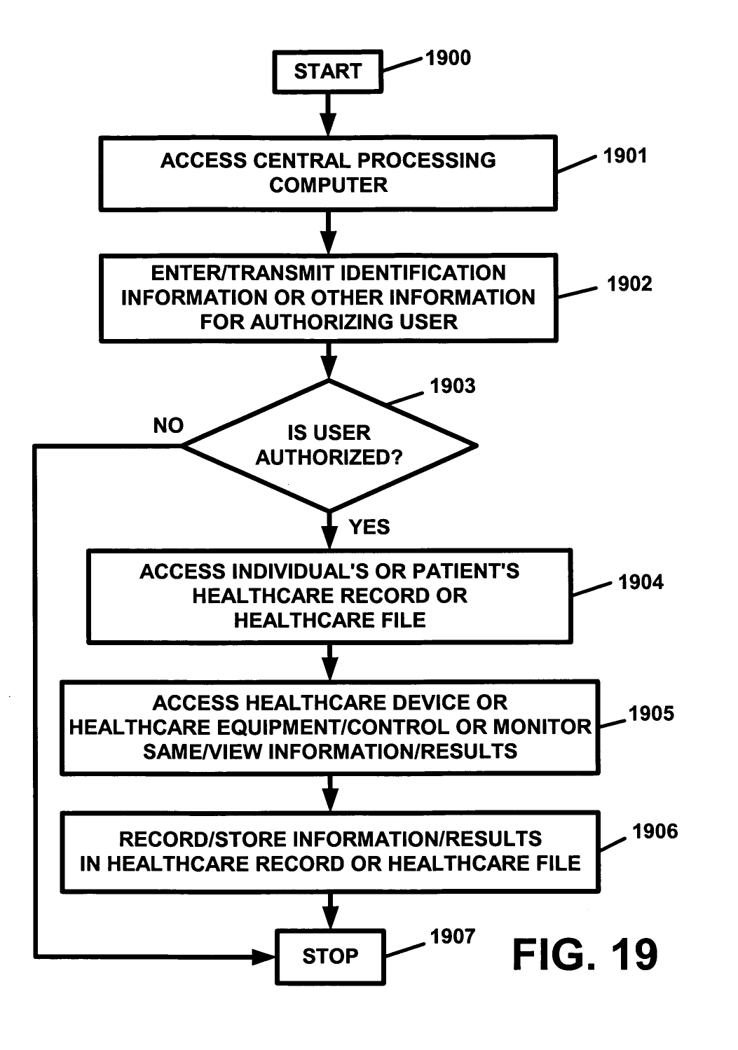

FIG. 19 illustrates, in flow diagram form, another preferred embodiment method for utilizing the apparatus 100 and method of the present invention in order to allow, or to facilitate, a remote monitoring of a patient or an individual by a healthcare provider, a provider, an insurer, a payer, or any intermediary or third party, or another individual, and/or which allows or facilitates a remote control and/or monitoring of a healthcare device or piece of healthcare equipment, used to monitor or to care for the patient or the individual, by a healthcare provider, a provider, an insurer, a payer, or any intermediary or third party, or any other individual.

With reference to FIG. 19, the operation of the apparatus 100 commences at step 1900. At step 1901, the respective healthcare provider, provider, insurer, payer, or any intermediary or third party, or any other individual, can utilize a respective provider computer or communication device 20, a payer computer or communication device 30, a patient or user computer or communication device 40, an intermediary computer or communication device, or any other computer or communication device, in order to access the central processing computer 10. At step 1902, the respective healthcare provider, provider, insurer, payer, or any intermediary or third party, or any other individual, can enter and transmit to the central processing computer 10, and the central processing computer 10 can receive, store, or process, any appropriate identification information, authorization information, an access code, a password, or any other data or information, which can be used to ensure that the respective healthcare provider, provider, insurer, payer, or any intermediary or third party, or any other individual, is authorized to access the central processing computer 10, is authorized to perform a remote control or monitoring operation regarding the individual or patient, or is authorized to access the healthcare record or the healthcare file of the individual or patient.

At step 1903, the central processing computer 10 will determine whether or not the respective healthcare provider, provider, insurer, payer, or any intermediary or third party, or any other individual, is authorized to access the central processing computer 10, is authorized to perform a remote control or monitoring operation regarding the individual or patient, or is authorized to access the healthcare record or the healthcare file of the individual or patient. If, at step 1903, the central processing computer 10 determines that the respective healthcare provider, provider, insurer, payer, or any intermediary or third party, or any other individual, is not authorized to access the central processing computer 10, is not authorized to perform a remote control or monitoring operation regarding the individual or patient, or is not authorized to access the healthcare record or the healthcare file of the individual or patient, the operation of the apparatus 100 will cease at step 1907. If, at step 1903, the central processing computer 10 determines that the respective healthcare provider, provider, insurer, payer, or any intermediary or third party, or any other individual, is authorized to access the central processing computer 10, is authorized to perform a remote control or monitoring operation regarding the individual or patient, or is authorized to access the healthcare record or the healthcare file of the individual or patient, the operation of the apparatus 100 will proceed to step 1904.

At step 1904, the respective healthcare provider, provider, insurer, payer, or any intermediary or third party, or any other individual, can then access the individual's or the patient's healthcare record or healthcare file, and select the respective healthcare device or healthcare devices, or the healthcare equipment or pieces of healthcare equipment which he or she desires to access, control, or monitor. The respective healthcare provider, provider, insurer, payer, or any intermediary or third party, or any other individual, can then access the healthcare device or healthcare devices or the healthcare equipment or pieces of healthcare equipment by using data or information obtained from the individual's or the patient's healthcare record or healthcare file. The respective healthcare provider, provider, insurer, payer, or any intermediary or third party, or any other individual, can also access the healthcare device or healthcare devices or the healthcare equipment or pieces of healthcare equipment via an appropriate link or hyperlink to each respective healthcare device or healthcare equipment, which link or hyperlink can be stored in, accessed via, or otherwise obtained from, the individual's or the patient's healthcare record or healthcare file.

At step 1905, the respective healthcare provider, provider, insurer, payer, or any intermediary or third party, or other individual, can then access the healthcare device or healthcare equipment. As and for an illustrative example, and for the sake or simplicity, in a situation where an individual or patient is under a healthcare provider's care for high blood pressure, the healthcare provider, seeking to monitor an individual's or a patient's blood pressure, can access the patient's blood pressure measurement device, which is the healthcare device in this example, and obtain, and record, a blood pressure measurement or reading for the individual or patient. In a preferred embodiment, where this blood pressure reading can be performed live such as by appointment, the healthcare provider can take the individual's or patient's blood pressure live or in real-time. A same, a similar, or an analogous, method can also be employed using any of the other herein-described healthcare devices or healthcare equipment. In another preferred embodiment, the individual or patient can take his or her own blood pressure measurement or reading, or can take it with the help or assistance of another individual, and the measurement or reading can be stored in the blood pressure measurement device. Likewise, a same, a similar, or an analogous, method can also be employed using any of the other herein-described healthcare devices or healthcare equipment.

At step 1905, the healthcare provider can also control an operation of the respective healthcare device or healthcare equipment, can monitor an operation of the respective healthcare device or healthcare equipment, or can view or observe data, information, video, audio, or other information provided by the healthcare device or healthcare equipment. At step 1905, the healthcare provider can also view results obtained or recorded by the healthcare device or healthcare equipment, retrieve previously stored or recorded information or results obtained via or with the healthcare device or healthcare equipment, or can perform any desired operation, function, or task, with or using the healthcare device or healthcare equipment. At step 1905, the healthcare provider can also activate a video camera, a microphone or audio recording device, video conferencing equipment, a telephone, or an intercom, so as to communicate with the individual or patient or any other person.

Upon obtaining the information or results from the healthcare device, the healthcare provider can then, at step 1906, view and store or record the obtained information or results in the individual's or patient's healthcare record or healthcare file. In instances when multiple healthcare devices or multiple pieces of healthcare equipment are to be accessed, steps 1905 and 1906 can be repeated as described above for each healthcare device or for each piece of healthcare equipment. Upon the completion of the operation at step 1906, the operation of the apparatus 100 will cease at step 1907.

In another preferred embodiment of the present invention, the apparatus 100 can be used by any of the herein-described healthcare providers, providers, insurers, payers, intermediary, intermediaries, third party, third parties, or any other individual or person, in order to remotely access, control, monitor, obtain information from, or otherwise use, any of the herein-described, or any other electrically or electronically controlled or operated, healthcare device or piece of healthcare equipment.

In another preferred embodiment, an individual or patient, or a person assisting the individual or patient, can also use a healthcare device or healthcare equipment in order to obtain information or results regarding the individual or patient and to store or record the obtained information or results in the healthcare device or healthcare equipment or in a personal computer or any other computer. In this embodiment, the healthcare provider can access the respective healthcare device, healthcare equipment, personal computer, or other computer, and can retrieve, obtain, or upload, the information or results. The healthcare provider can then review and store or record the obtained information or results in the individual's or patient's healthcare record or healthcare file.

In another preferred embodiment, an individual or patient, or a person assisting the individual or patient, can use a healthcare device or healthcare equipment in order to obtain information or results regarding the individual or patient and store or record the obtained information or results in the healthcare device or healthcare equipment or in a patient computer or communication device 40. Thereafter, the individual or patient, or the person assisting the individual or patient, can access the central processing computer 10 using the patient computer or communication device 40, access the individual's or patient's healthcare record or healthcare file, and transmit the information or results to the central processing computer 10, and the information or results can then be stored in the individual's or patient's healthcare record or healthcare file. Thereafter, a respective healthcare provider, provider, insurer, payer, or any intermediary or third party, or any other individual, can access the central processing computer 10, access the individual's or patient's healthcare record or healthcare file, and obtain or review the information or results.

In another preferred embodiment, the embodiment of FIG. 19 can be used by a respective healthcare provider, provider, insurer, payer, or any intermediary or third party, or any other individual, in order to monitor an individual or patient at home, at work, in a hospital, at a healthcare facility, during an operation or a procedure, during a test, during an office visit with another provider, during an MRI, a Cat Scan, a PET scan, or any other procedure, during an exercise session, while asleep, while on vacation, while in surgery, during a stress test, or at any other time or place.

In another preferred embodiment, the embodiment of FIG. 19 can be used by a respective healthcare provider, provider, insurer, payer, or any intermediary or third party, or any other individual, in order to monitor an individual or patient while they are located at any type or kind of premises, including, but not limited to, a residential premises, a commercial premises, or a healthcare facility or premises, or while they are located in, or traveling in, any type of land, sea, air, or space vehicle. The embodiment of FIG. 19 can also be used by a respective healthcare provider, provider, insurer, payer, or any intermediary or third party, or any other individual, in order to monitor an individual or patient while they are located at, or while they are located in, or traveling in, a motor vehicle, an automobile, a mass transportation vehicle, a truck, a tractor trailer, a bus, a school bus, a commercial vehicle, commercial equipment, industrial equipment, a military vehicle, a snowmobile, a jetski, a scooter, a recreational vehicle, a motorcycle, a minibike, a go-cart, a moped, an unmanned vehicle, a train, a subway train, an aircraft, an airplane, a jet, a helicopter, a glider, a spacecraft, a space shuttle, a satellite, an unmanned aircraft, a commercial aircraft, a military aircraft, a boat, a marine vessel, a marine vehicle, a motor boat, a sailboat, a ship, a cruise ship, a commercial boat, a military boat, an unmanned boat, or a submarine. In the above-described embodiment, any necessary or appropriate information, or a link(s) or hyperlink(s), for facilitating access to the respective premises, vehicle, healthcare device, or healthcare equipment, or for facilitating an accessing, a controlling, or a monitoring, of any healthcare device, healthcare equipment, video device, audio device, videoconferencing device, or communication device, can be provided or stored, or otherwise made available, in the individual's or patient's healthcare record or healthcare file, or in the central processing computer 10 or in the database 10H of same.

In another preferred embodiment, the embodiment of FIG. 19 can be used by a respective healthcare provider, provider, insurer, payer, or any intermediary or third party, or any other individual, to be virtually or remotely present while an individual or patient is being examined, cared for, or treated, by another provider. For example, if an individual or patient is injured while traveling abroad and is treated at a hospital, the individual's or patient's primary care physician can be contacted and, when provided with appropriate information, a link, or a hyperlink, can remotely access and monitor the examination session or a procedure, and/or can communicate with and/or confer with the treating provider, the individual or patient, and/or any other individual or person. In a preferred embodiment, the primary care physician can be contacted via an e-mail message or other message. Any necessary or appropriate information, or a link(s) or hyperlink(s), for facilitating access to the respective premises, vehicle, healthcare device, or healthcare equipment, or for facilitating an accessing, a controlling, or a monitoring, of any healthcare device, healthcare equipment, video device, audio device, videoconferencing device, or communication device, can be provided or stored, or otherwise made available, in the individual's or patient's healthcare record or healthcare file, or in the central processing computer 10 or in the database 10H of same.

In another preferred embodiment of the embodiment of FIG. 19, a respective healthcare provider, provider, insurer, payer, or any intermediary or third party, or any other individual, can control a dispensing of a medication, a medicine, or a drug, can dispense a medication, a medicine, or a drug, to the individual or patient so as to administer same to the individual or patient, can issue an emergency call for help or a 911 call, can issue a prescription for a medication, a medicine, or a drug, or can issue a referral for a good or a service.

In another preferred embodiment, any and/or all information, links, or hyperlinks, needed to perform any of the functionality, functions, or operations, described herein with reference to the embodiment of FIG. 19, can be stored in, and/or can be obtained from, the healthcare record or healthcare file of the individual or patient, thereby providing a healthcare record or healthcare file having a remote monitoring, remote care, remote care management, remote control, or telehealth or telemedicine, capability.

In any and/or all of the herein-described embodiments, an individual, a patient, a provider of an individual or patient, a payer or insurer of an individual or patient, or any authorized third party or intermediary, can, if so authorized, access the individual's or the patient's healthcare record or healthcare file and obtain any of the data, information, measurements, readings, vital signs, photographs, pictures, video clips, transcripts, audio clips, X-rays, MRI image, CAT scan, or PET scan, or other scan films or scan results, test results, lab test results, any measurements or readings obtained with or from any healthcare device or healthcare equipment, healthcare histories, prescriptions, referrals, records, files, insurance claims, payment histories, or any other data or information described herein as being provided, processed, or stored, by, from, or in, the apparatus 100 and/or method of the present invention, the central processing computer 10 or the database 10H of same, or any healthcare record, healthcare file, or healthcare history. The individual, patient, a provider of an individual or patient, a payer or insurer of an individual or patient, or any authorized third party or intermediary, can access the central processing computer 10 via a respective computer or communication device, which can be any one of the herein-described computers or communication devices 20, 30, 40, or 50, or any other computer or communication device, can access the individual's or patient's healthcare record or healthcare file, and can request or select, and can be provided with the desired data, information, photograph(s), picture(s), video clip(s), transcript(s), audio clip(s), X-rays, MRI image, CAT scan, or PET scan, or other scan films or scan results, test results, lab test results, any measurements or readings obtained with or from any healthcare device or healthcare equipment, healthcare history or histories, prescription(s), referral(s), record(s), file(s), insurance claim(s), payment history or histories, or any other data or information described herein as being provided, processed, or stored, by, from, or in, the apparatus 100 and/or method of the present invention, the central processing computer 10 or the database 10H of same, or any healthcare record, healthcare file, or healthcare history.

In any and/or all the herein-described embodiments, the apparatus 100 or the central processing computer 10, can also provide information regarding ICD, ICD-10, ICD-9, or other codes, diagnostic codes, symptom codes, treatment codes, billings codes, or any other codes or information useful in entering patient or individual information into a healthcare record or a healthcare file of the patient or individual. In this manner, the present invention can provide any individual, patient, user, provider, payer, insurer, third party or intermediary, or any other individual or person using the apparatus 100 of the present invention, with accurate and current data or information, so as to ensure that any information described herein as being stored in the healthcare records or healthcare files of individuals or patients, any records or files of providers, payers, insurers, third parties, or intermediaries, or any insurance claims, prescriptions, referrals, or other information, described herein as being processed, generated, or stored, by the apparatus 100 of the present invention, is accurate, correct, and up-to-date with current standards in the healthcare field and/or in related fields.

In any and/or all of the herein-described embodiment, any appropriate rules algorithms can be utilized by the apparatus 100, by the central processing computer 10, and/or by any of the computers or communication devices 20, 30, 40, or 50, so that all processing routines, data or information storing routines, insurance claim generation routines, or prescription or referral generation routines, are performed, created, or generated, correctly and accurately, and/or pursuant to current standards in the healthcare filed or related fields.

In any and/or all of the embodiments described herein, any patient, provider, payer, user, and/or intermediary can access any one or more of the central processing computer(s) 10, the providers communication devices (20), the payer communication devices 30, the patient communication devices 40, and/or the intermediate communication devices 50, via any one or more of the said computers and/or communication devices 10, 20, 30, 40, and/or 50, as well as via any computer and/or communication device. In this manner, any of the herein-described parties can access the present invention from any computer and/or communication device. Public kiosks with links to any of the computers and/or communication devices 10, 20, 30, 40, and/or 50, can also be utilized to access and utilize the present invention and/or any of the computers and/or communication devices described herein.

In any and/or all of the embodiments described herein, access to any and/or all of the data, information, records. files, etc., which is stored in any of the databases 10H, 20H, 30H, 40H, and/or 50H, can be restricted to preserve the security and confidentiality of same. Any of the patients, users, providers, payers, and/or intermediaries, can be provided with identification and/or other cards with any and/or all pertinent data regarding the respective individual and/or party provided on the card.

The identification card, in the preferred embodiment can contain a magnetic strip for storing any and/or all pertinent information, a “smart card” for storing information, and/or a bar code or bard codes for storing identification information as well as any other information described herein as being pertinent to the respective patient, user, provider, payer, and/or intermediary.

Each of the central processing computer(s) 10, the providers communication devices 20, the payer communication devices 30, the patient communication devices 40, and/or the intermediate communication devices 50, as well as any other computer and/or communication device, can include suitable devices for reading, scanning, and/or obtaining information which may be stored on the identification card. In this manner, access to the present invention, and the respective use thereof, can be facilitated by the above-described identification card(s).

In another preferred embodiment, an identification card or device can also be utilized to store any and/or all pertinent information regarding an individual or patient, such as, but not limited to, identification information, contact information, any of the healthcare information or medical, dental, surgical, or other history, files, records, or any other information described herein as being stored in the database 10H regarding the individual or patient, information regarding the individual's or patient's providers, payers, insurance company or companies or healthcare insurance information, information regarding an emergency contact or contacts or next of kin contact information, and/or any other information regarding the individual or patient which is described herein as being utilized or provided via the apparatus 100 of the present invention. In a preferred embodiment, the identification card or device can be, or can include, a “smart” card or device or a microprocessor or other computer chip and a memory device for storing any of the herein-described information regarding the individual or patient.

In another preferred embodiment, the identification card or device can also include any of the devices described herein as being included in the patient communication device 40, such as, for example, an input device, a receiver for receiving data or information via a communication network, and/or a transmitter for transmitting data or information via a communication network of for providing voice communication via a communication network, and/or a display device for displaying data or information. In another preferred embodiment, the identification card or device can include any of the components described herein which can be included in the patient communication device 40 of FIG. 5. In this regard, the identification card or device can contain any of the devices or components 40A, 40B, 40C, 40D, 40E, 40F, 40G, 40H, and/or 401 illustrated in FIG. 5.

In another preferred embodiment, the identification card or device can also be utilized by the individual or patient, or by another person, in order to make a 911 or other emergency call in case the individual or patient needs to call for emergency help or emergency medical help or assistance. In another preferred embodiment, the identification card or device can take the form of, or be included in, a patient communication device 40. In another preferred embodiment, data or information in the individual's or patient's healthcare history, record, or file, described herein as being stored in the database 10H, can be accessed by the identification card or device and can be downloaded to the identification card or device. In another preferred embodiment, the identification card or device and all of its component parts can be implemented in or as a cellular telephone, a mobile telephone, a wireless telephone, a personal digital assistant, a beeper, a pager, an electronic wallet, a conventional wallet, a purse, or a tote or a pocket book, an electronic personal valet, a watch, a bracelet, an article of jewelry, a locket, a wearable article, or a wearable article of clothing. In this manner, the identification card or device can be carried by the individual or patient at any time or at all times and can contain any of the herein-described healthcare or healthcare-related information of or pertaining to the individual or patient which is described herein as being stored in the database 10H. In another preferred embodiment, the identification card or device, or the information contained therein or thereon, can be stored in, or can take the form of, a device which can be implantable within the human body. In another preferred embodiment, the identification card or device, or the information contained therein or thereon, can be stored in, or can take the form of, a device which can worn by, or which can be wearable by, an individual or patient. In this regard, any authorized provider or authorized person may obtain access to the individual's or patient's healthcare information or healthcare-related information in or during an emergency or in or during a treatment setting. For example, if the individual or patient is traveling abroad or at a distance from home, emergency or medical or healthcare personnel, called upon to treat or otherwise attend to the individual or patient in an emergency or other treatment setting, can gain access to the individual's or patient's medical or healthcare information or other healthcare-related information in order to provide appropriate treatment and/or care for the individual or patient.

In another preferred embodiment, the database 10H, as well as any of the other herein-described databases 20H, 30H, 40H, and/or 50H, can also contain language translation information or software so that any of the data or information described herein as being stored in the respective database(s), or as being provided by the apparatus 100 of the present invention, can be translated into any language necessary. In this regard, if the individual or patient may need to seek healthcare in a foreign country, information in the individual's or patient's healthcare history, record, or file, can be accessed and translated into the language of the provider or other person who is attending to the individual or patient, or who is seeking or attempting to provide care, or to administer care, to or for the individual or patient, or who may otherwise be attempting to assist the individual or patient in any other manner deemed necessary or appropriate. In this regard, any information described herein as being stored in the database 10H, as well as any of the other herein-described databases 20H, 30H, 40H, and/or 50H, any diagnostic reports, treatment reports, evaluation reports, or any other messages or reports described herein as being generated or provided by the apparatus 100 of the present invention, or any other data, information, materials, reports, results, news reports, news information, news reports, published reports, theses, study reports, or any other data or information regarding described herein, which can be generated by or provided by or via the apparatus 100, can be translated upon request into any requested language.

In a preferred embodiment, the requesting person or entity can access the central processing computer 10 via any suitable communication device or computer, request the information and the language into which the requested information is to be translated. Thereafter, the central processing computer 10 will receive and process the request, retrieve the requested information from the database 10H, translate same into the requested language, and generate a message containing the requested information in the translated language. Thereafter, the central processing computer 10 will transmit the message to the communication device or computer of the requesting person or entity.

Any data or information, or any function, described-herein as capable of being provided by or performed by the apparatus 100 of the present invention, can, if needed, be translated or converted, by the apparatus 100 of the present invention, or by the central processing computer 10 or by any of the computers or communication devices 20, 30, 40, or 50, or any other device, used in connection with the present invention, into a foreign language or a foreign language counterpart or can be translated or converted into a corresponding foreign language code or information. In an preferred embodiment, any translation or conversion can be performed automatically in response to a respective individual, patient, healthcare provider, provide, payer, insurer, intermediary, or third party, registering or requesting a language preference or translation or conversion request or order with the apparatus 100 at any time, or in response to a request or a selection to provide, display, of store, the data or information, or code, or to convert the data or information, or code, into a foreign language at any time. In a preferred embodiment, any individual, patient, healthcare provider, provide, payer, insurer, intermediary, or third party, can view any information or information screens provided by the apparatus 100 in any selected foreign language, can request and be provided with a translation or a conversion of any data, information, or codes, described herein, into any selected foreign language, or can generate or transmit any claim forms, claims, requests, messages, reports, of other information, in any selected foreign language.

In a preferred embodiment, any translation or conversion from one language to another can be performed using a pre-stored look-up table, stored in the database 10H, containing or having foreign language translations or foreign language counterparts of data, information, or codes, which can be used, stored, processed, or generated, in connection with the use of any of the embodiments or functionality of the apparatus 100 of the present invention described herein. In a preferred embodiment, any translation or conversion can also be performed using a language translation or code translation software of processing routines. In a preferred embodiment, the apparatus 100 of the present invention can translate or convert any of the data or information, or any codes, described herein, into any number of foreign languages. In a preferred embodiment, information in any look-up tables can be entered and stored manually so as to ensure accurate, correct, and up-to-date translations. In another preferred embodiment, the apparatus 100 or the central processing computer 10 can perform any translations or conversions using language translation software or processing routines.

In another preferred embodiment, any or all of the International Classification of Diseases (ICD) codes, ICD-10 codes, ICD-9, or any other ICD codes, or any other codes, billing codes, diagnostic codes, treatment codes, symptom codes, as well as any other codes or coding information which pertains to healthcare, the administration of healthcare services, healthcare record keeping, healthcare billing, healthcare diagnostics, healthcare treatments, or any of the healthcare or healthcare-related functions or services, or any information or function described-herein as capable of being provided by the apparatus 100 and method of the present invention, can, if needed, be translated by the apparatus 100, by the central processing computer 10, or by any of the other computers or communication devices 20, 30, 40, and/or 50, into a foreign language or translated or converted into a foreign language counterpart or corresponding code or information. In a preferred embodiment, any translation or conversion can be performed automatically in response to a respective individual, patient, healthcare provider, provider, payer, insurer, intermediary, or third party, or any other person, registering or selecting a language preference with the apparatus 100 or with the central processing computer 10 at any time.

In another preferred embodiment, the apparatus 100 and method of the present invention can be used to provide, and the database 10H can contain, information regarding audits or other information regarding, for each payer or insurer, the payer's or the insurer's responsiveness to process or pay claims, the payer's or the insurer's time to pay claims, information regarding why the payer or the insurer rejects a claim or has rejected a claim, claim rejection information regarding the payer or the insurer, claims allowed information regarding the payer or the insurer, payment rates or schedules for goods or services paid for by the payer or the insurer, reimbursement rates paid by the payer or the insurer, or any other information which can be used to provide information regarding the payer or the insurer. In this embodiment, the apparatus 100 or the central processing computer 10 can record or store information regarding each and every claim submitted to a payer or an insurer, as well as information regarding the payer's or the insurer's responsiveness to process or pay claims, the payer's or the insurer's time to pay claims, information regarding why the payer or the insurer rejects a claim or has rejected a claim, claim rejection information regarding the payer or the insurer, claims allowed information regarding the payer or the insurer, payment rates or schedules for a good or a service paid for by the payer or the insurer, reimbursement rates paid by the payer or the insurer, and/or any other information which can be used to provide information regarding the payer or the insurer.

Any time a respective individual, patient, healthcare provider, provider, insurer, payer, or any intermediary or third party, or any other individual, desires to obtain any of the herein-described or other information regarding the payer or the insurer, he, she, or it, can access the central processing computer 10 via a respective provider computer or communication device 20, a payer computer or communication device 30, a patient computer or communication device 40, or an intermediary computer or communication device 50, or any other computer or communication device, and request and obtain a payer or insurer report. In this manner, the apparatus 100 and method of the present invention can be used to audit a payer or an insurer or to monitor any of the herein-described or other pertinent information regarding the payer or the insurer.

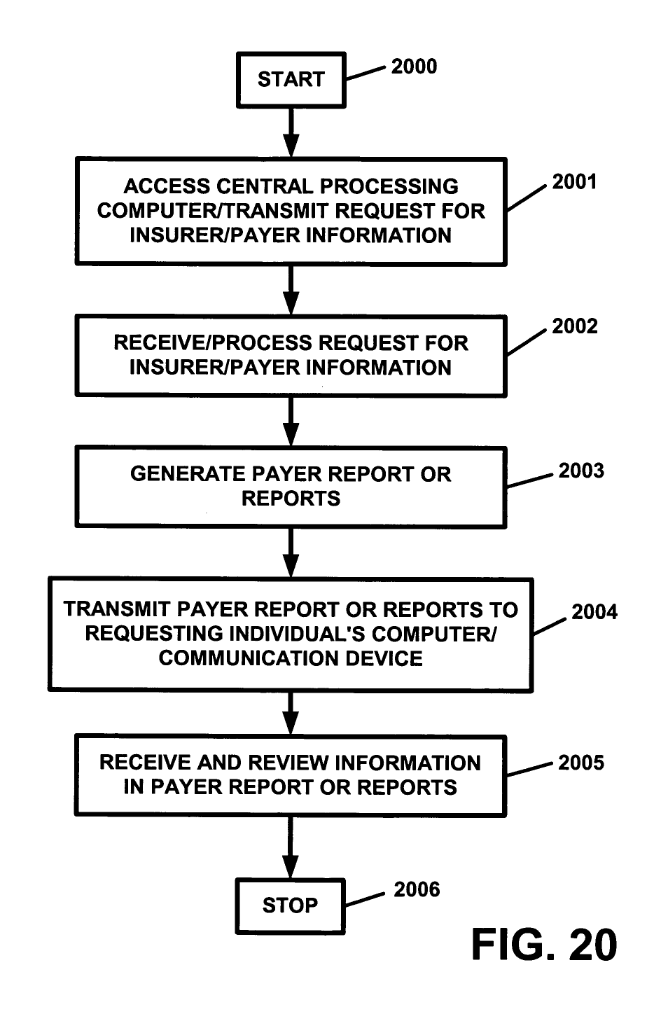

FIG. 20 illustrates, in flow diagram form, another preferred embodiment method for utilizing the apparatus 100 and method of the present invention in order to audit a payer or an insurer or to monitor any of the herein-described or other pertinent information regarding the payer or the insurer.

With reference to FIG. 20, the operation of the apparatus 100 commences at step 2000. At step 2001, the respective individual, patient, healthcare provider, provider, insurer, payer, or any intermediary or third party, or any other individual, desiring to obtain any of the herein-described or other information regarding the payer or the insurer, can access the central processing computer 10 via a respective computer or communication device 20, 30, 40, or 50, or via any other computer or communication device. At step 2001, the respective individual, patient, healthcare provider, provider, insurer, payer, or any intermediary or third party, or any other individual, can transmit the request to obtain, for a particular payer or insurer, or for particular payers or insurers, any one or more of the, or each, payer's or insurer's responsiveness to process or pay claims, the, or each, payer's or insurer's time to pay claims, information regarding why the, or each, payer or insurer rejects a claim or has rejected a claim, claim rejection information regarding the, or each, payer or insurer, claims allowed information regarding the, or each, payer or insurer, payment rates or schedules for goods or services paid for by the, or each, payer or insurer, reimbursement rates paid by the, or each, payer or insurer, or any other information which can be used to provide information regarding the, or each, payer or insurer.

At step 2002, the central processing computer 10 will receive and process the request or requests, process or gather data of information from the database 10H and/or from any healthcare records or healthcare files stored in the database 10H, or perform any necessary querying operations or functions with, on, or using, the data or information stored in the database 10H. At step 2003, the central processing computer 10 will generate a payer report or reports containing data or information responsive to the request or requests. At step 2004, the report or reports can be transmitted to the respective computer or communication device 20, 30, 40, or 50, or any other computer or communication device, associated with or used by the respective requesting individual, patient, healthcare provider, provider, insurer, payer, or any intermediary or third party, or any other individual. At step 2005, the report or reports can be received by the respective computer or communication device, and the respective requesting individual, patient, healthcare provider, provider, insurer, payer, or any intermediary or third party, or any other individual, can review the data or information contained in the report or reports. Thereafter, the operation of the apparatus will cease at step 2006.

In another preferred embodiment, a respective individual, patient, healthcare provider, provider, insurer, payer, or any intermediary or third party, or any other individual, can program the apparatus 100, or the central processing computer 10, to generate and to send, or transmit to, him, her, or it, any of the herein-described or other payer reports or insurer reports at any time, at various time intervals, on certain specified dates, quarterly, semi-annually, annually, or at any time, or upon the occurrence or a pre-specified event or events. In this preferred embodiment, a respective individual, patient, healthcare provider, provider, insurer, payer, or any intermediary or third party, or any other individual, can program the apparatus 100, or the central processing computer 10, such as by registering the request or requests at any time in order to receive future payer reports or insurer reports. Any payer reports or insurer reports can be stored in the database 10H for later retrieval or use by any user of the apparatus 100.

In another preferred embodiment, the apparatus 100 and method of the present invention can be used to audit or monitor a healthcare provider, healthcare providers, or any other provider or providers described herein. In this regard, the apparatus 100 and method of the present invention can be used to provide, and the database 10H can contain, information regarding, for each healthcare provider or other provider, the respective healthcare provider's or other provider's insurances accepted, fees, fee schedules, claim success rates, diagnosis success rates, treatment success rates, time to update patient healthcare record or healthcare file from service time or date, time to submit insurance claims from service time or date, number of visits per illness, patient or client satisfaction information or comments, patient or client reviews, malpractice claims made against the healthcare provider, complaints made against the healthcare provider, satisfaction ratings, competence ratings, number of patients or clients under care, and/or any other information regarding the healthcare provider or other provider.

Any time a respective individual, patient, healthcare provider, provider, insurer, payer, or any intermediary or third party, or any other individual, desires to obtain any of the herein-described or other information regarding a healthcare provider or other provider, he, she, or it, can access the central processing computer 10 via a respective provider computer or communication device 20, a payer computer or communication device 30, a patient computer or communication device 40, an intermediary computer or communication device 50, or any other computer or communication device, and request and obtain a provider report. In this manner, the apparatus 100 and method of the present invention can be used to audit a healthcare provider or other provider or to obtain or monitor any of the herein-described or other pertinent information regarding the healthcare provider or other provider.

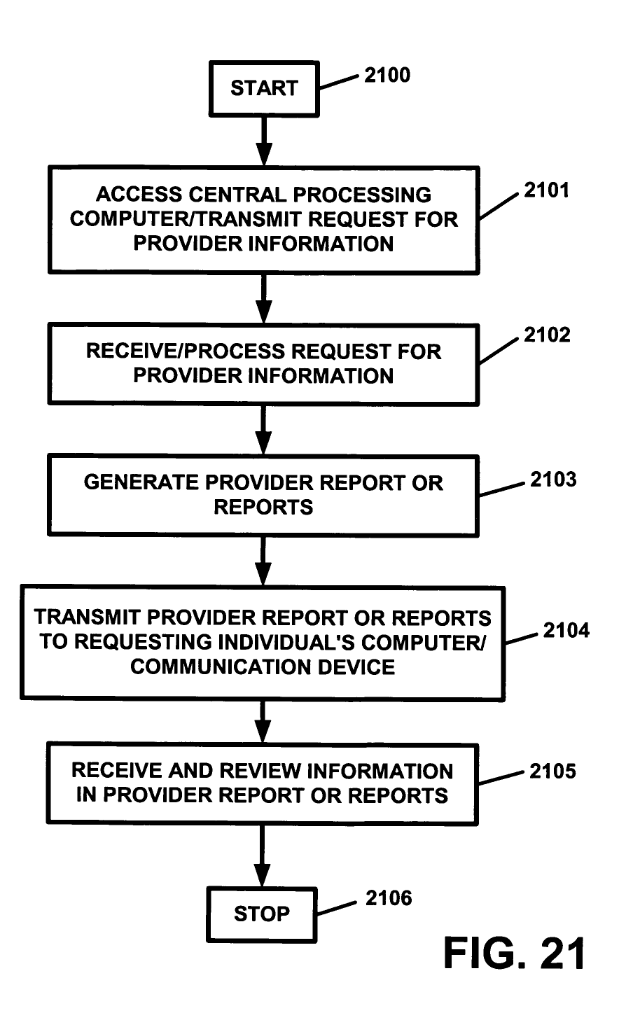

FIG. 21 illustrates, in flow diagram form, another preferred embodiment method for utilizing the apparatus 100 and method of the present invention in order to audit a healthcare provider or other provider or to obtain or monitor any of the herein-described or other pertinent information regarding the healthcare provider or other provider. With reference to FIG. 21, the operation of the apparatus 100 commences at step 2100.

At step 2101, the respective individual, patient, healthcare provider, provider, insurer, payer, or any intermediary or third party, or any other individual, desiring to obtain any of the herein-described or other information regarding the healthcare provider or other provider, can access the central processing computer 10 via a respective computer or communication device 20, 30, 40, or 50, or via any other computer or communication device. At step 2001, the respective individual, patient, healthcare provider, provider, insurer, payer, or any intermediary or third party, or any other individual, can transmit the request to obtain, for a particular healthcare provider or other provider, or for particular healthcare providers or other providers, any one or more of the, or each, healthcare provider's or other provider's insurances accepted, fees, fee schedules, claim success rates, diagnosis success rates, treatment success rates, time to update patient healthcare record or healthcare file from service time or date, time to submit insurance claim from service time or date, number of visits per illness, patient or client satisfaction information or comments, patient or client reviews, malpractice claims made against the healthcare provider, complaints made against the healthcare provider, satisfaction ratings, competence ratings, number of patients or clients under care, and/or any other information regarding the healthcare provider or other provider.

At step 2102, the central processing computer 10 will receive and process the request or requests, process or gather data of information from the database 10H, and/or from any healthcare records or healthcare files stored in the database 10H, or perform any necessary querying operations or functions with, on, or using, the data or information stored in the database 10H. At step 2103, the central processing computer 10 will generate a provider report or reports containing data or information responsive to the request or requests. At step 2104, the report or reports can be transmitted to the respective computer or communication device 20, 30, 40, or 50, or any other computer or communication device, associated with or used by the respective requesting individual, patient, healthcare provider, provider, insurer, payer, or any intermediary or third party, or any other individual. At step 2105, the report or reports can be received by the respective computer or communication device, and the respective requesting individual, patient, healthcare provider, provider, insurer, payer, or any intermediary or third party, or any other individual, can review the data or information contained in the report or reports. Thereafter, the operation of the apparatus 100 will cease at step 2106.

In another preferred embodiment, a respective individual, patient, healthcare provider, provider, insurer, payer, or any intermediary or third party, or any other individual, can program the apparatus 100, or the central processing computer 10, to generate and send, or transmit to, him, her, or it, any of the herein-described or other provider reports at any time, at various time intervals, on certain specified dates, quarterly, semi-annually, annually, or at any time, or upon the occurrence or a pre-specified event or events. In this embodiment, a respective individual, patient, healthcare provider, provider, insurer, payer, or any intermediary or third party, or any other individual, can program the apparatus 100 such as by registering the request or requests at any time in order to receive future provider reports. Any provider reports can be stored in the database 10H for later retrieval or use by any user of the apparatus 100.

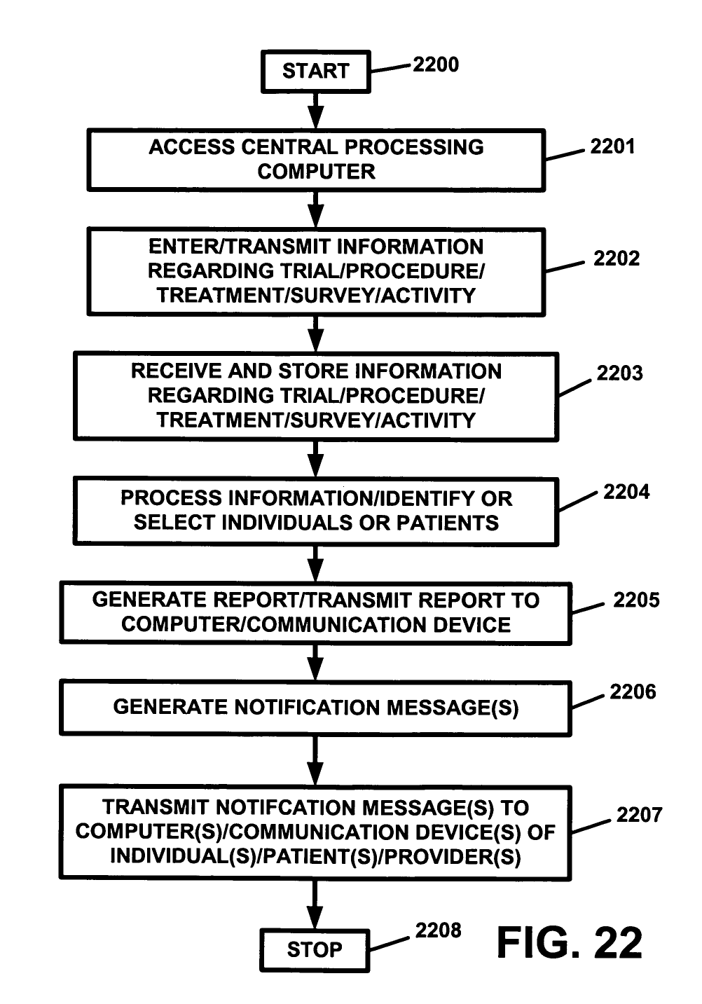

In another preferred embodiment, the apparatus 100 and method of the present invention can be utilized in order to identify or select individuals or patients for clinical trials, experimental procedures, experimental treatments, healthcare focus groups, healthcare surveys, or for any other activities or events which involve one or more individuals or patients. FIG. 22 illustrates, in flow diagram form, another preferred embodiment method for utilizing the apparatus 100 and method of the present invention in order to identify or select individuals or patients for clinical trials, experimental procedures, experimental treatments, healthcare focus groups, healthcare surveys, or for any other activities or events which involve one or more individuals or patients. With reference to FIG. 22, the operation of the apparatus 100 commences at step 2200. At step 2201, an individual or user seeking to identify or select one or more individuals or patients for a clinical trial, an experimental procedure, an experimental treatment, a healthcare focus group, a healthcare survey, or any other activity or event, can access the central processing computer 10 via a respective computer or communication device 20, 30, 40, or 50, or any other computer or communication device.

At step 2202, the individual or user can enter information or criteria regarding the respective clinical trial, experimental procedure, experimental treatment, healthcare focus group, healthcare survey, or the other activity or event, into the respective computer or communication device 20, 30, 40, or 50, or any other computer or communication device, and can transmit the respective information or criteria to the central processing computer 10. At step 2203, the central processing computer 10 can receive and store the information or criteria regarding the respective clinical trial, experimental procedure, experimental treatment, healthcare focus group, healthcare survey, or the other activity or event. At step 2204, the central processing computer 10 will process the information or criteria regarding the respective clinical trial, experimental procedure, experimental treatment, healthcare focus group, healthcare survey, or the other activity or event, using the data or information contained in the database 10H, as well as any data or information contained in any of the healthcare records, healthcare files, or healthcare histories, stored in the database 10, and identify or select one or more individuals or patients for, for use in, or for participation in, the respective clinical trial, experimental procedure, experimental treatment, healthcare focus group, healthcare survey, or the other activity or event. At step 2204, the central processing computer 10 will also generate a list of the identified or selected individual(s) or patient(s).

At step 2205, the central processing computer 10 can generate, and store in the database 10H, a report containing information regarding the individual or patient or the individuals or patients identified or selected for use in, or for participation in, the respective clinical trial, experimental procedure, experimental treatment, healthcare focus group, healthcare survey, or the other activity or event, and/or containing the list of the identified or selected individual(s) or patient(s). Information regarding the respective clinical trial, experimental procedure, experimental treatment, healthcare focus group, healthcare survey, the specific condition(s), or the other activity or event, and the individual(s) or patient(s) identified or selected for same, or identified or selected as having or satisfying any specified or specific condition(s) or criteria, can also be stored in the database 10H. At step 2205, the report can be transmitted from the central processing computer 10 to the respective computer or communication device 20, 30, 40, or 50, or any other computer or communication device, associated with or used by the requesting individual or user.

At step 2206, the central processing computer 10 can also generate a notification message containing information regarding, for each identified or selected individual or patient, information regarding the individual's or patient's having been or being identified or selected for the respective clinical trial, experimental procedure, experimental treatment, healthcare focus group, healthcare survey, or other activity or event, information regarding the respective clinical trial, experimental procedure, experimental treatment, healthcare focus group, healthcare survey, or other activity or event, or information regarding the individual or patient having been or being identified or selected for same, including, but not limited to, contact information or other information, such as a link or hyperlink, for allowing the individual or patient to register for the respective clinical trial, experimental procedure, experimental treatment, healthcare focus group, healthcare survey, or the other activity or event.

In the case of a link or hyperlink being provided, an individual or patient can register for the respective clinical trial, experimental procedure, experimental treatment, healthcare focus group, healthcare survey, or other activity or event, via the central processing computer 10 using the link or the hyperlink. At step 2206, a notification message can be generated for each individual or patient, for any one, or each, healthcare provider of the individual or patient, as well as for the person, company, organization, or entity, administering or holding the respective clinical trial, experimental procedure, experimental treatment, healthcare focus group, healthcare survey, or other activity or event, or for a healthcare facility associated with the individual or patient and/or a healthcare facility or provider facility, or any other facility which can be the site or location or the respective clinical trial, experimental procedure, experimental treatment, healthcare focus group, healthcare survey, or other activity or event.

At step 2207, the notification message can be transmitted to a respective computer or communication device 40 associated with the individual or patient, to a computer or communication device 20 associated with a healthcare provider of the individual or patient, to a computer or communication device 20 associated with a healthcare facility or other facility, or to a provider computer or communication device 20 associated with a public health agency or department, or to any computer of communication device associated with the person, company, organization, or entity, administering or holding the respective clinical trial, experimental procedure, experimental treatment, healthcare focus group, healthcare survey, or other activity or event. In the case or a healthcare provider receiving the notification instead of or in addition to the individual or patient receiving same, the healthcare provider may be provided with the opportunity to discuss the respective clinical trial, experimental procedure, experimental treatment, healthcare focus group, healthcare survey, or other activity or event, as well as any specific condition(s) regarding the individual or the patient or any specific condition(s) regarding the respective clinical trial, experimental procedure, experimental treatment, healthcare focus group, healthcare survey, or other activity or event, with the individual or patient. At step 2207, either the individual or the patient can register for the respective clinical trial, experimental procedure, experimental treatment, healthcare focus group, healthcare survey, or other activity or event, the individual or the patient can take steps to address the specific condition(s) he or she has, or the individual or the patient can disregard the notification message, or the healthcare provider can register the individual or patient for the respective clinical trial, experimental procedure, experimental treatment, healthcare focus group, healthcare survey, or other activity or event, or any treatment program. Thereafter, the operation of the apparatus 100 will cease at step 2208.

Any results of, for, or regarding, the individual's or patient's participation in the respective clinical trial, experimental procedure, experimental treatment, healthcare focus group, healthcare survey, or other activity or event, can be stored in the individual's or patient's healthcare record, healthcare file, or healthcare history, as well as in any record or file regarding the respective clinical trial, experimental procedure, experimental treatment, healthcare focus group, healthcare survey, or other activity or event.

In the above described manner, the apparatus 100 of the present invention can be used to test new medications, medicines, drugs, pharmaceutical products, pharmaceutical services, healthcare devices, goods, products, or services, new or experimental treatments or procedures, treatment plans, or care management plans, and/or can be used to obtain survey information or focus group information from the identified or selected individuals and/or patients. Any information or results obtained can be stored in the database 10H for later use.

In another preferred embodiment of the embodiment of FIG. 22, the apparatus 100 and method of the present invention can be utilized, in a same, a similar, or an analogous manner, in order to identify or select, and generate a list of individuals or patients with or having a specific condition(s), which list of individuals or patients can be used for research, quality improvement, outreach, reduction of disparities, care management, treatment planning, infection disease control, or any other healthcare-related activity. In this preferred embodiment, the list of individuals or patients, with or having a specific condition(s), can be determined by the central processing computer 10 which can then generate a message containing information regarding the list of individuals or patients. The message can be generated in response to a request for the list of individuals or patients entered by a user or individual and transmitted from a respective computer or communication device, which can be any one of the computers or communication devices 20, 30, 40, or 50, or any other computer or communication device, and received and stored by the central processing computer 10.

The message can then be transmitted from the central processing computer 10 to any provider computer or communication device 20, any payer computer or communication device 30, any patient computer or communication device 40, any intermediary computer or communication device 50, or any other computer or communication device, associated with or used by the requesting individual, person, or entity, healthcare provider, provider of any good or service, payer or insurer, any patient or individual, any public health agency or department, any research institution, any healthcare facility, any research center, any university, any college, or any school, or any other person or entity who or which might use the information contained in the message for purposes of research, quality improvement, outreach, reduction of disparities, care management, treatment planning, infection disease control, or any other healthcare-related activity or purpose. The message can also be transmitted to a patient computer or communication device 40 associated with the individual or the patient identified as having the specific condition(s). The message, in a preferred embodiment, can also contain information, or links or hyperlinks, to other and additional information.

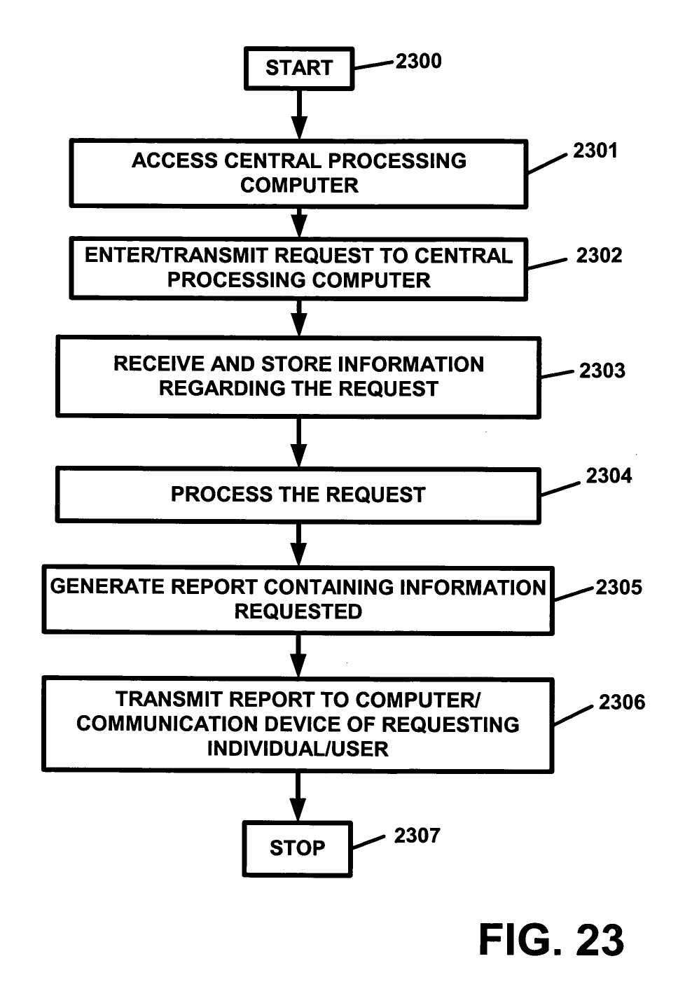

In another preferred embodiment, the apparatus 100 and method of the present invention can be used to determine or to measure the effectiveness of, or side effects experienced or associated with, any medications, medicines, drugs, dietary supplements, supplements, vitamins, over-the-counter products or substances, or to measure the effectiveness of, or the side effects experienced or associated with, any procedures, treatments, treatment plans, care management plans, or any other goods, products, or services which can be offered in the marketplace. FIG. 23 illustrates, in flow diagram form, another preferred embodiment method for utilizing the apparatus 100 and method of the present invention in order to determine or measure the effectiveness of, or side effects experienced or associated with, any medications, medicines, drugs, dietary supplements, supplements, vitamins, over-the-counter products or substances, or the effectiveness of, or side effects experienced or associated with, any procedures, treatments, treatment plans, care management plans, or any other good, product, or service, which can be offered in the marketplace. With reference to FIG. 23, the operation of the apparatus 100 commences at step 2300. At step 2301, an individual or user seeking to determine or measure the effectiveness of, or side effects experienced or associated with, any medications, medicines, drugs, dietary supplements, supplements, vitamins, over-the-counter products or substances, or the effectiveness of, or side effects experienced or associated with, any procedures, treatments, treatment plans, care management plans, or any other goods, products, or services, which can be offered in the marketplace, can access the central processing computer 10 via a respective computer or communication device 20, 30, 40, or 50, or any other computer or communication device.

At step 2302, the individual or user can enter information regarding the request regarding the effectiveness of, or side effects experienced or associated with, or regarding, a respective medication, medicine, drug, dietary supplement, supplement, vitamin, over-the-counter product or substance, procedure, treatment, treatment plan, care management plan, or other good, product, or service, into the respective computer or communication device 20, 30, 40, or 50, or any other computer or communication device and can transmit same to the central processing computer 10. At step 2303, the central processing computer 10 can receive and store the information regarding the request or contained in the request. At step 2304, the central processing computer 10 will process the information regarding the request using the data or information contained in the database 10H as well as any data or information contained in any of the healthcare records, healthcare files, or healthcare histories, stored in the database 10.

At step 2305, the central processing computer 10 can generate, and store in the database 10H, a report containing information regarding the effectiveness of, or side effects experienced or associated with, or regarding, the respective medication, medicine, drug, dietary supplement, supplement, vitamin, over-the-counter product or substance, procedure, treatment, treatment plan, care management plan, or other good, product, or service, which is the subject of the request.

At step 2306, the central processing computer 10 can transmit the report to the computer or communication device of the requesting individual or user and the individual or user can review the information contained in the report. Thereafter, the operation of the apparatus 100 will cease at step 2307.

In another preferred embodiment, the individual or user seeking to obtain information regarding the effectiveness of, or side effects experienced or associated with, any medications, medicines, drugs, dietary supplements, supplements, vitamins, over-the-counter products or substances, or the effectiveness of, or side effects experienced or associated with, any procedures, treatments, treatment plans, care management plans, or any other good, product, or service, which can be offered in the marketplace, can program the apparatus 100 or the central processing computer 10 to generate reports automatically at a specified time, at regular time intervals, monthly, annually, or at any at specified time interval, upon an updating of information in the database 10H regarding the respective medication, medicine, drug, dietary supplement, supplement, vitamin, over-the-counter product or substance, procedure, treatment, treatment plan, care management plan, or other good, product, or service, or any individual or patient using same or being treated or cared for by, with, or using, same, or upon any other pre-specified occurrence or happening.

In this manner, the apparatus 100 can provide updated reports regarding the effectiveness of, or side effects experienced or associated with, any medications, medicines, drugs, dietary supplements, supplements, over-the-counter products or substances, or the effectiveness of, or side effects experienced or associated with, any procedures, treatments, treatment plans, care management plans, or any good, product, or service, automatically or on an on-going basis. Any reports can also be stored in the database 10H for retrieval by any of the herein-described users, individuals, patients, healthcare providers, other providers, payers, insurers, intermediaries, or third parties, or any other persons or entities who or which utilize the apparatus 100 and method of the present invention.

In another preferred embodiment, the apparatus 100 and method of the present invention can be used to provide information regarding health conditions, healthcare conditions, illnesses, diagnoses, symptoms, treatments, treatment plans, care management practices, care management plans, insurance information, information regarding type of insurance, wellness information, healthcare practices, healthcare history patterns, healthcare history patterns, healthcare trends, treatment trends, statistics, statistical analyses, studies, study trends, or any other pertinent healthcare or healthcare-related information, regarding any number or type of groups of individuals or patients. In a preferred embodiment, the apparatus 100 can provide any of the above-described information for any number of groups of individuals or patients based on gender, sex, age, occupation, education, ethnicity, country of origin, nationality, race, religion, any demographic criteria or demographics, or any other criteria. The apparatus 100 can also be utilized in order to provide statistical information or probability information regarding any of the above-described or herein-described information.

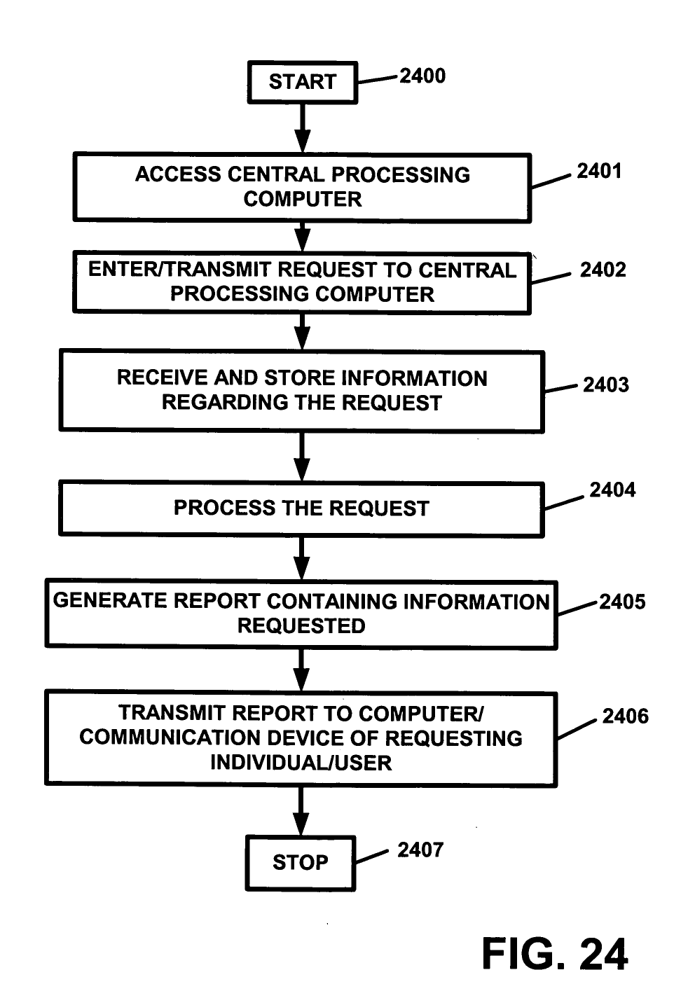

FIG. 24 illustrates, in flow diagram form, another preferred embodiment method for utilizing the apparatus 100 and method of the present invention in order to provide information regarding health conditions, healthcare conditions, illnesses, diagnoses, symptoms, treatments, treatment plans, care management practices, care management plans, insurance information, information regarding type of insurance, wellness information, healthcare practices, healthcare history patterns, healthcare trends, treatment trends, statistics, statistical analyses, studies, study trends, or any other pertinent healthcare or healthcare-related information, regarding any number or type of groups of individuals or patients, or to provide any of the herein-described information for any number of groups of individuals or patients based on gender, sex, age, occupation, education, ethnicity, country of origin, nationality, race, religion, any demographic criteria or demographics, or any other criteria. With reference to FIG. 24, the operation of the apparatus 100 commences at step 2400. At step 2401, an individual or user desiring to obtain any of the above-described information can access the central processing computer 10 via a respective computer or communication device 20, 30, 40, or 50, or any other computer or communication device.

At step 2402, the individual or user can enter information regarding the request for information regarding health conditions, healthcare conditions, illnesses, diagnoses, symptoms, treatments, treatment plans, care management practices, care management plans, insurance information, information regarding type of insurance, wellness information, healthcare practices, healthcare history patterns, healthcare trends, treatment trends, statistics, statistical analyses, studies, study trends, or any other pertinent healthcare or healthcare-related information, regarding any number or type of groups of individuals or patients, or information for any number of groups of individuals or patients based on gender, sex, age, occupation, education, ethnicity, country of origin, nationality, race, religion, any demographic criteria or demographics, or any other criteria, into the respective computer or communication device 20, 30, 40, or 50, or any other computer or communication device and transmit same to the central processing computer 10. At step 2403, the central processing computer 10 can receive and store the information contained in the request. At step 2404, the central processing computer 10 will process the information regarding the request using the data or information contained in the database 10H as well as any data or information contained in any of the healthcare records, healthcare files, or healthcare histories, stored in the database 10.

At step 2405, the central processing computer 10 can generate, and store in the database 10H, a report containing information regarding the health conditions, healthcare conditions, illnesses, diagnoses, symptoms, treatments, treatment plans, care management practices, care management plans, insurance information, information regarding type of insurance, wellness information, healthcare practices, healthcare history patterns, healthcare trends, treatment trends, statistics, statistical analyses, studies, study trends, or any other pertinent healthcare or healthcare-related information, regarding any number or type of groups of individuals or patients, or information for any number of groups of individuals or patients based on gender, sex, age, occupation, education, ethnicity, country of origin, nationality, race, religion, any demographic criteria or demographics, or any other criteria, which is the subject of the request.

At step 2406, the central processing computer 10 can transmit the report to the computer or communication device of the requesting individual or user and the individual or user can review the information contained in the report. Thereafter, the operation of the apparatus 100 will cease at step 2407.

In another preferred embodiment, the individual or user seeking to obtain information regarding health conditions, healthcare conditions, illnesses, diagnoses, symptoms, treatments, treatment plans, care management practices, care management plans, insurance information, information regarding type of insurance, wellness information, healthcare practices, healthcare history patterns, healthcare trends, treatment trends, statistics, statistical analyses, studies, study trends, or any other pertinent healthcare or healthcare-related information, regarding any number or type of groups of individuals or patients, or any of the herein-described information for any number of groups of individuals or patients based on gender, sex, age, occupation, education, ethnicity, country of origin, nationality, race, religion, any demographic criteria or demographics, or any other criteria, can program the apparatus 100 or the central processing computer 10 to generate the above-described reports automatically, at a specified time, at regular time intervals, monthly, annually, or at any specified time interval, upon an updating of information in the database 10H regarding the respective health conditions, healthcare conditions, illnesses, diagnoses, symptoms, treatments, treatment plans, care management practices, care management plans, insurance information, information regarding type of insurance, wellness information, healthcare practices, healthcare history patterns, healthcare trends, treatment trends, statistics, statistical analyses, studies, study trends, or any other pertinent healthcare or healthcare-related information, regarding any number or type of groups of individuals or patients, or regarding any of the herein-described information for any number of groups of individuals or patients based on gender, sex, age, occupation, education, ethnicity, country of origin, nationality, race, religion, any demographic criteria or demographics, or any other criteria, or upon any other pre-specified occurrence or happening.

In this manner, the apparatus 100 can provide updated reports regarding health conditions, healthcare conditions, illnesses, diagnoses, symptoms, treatments, treatment plans, care management practices, care management plans, insurance information, information regarding type of insurance, wellness information, healthcare practices, healthcare history patterns, healthcare trends, treatment trends, statistics, statistical analyses, studies, study trends, or any other pertinent healthcare or healthcare-related information, regarding any number or type of groups of individuals or patients, or any of the herein-described information for any number of groups of individuals or patients based on gender, sex, age, occupation, education, ethnicity, country of origin, nationality, race, religion, any demographic criteria or demographics, or any other criteria, automatically or on an on-going basis.

Any reports can also be stored in the database 10H for retrieval by any of the herein-described users, individuals, patients, healthcare providers, other providers, payers, insurers, intermediaries, or third parties, or any other persons or entities who or which utilize the apparatus 100 and method of the present invention.

In any and/or all of the embodiments described herein, any signals, messages, reports, notifications messages, or any other communications, described herein as being transmitted from one device, computer, or communication device, to another, can be, or can be included in, or can be attached to, an e-mail message, an instant messaging message, an electronic transmission, an electronic data interchange, or electronic data transmission or any other data or information transmission.

In any and/or all of the embodiments described herein, any of the herein-described individuals, patients, healthcare providers, providers, payers, insurers, third parties, or intermediaries, or any other persons or entities, who or which utilize the apparatus 100 or method of the present invention, if so authorized, can program the apparatus 100 or the central processing computer 10 so as to have any of the herein-described data, information, reports, signals, messages, notification messages, news reports, study reports, news of developments pertinent to the healthcare field or healthcare related fields, or any other information described herein as being provided by the apparatus 100, transmitted to he, she, or it, or to a computer or communication device used by or associated with he, she, or it, as the respective data, information, report, signal, message, notification message, news report, study report, news of a development pertinent to the healthcare field or healthcare related field, or any other information, is generated by or stored by the apparatus 100 or is made available to the apparatus 100.

In any and/or all of the embodiments described herein, any time a medication, a medicine, or a drug, is prescribed, is being considered as part of a treatment, or is about to be administered, to an individual or a patient, the apparatus 100 or the central processing computer 10, as part of a respective processing of any information regarding same, can determine whether or not the respective medication, medicine, or drug, being considered could result in any adverse drug interaction(s) or any adverse reaction(s) with any other medication, medicine, or drug, the individual or patient may currently be taking, or the apparatus 100 or the central processing computer 10, can determine whether or not the individual or patient is, or may be, allergic to the respective medication, medicine, or drug.

In any and/or all of the embodiments described herein, the apparatus 100 or the central processing computer 10, when processing information for generating any of the treatment plans described herein, can also determine whether or not any respective medication, medicine, or drug, or treatment, being considered could result in any adverse drug interaction(s), adverse reaction(s), or have any other adverse effect, with any other medication, medicine, or drug, or treatment, the individual or patient may currently be taking, may be undergoing, or may have undergone, or the apparatus 100 or the central processing computer 10, can determine whether or not the individual or the patient is, or may be, allergic to the respective medication, medicine, or drug, or treatment.

In any and/or all of the embodiments described herein, the apparatus 100 or the central processing computer 10, can also perform drug formulary checks for or regarding any medication, medicine, or drug, for which information may be stored in the database 10H or otherwise processed by the apparatus 100 of the present invention. In any and/or all of the embodiments described herein, the apparatus 100 or the central processing computer 10, can also perform drug formulary checks for or regarding any medication, medicine, or drug, being considered for an individual or patient so as to ensure that same is appropriate for the individual or patient, so as to ensure safety in treatment, so as to ensure effectiveness in treatment, or for any other appropriate reason.

In any and/or all of the embodiments described herein, the apparatus 100 or the central processing computer 10, can also perform processing routines to effectuate medication, medicine, or drug, reconciliation at any time in or during a treatment, care, or care management, of or for an individual or patient. These medication, medicine, or drug, reconciliation processing routines can be performed continuously during a treatment or care setting for an individual or patient, as well as in between treatment or care settings for the individual or patient.

In any and/or all of the embodiments described herein. the information contained in the database 10H, or in the healthcare records, healthcare files, or healthcare histories, contained therein, can include immunization records and information for each individual, as well as other immunization data and/or information. In another preferred embodiment, the apparatus 100, or the central processing computer 10, at any appropriate time, or upon any updating of immunization information, upon an updating of a certain number of immunization records, upon an updating of immunization information for a specified number of individuals or patients, at any pre-specified or pre-selected time, at pre-specified time intervals, upon request by a public health agency or department, upon request by an immunization center or an immunization registry, or upon request by a healthcare provider, a healthcare facility, a hospital, a research center or facility, a payer or insurer, an intermediary, or any person, individual, or entity, can generate an immunization information report and can transmit same to a respective computer or communication device 20, 30, 40, or 50, or any other computer or communication device, associated with or used by the requesting public health agency or department, immunization center or immunization registry, healthcare provider, healthcare facility, hospital, research center or facility, payer or insurer, intermediary, or person, individual, or entity. In this regard, the apparatus 100 and method of the present invention can be used to submit electronic immunization data or information to an immunization center or immunization registry, a healthcare provider, a healthcare facility, a hospital, a research center facility, a payer or an insurer, an intermediary, a person, an individual, or an entity, or any immunization information system.

In another preferred embodiment, as well as any and/or all of the embodiments described herein, the apparatus 100 or the central processing computer 10, can receive and process a request, by any healthcare provider, any other provider, a patient or an individual, a payer or an insurer, a secondary payer or a secondary insurer, a tertiary or other payer or insurer, or any authorized third party or intermediary, to provide co-payment information and/or deductible information regarding an insurance policy, a healthcare insurance policy, a disability insurance policy, or a life insurance policy, of or for any individual or patient described herein, or to provide co-payment information and/or deductible information regarding any healthcare payer or healthcare insurance policy, payment policy, or plan.

The apparatus 100 or the central processing computer 10 can process the request and generate a co-payment message or a deductible information message and transmit same the respective computer or communication device 20, 30, 40, or 50, of, associated with, or used by, the requesting healthcare provider, other provider, patient or individual, payer or insurer, secondary payer or secondary insurer, tertiary or other payer or insurer, or authorized third party or intermediary. In another preferred embodiment, any patient or individual, payer or insurer, secondary payer or secondary insurer, tertiary or other payer or insurer, or authorized third party or intermediary, can also pay the respective co-payment or deductible via the respective computer or communication device 30, 40, or 50, via the apparatus 100 of the present invention, such as by making or submitting payment to the central processing computer 10 which can receive and process the payment for or on behalf of a respective healthcare provider, other provider, or payer or insurer.

In another preferred embodiment, the apparatus 100 and method of the present invention can also be utilized to provide employee benefits information, to allow an individual, a patient, a beneficiary, or any other person or third party, to enroll in an employee benefit or in employee benefits, to submit a claim or claims or make a request for, or pursuant to, an employee benefit or an insurance policy or payment policy or plan, to take or retain an employee benefit from one employment relationship, job, or position, to another employment relationship, job, or position, or to maintain an employee benefit after leaving an employment relationship, job, or position, or retiring from an employment relationship, job, or position, thereby providing benefits portability, or to post information regarding a need, a requirement, or a desire, for or to obtain, or enroll in, an employee benefit or policy. In another preferred embodiment, the apparatus 100 and method of the present invention can also be utilized to allow a benefit provider or an insurance provider to provide information to individuals, patients, beneficiaries, or any other persons or third parties, of an availability or an offering of a benefit, a policy, an insurance policy, or other policy, plan, or program, being offered by the benefit provider.

In another preferred embodiment, the apparatus 100 and method of the present invention can be used to provide a user, patient, individual, or any other authorized person, with information regarding any employee benefit(s) or employee benefit(s) insurance policies or plans which the user, patient, individual, or other authorized person, my have or be covered under as a beneficiary. In another preferred embodiment, information, links, or hyperlinks, regarding, or providing a link to, any employee benefit(s), healthcare insurance policy or policies, disability insurance policy or policies, life insurance policy or policies, healthcare payment plan or plans, individual retirement account(s) (IRA(s)), self-employed pension (SEP) account(s), bank account(s), savings account(s), financial account(s), or a vacation time benefit, a personal time benefit, a sick time benefit, a healthcare insurance benefit, a disability insurance benefit, a life insurance benefit, an employee discount benefit, a buying service benefit, a tuition reimbursement benefit, an educational assistance benefit, an in-house training benefit, a child care benefit, a day care program benefit, a stock option benefit, a pension benefit, a retirement benefit, a credit union benefit, an employee stock ownership benefit, a profit sharing benefit, an educational assistance program benefit, a child care program benefit, or any other employee benefit noted in U.S. Pat. No. 7,305,347, or any other employee benefit which can be offered to an employee by a respective employer, or any other employee benefit or employee benefits described herein, can be included in the database 10H of the central processing computer 10, and/or in any of the other databases 20H, 30H, 40H, and/or 50H, described herein.

In another preferred embodiment, information, links, or hyperlinks, regarding, or providing a link to, any employee benefit or employee benefits, healthcare insurance policy or policies, disability insurance policy or policies, life insurance policy or policies, healthcare payment plan or plans, individual retirement account(s) ((IRA(s)), self-employed pension (SEP) account(s), bank account(s), savings account(s), financial account(s), or any other employee benefit or employee benefits described herein, or any employer(s) or benefits provider(s), can also be included in the healthcare record or healthcare file of each patient or individual, or in the database 10H of the central processing computer 10.

Applicant hereby incorporates by reference herein the subject matter and teachings of U.S. Pat. No. 7,305,347 and entitled “APPARATUS AND METHOD FOR PROVIDING EMPLOYEE BENEFITS AND/OR EMPLOYEE BENEFITS INFORMATION” and, in particular, its teachings regarding providing information regarding employee benefits, allowing an individual to submit or file a request or a claim for, or pursuant to, an employee benefit, providing an employee benefit in response to a claim or request for same, providing a platform for providing for the portability of employee benefits, providing information regarding benefits which are portable, providing individual benefits accounts, providing information regarding, or processing requests or claims for, or pursuant to, benefits which are portable, providing an employee benefit, which is a portable benefit, in response to a claim or request for same, providing alerts to benefits providers when an individual posts a need or a request for a particular employee benefit, and providing alerts to individuals when a benefits provider posts information regarding an employee benefit or benefits package.

The apparatus 100 and method of the present invention can provide the herein-described functionality to employees, independent contractors, temporary workers, freelancers, or any other individuals who are provided with, or who maintain for themselves, any employee benefits or any benefits that can or may be offered as an employee benefit.

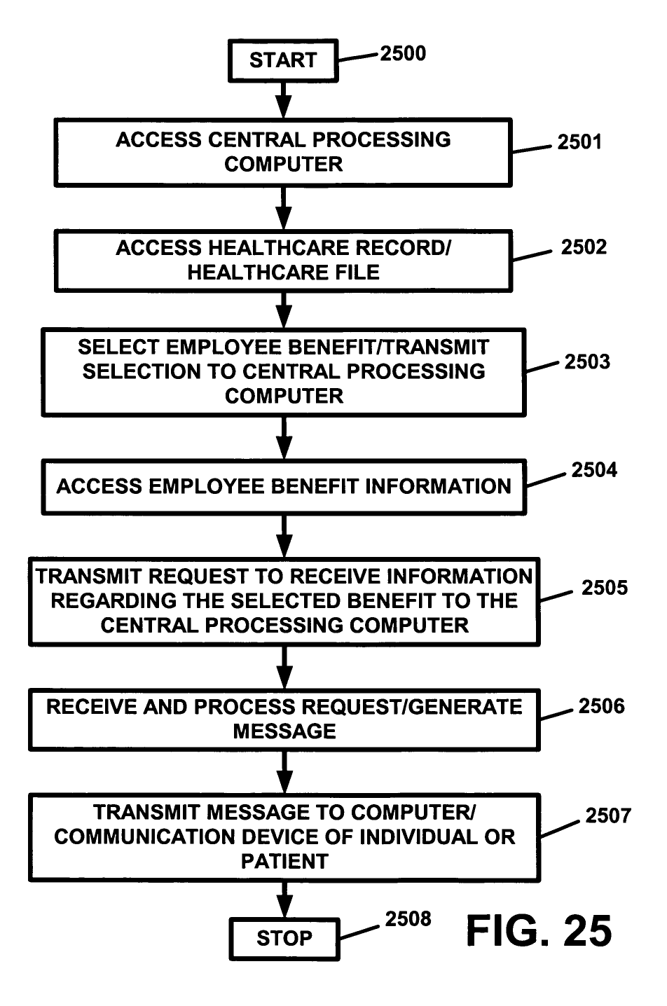

In another preferred embodiment, the apparatus 100 of the present invention can be utilized by an individual or a patient, having a healthcare record or a healthcare file stored in the database 10H of the central processing computer 10, to access or obtain information regarding an employee benefit via the apparatus 100, the central processing computer 10, or via, or using information, a link, or a hyperlink, contained in or stored in the individual's or the patient's healthcare record or healthcare file. FIG. 25 illustrates, in flow diagram form, another preferred embodiment method for utilizing the apparatus 100 and method of the present invention in order to allow an individual or a patient to obtain information regarding one of more employee benefits the individual or the patient may have or under which the individual or the patient may be a beneficiary.

With reference to FIG. 25, the operation of the apparatus 100 commences at step 2500. At step 2501, the individual or the patient can access the central processing computer 10 via his or her patient computer or communication device 40. At step 2502, the individual or the patient can access his or her healthcare record or healthcare file. At step 2503, the individual or the patient can then select the employee benefit for which he or she desires to obtain information, and can transmit information regarding the selection to the central processing computer 10. At step 2504, the individual or the patient can access the information he or she desires regarding the employee benefit. At step 2504, the information can be stored in, or can be accessed via, the healthcare record or the healthcare file of the individual or the patient, or the information can be accessed via a link or a hyperlink to the information, or via a link or a hyperlink to a provider computer or communication device 20, 30, or 50, associated with the benefit provider of the employee benefit, which link(s) or hyperlink(s) can be stored in the healthcare record or healthcare file of the individual or the patient. In a preferred embodiment, the benefit provider, if a provider of goods or services, including, but not limited to, healthcare services, can use or have associated therewith a provider computer or communication device 20. In another preferred embodiment, the benefit provider, if a payer or an insurer, can use or have associated therewith a payer computer or communication device 30. In another preferred embodiment, the benefit provider, if a third party or an intermediary, can use or have associated therewith an intermediary computer or communication device 50.

In another preferred embodiment, as well as any and/or all of the embodiments described herein, a link or a hyperlink to any of the benefits providers described herein, or any of their respective computers or communication devices 20, 30, or 50, or other computers or communication devices, can also be stored in the database 10H or in any of the other databases 20H, 30H, 40H, or 50H, or in any other database(s).

At step 2505, the individual or the patient can transmit, to the central processing computer 10 or to the computer or communication device associated with the respective benefit provider, a request to obtain or receive the information which he or she desires regarding the selected employee benefit. At step 2506, the central processing 10, or the computer or communication device associated with the benefit provider, can receive and process the request and can generate a message containing the requested information or containing information regarding the requested information or a response to the request. At step 2507, the central processing 10, or the computer or communication device associated with the benefit provider, can then transmit the message to the patient computer or communication device 40. At step 2507, the individual or the patient can then review the information requested or any other information contained in the message. Thereafter, the operation of the apparatus 100 will cease at step 2508.

In another preferred embodiment, the central processing computer 10 can also record and store, in the individual's or the patient's healthcare record or healthcare file, or in the database 10H, any information regarding the individual's or the patient's request for information and/or the information provided in response thereto or the information contained in the message.

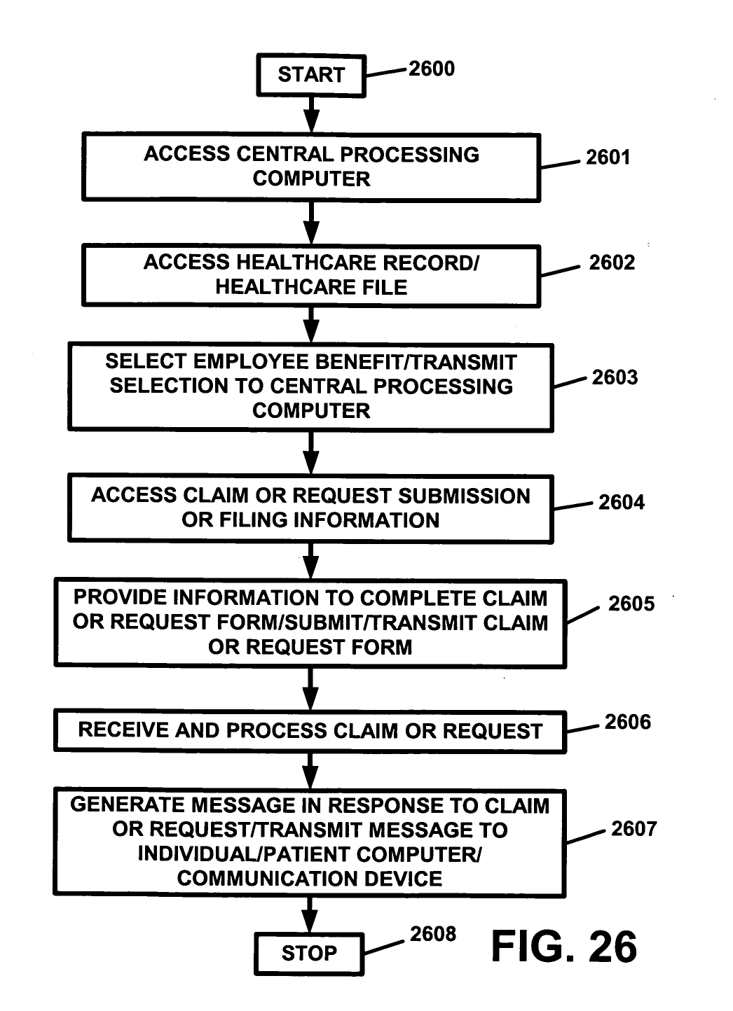

In another preferred embodiment, the apparatus 100 of the present invention can be utilized by an individual or a patient, having a healthcare record or a healthcare file stored in the database 10H of the central processing computer 10, to submit or to file a claim or a request for, or pursuant to, an employee benefit, via the apparatus 100, via the central processing computer 10, or via, or using information, a link, or a hyperlink, contained in or stored in the individual's or the patient's healthcare record or healthcare file. FIG. 26 illustrates, in flow diagram form, another preferred embodiment method for utilizing the apparatus 100 and method of the present invention in order to allow an individual or a patient to submit or to file a claim or a request for, or pursuant to, an employee benefit, via the apparatus 100, via the central processing computer 10, or via, or using information, a link, or a hyperlink, contained in, or stored in, the individual's or the patient's healthcare record or healthcare file.

With reference to FIG. 26, the operation of the apparatus 100 commences at step 2600. At step 2601, the individual or the patient can access the central processing computer 10 via his or her patient computer or communication device 40. At step 2602, the individual or the patient can access his or her healthcare record or healthcare file. At step 2603, the individual or the patient can then select the employee benefit for which, or pursuant to which, he or she desires to submit or file a claim or request. At step 2603, the individual or the patient can transmit information regarding the selection to the central processing computer 10. At step 2604, the individual or the patient can then access the claim submission or filing information, or the request submission or filing information, he or she desires regarding the employee benefit. At step 2604, the claim submission or filing information, or the request submission or filing information, can be stored in, or accessed via, the healthcare record or the healthcare file of the individual or the patient, or the respective information can be accessed via a link or a hyperlink to the claim submission or filing information, or to the request submission or filing information, or can be accessed via a link or a hyperlink to a provider computer or communication device 20, 30, or 50, associated with the benefit provider of the employee benefit, which link(s) or hyperlink(s) can be stored in the healthcare record or healthcare file of the individual or the patient. In another preferred embodiment, the benefit provider, if a provider of goods or services, including, but not limited to, healthcare services, can also use or have associated therewith a provider computer or communication device 20. In another preferred embodiment, the benefit provider, if a payer or an insurer, can use or have associated therewith a payer computer or communication device 30. In another preferred embodiment, the benefit provider, if a third party or an intermediary, can use or have associated therewith an intermediary computer or communication device 50.

In another preferred embodiment, as well as any and/or all of the embodiments described herein, a link or a hyperlink to any of the benefits providers described herein, or to any of their respective computers or communication devices 20, 30, or 50, or other computers or communication devices, can also be stored in the database 10H or in any of the other databases 20H, 30H, 40H, or 50H, or in any other database(s).

At step 2605, the individual or the patient can provide or can fill in, or complete, any necessary form(s), claims form(s), request form(s), or can provide any other needed or required information via any other information vehicle, using his or her patient computer or communication device 40, and can then submit or file the respective claim or request, for, or pursuant to, the employee benefit, by transmitting the completed form(s), claims form(s), request form(s), or other needed or required information, to the central processing computer 10 or to the computer or communication device associated with the respective benefit provider. At step 2606, the central processing 10, or the computer or communication device associated with the benefit provider, can receive the claim or the request and can then process any information contained in the completed form(s), claims form(s), or request form(s), or can process any other provided information.

At step 2606, the central processing 10, or the computer or communication device associated with the benefit provider, can process the claim or the request for, or pursuant to, the employee benefit, or any information associated with the claim or the request for, or pursuant to, the employee benefit, such as by processing any information contained in the completed form(s), claims form(s), request form(s), or by processing any other provided information, submitted by, or filed by, the individual or the patient at step 2605.

At step 2607, the central processing 10, or the computer or communication device associated with the benefit provider, can generate a message in response to the claim or the request for, or pursuant to, the employee benefit. The message generated by the central processing 10, or by the computer or communication device associated with the benefit provider, can contain information regarding a confirmation that the claim or the request for, or pursuant to, the employee benefit has been received by the benefit provider of the employee benefit, that the claim or the request is allowed or will be allowed, that a benefit or a payment in response to the claim or the request will be provided, that a payment has been made, or will be made, to a financial account, a savings account, a checking account, or any other employee benefit financial account, of or associated with the individual or the patient, that the claim or the request is denied or disallowed or will be denied or disallowed, that a benefit or a payment in response to the claim or the request will not be provided, or that more information is needed from the individual or the patient, or that a response to the claim or the request will be forthcoming.

At step 2607, the central processing 10, or the computer or communication device associated with the benefit provider, can then transmit the message to the patient computer or communication device 40. At step 2607, the individual or the patient can then review the information contained in the message. Thereafter, the operation of the apparatus 100 will cease at step 2608.

In another preferred embodiment, the central processing computer 10 can record and store, in the individual's or the patient's healthcare record or healthcare file, or in the database 10H, any information regarding the individual's or the patient's claim or request for, or pursuant to, the employee benefit, the completed form(s), claims form(s), request form(s), or any other needed or required information, or any information, which was submitted pertaining to the claim or the request, a response to the claim or the request, the message, or any information contained in the message.

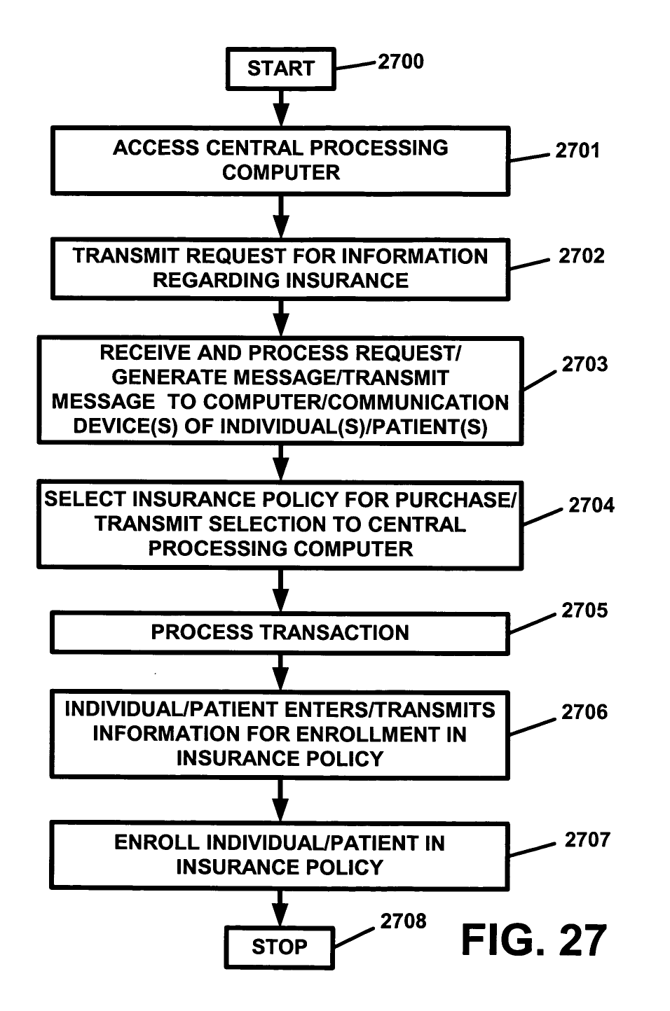

In another preferred embodiment, the present invention can be utilized as, and/or as a platform for, an insurance exchange in order to provide a venue by which to allow insurers or payers to sell healthcare insurance, disability insurance, life insurance, automobile insurance, homeowner's insurance, property or casualty insurance, or any other insurance policy, payer policy, payer program, or payer plan. FIG. 27 illustrates, in flow diagram form, another preferred embodiment method for utilizing the apparatus 100 and method of the present invention in order to allow insurers or payers to sell healthcare insurance, disability insurance, life insurance, automobile insurance, homeowner's insurance, property or casualty insurance, or any other insurance policy, payer policy, payer program, or payer plan, via the apparatus 100, the central processing computer 10, or any computer or communication device used by an insurer, a payer, a provider, or any other intermediary. In the preferred embodiment of FIG. 27, the apparatus 100 of the present invention can also be utilized by any provider of any type or kind of good, product, or service, to sell its respective goods, products, or services, via the apparatus 100. It is important to note that, while the embodiment of FIG. 27 is described and illustrated as being utilized in order to sell insurance, it can also be utilized in a same, a similar, or an analogous, manner in order to sell any type or kind of good, product, or service, which can be healthcare-related goods, products, or services, or non-healthcare-related goods, products, or services, or any other goods, products, or services, which can be the subject of commerce.

With reference to FIG. 27, the operation of the apparatus 100 commences at step 2700. At step 2701, the individual or the patient can access the central processing computer 10 via his or her patient computer or communication device 40. At step 2702, the individual or the patient can enter and transmit, to the central processing computer 10, a request to receive information regarding the insurance which he or she desires to purchase. For example, an individual desiring to purchase healthcare insurance can request to receive information regarding the various healthcare insurance policies or other payer policies, programs, or plans, which are offered by the various insurers or payers, or employee benefits providers, who or which use the apparatus 100 of the present invention to sell their respective healthcare insurance policies or other payer policies, programs, or plans, or which healthcare insurance policies or other payer policies, programs, or plans, are made available for purchase via the apparatus 100 of the preset invention. In this regard, in a preferred embodiment, any number of insurers or payers, or benefits providers, can offer their healthcare insurance policies, plans, or programs, for sale via the apparatus 100 of the present invention in order to create an healthcare insurance exchange.

It is important to note that, although the apparatus 100 of the present invention of the embodiment of FIG. 27 is described and illustrated as being used as an insurance exchange for selling healthcare insurance, the apparatus 100 can also be utilized in a same, a similar, or an analogous, manner in order to create an exchange for selling disability insurance, life insurance, automobile insurance, homeowner's insurance, property or casualty insurance, or any other insurance policy, payer policy, payer program, or payer plan, or any type or kind of goods, products, or services, which can be healthcare-related goods, products, or services, or non-healthcare-related goods, products, or services, or any other goods, products, or services, which can be the subject of commerce.

In another preferred embodiment, at step 2702, the individual or the patient can also include, in his or her request, any specific needs or requirements he or she has for the healthcare insurance he or she is seeking to purchase.

At step 2703, the central processing computer 10 can process the request and can generate information or generate a message containing information regarding one or more healthcare insurance policies which are available for sale. At step 2703, the message can be transmitted from the central processing computer 10 to the patient computer or communication device 40 associated with or used by the individual or the patient. At step 2704, the individual or the patient can select the healthcare insurance policy he or she desires to purchase and can transmit his or her selection to the central processing computer 10. At step 2705, the central processing computer 10 can either process the transaction involving the individual's or the patient's purchase of the selected healthcare insurance policy or the central processing computer 10 can forward the individual or the patient to the computer or communication device 30 which is associated with the insurer or the payer whose healthcare insurance policy the individual or the patient is purchasing.

At step 2706, the individual or the patient can enter any needed or required information for enrolling the individual or the patient, and any dependents or other beneficiaries of the individual or the patient, if applicable, in the healthcare insurance policy. At step 2706, the information for enrolling the individual or the patient, and any dependents or other beneficiaries of the individual or the patient, if applicable, in the healthcare insurance policy can also be transmitted to and received at the central processing computer 10 and, if applicable, can also be transmitted or forwarded to computer or communication device 30 which is associated with the insurer or payer whose healthcare insurance policy the individual or patient is purchasing. In another preferred embodiment, the central processing computer 10 can be programmed to automatically query the database 10H or the healthcare record or the healthcare file of the individual or the patient, and collect any and/or all needed information for enrolling the individual or the patient, and any dependents or other beneficiaries of the individual or the patient, if applicable, in the healthcare insurance policy.

At step 2707, the central processing computer 10, or the computer or communication device 30 which is associated with the insurer or the payer, can process the information and enroll the individual or the patient, and any dependents or other beneficiaries of the individual or the patient, if applicable, in the healthcare insurance policy. In another preferred embodiment, at step 2707, the central processing computer 10, or the computer or communication device 30 which is associated with the insurer or the payer, can be programmed to automatically enroll the individual or the patient, and any dependents or other beneficiaries of the individual or the patient, if applicable, in the healthcare insurance policy. At step 2707, the central processing computer 10, or the computer or communication device 30 which is associated with the insurer or the payer, can also process any payment by or on behalf of the individual or the patient. In a situation where the individual or the patient is paying for the healthcare insurance policy, the individual or the patient can make payment in any appropriate manner, such as, for example, by a credit card payment, by a debit card payment, by an electronic bill payment process or operation, by an electronic funds transfer, or by or in any other appropriate manner. In a situation where the healthcare insurance is to be paid for by a third party, such as, for example, by an employer of the individual or the patient, as part of an employee benefits package, or by any person, entity, or any third party, the individual or the patient can provide any needed information identifying the respective employer, or the respective person, entity, to third party, and the payment for the healthcare insurance policy can be effected from a financial account associated with that employer, or from a financial account associated with that person, entity, or third party, using information stored regarding that employer, or that person, entity, or third party, or any financial account associated with same.

The central processing computer 10 can then record and store, in the individual's or the patient's healthcare record or healthcare file, or in the database 10H, any information regarding the healthcare insurance or the healthcare insurance policy purchased by of for the individual or the patient. Thereafter, the operation of the apparatus 100 will cease at step 2708.

In another preferred embodiment, the apparatus 100 of the embodiment of FIG. 27 can be utilized in a same, a similar, or an analogous, manner in order to allow an individual or a patient to purchase and enroll in a supplemental healthcare insurance policy or to purchase an upgrade to or for a current healthcare insurance policy. In another preferred embodiment, the apparatus 100 of the embodiment of FIG. 27 can also be utilized in a same, a similar, or an analogous, manner in order to allow an individual or a patient to purchase and enroll in a supplemental healthcare insurance policy or to purchase an upgrade to or for a current disability insurance policy, a life insurance policy, an automobile insurance policy, a homeowner's insurance policy, a property or casualty insurance policy, or any other insurance policy, payer policy, payer program, or payer plan.

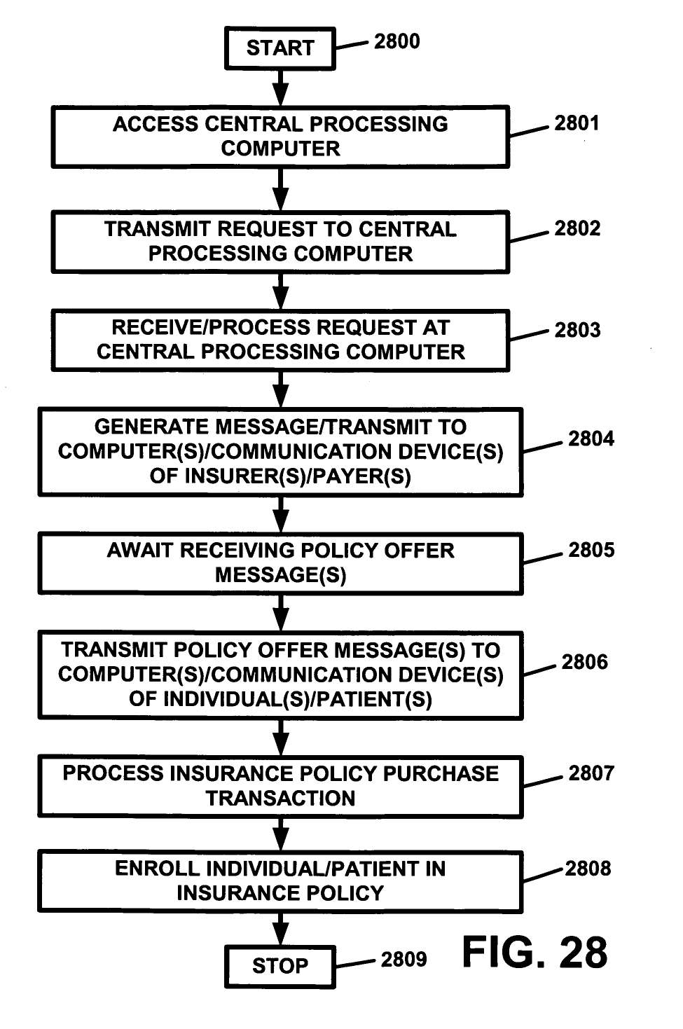

In another preferred embodiment, the apparatus 100 of the present invention can be utilized in order to allow an individual or a patient to post with the apparatus 100 a request for an insurance policy, his or her requirement for an insurance policy, or his or her need for an insurance policy. The insurance policy can be a policy for healthcare insurance, disability insurance, life insurance, automobile insurance, homeowner's insurance, property or casualty insurance, or any other insurance policy, payer policy, payer program, or payer plan. FIG. 28 illustrates, in flow diagram form, another preferred embodiment method for utilizing the apparatus 100 and method of the present invention in order to allow an individual or a patient to post a request for an insurance policy, his or her requirement for an insurance policy, or his or her need for an insurance policy.

In a preferred embodiment, the apparatus 100 can provide information regarding the individual's or the patient's posting of the request for an insurance policy, information contained in the request, or the requirement for an insurance policy, or the need for an insurance policy, to any number of insurers or payers, or to any number of brokers of insurance. Thereafter, any insurer or payer, or any broker, can offer the individual or the patient an insurance policy fitting or matching the individual's or the patients request, request criteria, requirements, or needs, via the apparatus 100. If the individual or the patient decides to purchase the offered insurance policy, he or she can do so and can be enrolled in the insurance policy via the apparatus 100.

In the description of the preferred embodiment of FIG. 28, the operation of the apparatus 100 is described as being utilized in connection with selling healthcare insurance. It is, however, important to note that the embodiment of FIG. 28 can also be utilized in a same, a similar, or an analogous, manner in connection with selling disability insurance, life insurance, automobile insurance, homeowner's insurance, property or casualty insurance, or any other insurance policy, payer policy, payer program, or payer plan. In a preferred embodiment, any number of insurers or payers can offer their respective healthcare insurance policies, plans, or programs, for sale via the apparatus 100 and method of the present invention. In another preferred embodiment of FIG. 28, the apparatus 100 can also be utilized in a same, a similar, or an analogous, manner in order to sell any type or kind of goods, products, or services, which can be healthcare-related goods, products, or services, or non-healthcare-related goods, products, or services, or any other goods, products, or services, which can be the subject of commerce.

With reference to FIG. 28, the operation of the apparatus 100 commences at step 2800. At step 2801, the individual or the patient can access the central processing computer 10 via his or her patient computer or communication device 40. At step 2802, the individual or the patient can enter and transmit, to the central processing computer 10, a request for a healthcare insurance policy, information regarding his or her requirement for a healthcare insurance policy, or information regarding his or her need for a healthcare insurance policy. At step 2803, the central processing computer 10 can receive and process the information regarding the individual's or the patient's request for a healthcare insurance policy, the information regarding his or her requirement for a healthcare insurance policy, or the information regarding his or her need for a healthcare insurance policy. At step 2804, the central processing computer 10 can generate a message containing information regarding the individual's or the patient's request for a healthcare insurance policy, information regarding his or her requirement for a healthcare insurance policy, or information regarding his or her need for a healthcare insurance policy. At step 2804, the central processing computer 10 can transmit the message to the payer computer or communication device 30, or to any other computer or communication device, associated with or used by each of any number of insurers or payers who or which have indicated an interest in receiving same and in selling healthcare insurance pursuant to this preferred embodiment.

At step 2805, the operation of the apparatus 100, or the central processing computer 10, will await the receiving of offers, each in an policy offer message, of healthcare insurance policies from each of any of the insurers or the payers who or which have a healthcare insurance policy to offer the individual or the patient. At step 2806, any policy offer message, containing an offer to sell a healthcare insurance policy, and details regarding same, along with a link or hyperlink to the apparatus 100, to the central processing computer 10, or to the computer or communication device 30 associated with the insurer or the payer offering the respective healthcare insurance policy, can be transmitted to the patient's computer or communication device 40 associated with the individual or the patient. At step 2807, the individual or the patient can review any of the offers contained in any of the policy offer messages, or any number of the offers and, if the individual or the patient desires to purchase a healthcare insurance policy, the individual or the patient can utilize the patient computer or communication device 40, or any other computer or communication device, in order to access or link to the respective central processing computer 10, or to the respective computer or communication device 30 associated with the insurer or the payer offering the healthcare insurance policy, and can purchase the healthcare insurance policy.

At step 2808, the central processing computer 10, or the computer or communication device 30 associated with the insurer or the payer, whichever the case may be, can then process the transaction involving the individual's or the patient's purchase of the healthcare insurance policy. At step 2808, the individual or the patient can enter any needed or required information for enrolling the individual or patient, and any dependents or other beneficiaries of the individual or the patient, if applicable, in the healthcare insurance policy. At step 2808, any information for enrolling the individual or the patient, and any dependents or other beneficiaries of the individual or the patient, if applicable, in the healthcare insurance policy can also be transmitted to and received at the respective central processing computer 10 or the computer or communication device 30 associated with the insurer or the payer.

In another preferred embodiment, the central processing computer 10, or the computer or communication device 30 associated with the insurer or the payer, can also be programmed to automatically query the database 10H or the healthcare record or the healthcare file of the individual or patient, and collect any or all needed information for enrolling the individual or the patient, and any dependents or other beneficiaries of the individual or the patient, if applicable, in the healthcare insurance policy.

At step 2808, the central processing computer 10, or the computer or communication device 30 which is associated with the insurer or the payer, can process the information and enroll the individual or the patient, and any dependents or other beneficiaries of the individual or the patient, if applicable, in the healthcare insurance policy. In another preferred embodiment, at step 2808, the central processing computer 10, or the computer or communication device 30 associated with the insurer or the payer, can also be programmed to automatically enroll the individual or the patient, and any dependents or other beneficiaries of the individual or the patient, if applicable, in the healthcare insurance policy. At step 2808, the central processing computer 10, or the computer or communication device 30 which is associated with the insurer or payer, can also process any payment by or on behalf of the individual or the patient. In an situation where the individual or the patient is paying for the healthcare insurance policy, the individual or the patient can make payment in any appropriate manner, such as, for example, by a credit card payment, by a debit card payment, by an electronic bill payment process or operation, by an electronic funds transfer, or by or in any other appropriate manner. In a situation where the healthcare insurance policy is to be paid for by a third party, such as, for example, by an employer of the individual or the patient as part of an employee benefits package, or by any person, entity, or third party, the individual or the patient can provide any needed information identifying the employer, or the person, entity, or third party, and payment can be effected from a financial account associated with that employer, or from a financial account associated with that person, entity, or third party, using information stored regarding that employer, or that person, entity, or third party, or any respective financial account associated with same.

The central processing computer 10 can then record and store, in the individual's or the patient's healthcare record or healthcare file, or in the database 10H, any information regarding the healthcare insurance or the healthcare insurance policy purchased by or for the individual or the patient. Thereafter, the operation of the apparatus 100 will cease at step 2809.

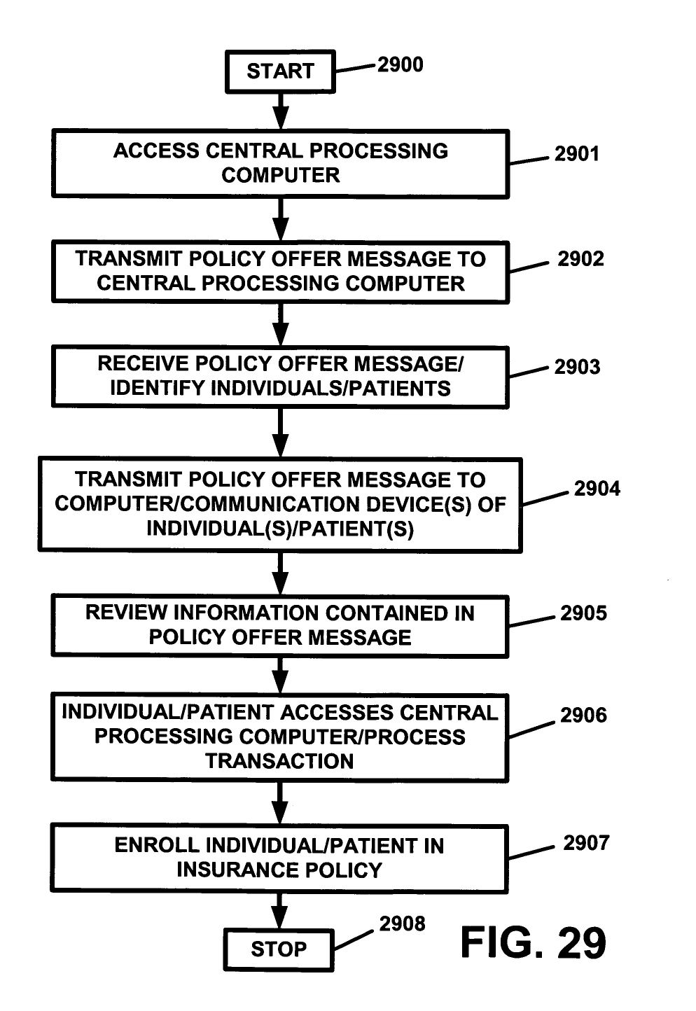

In another preferred embodiment, the present invention can be utilized in order to allow an insurer, a payer, a healthcare provider, or a provider of any goods, products, or services, to offer, and/or to transmit messages offering, their respective insurance policies, payment policies, payment plans, payment programs, benefits, benefits packages, or any other goods, products, or services, to any number of the herein-described individuals or patients who utilize the apparatus 100 of the present invention. Any of the insurance policies offered via this embodiment can be a policy for healthcare insurance, disability insurance, life insurance, automobile insurance, homeowner's insurance, property or casualty insurance, or any other insurance policy, payer policy, payer program, or payer plan. FIG. 29 illustrates, in flow diagram form, another preferred embodiment method for utilizing the apparatus 100 and method of the present invention in order to allow an insurer, a payer, a healthcare provider, or a provider of any goods, products, or services, to offer, and/or to transmit messages offering, their respective insurance policies, payment policies, payment plans, payment programs, benefits, benefits packages, or any other goods, products, or services, to any number of the herein-described individuals or patients who utilize the apparatus 100 of the present invention. Thereafter, an individual or patient can purchase a respective insurance policy, payment policy, payment plan, payment program, benefits, benefits package, or any other good, product, or service. offered by the respective insurer, a payer, a healthcare provider, or provider.

In the description of the preferred embodiment of FIG. 29, the operation of the apparatus 100 is described as being utilized in connection with selling a healthcare insurance policy. It is, however, important to note that the embodiment of FIG. 29 can also be utilized in a same, a similar, or an analogous, manner in connection with selling disability insurance, life insurance, automobile insurance, homeowner's insurance, property or casualty insurance, or any other insurance policy, payer policy, payer program, or payer plan, or in connection with selling any good, product, or service. In a preferred embodiment, any number of insurers or payers, or any number of providers, can offer their respective healthcare insurance policies, plans, or programs, disability insurance policies, plans, or programs, life insurance policies, plans, or programs, automobile insurance policies, plans, or programs, homeowner's insurance policies, plans, or programs, property or casualty insurance policies, plans, or programs, or any other insurance, policies, plans, or programs, payer policies, payer programs, payer plans, or any goods, products, or services, for sale via the apparatus 100 of the present invention. In another preferred embodiment of FIG. 29, the apparatus 100 can also be utilized in a same, a similar, or an analogous, manner in order to sell any type or kind of good, product, or service, which can be healthcare-related goods, products, or services, or non-healthcare-related goods, products, or services, or any other goods, products, or services, which can be the subject of commerce.

With reference to FIG. 29, the operation of the apparatus 100 commences at step 2900. At step 2901, the insurer offering a healthcare insurance policy can access the central processing computer 10 via its payer computer or communication device 30. At step 2902, the insurer can enter and transmit, to the central processing computer 10, a policy offer message containing its offering of a healthcare insurance policy along with details regarding the healthcare insurance policy being offered. The policy offer message can also contain contact information regarding, or a link or a hyperlink to a computer or communication device 30 associated with the insurer.

At step 2903, the central processing computer 10 can receive the policy offer message, and can identify the individuals or patients, who may have, or who may not have, indicated an interest in receiving same, and to whom the policy offer message can be transmitted. At step 2904, the central processing computer 10 can transmit the policy offer message to any number of, or all of, the identified individuals or patients, by transmitting the policy offer message to the respective patient computer or communication device 40 associated with the respective individual or patient.

At step 2905, the individual or the patient can review the offer contained in the policy offer message. If the individual or the patient desires to purchase the healthcare insurance policy offered in the policy offer message, he or she, at step 2906, can access the central processing computer 10, or the insurer's payer computer or communication device 30, via his or her patient computer or communication device 40. In the case of accessing the insurer's payer computer or communication device 30, the individual or the patient can access same by using a link or a hyperlink provided in the policy offer message. At step 2906, the central processing computer 10, or the computer or communication device 30 associated with the insurer, whichever the case may be, can then process information or transaction information regarding or involving the individual's or the patient's purchase of the healthcare insurance policy.

At step 2906, the individual or the patient can enter any needed or required information for enrolling the individual or patient, and any dependents or other beneficiaries of the individual or the patient, if applicable, in the healthcare insurance policy. At step 2906, any information for enrolling the individual or patient, and any dependents or other beneficiaries of the individual or the patient, if applicable, in the healthcare insurance policy can also be transmitted to and received at the respective central processing computer 10 or at the computer or communication device 30 associated with the insurer. In another preferred embodiment, the central processing computer 10, or the computer or communication device 30 associated with the insurer, can be programmed to automatically query the database 10H or the healthcare record or the healthcare file of the individual or the patient, and collect any or all needed information for enrolling the individual or the patient, and any dependents or other beneficiaries of the individual or the patient, if applicable, in the healthcare insurance policy.

At step 2907, the central processing computer 10, or the computer or communication device 30 which is associated with the insurer, whichever the case may be, can process the information and enroll the individual or the patient, and any dependents or other beneficiaries of the individual or the patient, if applicable, in the healthcare insurance policy. In another preferred embodiment, at step 2907, the central processing computer 10, or the computer or communication device 30 associated with the insurer, can also be programmed to automatically enroll the individual or the patient, and any dependents or other beneficiaries of the individual or the patient, if applicable, in the healthcare insurance policy.

At step 2907, the central processing computer 10, or the computer or communication device 30 which is associated with the insurer, can also process any payment by or on behalf of the individual or the patient. In an situation where the individual or the patient is paying for the healthcare insurance policy, the individual or the patient can make payment in any appropriate manner, such as, for example, by a credit card payment, by a debit card payment, by an electronic bill payment process or operation, by an electronic funds transfer, or by or in any other appropriate manner. In a situation where the healthcare insurance policy is to be paid for by a third party, such as, for example, by an employer of the individual or the patient as part of an employee benefits package, or by any person, entity, or third party, the individual or the patient can provide any needed information identifying the employer, or the person, entity, or third party, and payment can be effected from a financial account associated with that employer, or from a financial account associated with that person, entity, or third party, using information stored regarding that employer, or that person, entity, or third party, or any respective financial account associated with same.

The central processing computer 10 can then record and store, in the individual's or the patient's healthcare record or healthcare file, or in the database 10H, any information regarding the healthcare insurance or the healthcare insurance policy purchased by or for the individual or the patient. Thereafter, the operation of the apparatus 100 will cease at step 2908.

The apparatus 100, in the embodiment of FIG. 29, can also be utilized in a same, a similar, or an analogous, manner in order to allow an insurer, payer, or any provider, to sell, or to offer to sell, disability insurance, life insurance, automobile insurance, homeowner's insurance, property or casualty insurance, or any other insurance policy, payer policy, payer program, or payer plan, or can be utilized in connection with selling any good, product, or service, which can be the subject of commerce.

In another preferred embodiment, the apparatus 100 of the present invention can also be utilized in order to provide for the selling or the purchasing of any type or kind of healthcare insurance policy, disability insurance policy, life insurance policy, automobile insurance policy, homeowner's insurance policy, property or casualty insurance policy, or any other insurance or insurance policies described or noted herein, payer policy, payer program, or payer plan, and can provide for allowing any individual, patient, employer, third party, or intermediary, to pay for same, with any and/or all information regarding the respective healthcare insurance policy, disability insurance policy, life insurance policy, automobile insurance policy, homeowner's insurance policy, property or casualty insurance policy, or any other insurance or insurance policies, or any other insurance policy, payer policy, payer program, or payer plan, being stored in the database 10H, in the central processing computer 10, or in any other computer or communication device described herein.

In another preferred embodiment, the apparatus 100 of the present invention can provide for the portability of benefits, such as the portability of healthcare insurance, disability insurance, life insurance, or their respective policies, plans, or programs, or any other related or unrelated insurance policy, payer policy, payer program, or payer plan, from one job to another job, from one employment relationship to another employment relationship, from a period of employment to or during a period of unemployment, from or during a period of unemployment to a period of employment, from a period of employment to or during a period of self-employment, or from a period of employment to, through, or during, a period of retirement, or from or between, or during, any employment or unemployment period or status of an individual or a patient.

The apparatus 100 of the present invention, by storing information regarding the respective healthcare insurance policy, disability insurance policy, life insurance policy, or any other related or unrelated insurance policy, payer policy, payer program, or payer plan, and by allowing for the payment for same via the apparatus 100, such as by or from accounts associated with, individuals, patients, employers, third parties, or intermediaries, or any other person or entity, facilitates the portability of these respective healthcare insurance policies, disability insurance policies, life insurance policies, or any other related or unrelated insurance policies, plans, or programs, or any payer policies, payer programs, or payer plans. By storing this information in a healthcare record or a healthcare file of an individual or a patient, and by making it possible for individuals, patients, employers, third parties, or intermediaries, or any other person or entity, to pay for same, the apparatus 100 and method of the present invention facilitates the portability of these healthcare insurance policies, disability insurance policies, life insurance policies, or any other related or unrelated insurance policies, payer policies, payer programs, or payer plans, from one job to another job, from one employment relationship to another employment relationship, from a period of employment to or during a period of unemployment, from or during a period of unemployment to a period of employment, from a period of employment to or during a period of self-employment, or from a period of employment to, through, or during, a period of retirement, or from or between, or during, any employment or unemployment period or status of an individual or a patient.

In another preferred embodiment, any and/or all of the herein-described embodiments of the apparatus 100 and method of the present invention can be utilized in a same, a similar, or an analogous, manner in order to provide healthcare information, healthcare-related information, and/or any of the herein-described functionality, for or regarding animals of any type or kind, pets, dogs, cats, domestic animals, zoo animals, theme park animals, circus animals, animals used in entertainment shows or water shows, or any other animals for which an owner, keeper, or caretaker, desires to store or maintain a healthcare record, a healthcare file, or a healthcare history, or for which an owner, keeper, or caretaker, desires to utilize any of the functionality described herein as being provided by the apparatus 100 and method of the present invention.

In another preferred embodiment, as well as any and/or all of the embodiments described herein, the apparatus 100, the central processing computer 10, or any provider computer or communication device 20 associated with any laboratory testing provider, can also generate a message containing laboratory testing results and transmit same to a patient computer or communication device 40 associated with or used by an individual or a patient and/or to a provider computer or communication device 20 associated with or used by the healthcare provider of the individual or patient who ordered the test, or can be transmitted to a provider computer or communication device 20 of or associated with any other healthcare provider of the individual or patient. The message can also be sent to the central processing computer 10 and can be stored in the healthcare record or healthcare file of the individual or the patient.

Any and/or all of the signals, messages, reports, notification messages, or any other communications, described herein as being transmitted from one device, computer, or communication device, to another, can be, or can be included in, or be attached to, an e-mail message, an instant messaging message, an electronic transmission, or electronic data transmission or any other data or information transmission, or any data or information exchange, or an electronic data interchange, and can be transmitted via any appropriate or necessary computer(s) or device(s).

In another preferred embodiment, the apparatus 100 and method of the present invention can process any of the data or information described herein as being recorded or stored, processed by, or generated by, the apparatus 100 and method of the present invention, so as to obtain information for or regarding the meaningful use of electronic healthcare records, electronic medical records, or electronic dental records.

In another preferred embodiment, as well as in any of the embodiments described herein, intelligent agents, software agents, mobile agents, and/or related technologies, can be utilized in conjunction with the present invention. The respective intelligent agent(s), software agent(s), mobile agent(s), (hereinafter referred to collectively as “intelligent agent” or “intelligent agents”) can be programmed and/or designed to act on behalf of the respective patients, users, providers, payers, and/or intermediaries, so as to act on behalf of the respective party as well as to perform any of processing functions and/or other functions described herein.

The intelligent agent can act on behalf of the respective party in various related interactions and/or other activities which are described as being performed herein and/or which may be incidental and/or related thereto. Therefore, the present invention also provides an agent-based apparatus and method for providing healthcare information and/or healthcare-related information.

Applicant hereby incorporates by reference herein the subject matter of the Agent Sourcebook, A Complete Guide to Desktop, Internet and Intranet Agents, by Alper Caglayan and Colin Harrison, Wiley Computer Publishing, 1997. Applicant also incorporates by reference herein the subject matter of Cool Intelligent Agents For The Net, by Leslie L. Lesnick with Ralph E. Moore, IDG Books Worldwide, Inc. 1997.

The apparatus of the present invention, in any and/or all of the embodiments described herein, can also be programmed to be self-activating and/or activated automatically.

The apparatus of the present invention can also be programmed in order to automatically generate and/or transmit any of the e-mails, electronic message transmissions, electronic notification transmissions, and/or any of the communications, which are described herein, between any of the parties which utilize the present invention.

The present invention, in any and/or all of the herein-described embodiments, can utilize electronic commerce technologies and security methods, techniques and technologies, as described and as set forth in Electronic Commerce Technical, Business, and Legal Issues, Nabil R. Adam, et al. Prentice Hall, 1999 and Web Security & Commerce, Simson Garfinkel with Gene Spafford, O'Reilly 1997, the subject matter of which are hereby incorporated by reference herein.

The communications networks and/or systems on, or over, which the present invention may be utilized, can include any one or combination of telecommunication networks or systems, satellite communication networks or systems, radio communication networks or systems, digital communication networks or systems, digital satellite communication networks or systems, personal communications services networks or systems, cable television networks or systems, broadband communication networks or systems, low earth orbiting satellite (LEOs) networks or systems, wireless communication networks or systems, wireless Internet networks or systems, wireless World Wide Web networks or systems, as well as in, or on any internets and/or intranets, the Internet, the World Wide Web, and any other suitable communication network or system.

The data and/or information, described as being stored in the database 10H and/or in any of the other databases described herein, can be continuously updated so as to store the latest values for the data and/or information and can be stored and be made available for future processing routines.

Any and/or all of the data and/or information described herein, which is stored in the database 10H, or in the collection of databases, can be linked via relational database techniques and/or via any appropriate database management techniques. The data and/or information, in the preferred embodiments, can be updated via inputs from any of the computers and/or communication devices 10, 20, 30, 40, and/or 50, and/or external computers or communication devices, described herein, in real-time, and/or via dynamically linked database management techniques. The above-described updates can also be provided from other information sources via the communication network.

The data and/or information which is stored in the database 10H and/or which may be otherwise utilized with, and/or in conjunction with, the apparatus and method of the present invention, can be linked via any suitable data linking techniques such as, for example, dynamically linked lists (DLLs), linked lists, and object links embedded (OLE's). Any suitable database management technique(s) may also be utilized in conjunction with the present invention.

The present invention provides an apparatus and a method for providing comprehensive information in the healthcare fields and/or healthcare-related fields. The present invention also provides valuable services to the various parties who seek, provide, pay for, administer, and/or monitor healthcare services, goods and/or products as well as healthcare-related services, goods, and/or products.

The present invention can provide comprehensive and accurate information to any of the parties described herein so as to facilitate an improved healthcare system which can provide up-to-date patient, provider, payer, and/or intermediary, information. The present invention, by facilitating the creation and maintenance of a comprehensive database of information, which can be accessed on a global basis, at any time of day or night, and from any location, can provide patients, providers, payers, and/or intermediaries, with information which can improve healthcare treatments, reduce the likelihood of errors in diagnoses and/or prescribed treatments, reduce healthcare costs, reduce the likelihood of incorrect and/or fraudulent care, and can provide for a healthcare system which is characterized by an improved quality of care and cost efficiency.

Any of the messages or information described herein, which, can be transmitted to or provided to any of the individuals, patients, providers, payers, insurers, insurance companies, employers, and third party intermediaries, who or which use the apparatus 100 and method of the present invention, can contain or include advertisements or marketing materials or information regarding any good, product, or service, which may be of interest to a respective individual, patient, provider, payer, insurer, insurance company, healthcare insurance company, healthcare maintenance organization, or any other healthcare-related entity, employer, or third party intermediary. In this manner, the apparatus 100 and method of the present invention can be used to market any goods, products, or services, including any healthcare goods, products, or services, healthcare provider goods, products, services, medications, therapies, healthcare, life, or disability, insurance products or services, or any other goods, products, or services, which can be marketed to, or which may be of interest to, any respective individual, patient, provider, payer, insurer, insurance company, healthcare insurance company, healthcare maintenance organization, or any other healthcare-related entity, employer, or third party intermediary, who or which utilize the apparatus 100 and method of the present invention.

In this manner, the apparatus 100 and method of the present invention can also be used to advertise or market any goods, products, or services, including any healthcare goods, products, or services, healthcare provider goods, products, services, medications, therapies, healthcare, life, or disability, insurance products or services, or any other goods, products, or services, which can be marketed to, or which may be of interest to, any respective individual, patient, provider, payer, insurer, insurance company, healthcare insurance company, healthcare maintenance organization, or any other healthcare-related entity, employer, or third party intermediary. In this manner, the apparatus 100 can also be utilized to generate advertising revenues.

In another preferred embodiment, the apparatus 100 and method of the present invention, and in particular, the central processing computer 10, can process transactions regarding or involving the purchase and/or sale of goods, products, services, healthcare insurance policies, life insurance policies, disability insurance policies, group healthcare insurance policies, group life insurance policies, group disability insurance policies, healthcare, life, or disability, insurance products and/or services, healthcare goods, products, or services, provider offered goods, products, or services, health and/or wellness goods, products, or services, exercise goods, products, or services, drugs, medications, or any other good(s), product(s), or service(s), which may be of interest to any of the of the individuals, patients, providers, payers, insurers, insurance companies, employers, or third party intermediaries, who or which utilize the apparatus 100 and method of the present invention. In this regard, the apparatus 100 of the present invention can also be utilized as a venue, site, or portal, for conducting electronic commerce, or web-based or Internet-based commerce, or cable television-based, or telecommunication networked-based commerce, with or in any of the various goods, products, or services, which can or may be offered for sale via the apparatus 100 of the present invention.

In addition to any and/or all of the preferred embodiments described herein, the present invention can also be utilized in other preferred embodiments so as to incorporate, so as to improve upon, and/or so as to utilize, various teachings of the prior art. In this regard, Applicant hereby incorporates by reference herein the subject matter of the following U.S. patents for their respective teachings: U.S. Pat. No. 5,988,851 which teaches a medical treatment and or diagnostic system; U.S. Pat. No. 5,974,124 which teaches a methods and system aiding medical diagnosis and treatment; U.S. Pat. No. 5,961,448 which teaches a virtual medical instrument for performing medical diagnostic testing on patients; U.S. Pat. No. 5,957,854 which teaches a wireless medical diagnosis and monitoring equipment; U.S. Pat. No. 5,954,641 which teaches a method, apparatus and operating system for managing the administration of medication and medical treatment regimens; U.S. Pat. No. 5,935,060 which teaches a computerized medical diagnostic and treatment advice system including list based processing; U.S. Pat. No. 5,910,107 which teaches a computerized medical diagnostic and treatment advice method; U.S. Pat. No. 5,899,857 which teaches a medical treatment method with scanner input; U.S. Pat. No. 5,895,354 which teaches an integrated medical diagnostic center; U.S. Pat. No. 5,878,746 which teaches a computerized medical diagnostic system; U.S. Pat. No. 5,876,351 which teaches a portable modular diagnostic medical device; U.S. Pat. No. 5,868,669 which teaches a computerized medical diagnostic and treatment advice system; U.S. Pat. No. 5,862,803 which teaches a wireless medical diagnosis and monitoring system; U.S. Pat. No. 5,839,438 which teaches a computer-based neural network system and method for medical diagnosis and interpretation; U.S. Pat. No. 5,807,256 which teaches a medical information processing system for supporting diagnosis; U.S. Pat. No. 5,807,246 which a display device in medical examination and treatment system; U.S. Pat. No. 5,801,755 which teaches an interactive communication system for medical treatment of remotely located patients; U.S. Pat. No. 5,797,901 which teaches an automatic activation system for a medical diagnostic monitoring and surgical apparatus and method therefore; U.S. Pat. No. 5,779,634 which teaches a medical information processing system for supporting diagnosis; U.S. Pat. No. 5,776,057 which teaches a virtual medical instrument for performing medical diagnostic testing on patients; U.S. Pat. No. 5,761,334 which teaches an apparatus for computer aided diagnosis of medical images having abnormal patterns; U.S. Pat. No. 5,724,968 which teaches a computerized medical diagnostic system including meta function; U.S. Pat. No. 5,666,953 which teaches a system and associated method for providing information for use in forming medical diagnosis; U.S. Pat. No. 5,660,176 which teaches a computerized medical diagnostic and treatment advice system; U.S. Pat. No. 5,594,638 which teaches a computerized medical diagnostic system including re-enter function and sensitivity factors; U.S. Pat. No. 5,583,758 which teaches a health care management system for managing medical treatments and comparing user-proposed and recommended resources required for treatment; U.S. Pat. No. 5,551,436 which teaches a medical diagnosis system; U.S. Pat. No. 5,544,651 which teaches a medical system and associated method for automatic treatment; U.S. Pat. No. 5,437,278 which teaches medical diagnosis system and method; U.S. Pat. No. 5,415,167 which teaches a medical system and associated method for automatic diagnosis and treatment; U.S. Pat. No. 5,360,005 which teaches a medical diagnosis device for sensing cardiac activity and blood flow; U.S. Pat. No. 5,331,550 which teaches an application of neural networks as an aid in medical diagnosis and general anomaly detection; U.S. Pat. No. 5,324,077 which teaches a medical data draft for tracking and evaluating medical treatment; U.S. Pat. No. 5,305,748 which teaches a medical diagnostic system and related method; U.S. Pat. No. 5,279,294 which teaches a medical diagnostic system; U.S. Pat. No. 5,255,187 which teaches a computer aided medical diagnostic method and apparatus; U.S. Pat. No. 5,235,510 which teaches a computer-aided diagnosis system for medical use; U.S. Pat. No. 5,090,417 which teaches a medical diagnostic apparatus; U.S. Pat. No. 4,733,354 which teaches a method and apparatus for automated medical diagnosis using decision tree analysis; U.S. Pat. No. 4,731,725 which teaches a data processing system which suggests a pattern of medical tests to reduce the number of tests necessary to confirm or deny a diagnosis; U.S. Pat. No. 4,674,512 which teaches a medical electrode for monitoring and diagnostic use; U.S. Pat. No. 4,674,108 which teaches a digital X-ray medical diagnostic apparatus; U.S. Pat. No. 4,641,659 which teaches a medical diagnostic microwave scanning apparatus; U.S. Pat. No. 4,290,114 which teaches a medical diagnostic computer; U.S. Pat. No. 4,251,850 which teaches a control desk for medical apparatus, in particular for an x-ray diagnostic apparatus; U.S. Pat. No. 4,242,911 which teaches an ultrasonic medical diagnostic apparatus and method; U.S. Pat. No. 4,235,454 which teaches a stabilization system for a medical diagnostic device; U.S. Pat. No. 4,209,022 which teaches an echography apparatus for medical diagnosis, using a multiple-element probe; U.S. Pat. No. 4,170,987 which teaches a medical diagnosis system and method with multispectral imaging; U.S. Pat. No. 4,110,723 which teaches an ultrasonic apparatus for medical diagnosis; and U.S. Pat. No. 3,978,850 which teaches medical diagnostic instruments.

The apparatus 100 and method of the present invention can provide an apparatus and a method, as well as can provide a healthcare record, a healthcare file, a healthcare history, an electronic healthcare record, an electronic medical record, an electronic dental record, or any other electronic file or history, which can perform any of the functions or functionality described herein as being capable of being provided by the apparatus 100 and method of the present invention.

While the present invention has been described and illustrated in various preferred and alternate embodiments, such descriptions are merely illustrative of the present invention and are not to be construed to be limitations thereof. In this regard, the present invention encompasses all modifications, variations and/or alternate embodiments, with the scope of the present invention being limited only by the claims which follow.

What is claimed is:

1. A computer-implemented method, comprising:
storing information regarding a plurality of individuals, a plurality of healthcare providers, and at least one healthcare insurer or healthcare payer, in a database or a memory device, wherein the information regarding a plurality of individuals, a plurality of healthcare providers, and at least one healthcare insurer or healthcare payer, includes a healthcare record or a healthcare history of, for, or associated with, each individual of the plurality of individuals, including a healthcare record or a healthcare history of, for, or associated with, an individual, information regarding a healthcare practice of, and an insurance accepted by, each of the plurality of healthcare providers, including information regarding a healthcare practice of, and an insurance accepted by, a healthcare provider, and information, a link, or a hyperlink, for allowing or for facilitating a healthcare provider, a healthcare insurer, a healthcare payer, or a third party, to access, control, monitor, or obtain information from, a healthcare device or a piece of healthcare equipment used to remotely monitor or to remotely obtain information from or regarding an individual;
processing, with or using a processing device, information for allowing a healthcare provider, a healthcare insurer, a healthcare payer, or a third party, to remotely access, via the Internet or the World Wide Web, using a first computer or a first communication device associated with or used by a healthcare provider, a healthcare insurer, a healthcare payer, or a third party, and using information, a link, or a hyperlink, stored in the database or the memory device or in the healthcare record or the healthcare history of the individual, a healthcare device or a piece of healthcare equipment used to remotely monitor or to remotely obtain information from or regarding an individual;
receiving information, a measurement, or a reading, regarding the individual obtained with or from the healthcare device or the piece of healthcare equipment;
storing the information, the measurement, or the reading, obtained with or from the healthcare device or the piece of healthcare equipment in the healthcare record or the healthcare history of the individual, or updating the healthcare record or the healthcare history of the individual with the information, the measurement, or the reading, obtained with or from the healthcare device or the piece of healthcare equipment.

2. The computer-implemented method of claim 1, further comprising:
processing, using the processing device or a computer, information regarding a prescription or a referral for the individual;
generating the prescription or the referral;
transmitting information regarding the prescription or the referral to a second computer or a second communication device, wherein the second computer or the second communication device is associated with or used by a second provider who or which can fill the prescription or who or which can provide a healthcare service for the individual.

3. The computer-implemented method of claim 1, further comprising:
storing information regarding the prescription or the referral in the healthcare record or the healthcare history of the individual.

4. The computer-implemented method of claim 1, further comprising:
generating an insurance claim, wherein the insurance claim is automatically generated by the processing device or by a computer, in response to the storing of the information, the measurement, or the reading, obtained with or from the healthcare device or the piece of healthcare equipment in the healthcare record or the healthcare history of the individual, or in response to the updating of the healthcare record or the healthcare history of the individual with the information, the measurement, or the reading, obtained with or from the healthcare device or the piece of healthcare equipment, wherein the insurance claim is suitable for being automatically submitted to a healthcare insurer or a healthcare payer associated with the individual or is suitable for being automatically transmitted to a second computer or to a second communication device, wherein the second computer or the second communication device is associated with a healthcare insurer or a healthcare payer associated with the individual; and
transmitting the insurance claim to the second computer or to the second communication device.

5. The computer-implemented method of claim 1, further comprising:
remotely dispensing or administering a medication, a medication, or a drug, to the individual via the healthcare device or the piece of healthcare equipment.

6. The computer implemented method of claim 1, wherein the healthcare device or the piece of healthcare equipment is located at a home, at a hospital, or at a healthcare facility.

7. The computer-implemented method of claim 1, wherein the healthcare device or the piece of healthcare equipment is located at or in a vehicle.

8. The computer-implemented method of claim 7, wherein the vehicle is an automobile, an ambulance, an emergency vehicle, a truck, a bus, a train, a subway train, or other land vehicle.

9. The computer-implemented method of claim 7, wherein the vehicle is a boat, a ship, a cruise ship, or a marine vessel.

10. The computer-implemented method of claim 7, wherein the vehicle is a helicopter, an airplane, an aircraft, or a jet.

11. A computer-implemented method, comprising:
storing information regarding a plurality of individuals, a plurality of healthcare providers, and at least one healthcare insurer or healthcare payer, in a database or a memory device, wherein the information regarding a plurality of individuals, a plurality of healthcare providers, and at least one healthcare insurer or healthcare payer, includes a healthcare record or a healthcare history of, for, or associated with, each individual of the plurality of individuals, including a healthcare record or a healthcare history of, for, or associated with, an individual, information regarding a healthcare practice of, and an insurance accepted by, each of the plurality of healthcare providers, including information regarding a healthcare practice of, and an insurance accepted by, a healthcare provider, and information, a link, or a hyperlink, for allowing or for facilitating an individual, to obtain information regarding an employee benefit the individual is enrolled in or is a beneficiary under, or to submit or to file a claim or a request for, or pursuant to, an employee benefit;
processing, with or using a processing device, information for allowing an individual to access a healthcare record or a healthcare history of the individual with or using a first computer or a first communication device;
processing information for allowing the individual to access or obtain information, a link, or a hyperlink, to information regarding an employee benefit in which the individual is enrolled;
processing information regarding an information request regarding the employee benefit or processing information for generating a claim or a request for, or pursuant to, the employee benefit;
generating a message containing information responsive to the information request or responsive to the claim or the request for, or pursuant to, the employee benefit; and
transmitting the message to the first computer or to the first communication device.

12. The computer-implemented method of claim 11, wherein the message contains information confirming that the claim or the request was received.

13. The computer-implemented method of claim 11, wherein the message contains information that the claim or the request is allowed or will be allowed, that a benefit or a payment in response to the claim or the request will be provided, or that a payment has been made, or will be made, to a financial account, a savings account, a checking account, or any other employee benefit financial account, of or associated with the individual.

14. The computer-implemented method of claim 11, further comprising:
storing information regarding the claim or the request, or storing the message or information regarding the message, in the healthcare record or the healthcare history of the individual.

15. The computer-implemented method of claim 11, further comprising:
processing information for allowing the individual to purchase, or to purchase an upgrade for, a healthcare insurance policy, a disability insurance policy, or a life insurance policy.

16. The computer-implemented method of claim 11, further comprising:
processing information for enrolling the individual in a healthcare insurance policy, a disability insurance policy, or a life insurance policy.

17. The computer-implemented method of claim 11, further comprising:
storing, in the healthcare record or the healthcare history of the individual, information regarding the enrollment of the individual in the healthcare insurance policy.

18. The computer-implemented method of claim 11, further comprising:
processing information regarding a need or a requirement of the individual for a healthcare insurance policy;
generating a message containing information regarding the need or the requirement of the individual for a healthcare insurance policy; and
transmitting the message to second computer or a second communication device, wherein the second computer or the second communication device is associated with or used by a healthcare insurance company.

19. The computer-implemented method of claim 18, further comprising:
receiving a policy offer message from the second computer or the second communication device, wherein the policy offer message contains an offer of a healthcare insurance policy in response to the message;
providing the policy offer message to the individual;
processing information regarding a purchase of the healthcare insurance policy by the individual; and
enrolling the individual in the healthcare insurance policy.

20. The computer-implemented method of claim 11, further comprising:
receiving a policy offer message from a second computer or a second communication device, wherein the second computer or the second communication device is associated with or used by a healthcare insurance company;
providing the policy offer message to the individual;
processing information regarding a purchase of the healthcare insurance policy by the individual; and
enrolling the individual in the healthcare insurance policy.
